(19) United States
(12) Patent Application Publication
(10) Pub. No.: US 2023/0336694 A1
(43) Pub. Date: Oct. 19, 2023

(54) Tagging Characteristics of an Interpersonal Encounter Based on Vocal Features

(71) Applicant: OrCam Technologies Ltd., Jerusalem (IL)

(72) Inventors: Yonatan Wexler, Jerusalem (IL); Amnon Shashua, Jerusalem (IL); Nir Sancho, Jerusalem (IL); Tal Rosenwein, Herzliya (IL); Roi Nathan, Jerusalem (IL)

(21) Appl. No.: 18/331,836

(22) Filed: Jun. 8, 2023

Related U.S. Application Data
(63) Continuation of application No. PCT/IB2021/000834, filed on Nov. 30, 2021.
(60) Provisional application No. 63/125,537, filed on Dec. 15, 2020.

(51) Int. Cl. H04N 7/18; G10L 17/06; G10L 25/63; G06V 20/50; G06V 10/764; G06V 40/16

(52) U.S. Cl. CPC H04N 7/183; G10L 17/06; G10L 25/63; G06V 20/50; G06V 10/764; G06V 40/174

(57) ABSTRACT

Embodiments are provided for a system comprising a camera, a microphone, and at least one processor programmed to execute a method, which may include: identifying at least one individual speaker in a first environment of a user; applying a voice classification model to classify at least a portion of an audio signal into one of a plurality of voice classifications based on at least one voice characteristic, the voice classifications denoting an emotional state of the at least one individual speaker; applying a context classification model to classify the first environment of the user into one of a plurality of contexts; associating, in at least one database, the at least one individual speaker with the voice classification, and the context classification of the first environment; and providing, to the user, at least one of an audible, visible, or tactile indication of the association.

### CROSS REFERENCE TO RELATED APPLICATION

This application claims the benefit of priority of U.S. Provisional Patent Application No. 63/125,537, filed on Dec. 15, 2020. The foregoing application is incorporated herein by reference in its entirety.

### BACKGROUND

### Technical Field

This disclosure generally relates to devices and methods for capturing and processing images and audio from an environment of a user, and using information derived from captured images and audio.

### Background Information

Today, technological advancements make it possible for wearable devices to automatically capture images and audio, and store information that is associated with the captured images and audio. Certain devices have been used to digitally record aspects and personal experiences of one's life in an exercise typically called “lifelogging.” Some individuals log their life so they can retrieve moments from past activities, for example, social events, trips, etc. Lifelogging may also have significant benefits in other fields (e.g., business, fitness and healthcare, and social research). Lifelogging devices, while useful for tracking daily activities, may be improved with capability to enhance one's interaction in his environment with feedback and other advanced functionality based on the analysis of captured image and audio data.

Even though users can capture images and audio with their smartphones and some smartphone applications can process the captured information, smartphones may not be the best platform for serving as lifelogging apparatuses in view of their size and design. Lifelogging apparatuses should be small and light, so they can be easily worn. Moreover, with improvements in image capture devices, including wearable apparatuses, additional functionality may be provided to assist users in navigating in and around an environment, identifying persons and objects they encounter, and providing feedback to the users about their surroundings and activities. Therefore, there is a need for apparatuses and methods for automatically capturing and processing images and audio to provide useful information to users of the apparatuses, and for systems and methods to process and leverage information gathered by the apparatuses.

### SUMMARY

Embodiments consistent with the present disclosure provide devices and methods for automatically capturing and processing images and audio from an environment of a user, and systems and methods for processing information related to images and audio captured from the environment of the user.

In an embodiment, a system for associating individuals with context may comprise a camera configured to capture images from an environment of a user and output a plurality of image signals, the plurality of image signals including at least a first image signal and a second image signal; a microphone configured to capture sounds from an environment of the user and output a plurality of audio signals, the plurality of audio signals including at least a first audio signal and a second audio signal; and at least one processor. The at least one processor may be programmed to execute a method comprising receiving the first image signal output by the camera; receiving the first audio signal output by the microphone; and recognizing, based on at least one of the first image signal or the first audio signal, at least one individual in a first environment of the user. The method may further comprise applying a context classifier to classify the first environment of the user into one of a plurality of contexts, based on information provided by at least one of the first image signal, the first audio signal, an external signal, or a calendar entry; and associating, in at least one database, the at least one individual with the context classification of the first environment. The method may further comprise subsequently recognizing, based on at least one of the second image signal or the second audio signal, the at least one individual in a second environment of the user; and providing, to the user, at least one of an audible, visible, or tactile indication of the association of the at least one individual with the context classification of the first environment.

In an embodiment, a method for associating individuals with context is disclosed. The method may comprise receiving a plurality of image signals output by a camera configured to capture images from an environment of a user, the plurality of image signals including at least a first image signal and a second image signa; receiving a plurality of audio signals output by a microphone configured to capture sounds from an environment of the user, the plurality of audio signals including at least a first audio signal and a second audio signal; and recognizing, based on at least one of the first image signal or the first audio signal, at least one individual in a first environment of the user. The method may further comprise applying a context classifier to classify the first environment of the user into one of a plurality of contexts, based on information provided by at least one of the first image signal, the first audio signal, an external signal, or a calendar entry; and associating, in at least one database, the at least one individual with the context classification of the first environment. The method may further comprise subsequently recognizing, based on at least one of the second image signal or the second audio signal, the at least one individual in a second environment of the user; and providing, to the user, at least one of an audible, visible, or tactile indication of the association of the at least one individual with the context classification of the first environment.

In an embodiment, a system may comprise a camera configured to capture a plurality of images from an environment of a user, and at least one processor. The at least one processor may be programmed to execute a method, the method comprising receiving an image signal comprising the plurality of images; detecting an unrecognized individual shown in at least one of the plurality of images taken at a first time; and determining an identity of the detected unrecognized individual based on acquired supplemental information. The method may further comprise accessing at least one database and comparing one or more characteristic features associated with the detected unrecognized individual with features associated with one or more previously unidentified individuals represented in the at least one database; and based on the comparison, determining whether the detected unrecognized individual corresponds to any of the previously unidentified individuals represented in the at least one database. The method may then comprise if the detected unrecognized individual is determined to correspond to any of the previously unidentified individuals represented in the at least one database, updating at least one record in the at least one database to include the determined identity of the detected unrecognized individual.

In an embodiment, a system may comprise a camera configured to capture a plurality of images from an environment of a user, and at least one processor. The at least one processor may be programmed to execute a method, the method comprising receiving an image signal comprising the plurality of images; detecting a first individual and a second individual shown in the plurality of images; determining an identity of the first individual and an identity of the second individual; and accessing at least one database and storing in the at least one database one or more indicators associating at least the first individual with the second individual.

In an embodiment, a system may comprise a camera configured to capture a plurality of images from an environment of a user, and at least one processor. The at least one processor may be programmed to execute a method, the method comprising receiving an image signal comprising the plurality of images; detecting a first unrecognized individual represented in a first image of the plurality of images; and associating the first unrecognized individual with a first record in a database. The method may further comprise detecting a second unrecognized individual represented in a second image of the plurality of images; associating the second unrecognized individual with the first record in a database: determining, based on supplemental information, that the second unrecognized individual is different from the first unrecognized individual; and generating a second record in the database associated with the second recognized individual.

In an embodiment, a system may comprise a camera configured to capture a plurality of images from an environment of a user, and at least one processor. The at least one processor may be programmed to receive the plurality of images; detect one or more individuals represented by one or more of the plurality of images; and identify at least one spatial characteristic related to each of the one or more individuals. The at least one processor may further be programmed to generate an output including a representation of at least a face of each of the detected one or more individuals together with the at least one spatial characteristic identified for each of the one or more individuals; and transmit the generated output to at least one display system for causing a display to show to a user of the system a timeline view of interactions between the user and the one or more individuals, wherein representations of each of the one or more individuals are arranged on the timeline according to the identified at least one spatial characteristic associated with each of the one or more individuals.

In an embodiment, a graphical user interface system for presenting to a user of the system a graphical representation of a social network may comprise a display, a data interface, and at least one processor. The at least one processor may be programmed to receive, via the data interface, an output from a wearable imaging system including at least one camera. The output may include image representations of one or more individuals from an environment of the user along with at least one element of contextual information for each of the one or more individuals. The at least one processor may further be programmed to identify the one or more individuals associated with the image representations; store, in at least one database, identities of the one or more individuals along with corresponding contextual information for each of the one or more individuals; and cause generation on the display of a graphical user interface including a graphical representation of the one or more individuals and the corresponding contextual information determined for the one or more individuals.

In an embodiment, a system or processing audio signals may comprise a camera configured to capture images from an environment of a user and output an image signal; a microphone configured to capture voices from an environment of the user and output an audio signal; and at least one processor programmed to execute a method. The method may comprise identifying, based on at least one of the image signal or the audio signal, at least one individual speaker in a first environment of the user; applying a voice classification model to classify at least a portion of the audio signal into one of a plurality of voice classifications based on at least one voice characteristic, the voice classifications denoting an emotional state of the individual speaker; applying a context classification model to classify the first environment of the user into one of a plurality of contexts, based on information provided by at least one of the image signal, the audio signal, an external signal, or a calendar entry; associating, in at least one database, the at least one individual speaker with the vocal voice classification, and the context classification of the first environment; and providing, to the user, at least one of an audible, visible, or tactile indication of the association.

In an embodiment, a system for processing audio signals may comprise a camera configured to capture a plurality of images from an environment of a user; a microphone configured to capture sounds from the environment of the user; and at least one processor programmed to execute a method. The method may comprise identifying a vocal component of the audio signal; determining whether at least one characteristic of the vocal component meets a prioritization criteria for the at least one characteristic; adjusting at least one control setting of the camera when the at least one characteristic meets the prioritization criteria; and foregoing adjustment of the at least one control setting when the at least one characteristic does not meet the prioritization criteria.

In an embodiment, a method for controlling a camera may comprise receiving a plurality of images captured by a wearable camera from an environment of a user; receiving an audio signal representative of sounds captured by a microphone from the environment of the user; identifying a vocal component of the audio signal; determining whether at least one characteristic of the vocal component meets a prioritization criteria for the at least one characteristic; adjusting at least one control setting of the camera when the at least one characteristic meets the prioritization criteria; and foregoing adjustment of the at least one control setting when the at least one characteristic does not meet the prioritization criteria.

In an embodiment, a system for tracking sidedness of conversations may comprise a microphone configured to capture sounds from the environment of the user; a communication device configured to provide at least one audio signal representative of the sounds captured by the microphone: and at least one processor programmed to execute a method. The method may comprise analyzing the at least one audio signal to distinguish a plurality of voices in the at least one audio signal; and identifying a first voice among the plurality of voices. The method may also comprise determining, based on the analysis of the at least one audio signal: a start of a conversation between the plurality of voices; an end of the conversation between the plurality of voices; a duration of time, between the start of the conversation and the end of the conversation; and a percentage of the time, between the start of the conversation and the end of the conversation, for which the first voice is present in the audio signal. Additionally, the method may comprise providing, to the user, an indication of the percentage of the time for which the first voice is present in the audio signal.

In an embodiment, a method for tracking sidedness of conversations may comprise receiving at least one audio signal representative of sounds captured by a microphone from the environment of the user; analyzing the at least one audio signal to distinguish a plurality of voices in the at least one audio signal; and identifying a first voice among the plurality of voices. The method may also comprise determining, bused on the analysis of the at least one audio signal: a start of a conversation between the plurality of voices; an end of the conversation between the plurality of voices; a duration of time, between the start of the conversation and the end of the conversation; and a percentage of the time, between the start of the conversation and the end of the conversation, in which the first voice is present in the audio signal. Additionally, the method may comprise providing, to the user, an indication of the percentage of the time in which the first voice is present in the audio signal.

In an embodiment, a system may include a camera configured to capture a plurality of images from an environment of a user, at least one microphone configured to capture at least a sound of the user's voice, a communication device configured to provide at least one audio signal representative of the user's voice, and at least one processor programmed to execute a method. The method may comprise analyzing at least one image front among the plurality of images to identify a user action, analyzing at least a portion of the at least one audio signal or at least one second image captured subsequent to the identified user action to take one or more measurements of at least one characteristic of the user's voice or behavior. The at least one characteristic may comprise at least one of—(i) a pitch of the user's voice. (ii) a tone of the user's voice, (iii) a rate of speech of the user's voice, (iv) a volume of the user's voice, (v) a center frequency of the user's voice, (vi) a frequency distribution of the user's voice, (vii) a responsiveness of the user's voice, (viii) drowsiness by the user, (ix) hyper-activity by the user, (x) a yawn by the user, (xii) a shaking of the user's hand, (xiii) a period of time in which the user is laying down, or (xiv) whether the user takes a medication. The method may also include determining, based on the one or more measurements of the at least one characteristic of the user's voice or behavior, a state of the user at the time of the one or more measurements, and determining whether there is a correlation between the user action and the state of the user at the time of the one or more measurements. If it is determined that there is a correlation between the user action and the state of the user at the time of the one or more measurements, the method may further include providing, to the user, at least one of an audible or visible indication of the correlation.

In another embodiment, a method of correlating a user action to a user state subsequent to the user action may comprise receiving, at a processor, a plurality of images from an environment of a user, receiving, at the processor, at least one audio signal representative of the user's voice, analyzing at least one image from among the received plurality of images to identify a user action, and analyzing at least a portion of the at least one audio signal or at least one second image captured subsequent to the identified user action to take one or more measurements of at least one characteristic of the user's voice or behavior. The at least one characteristic may comprise at least one of—(i) a pitch of the user's voice, (ii) a tone of the user's voice, (iii) a rate of speech of the user's voice. (iv) a volume of the user's voice, (v) a center frequency of the user's voice, (vi) a frequency distribution of the user's voice, (vii) a responsiveness of the user's voice, (viii) drowsiness by the user. (ix) hyper-activity by the user. (x) a yawn by the user. (xii) a shaking of the user's hand, (xiii) a period of time in which the user is laying down, or (xiv) whether the user takes a medication. The method may also include determining, based on the one or more measurements of the at least one characteristic of the user's voice or behavior, the user state, the user state being a state of the user at the time of the plurality of measurements, and determining whether there is a correlation between the user action and the user state. If it is determined that there is a correlation between the user action and the user state, the method may further include providing, to the user, at least one of an audible or visible indication of the correlation.

In an embodiment, a system may include a camera configured to capture a plurality of images from an environment of a user, at least one microphone configured to capture at least a sound of the user's voice, and a communication device configured to provide at least one audio signal representative of the user's voice. At least one processor may be programmed to execute a method comprising analyzing at least one image from among the plurality of images to identify an event in which the user is involved, and analyzing at least a portion of the at least one audio signal captured during the identified event to identify at least one indicator of alertness of the user based on the at least one audio signal. The method may also include tracking changes in the at least one indicator of alertness of the user during the identified event, and causing an audible or visual output to the user indicative of a level of alertness of the user during the identified event

In an embodiment, a method for detecting alertness of a user during an event may include receiving, at a processor, a plurality of images from an environment of a user, receiving, at the processor, at least one audio signal representative of the user's voice, and analyzing at least one image from among the plurality of images to identify an event in which the user is involved. The method may also include analyzing at least a portion of the at least one audio signal captured during the identified event to identify at least one indicator of alertness of the user based on the at least one audio signal, tracking changes in the at least one indicator of alertness of the user during the identified event, and causing an audible or visual output to the user indicative of a level of alertness of the user during the identified event.

In an embodiment, a system may include at least one microphone and at least one processor. The at least one microphone may be configured to capture voices from an environment of the user and output at least one audio signal, and the at least one processor may be programmed to execute a method. The method may include analyzing the at least one audio signal to identify a conversation, logging the conversation, and analyzing the at least one audio signal to automatically identify words spoken during the logged conversation. The method may also include comparing the identified words to a user-defined list of key words to identify at least one key word spoken during the logged conversation, associating, in at least one database, the identified spoken key word with the logged conversation, and providing, to the user, at least one of an audible or visible indication of the association between the spoken key word and the logged conversation.

In another embodiment, a method of detecting key words in a conversation associated with a user may include receiving, at a processor, at least one audio signal from at least one microphone, analyzing the at least one audio signal to identify a conversation, logging the conversation, and analyzing the at least one audio signal to automatically identify words spoken during the logged conversation. The method may also include comparing the identified words to a user-defined list of key words to identify at least one key word spoken during the logged conversation, associating, in at least one database, the identified spoken key word with the logged conversation, and providing, to the user, at least one of an audible or visible indication of the association between the spoken key word and the logged conversation.

In an embodiment, a system may include a user device comprising a camera configured to capture a plurality of images from an environment of a user and output an image signal comprising the plurality of images; and at least one processor. The at least one processor may be programmed to detect, in at least one of the plurality of images, a face of an individual represented in the at least one of the plurality of images; isolate at least one facial feature of the detected face; store, in a database, a record including the at least one facial feature; share the record with one or more other devices; receive a response including information associated with the individual, the response provided by one of the other devices; update the record with the information associated with the individual; and provide, to the user, at least some of the information included in the updated record.

In an embodiment, a system may include a user device. The user device may include a camera configured to capture a plurality of images from an environment of a user and output an image signal comprising the plurality of images; and at least one processor programmed to detect, in at least one of the plurality of images, a face of an individual represented in the at least one of the plurality of images; based on the detection of the face, share a record with one or more other devices; receive a response including information associated with the individual, the response provided by one of the other devices; update the record with the information associated with the individual; and provide, to the user, at least some of the information included in the updated record.

In an embodiment, a method may include capturing, by a camera of a user device, a plurality of images from an environment of a user and outputting an image signal comprising the plurality of images; detecting, in at least one of the plurality of images, a face of an individual represented in the at least one of the plurality of images; isolating at least one facial feature of the detected face; storing, in a database, a record including the at least one facial feature; sharing the record with one or more other devices; receiving a response including information associated with the individual, the response provided by one of the other devices; updating the record with the information associated with the individual; and providing, to the user, at least some of the information included in the updated record.

In an embodiment, a non-transitory computer readable medium that stores a set of instructions that is executable by at least one processor of a computing device to cause the computing device to perform a method may include capturing, by a camera of a user device, a plurality of images from an environment of a user and outputting an image signal comprising the plurality of images; detecting, in at least one of the plurality of images, a face of an individual represented in the at least one of the plurality of images; isolating at least one facial feature of the detected face; storing, in a database, a record including the at least one facial feature; sharing the record with one or more other devices; receiving a response including information associated with the individual, the response provided by one of the other devices; updating the record with the information associated with the individual; and providing, to the user, at least some of the information included in the updated record.

In an embodiment, a wearable camera-based computing device may include a camera configured to capture a plurality of images from an environment of a user and output an image signal comprising the plurality of images, and a memory unit including a database configured to store information related to each individual included in a plurality of individuals, the stored information including one or more facial characteristics and at least one of: a name, a place of employment, a job title, a place of residence, a birthplace, an age, an indication of expertise, a name of a college or university attended by the individual, one or more interests shared by the user and the individual, one or more likes or dislikes shared by the user and the individual, or an indication of at least one relationship between the individual and a third person with whom the user also has a relationship. The wearable camera-based computing device may include at least one processor programmed to detect, in at least one of the plurality of images, a face represented in the at least one of the plurality of images; compare at least one aspect of the detected face with at least some of the one or more facial characteristics stored in the database for the plurality of individuals to identify a recognized individual associated with the detected face; retrieve at least some of the stored information for the recognized individual from the database; and cause the at least some of the stored information retrieved for the recognized individual to be automatically conveyed to the user.

In an embodiment, a method may include capturing, via a camera, a plurality of images from an environment of a user and outputting an image signal comprising the plurality of images; storing, via a memory unit including a database, information related to each individual included in a plurality of individuals, the stored information including one or more facial characteristics and at least one of: a name, a place of employment, a job title, a place of residence, a birthplace, an age, an indication of expertise, a name of a college or university attended by the individual, one or more interests shared by the user and the individual, one or more likes or dislikes shared by the user and the individual, or an indication of at least one relationship between the individual and a third person with whom the user also has a relationship; and detecting, in at least one of the plurality of images, a face represented in the at least one of the plurality of images; comparing at least one aspect of the detected face with at least some of the one or more facial characteristics stored in the database for the plurality of individuals to identify a recognized individual associated with the detected face; retrieving at least some of the stored information for the recognized individual from the database; and causing the at least some of the stored information retrieved for the recognized individual to be automatically conveyed to the user.

In an embodiment, a non-transitory computer readable medium that stores a set of instructions that is executable by at least one processor of a computing device to cause the computing device to perform a method may include capturing, via a camera, a plurality of images from an environment of a user and outputting an image signal comprising the plurality of images; storing, via a memory unit including a database, information related to each individual included in a plurality of individuals, the stored information including one or more facial characteristics and at least one of: a name, a place of employment, a job title, a place of residence, a birthplace, an age, an indication of expertise, a name of a college or university attended by the individual, one or more interests shared by the user and the individual, one or more likes or dislikes shared by the user and the individual, or an indication of at least one relationship between the individual and a third person with whom the user also has a relationship; and detecting, in at least one of the plurality of images, a face represented in the at least one of the plurality of images; comparing at least one aspect of the detected face with at least some of the one or more facial characteristics stored in the database for the plurality of individuals to identify a recognized individual associated with the detected face; retrieving at least some of the stored information for the recognized individual from the database; and causing the at least some of the stored information retrieved for the recognized individual to be automatically conveyed to the user.

In an embodiment, a system for automatically tracking and guiding one or more individuals in an environment may include at least one tracking subsystem including one or more cameras, wherein the tracking subsystem includes a camera unit configured to be worn by a user, and wherein the at least one tracking subsystem includes at least one processor. The at least one processor may be programmed to receive a plurality of images from the one or more cameras; identify at least one individual represented by the plurality of images; determine at least one characteristic of the at least one individual; and generate and send an alert based on the at least one characteristic.

In an embodiment, a system may include a first device comprising a first camera configured to capture a plurality of images from an environment of a user and output an image signal comprising the plurality of images; a memory device storing at least one visual characteristic of at least one person; and at least one processor. The at least one processor may be programmed to transmit the at least one visual characteristic to a second device comprising a second camera, the second device being configured to recognize the at least one person in an image captured by the second camera.

In an embodiment, a camera-based assistant system may comprise a housing; at least one camera included in the housing, the at least one camera being configured to capture a plurality of images representative of an environment of a wearer of the camera-based assistant system; a location sensor included in the housing; a communication interface; and at least one processor. The at least one processor may be programmed to receive, via the communication interface and from a server located remotely with respect to the camera unit, an indication of at least one identifiable feature associated with a person of interest; analyze the plurality of captured images to detect whether the at least one identifiable feature of the person of interest is represented in any of the plurality of captured images; and send an alert, via the communication interface, to one or more recipient computing devices remotely located relative to the camera-based assistant system, wherein the alert includes a location associated with the camera-based assistant system, determined based on an output of the location sensor, and an indication of a positive detection of the person of interest.

In another embodiment, a system for locating a person of interest may comprise at least one server; one or more communication interfaces associated with the at least one server; and one or more processors included in the at least one server. The one or more processors may be programmed to send to a plurality of camera-bused assistant systems, via the one or more communication interfaces, an indication of at least one identifiable feature associated with a person of interest, wherein the at least one identifiable feature is associated with one or more of: a facial feature, a tattoo, a body shape; or a voice signature. The one or more processors may also receive, via the one or more communication interfaces, alerts from the plurality of camera-based assistant systems, wherein each alert includes: an indication of a positive detection of the person of interest, based on analysis of the indication of at least one identifiable feature associated with a person of interest provided by one or more sensors included onboard a particular camera-based assistant system, and a location associated with the particular camera-based assistant system. Further, the one or more processors may provide to one or more law enforcement agencies after receiving alerts from at least a predetermined number of camera-based assistant systems, via the one or more communication interfaces, an indication that the person of interest has been located.

In an embodiment, a camera-based assistant system may comprise a housing; at least one camera included in the housing, the at least one camera being configured to capture a plurality of images representative of an environment of a wearer of the camera-based assistant system; and at least one processor. The at least one processor may be programmed to automatically analyze the plurality of images to detect a representation in at least one of the plurality of images of at least one individual in the environment of the wearer; predict an age of the at least one individual based on detection of one or more characteristics associated with at least one individual represented in the at least one of the plurality of images; perform at least one identification task associated with the at least one individual if the predicted age greater is than a predetermined threshold; and forego the at least one identification task if the predicted age is not greater than the predetermined threshold.

In another embodiment, a method for identifying faces using a wearable camera-based assistant system includes automatically analyzing a plurality of images captured by a camera of the wearable camera-based assistant system to detect a representation in at least one of the plurality of images of at least one individual in an environment of a wearer; predicting an age of the at least one individual based on detection of one or more characteristics associated with at least one individual represented in the at least one of the plurality of images; performing at least one identification task associated with the at least one individual if the predicted age is greater than a predetermined threshold; and foregoing the at least one identification task if the predicted age is not greater than the predetermined threshold.

In an embodiment, a wearable device is provided. The wearable device may include a housing; at least one camera associated with the housing, the at least one camera being configured to capture a plurality of images from an environment of a user of the wearable device; at least one microphone associated with the housing, the at least one microphone being configured to capture an audio signal of a voice of a speaker; and at least one processor. The at least one processor may be configured to detect a representation of an individual in the plurality of images and identify the individual as the speaker by correlating at least one aspect of the audio signal with one or more changes associated with the representation of the individual across the plurality of images; monitor one or more indicators of body language associated with the speaker over a time period, based on analysis of the plurality of images: monitor one or more characteristics of the voice of the speaker over the time period, based on analysis of the audio signal; determine, over the time period and based on a combination of the one or more monitored indicators of body language and the one or more characteristics of the voice of the speaker, a plurality of mood index values associated with the speaker; store the plurality of mood index values in a database; determine a baseline mood index value for the speaker based on the plurality of mood index values stored in the database; and provide to the user at least one of an audible or visible indication of at least one characteristic of a mood of the speaker.

In an embodiment, a computer-implemented method for detecting mood changes of an individual is provided. The method may comprise receiving a plurality of images from an environment of a user, the plurality of images being captured by a camera. The method may also comprise receiving an audio signal of a voice of a speaker, the audio signal being captured by at least one microphone. The method may also comprise detecting a representation of an individual in the plurality of images and identifying the individual as the speaker by correlating at least one aspect of the audio signal with one or more changes associated with the representation of the individual across the plurality of images. The method may also comprise monitoring one or more indicators of body language associated with the speaker over a time period, based on analysis of the plurality of images. The method may also comprise monitoring one or more characteristics of the voice of the speaker over the time period, based on analysis of the audio signal. The method may also comprise determining, over the time period and based on a combination of the one or more monitored indicators of body language and the one or more characteristics of the voice of the speaker, a plurality of mood index values associated with the speaker. The method may also comprise storing the plurality of mood index values in a database. The method may also comprise determining a baseline mood index value for the speaker based on the plurality of mood index values stored in the database. The method may also comprise providing to the user at least one of an audible or visible indication of at least one characteristic of a mood of the speaker.

In an embodiment, an activity tracking system is provided. The activity tracking system may include a housing; a camera associated with the housing and configured to capture a plurality of images from an environment of a user of the activity tracking system; and at least one processor. The at least one processor may be programmed to execute a method comprising: analyzing at least one of the plurality of images to detect one or more activities, from a predetermined set of activities, in which the user of the activity tracking system is engaged; monitoring an amount of time during which the user engages in the detected one or more activities; and providing to the user at least one of audible or visible feedback regarding at least one characteristic associated with the detected one or more activities.

In an embodiment, a computer-implemented method for tracking activity of an individual is provided. The method may comprise receiving a plurality of images from an environment of a user, the plurality of images being captured by a camera. The method may also comprise analyzing at least one of the plurality of images to detect one or more activities, from a predetermined set of activities, in which the user is engaged. The method may also comprise monitoring an amount of time during which the user engages in the detected one or more activities. The method may further comprise providing to the user at least one of audible or visible feedback regarding at least one characteristic associated with the detected one or more activities.

In an embodiment, a wearable personal assistant device may comprise a housing; a camera associated with the housing, the camera being configured to capture a plurality of images from an environment of a user of the wearable personal assistant device; and at least one processor. The at least one processor may be programmed to receive information identifying a goal of an activity; analyze the plurality of images to identify the user engaged in the activity and to assess a progress by the user of at least one aspect of the goal of the activity; and after assessing the progress by the user of the at least one aspect of the goal of the activity, provide to the user at least one of audible or visible feedback regarding the progress by the user of the at least one aspect of the goal of the activity.

In an embodiment, a system may comprise a wearable device including at least one of a camera, a second motion sensor, or a second location sensor; and at least one processor programmed to execute a method. The method may comprise receiving, from the mobile device, a first motion signal indicative of an output of at least one of the first motion sensor or the first location sensor; receiving, from the wearable device, a second motion signal indicative of an output of at least one of the camera, the second motion sensor, or the second location sensor; determining, based on the first motion signal and the second motion signal, whether the mobile device and the wearable device differ in one or more motion characteristics; and providing an indication to a user based on a determination that the mobile device and the wearable device differ in at least one of the one or more motion characteristics.

In an embodiment, a method of providing an indication to a user may comprise receiving, from a mobile device, a first motion signal indicative of an output of a first motion sensor or a first location sensor associated with the mobile device; receiving, from a wearable device, a second motion signal indicative of an output of at least one of a second motion sensor, a second location sensor, or a camera associated with the wearable device; determining, based on the first motion signal and the second motion signal, whether the mobile device and the wearable device differ in one or more motion characteristics; and providing an indication to a user based on a determination that the mobile device and the wearable device differ in at least one of the one or more motion characteristics.

Consistent with other disclosed embodiments, non-transitory computer-readable storage media may store program instructions, which are executed by at least one processor and perform any of the methods described herein.

The foregoing general description and the following detailed description are exemplary and explanatory only and are not restrictive of the claims.

### BRIEF DESCRIPTION OF THE DRAWINGS

The accompanying drawings, which are incorporated in and constitute apart of this disclosure, illustrate various disclosed embodiments. In the drawings:

FIG. 1A is a schematic illustration of an example of a user wearing a wearable apparatus according to a disclosed embodiment.

FIG. 1B is a schematic illustration of an example of the user wearing a wearable apparatus according to a disclosed embodiment.

FIG. 1C is a schematic illustration of an example of the user wearing a wearable apparatus according to a disclosed embodiment.

FIG. 1D is a schematic illustration of an example of the user wearing a wearable apparatus according to a disclosed embodiment.

FIG. 2 is a schematic illustration of an example system consistent with the disclosed embodiments.

FIG. 3A is a schematic illustration of an example of the wearable apparatus shown in FIG. 1A.

FIG. 3B is an exploded view of the example of the wearable apparatus shown in FIG. 3A.

FIG. 4A-4K are schematic illustrations of an example of the wearable apparatus shown in FIG. 1B from various viewpoints.

FIG. 5A is a block diagram illustrating an example of the components of a wearable apparatus according to a first embodiment.

FIG. 5B is a block diagram illustrating an example of the components of a wearable apparatus according to a second embodiment.

FIG. 5C is a block diagram illustrating an example of the components of a wearable apparatus according to a third embodiment.

FIG. 6 illustrates an exemplary embodiment of a memory containing software modules consistent with the present disclosure.

FIG. 7 is a schematic illustration of an embodiment of a wearable apparatus including an orientable image capture unit.

FIG. 8 is a schematic illustration of an embodiment of a wearable apparatus securable to an article of clothing consistent with the present disclosure.

FIG. 9 is a schematic illustration of a user wearing a wearable apparatus consistent with an embodiment of the present disclosure.

FIG. 10 is a schematic illustration of an embodiment of a wearable apparatus securable to an article of clothing consistent with the present disclosure.

FIG. 11 is a schematic illustration of an embodiment of a wearable apparatus securable to an article of clothing consistent with the present disclosure.

FIG. 12 is a schematic illustration of an embodiment of a wearable apparatus securable to an article of clothing consistent with the present disclosure.

FIG. 13 is a schematic illustration of an embodiment of a wearable apparatus securable to an article of clothing consistent with the present disclosure.

FIG. 14 is a schematic illustration of an embodiment of a wearable apparatus securable to an article of clothing consistent with the present disclosure.

FIG. 15 is a schematic illustration of an embodiment of a wearable apparatus power unit including a power source.

FIG. 16 is a schematic illustration of an exemplary embodiment of a wearable apparatus including protective circuitry.

FIG. 17A is a block diagram illustrating components of a wearable apparatus according to an example embodiment.

FIG. 17B is a block diagram illustrating the components of a wearable apparatus according to another example embodiment.

FIG. 17C is a block diagram illustrating the components of a wearable apparatus according to another example embodiment

FIG. 18A illustrates an example image that may be captured from an environment of a user, consistent with the disclosed embodiments.

FIG. 18B illustrates an example calendar entry that may be analyzed to determine a context, consistent with the disclosed embodiments.

FIG. 18C illustrates an example data structure that may be used for associating individuals with contexts, consistent with the disclosed embodiments.

FIGS. 19A. 19B, and 19C illustrate example interfaces for displaying information to a user, consistent with the disclosed embodiments.

FIG. 20 is a flowchart showing an example process for selectively substituting audio signals, consistent with the disclosed embodiments.

FIG. 21A illustrates an example data structure that may store information associated with unrecognized individuals, consistent with the disclosed embodiments.

FIG. 21B illustrates an example user interface of a mobile device that may be used to receive an input indicating an identity of an individual.

FIG. 22A illustrates an example record that may be disambiguated based on supplemental information, consistent with the disclosed embodiments

FIG. 22B illustrates an example image showing two unrecognized individuals, consistent with the disclosed embodiments.

FIG. 22C illustrates an example data structure storing associations between one or more individuals, consistent with the disclosed embodiments.

FIG. 23A is a flowchart showing an example process for retroactive identification of individuals, consistent with the disclosed embodiments.

FIG. 23B is a flowchart showing an example process for associating one or more individuals in a database, consistent with the disclosed embodiments.

FIG. 23C is a flowchart showing an example process for disambiguating unrecognized individuals, consistent with the disclosed embodiments.

FIG. 24A illustrates an example image that may be captured from an environment of a user, consistent with the disclosed embodiments.

FIG. 24B illustrates an example timeline view that may be displayed to a user, consistent with the disclosed embodiments.

FIG. 25A illustrates an example network interface, consistent with the disclosed embodiments.

FIG. 25B illustrates another example network interface displaying an aggregated social network, consistent with the disclosed embodiments.

FIG. 26A is a flowchart showing an example process, consistent with the disclosed embodiments.

FIG. 26B is a flowchart showing an example process, consistent with the disclosed embodiments.

FIG. 27A is a schematic illustration showing an exemplary environment for use of the disclosed tagging system, consistent with the disclosed embodiments.

FIG. 27B illustrates an exemplary embodiment of an apparatus comprising facial and voice recognition components consistent with the present disclosure.

FIG. 27C is another schematic illustration showing another exemplary environment for use of the disclosed tagging system, consistent with the disclosed embodiments.

FIG. 28A is an exemplary display showing a pie chart, illustrating a summary of vocal classifications identified by the disclosed tagging system, consistent with the disclosed embodiments.

FIG. 28B is another exemplary display showing a trend chart, illustrating changes in the vocal classifications over time, consistent with the disclosed embodiments.

FIG. 29 is a flowchart showing an example process for tagging characteristics of an interpersonal encounter, consistent with the disclosed embodiments.

FIG. 30A is a schematic illustration showing an exemplary environment for use of the disclosed variable image capturing system, consistent with the disclosed embodiments.

FIG. 30B illustrates an exemplary embodiment of an apparatus comprising voice recognition components consistent with the present disclosure.

FIG. 31 is a schematic illustration of an adjustment of a control setting of a camera based on a characteristic of a vocal component consistent with the present disclosure.

FIG. 32 is a flowchart showing an example process for variable image capturing, consistent with the disclosed embodiments.

FIG. 33A is a schematic illustration showing an exemplary environment for use of the disclosed variable image logging system, consistent with the disclosed embodiments.

FIG. 33B illustrates an exemplary embodiment of an apparatus comprising voice recognition components consistent with the present disclosure.

FIG. 34A illustrates an example of an audio signal containing one or more occurrences of voices of one or more speakers, consistent with the disclosed embodiments.

FIG. 34B is an example display showing a bar chart, illustrating sidedness of a conversation, consistent with the disclosed embodiments.

FIG. 34C is an example display showing a pie chart, illustrating sidedness of a conversation, consistent with the disclosed embodiments.

FIG. 35 is a flowchart showing an example process for tracking sidedness of conversations, consistent with the disclosed embodiments.

FIG. 36 is an illustration showing an exemplary user engaged in an exemplary activity with two individuals.

FIG. 37A and FIG. 37B are example user interfaces.

FIG. 38 is a flowchart of an exemplary method of correlating an action of the user with a subsequent behavior of the user using image recognition and/or voice detection.

FIG. 39 is an illustration of a user participating in an exemplary event.

FIG. 40A is an illustration of exemplary indications provided to the user while participating in the event of FIG. 39.

FIG. 40B is an illustration of the user with a wearable device participating in the event of FIG. 39.

FIG. 41 is a flowchart of exemplary method of correlating an action of the user with a subsequent behavior of the user using image recognition and/or voice detection.

FIG. 42 is an illustration showing an exemplary user engaged in an exemplary activity with two individuals.

FIG. 43 is an example user interface.

FIG. 44 is a flowchart of an exemplary method of automatically identifying and logging the utterance of selected key words in a conversation using voice detection and/or image recognition.

FIG. 45 is a schematic illustration showing an exemplary environment including a wearable device according to the disclosed embodiments.

FIG. 46 is an illustration of an exemplary image obtained by a wearable device according to the disclosed embodiments.

FIG. 47 is a flowchart showing an exemplary process for identifying and sharing information related to people according to the disclosed embodiments.

FIG. 48 is a schematic illustration showing an exemplary environment including a wearable camera-based computing device according to the disclosed embodiments.

FIG. 49 is an illustration of an exemplary image obtained by a wearable camera-based computing device and stored information displayed on a device according to the disclosed embodiments.

FIG. 50 is a flowchart showing an exemplary process for identifying and sharing information related to people in an organization related to a user based on images captured from an environment of the user according to the disclosed embodiments.

FIG. 51 is a schematic illustration showing an exemplary environment including a camera-based computing device according to the disclosed embodiments.

FIG. 52 is an illustration of an exemplary environment in which a camera-based computing device operates according to the disclosed embodiments.

FIG. 53 is a flowchart showing an exemplary process for tracking and guiding one or more individuals in an environment based on images captured from the environment of one or more users according to the disclosed embodiments.

FIG. 54A is a schematic illustration of an example of an image captured by a camera of the wearable apparatus consistent with the present disclosure.

FIG. 54B is a schematic illustration of an identification of an identifiable feature associated with a person of interest consistent with the present disclosure.

FIG. 55 is a schematic illustration of a network including a server and multiple wearable apparatuses consistent with the present disclosure.

FIG. 56 is a flowchart showing an exemplary process for sending alerts when a person of interest is found consistent with the present disclosure.

FIG. 57A is a schematic illustration of an example of a user wearing a wearable apparatus in an environment consistent with the present disclosure.

FIG. 57B is an example image captured by a camera of the wearable apparatus consistent with the present disclosure.

FIG. 58A is an example image captured by a camera of the wearable apparatus consistent with the present disclosure.

FIG. 58B is an example head-to-height ratio determination of individuals in an example image consistent with the present disclosure.

FIG. 59 is a flowchart showing an exemplary process for identifying faces using a wearable camera-based assistant system consistent with the present disclosure.

FIG. 60 is a schematic illustration of an exemplary wearable device consistent with the disclosed embodiments.

FIG. 61 is a schematic illustration showing an exemplary environment of a user of a wearable device consistent with the disclosed embodiments.

FIG. 62 is a schematic illustration showing a flowchart of an exemplary method for detecting mood changes of an individual consistent with the disclosed embodiments.

FIG. 63 is a schematic illustration of an exemplary wearable device included in an activity tracking system consistent with the disclosed embodiments.

FIGS. 64A and 64B are schematic illustrations showing exemplary environments of a user of an activity tracking system consistent with the disclosed embodiments.

FIG. 65 is a schematic illustration showing a flowchart of an exemplary method for tracking activity of an individual consistent with the disclosed embodiments.

FIG. 66A illustrates an example image that may be captured from an environment of a user, consistent with the disclosed embodiments.

FIG. 66B illustrates another example image that may be captured from an environment of a user, consistent with the disclosed embodiments.

FIGS. 67A, 67B, and 67C illustrate example information that may be displayed to a user, consistent with the disclosed embodiments.

FIG. 67D illustrates an example calendar that may be accessed by wearable apparatus 110.

FIG. 68 is a flowchart showing an example process for tracking goals for activities of a user, consistent with the disclosed embodiments.

FIG. 69A is another illustration of an example of the wearable apparatus shown in FIG. 1B.

FIG. 69B is an illustration of a situation when a user is moving but a wearable device is not moving, consistent with the disclosed embodiments.

FIG. 69C is an illustration of a situation when a user is moving but a mobile device is not moving, consistent with the disclosed embodiments.

FIG. 69D is an illustration of a situation when a user is not mowing but a mobile device is moving, consistent with the disclosed embodiments.

FIGS. 70A, 70B, and 70C illustrate examples of motion characteristics of a mobile device and a wearable device, consistent with the disclosed embodiments.

FIG. 71 is a flowchart showing an example process for providing an indication to a user, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

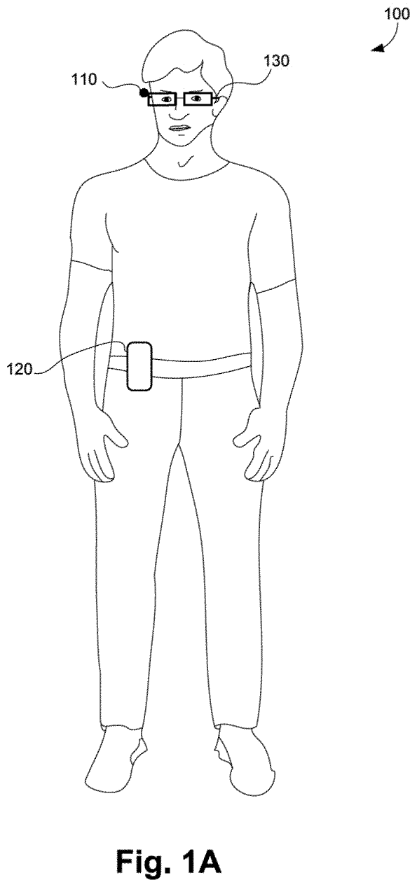

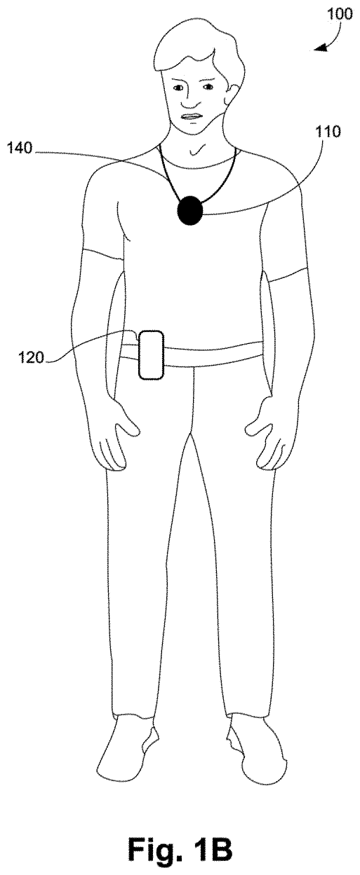

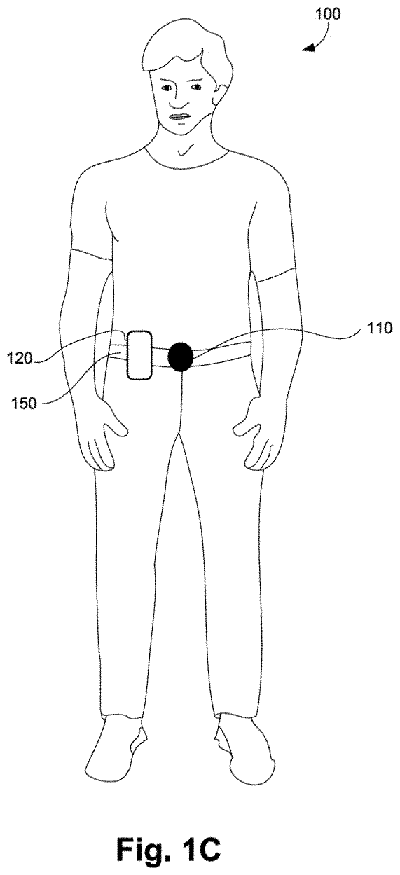

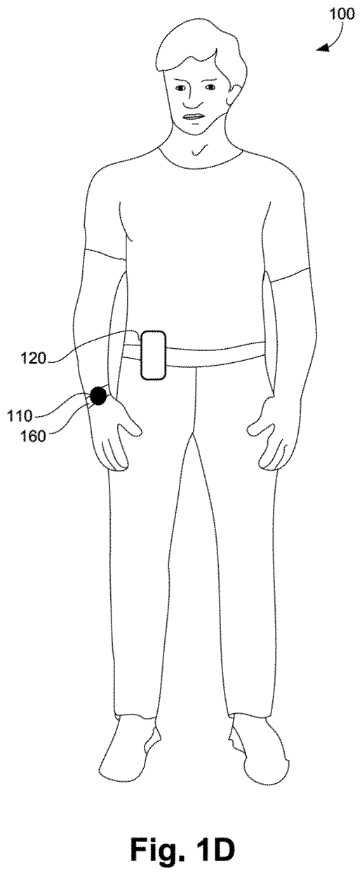

FIG. 1A illustrates a user 100 wearing an apparatus 110 that is physically connected (or integral) to glasses 130, consistent with the disclosed embodiments. Glasses 130 may be prescription glasses, magnifying glasses, non-prescription glasses, safety glasses, sunglasses, etc. Additionally, in some embodiments, glasses 130 may include parts of a frame and earpieces, nosepieces, etc., and one or no lenses. Thus, in some embodiments, glasses 130 may function primarily to support apparatus 110, and/or an augmented reality display device or other optical display device. In some embodiments, apparatus 110 may include an image sensor (not shown in FIG. 1A) for capturing real-time image data of the field-of-view of user 100. The term “image data” includes any form of data retrieved from optical signals in the near-infrared, infrared, visible, and ultraviolet spectrums. The image data may include video clips and/or photographs.

In some embodiments, apparatus 110 may communicate wirelessly or via a wire with a computing device 120. In some embodiments, computing device 120 may include, for example, a smartphone, or a tablet, or a dedicated processing unit, which may be portable (e.g., can be carried in a pocket of user 100). Although shown in FIG. 1A as an external device, in some embodiments, computing device 120 may be provided as part of wearable apparatus 110 or glasses 130, whether integral thereto or mounted thereon. In some embodiments, computing device 120 may be included in an augmented reality display device or optical head mounted display provided integrally or mounted to glasses 130. In other embodiments, computing device 120 may be provided as part of another wearable or portable apparatus of user 100 including a wrist-strap, a multifunctional watch, a button, a clip-on, etc. And in other embodiments, computing device 120 may be provided as part of another system, such as an on-board automobile computing or navigation system. A person skilled in the art can appreciate that different types of computing devices and arrangements of devices may implement the functionality of the disclosed embodiments. Accordingly, in other implementations, computing device 120 may include a Personal Computer (PC), laptop, an Internet server, etc.

FIG. 1B illustrates user 100 wearing apparatus 110 that is physically connected to a necklace 140, consistent with a disclosed embodiment. Such a configuration of apparatus 110 may be suitable for users that do not wear glasses some or all of the time. In this embodiment, user 100 can easily wear apparatus 110, and take it off.

FIG. 1C illustrates user 100 wearing apparatus 110 that is physically connected to a belt 150, consistent with a disclosed embodiment. Such a configuration of apparatus 110 may be designed as a belt buckle. Alternatively, apparatus 110 may include a clip for attaching to various clothing articles, such as belt 150, or a vest, a pocket, a collar, a cap or hat or other portion of a clothing article.

FIG. 1D illustrates user 100 wearing apparatus 110 that is physically connected to a wrist strap 160, consistent with a disclosed embodiment. Although the aiming direction of apparatus 110, according to this embodiment, may not match the field-of-view of user 100, apparatus 110 may include the ability to identify a hand-related trigger based on the tracked eye movement of a user 100 indicating that user 100 is looking in the direction of the wrist strap 160. Wrist strap 160 may also include an accelerometer, a gyroscope, or other sensor for determining movement or orientation of a user's 100 hand for identifying a hand-related trigger.

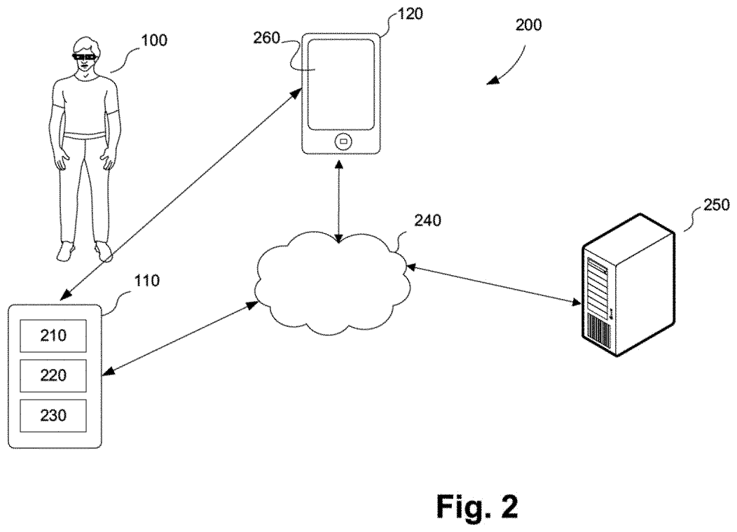

FIG. 2 is a schematic illustration of an exemplary system 200 including a wearable apparatus 110, worn by user 100, and an optional computing device 120 and/or a server 250 capable of communicating with apparatus 110 via a network 240, consistent with disclosed embodiments. In some embodiments, apparatus 110 may capture and analyze image data, identify a hand-related trigger present in the image data, and perform an action and/or provide feedback to a user 100, based at least in part on the identification of the hand-related trigger. In some embodiments, optional computing device 120 and/or server 250 may provide additional functionality to enhance interactions of user 100 with his or her environment, as described in greater detail below.

According to the disclosed embodiments, apparatus 110 may include an image sensor system 220 for capturing real-time image data of the field-of-view of user 100. In some embodiments, apparatus 110 may also include a processing unit 210 for controlling and performing the disclosed functionality of apparatus 110, such as to control the capture of image data, analyze the image data, and perform an action and/or output a feedback based on a hand-related trigger identified in the image data. According to the disclosed embodiments, a hand-related trigger may include a gesture performed by user 100 involving a portion of a hand of user 100. Further, consistent with some embodiments, a hand-related trigger may include a wrist-related trigger. Additionally, in some embodiments, apparatus 110 may include a feedback outputting unit 230 for producing an output of information to user 100.

As discussed above, apparatus 110 may include an image sensor 220 for capturing image data. The term “image sensor” refers to a device capable of detecting and converting optical signals in the near-infrared, infrared, visible, and ultraviolet spectrums into electrical signals. The electrical signals may be used to form an image or a video stream (i.e. image data) based on the detected signal. The term “image data” includes any form of data retrieved from optical signals in the near-infrared, infrared, visible, and ultraviolet spectrums. Examples of image sensors may include semiconductor charge-coupled devices (CCD), active pixel sensors in complementary metal-oxide-semiconductor (CMOS), or N-type metal-oxide-semiconductor (NMOS, Live MOS). In some cases, image sensor 220 may be part of a camera included in apparatus 110.

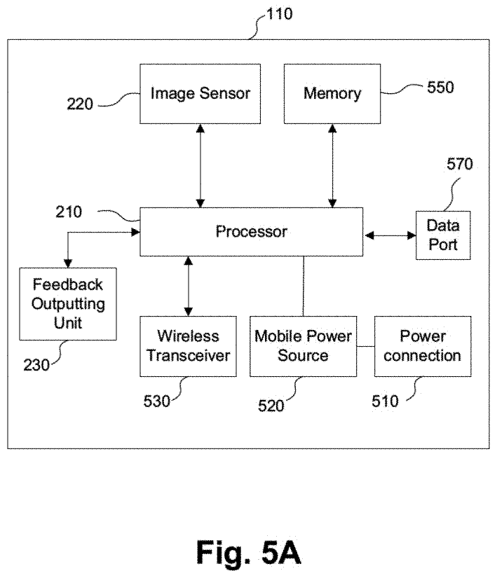

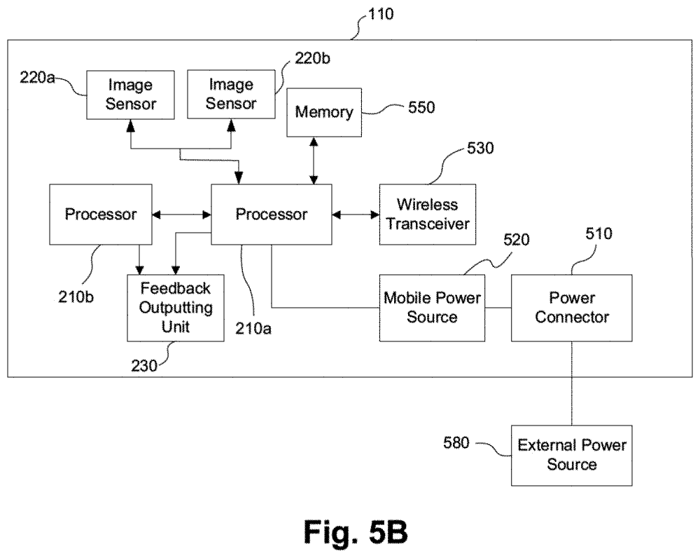

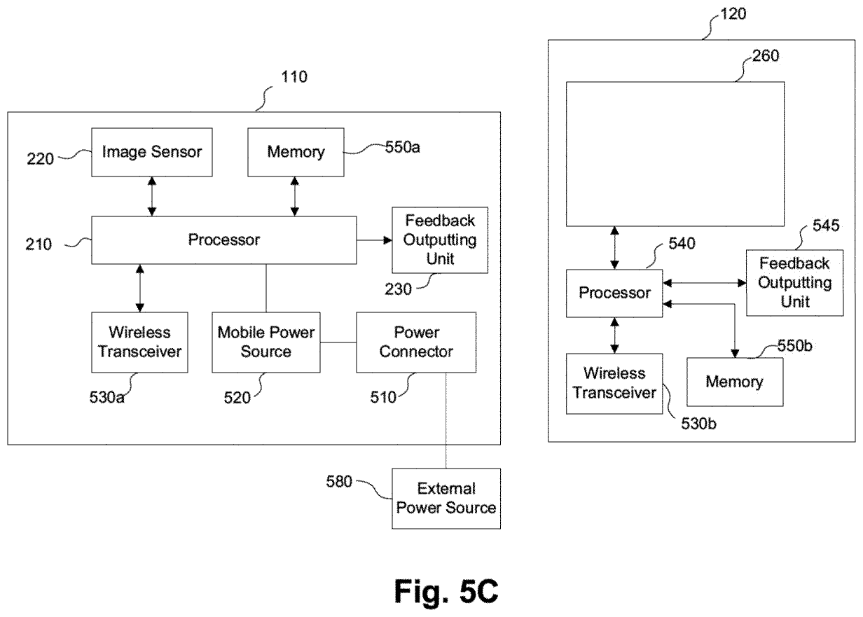

Apparatus 110 may also include a processor 210 for controlling image sensor 220 to capture image data and for analyzing the image data according to the disclosed embodiments. As discussed in further detail below with respect to FIG. 5A, processor 210 may include a “processing device” for performing logic operations on one or more inputs of image data and other data according to stored or accessible software instructions providing desired functionality. In some embodiments, processor 210 may also control feedback outputting unit 230 to provide feedback to user 100 including information based on the analyzed image data and the stored software instructions. As the term is used herein, a “processing device” may access memory where executable instructions are stored or, in some embodiments, a “processing device” itself may include executable instructions (e.g., stored in memory included in the processing device).

In some embodiments, the information or feedback information provided to user 100 may include time information. The time information may include any information related to a current time of day and, as described further below, may be presented in any sensory perceptive manner, in some embodiments, time information may include a current time of day in a preconfigured format (e.g., 2:30 pm or 14:30). Time information may include the time in the user's current time zone (e.g., based on a determined location of user 100), as well as an indication of the time zone and/or a time of day in another desired location. In some embodiments, time information may include a number of hours or minutes relative to one or more predetermined times of day. For example, in some embodiments, time information may include an indication that three hours and fifteen minutes remain until a particular hour (e.g., until 6:00 pm), or some other predetermined time. Time information may also include a duration of time passed since the beginning of a particular activity, such as the start of a meeting or the start of a jog, or any other activity. In some embodiments, the activity may be determined based on analyzed image data. In other embodiments, time information may also include additional information related to a current time and one or more other routine, periodic, or scheduled events. For example, time information may include an indication of the number of minutes remaining until the next scheduled event, as may be determined from a calendar function or other information retrieved from computing device 120 or server 250, as discussed in further detail below.

Feedback outputting unit 230 may include one or more feedback systems for providing the output of information to user 100. In the disclosed embodiments, the audible or visual feedback may be provided via any type of connected audible or visual system or both. Feedback of information according to the disclosed embodiments may include audible feedback to user 100 (e.g., using a Bluetooth™ or other wired or wirelessly connected speaker, or a bone conduction headphone). Feedback outputting unit 230 of some embodiments may additionally or alternatively produce a visible output of information to user 100, for example, as part of an augmented reality display projected onto a lens of glasses 130 or provided via a separate heads up display in communication with apparatus 110, such as a display 260 provided as part of computing device 120, which may include an onboard automobile heads up display, an augmented reality device, a virtual reality device, a smartphone. PC, table, etc.

The term “computing device” refers to a device including a processing unit and having computing capabilities. Some examples of computing device 120 include a PC, laptop, tablet, or other computing systems such as an on-board computing system of an automobile, for example, each configured to communicate directly with apparatus 110 or server 250 over network 240. Another example of computing device 120 includes a smartphone having a display 260. In some embodiments, computing device 120 may be a computing system configured particularly for apparatus 110, and may be provided integral to apparatus 110 or tethered thereto. Apparatus 110 can also connect to computing device 120 over network 240 via any known wireless standard (e.g., Wi-Fi, Bluetooth®, etc.), as well as near-filed capacitive coupling, and other short range wireless techniques, or via a wired connection. In an embodiment in which computing device 120 is a smartphone, computing device 120 may have a dedicated application installed therein. For example, user 100 may view on display 260 data (e.g., images, video clips, extracted information, feedback information, etc.) that originate from or are triggered by apparatus 110. In addition, user 100 may select part of the data for storage in server 250.

Network 240 may be a shared, public, or private network, may encompass a wide area or local area, and may be implemented through any suitable combination of wired and/or wireless communication networks. Network 240 may further comprise an intranet or the Internet. In some embodiments, network 240 may include short range or near-field wireless communication systems for enabling communication between apparatus 110 and computing device 120 provided in close proximity to each other, such as on or near a user's person, for example. Apparatus 110 may establish a connection to network 240 autonomously, for example, using a wireless module (e.g., Wi-Fi, cellular). In some embodiments, apparatus 110 may use the wireless module when being connected to an external power source, to prolong battery life. Further, communication between apparatus 110 and server 250 may be accomplished through any suitable communication channels, such as, for example, a telephone network, an extranet, an intranet, the Internet, satellite communications, off-line communications, wireless communications, transponder communications, a local area network (LAN), a wide area network (WAN), and a virtual private network (VPN).

As shown in FIG. 2, apparatus 110 may transfer or receive data to/from server 250 via network 240. In the disclosed embodiments, the data being received from server 250 and/or computing device 120 may include numerous different types of information based on the analyzed image data, including information related to a commercial product, or a person's identity, an identified landmark, and any other information capable of being stored in or accessed by server 250. In some embodiments, data may be received and transferred via computing device 120. Server 250 and/or computing device 120 may retrieve information from different data sources (e.g., a user specific database or a user's social network account or other account, the Internet, and other managed or accessible databases) and provide information to apparatus 110 related to the analyzed image data and a recognized trigger according to the disclosed embodiments. In some embodiments, calendar-related information retrieved from the different data sources may be analyzed to provide certain time information or a time-based context for providing certain information based on the analyzed image data.

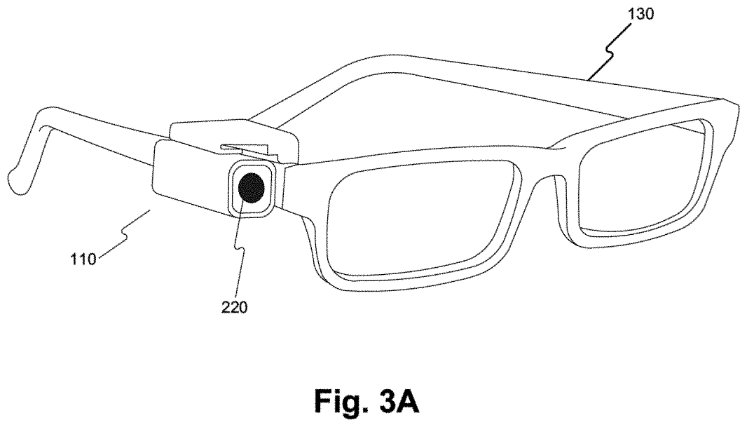

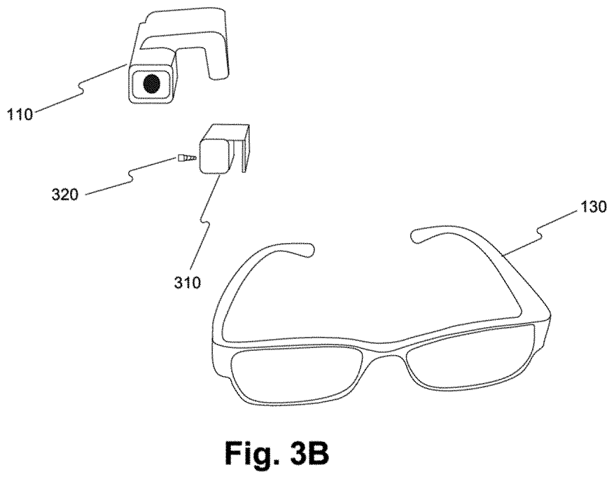

An example of wearable apparatus 110 incorporated with glasses 130 according to some embodiments (as discussed in connection with FIG. 1A) is shown in greater detail in FIG. 3A. In some embodiments, apparatus 110 may be associated with a structure (not shown in FIG. 3A) that enables easy detaching and reattaching of apparatus 110 to glasses 130. In some embodiments, when apparatus 110 attaches to glasses 130, image sensor 220 acquires a set aiming direction without the need for directional calibration. The set aiming direction of image sensor 220 may substantially coincide with the field-of-view of user 100. For example, a camera associated with image sensor 220 may be installed within apparatus 110 in a predetermined angle in a position facing slightly downwards (e.g., 5-15 degrees from the horizon). Accordingly, the set aiming direction of image sensor 220 may substantially match the field-of-view of user 100.

FIG. 3B is an exploded view of the components of the embodiment discussed regarding FIG. 3A. Attaching apparatus 110 to glasses 130 may take place in the following way. Initially, a support 310 may be mounted on glasses 130 using a screw 320, in the side of support 310. Then, apparatus 110 may be clipped on support 310 such that it is aligned with the field-of-view of user 100. The term “support” includes any device or structure that enables detaching and reattaching of a device including a camera to a pair of glasses or to another object (e.g., a helmet). Support 310 may be made from plastic (e.g., polycarbonate), metal (e.g., aluminum), or a combination of plastic and metal (e.g., carbon fiber graphite). Support 310 may be mounted on any kind of glasses (e.g., eyeglasses, sunglasses, 3D glasses, safety glasses, etc.) using screws, bolts, snaps, or any fastening means used in the art.

In some embodiments, support 310 may include a quick release mechanism for disengaging and reengaging apparatus 110. For example, support 310 and apparatus 110 may include magnetic elements. As an alternative example, support 310 may include a male latch member and apparatus 110 may include a female receptacle. In other embodiments, support 310 can be an integral part of a pair of glasses, or sold separately and installed by an optometrist. For example, support 310 may be configured for mounting on the arms of glasses 130 near the frame front, but before the hinge. Alternatively, support 310 may be configured for mounting on the bridge of glasses 130.

In some embodiments, apparatus 110 may be provided as part of a glasses frame 130, with or without lenses. Additionally, in some embodiments, apparatus 110 may be configured to provide an augmented reality display projected onto a lens of glasses 130 (if provided), or alternatively, may include a display for projecting time information, for example, according to the disclosed embodiments. Apparatus 110 may include the additional display or alternatively, may be in communication with a separately provided display system that may or may not be attached to glasses 130.

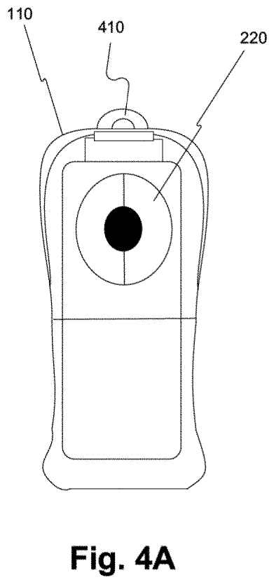

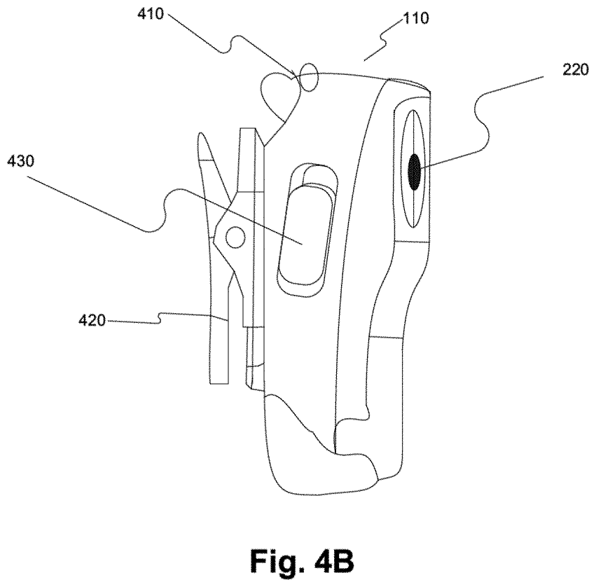

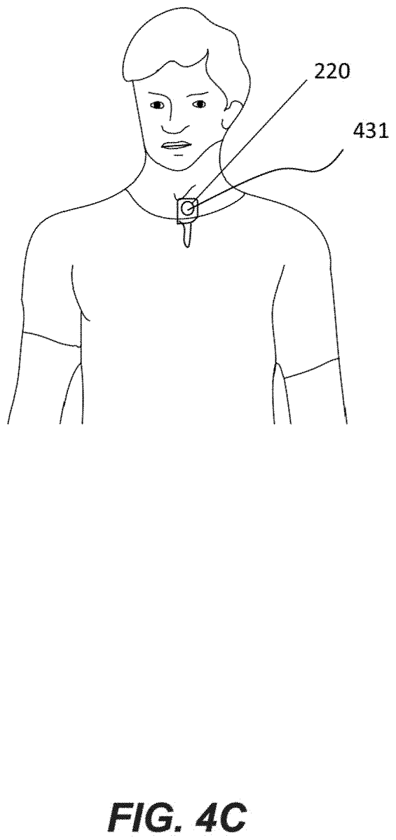

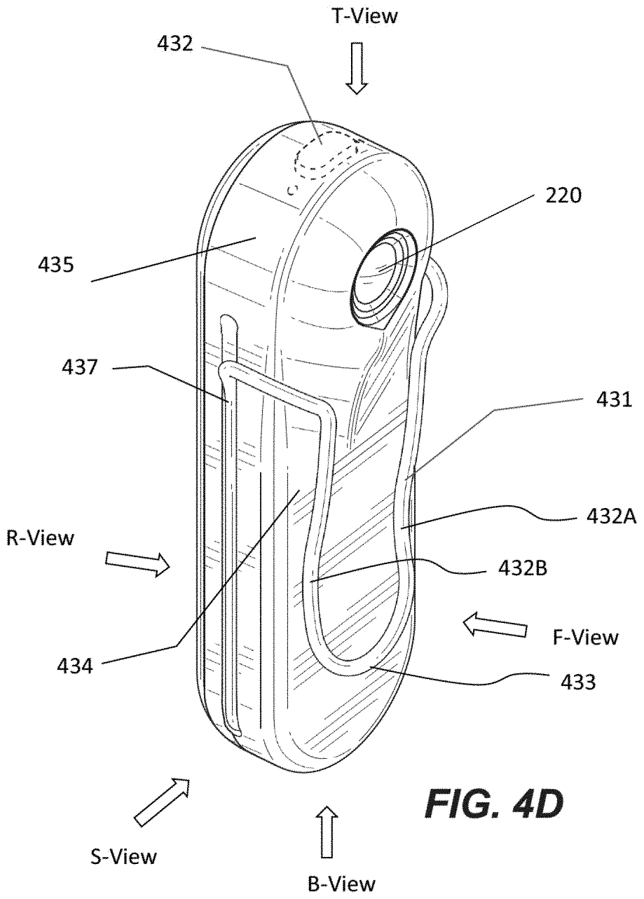

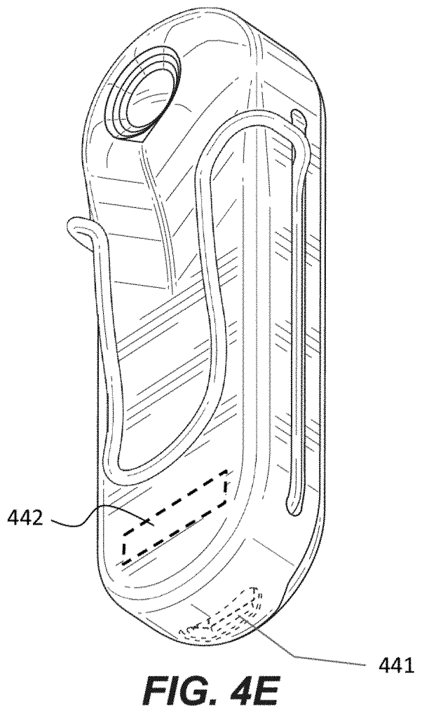

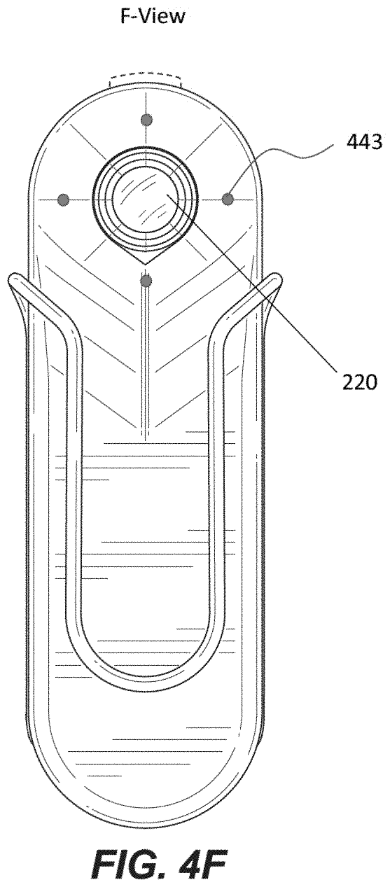

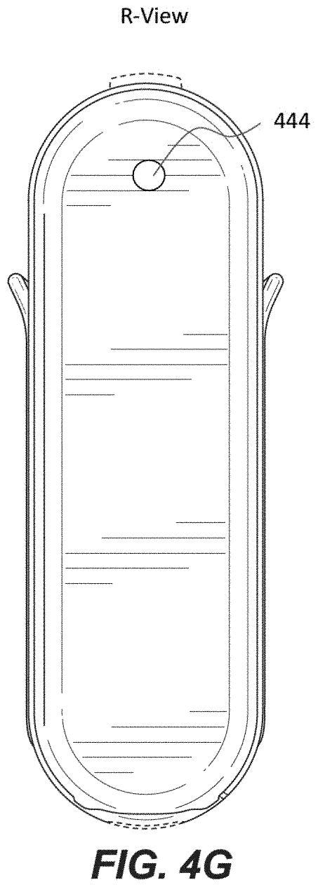

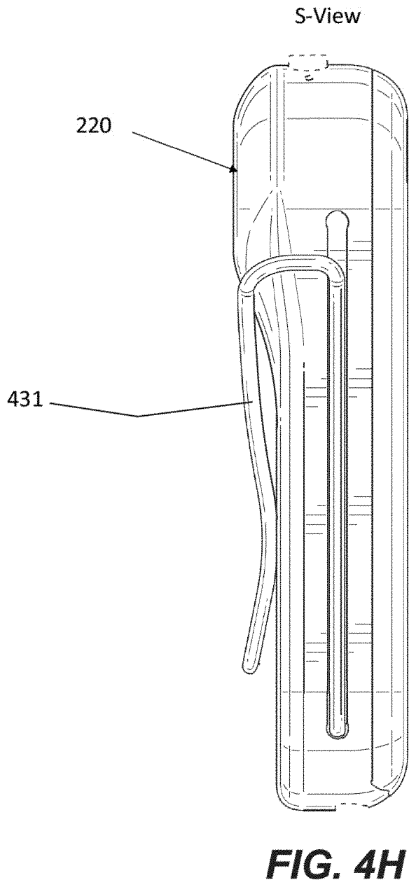

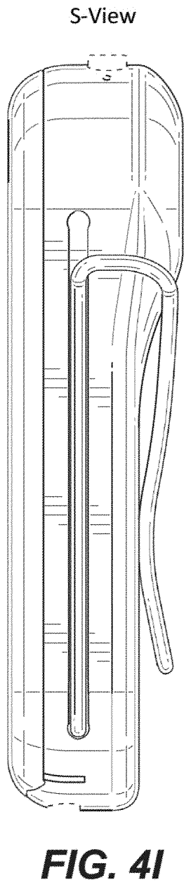

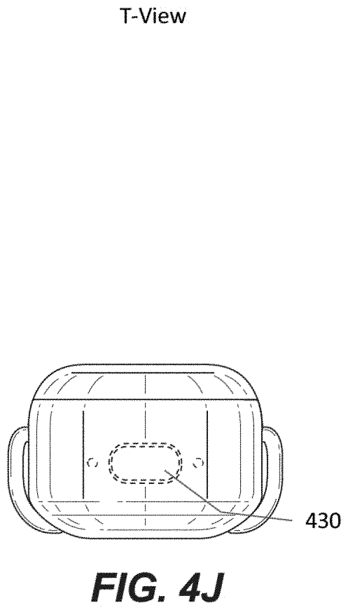

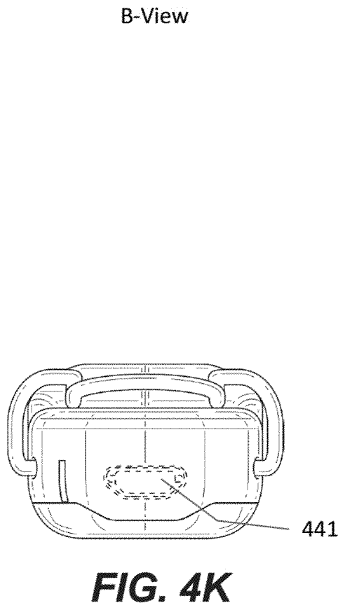

In some embodiments, apparatus 110 may be implemented in a form other than wearable glasses, as described above with respect to FIGS. 1B-1D, for example. FIG. 4A is a schematic illustration of an example of an additional embodiment of apparatus 110 from a front viewpoint of apparatus 110. Apparatus 110 includes an image sensor 220, a clip (not shown), a function button (not shown) and a hanging ring 410 for attaching apparatus 110 to, for example, necklace 140, as shown in FIG. 1B. When apparatus 110 hangs on necklace 140, the aiming direction of image sensor 220 may not fully coincide with the field-of-view of user 100, but the aiming direction would still correlate with the field-of-view of user 100.

FIG. 4B is a schematic illustration of the example of a second embodiment of apparatus 110, from a side orientation of apparatus 110. In addition to hanging ring 410, as shown in FIG. 4B, apparatus 110 may further include a clip 420. User 100 can use clip 420 to attach apparatus 110 to a shirt or belt 150, as illustrated in FIG. 1C. Clip 420 may provide an easy mechanism for disengaging and re-engaging apparatus 110 from different articles of clothing. In other embodiments, apparatus 110 may include a female receptacle for connecting with a male latch of a car mount or universal stand.

In some embodiments, apparatus 110 includes a function button 430 for enabling user 100 to provide input to apparatus 110. Function button 430 may accept different types of tactile input (e.g., a tap, a click, a double-click, a long press, a right-to-left slide, a left-to-right slide). In some embodiments, each type of input may be associated with a different action. For example, a tap may be associated with the function of taking a picture, while a right-to-left slide may be associated with the function of recording a video.

Apparatus 110 may be attached to an article of clothing (e.g., a shirt, a belt, pants, etc.), of user 100 at an edge of the clothing using a clip 431 as shown in FIG. 4C. For example, the body of apparatus 100 may reside adjacent to the inside surface of the clothing with clip 431 engaging with the outside surface of the clothing. In such an embodiment, as shown in FIG. 4C, the image sensor 220 (e.g., a camera for visible light) may be protruding beyond the edge of the clothing. Alternatively, clip 431 may be engaging with the inside surface of the clothing with the body of apparatus 110 being adjacent to the outside of the clothing. In various embodiments, the clothing may be positioned between clip 431 and the body of apparatus 110.

An example embodiment of apparatus 110 is shown in FIG. 4D. Apparatus 110 includes clip 431 which may include points (e.g., 432A and 432B) in close proximity to a front surface 434 of a body 435 of apparatus 110. In an example embodiment, the distance between points 432A, 432B and front surface 434 may be less than a typical thickness of a fabric of the clothing of user 100. For example, the distance between points 432A, 432B and surface 434 may be less than a thickness of a tee-shirt. e.g., less than a millimeter, less than 2 millimeters, less than 3 millimeters, etc., or, in some cases, points 432A, 432B of clip 431 may touch surface 434. In various embodiments, clip 431 may include a point 433 that does not touch surface 434, allowing the clothing to be inserted between clip 431 and surface 434.

FIG. 4D shows schematically different views of apparatus 110 defined as a front view (F-view), a rearview (R-view), a top view (T-view), a side view (S-view) and a bottom view (B-view). These views will be referred to when describing apparatus 110 in subsequent figures. FIG. 4D shows an example embodiment where clip 431 is positioned at the same side of apparatus 110 as sensor 220 (e.g., the front side of apparatus 110). Alternatively, clip 431 may be positioned at an opposite side of apparatus 110 as sensor 220 (e.g., the rear side of apparatus 110). In various embodiments, apparatus 110 may include function button 430, as shown in FIG. 4D.

Various views of apparatus 110 are illustrated in FIGS. 4E through 4K. For example, FIG. 4E shows a view of apparatus 110 with an electrical connection 441. Electrical connection 441 may be, for example, a USB port, that may be used to transfer data to/from apparatus 110 and provide electrical power to apparatus 110. In an example embodiment, connection 441 may be used to charge a battery 442 schematically shown in FIG. 4E. FIG. 4F shows F-view of apparatus 110, including sensor 220 and one or more microphones 443. In some embodiments, apparatus 110 may include several microphones 443 facing outwards, wherein microphones 443 are configured to obtain environmental sounds and sounds of various speakers communicating with user 100. FIG. 4G shows R-view of apparatus 110. In some embodiments, microphone 444 may be positioned at the rear side of apparatus 110, as shown in FIG. 4G. Microphone 444 may be used to detect an audio signal from user 100. It should be noted, that apparatus 110 may have microphones placed at any side (e.g., a front side, a rear side, a left side, a right side, a top side, or a bottom side) of apparatus 110. In various embodiments, some microphones may be at a first side (e.g., microphones 443 may be at the front of apparatus 110) and other microphones may be at a second side (e.g., microphone 444 may be at the back side of apparatus 110).

FIGS. 4H and 4I show different sides of apparatus 110 (i.e., S-view of apparatus 110) consisted with disclosed embodiments. For example, FIG. 4H shows the location of sensor 220 and an example shape of clip 431. FIG. 4J shows T-view of apparatus 110, including function button 430, and FIG. 4K shows B-view of apparatus 110 with electrical connection 441.

The example embodiments discussed above with respect to FIGS. 3A, 3B, 4A, and 4B are not limiting. In some embodiments, apparatus 110 may be implemented in any suitable configuration for performing the disclosed methods. For example, referring back to FIG. 2, the disclosed embodiments may implement an apparatus 110 according to any configuration including an image sensor 220 and a processor unit 210 to perform image analysis and for communicating with a feedback unit 230.

FIG. 5A is a block diagram illustrating the components of apparatus 110 according to an example embodiment. As shown in FIG. 5A, and as similarly discussed above, apparatus 110 includes an image sensor 220, a memory 550, a processor 210, a feedback outputting unit 230, a wireless transceiver 530, and a mobile power source 520. In other embodiments, apparatus 110 may also include buttons, other sensors such as a microphone, and inertial measurements devices such as accelerometers, gyroscopes, magnetometers, temperature sensors, color sensors, light sensors, etc. Apparatus 110 may further include a data port 570 and a power connection 510 with suitable interfaces for connecting with an external power source or an external device (not shown).

Processor 210, depicted in FIG. 5A, may include any suitable processing device. The term “processing device” includes any physical device having an electric circuit that performs a logic operation on input or inputs. For example, processing device may include one or more integrated circuits, microchips, microcontrollers, microprocessors, all or part of a central processing unit (CPU), graphics processing unit (GPU), digital signal processor (DSP), field-programmable gate array (FPGA), or other circuits suitable for executing instructions or performing logic operations. The instructions executed by the processing device may, for example, be pre-loaded into a memory integrated with or embedded into the processing device or may be stored in a separate memory (e.g., memory 550). Memory 550 may comprise a Random Access Memory (RAM), a Read-Only Memory (ROM), a hard disk, an optical disk, a magnetic medium, a flash memory, other permanent, fixed, or volatile memory, or any other mechanism capable of storing instructions.

Although, in the embodiment illustrated in FIG. 5A, apparatus 110 includes one processing device (e.g., processor 210), apparatus 110 may include more than one processing device. Each processing device may have a similar construction, or the processing devices may be of differing constructions that are electrically connected or disconnected from each other. For example, the processing devices may be separate circuits or integrated in a single circuit. When more than one processing device is used, the processing devices may be configured to operate independently or collaboratively. The processing devices may be coupled electrically, magnetically, optically, acoustically, mechanically or by other means that permit them to interact.

In some embodiments, processor 210 may process a plurality of images captured from the environment of user 100 to determine different parameters related to capturing subsequent images. For example, processor 210 can determine, based on information derived from captured image data, a value for at least one of the following: an image resolution, a compression ratio, a cropping parameter, frame rate, a focus point, an exposure time, an aperture size, and a light sensitivity. The determined value may be used in capturing at least one subsequent image. Additionally, processor 210 can detect images including at least one hand-related trigger in the environment of the user and perform an action and/or provide an output of information to a user via feedback outputting unit 230.

In another embodiment, processor 210 can change the aiming direction of image sensor 220. For example, when apparatus 110 is attached with clip 420, the aiming direction of image sensor 220 may not coincide with the field-of-view of user 100. Processor 210 may recognize certain situations from the analyzed image data and adjust the aiming direction of image sensor 220 to capture relevant image data. For example, in one embodiment, processor 210 may detect an interaction with another individual and sense that the individual is not fully in view, because image sensor 220 is tilted down. Responsive thereto, processor 210 may adjust the aiming direction of image sensor 220 to capture image data of the individual. Other scenarios are also contemplated where processor 210 may recognize the need to adjust an aiming direction of image sensor 220.

In some embodiments, processor 210 may communicate data to feedback-outputting unit 230, which may include any device configured to provide information to a user 100. Feedback outputting unit 230 may be provided as part of apparatus 110 (as shown) or may be provided external to apparatus 110 and communicatively coupled thereto. Feedback-outputting unit 230 may be configured to output visual or nonvisual feedback based on signals received from processor 210, such as when processor 210 recognizes a hand-related trigger in the analyzed image data.

The term “feedback” refers to any output or information provided in response to processing at least one image in an environment. In some embodiments, as similarly described above, feedback may include an audible or visible indication of time information, detected text or numerals, the value of currency, a branded product, a person's identity, the identity of a landmark or other environmental situation or condition including the street names at an intersection or the color of a traffic light, etc., as well as other information associated with each of these. For example, in some embodiments, feedback may include additional information regarding the amount of currency still needed to complete a transaction, information regarding the identified person, historical information or times and prices of admission etc. of a detected landmark etc. In some embodiments, feedback may include an audible tone, a tactile response, and/or information previously recorded by user 100. Feedback-outputting unit 230 may comprise appropriate components for outputting acoustical and tactile feedback. For example, feedback-outputting unit 230 may comprise audio headphones, a hearing aid type device, a speaker, a bone conduction headphone, interfaces that provide tactile cues, vibrotactile stimulators, etc. In some embodiments, processor 210 may communicate signals with an external feedback outputting unit 230 via a wireless transceiver 530, a wired connection, or some other communication interface. In some embodiments, feedback outputting unit 230 may also include any suitable display device for visually displaying information to user 100.

As shown in FIG. 5A, apparatus 110 includes memory 550. Memory 550 may include one or more sets of instructions accessible to processor 210 to perform the disclosed methods, including instructions for recognizing a hand-related trigger in the image data. In some embodiments memory 550 may store image data (e.g., images, videos) captured from the environment of user 100. In addition, memory 550 may store information specific to user 100, such as image representations of known individuals, favorite products, personal items, and calendar or appointment information, etc. In some embodiments, processor 210 may determine, for example, which type of image data to store based on available storage space in memory 550. In another embodiment, processor 210 may extract information from the image data stored in memory 550.

As further shown in FIG. 5A, apparatus 110 includes mobile power source 520. The term “mobile power source” includes any device capable of providing electrical power, which can be easily carried by hand (e.g., mobile power source 520 may weigh less than a pound). The mobility of the power source enables user 100 to use apparatus 110 in a variety of situations. In some embodiments, mobile power source 520 may include one or more batteries (e.g., nickel-cadmium batteries, nickel-metal hydride batteries, and lithium-ion batteries) or any other type of electrical power supply. In other embodiments, mobile power source 520 may be rechargeable and contained within a casing that holds apparatus 110. In yet other embodiments, mobile power source 520 may include one or more energy harvesting devices for converting ambient energy into electrical energy (e.g., portable solar power units, human vibration units, etc.).

Mobile power source 520 may power one or mom wireless transceivers (e.g., wireless transceiver 530 in FIG. 5A). The term “wireless transceiver” refers to any device configured to exchange transmissions over an air interface by use of radio frequency, infrared frequency, magnetic field, or electric field. Wireless transceiver 530 may use any known standard to transmit and/or receive data (e.g., Wi-Fi, Bluetooth®, Bluetooth Smart, 802.15.4, or ZigBee). In some embodiments, wireless transceiver 530 may transmit data (e.g., raw image data, processed image data, extracted information) from apparatus 110 to computing device 120 and/or server 250. Wireless transceiver 530 may also receive data from computing device 120 and/or server 250. In other embodiments, wireless transceiver 530 may transmit data and instructions to an external feedback outputting unit 230.

FIG. 5B is a block diagram illustrating the components of apparatus 110 according to another example embodiment. In some embodiments, apparatus 110 includes a first image sensor 220a, a second image sensor 220b, a memory 550, a first processor 210t, a second processor 210b, a feedback outputting unit 230, a wireless transceiver 530, a mobile power source 520, and a power connector 510. In the arrangement shown in FIG. 5B, each of the image sensors may provide images in a different image resolution, or face a different direction. Alternatively, each image sensor may be associated with a different camera (e.g., a wide angle camera, a narrow angle camera, an IR camera, etc.). In some embodiments, apparatus 110 can select which image sensor to use based on various factors. For example, processor 210a may determine, based on available storage space in memory 550, to capture subsequent images in a certain resolution.

Apparatus 110 may operate in a first processing-mode and in a second processing-mode, such that the first processing-mode may consume less power than the second processing-mode. For example, in the first processing-mode, apparatus 110 may capture images and process the captured images to make real-time decisions based on an identifying hand-related trigger, for example, in the second processing-mode, apparatus 110 may extract information from stored images in memory 550 and delete images from memory 550. In some embodiments, mobile power source 520 may provide more than fifteen hours of processing in the first processing-mode and about three hours of processing in the second processing-mode. Accordingly, different processing-modes may allow mobile power source 520 to produce sufficient power for powering apparatus 110 for various time periods (e.g., more than two hours, more than four hours, more than ten hours, etc.).

In some embodiments, apparatus 110 may use first processor 210a in the first processing-mode when powered by mobile power source 520, and second processor 210b in the second processing-mode when powered by external power source 580 that is connectable via power connector 510. In other embodiments, apparatus 110 may determine, based on predefined conditions, which processors or which processing modes to use. Apparatus 110 may operate in the second processing-mode even when apparatus 110 is not powered by external power source 580. For example, apparatus 110 may determine that it should operate in the second processing-mode when apparatus 110 is not powered by external power source 580, if the available storage space in memory 550 for storing new image data is lower than a predefined threshold.

Although one wireless transceiver is depicted in FIG. 5B, apparatus 110 may include more than one wireless transceiver (e.g., two wireless transceivers). In an arrangement with more than one wireless transceiver, each of the wireless transceivers may use a different standard to transmit and/or receive data. In son embodiments, a first wireless transceiver may communicate with server 250 or computing device 120 using a cellular standard (e.g., LTE or GSM), and a second wireless transceiver may communicate with server 250 or computing device 120 using a short-range standard (e.g., Wi-Fi or Bluetooth®). In some embodiments, apparatus 110 may use the first wireless transceiver when the wearable apparatus is powered by a mobile power source included in the wearable apparatus, and use the second wireless transceiver when the wearable apparatus is powered by an external power source.

FIG. 5C is a block diagram illustrating the components of apparatus 110 according to another example embodiment including computing device 120. In this embodiment, apparatus 110 includes an image sensor 220, a memory 550a, a first processor 210, a feedback-outputting unit 230, a wireless transceiver 530a, a mobile power source 520, and a power connector 510. As further shown in FIG. 5C, computing device 120 includes a processor 540, a feedback-outputting unit 545, a memory 550b, a wireless transceiver 530b, and a display 260. One example of computing device 120 is a smartphone or tablet having a dedicated application installed therein. In other embodiments, computing device 120 may include any configuration such as an on-board automobile computing system, a PC, a laptop, and any other system consistent with the disclosed embodiments. In this example, user 100 may view feedback output in response to identification of a hand-related trigger on display 260. Additionally, user 100 may view other data (e.g., images, video clips, object information, schedule information, extracted information, etc.) on display 260. In addition, user 100 may communicate with server 250 via computing device 120.

In some embodiments, processor 210 and processor 540 are configured to extract information from captured image data. The term “extracting information” includes any process by which information associated with objects, individuals, locations, events, etc., is identified in the captured image data by any means known to those of ordinary skill in the art. In some embodiments, apparatus 110 may use the extracted information to send feedback or other real-time indications to feedback outputting unit 230 or to computing device 120. In some embodiments, processor 210 may identify in the image data the individual standing in front of user 100, and send computing device 120 the name of the individual and the last time user 100 met the individual. In another embodiment, processor 210 may identify in the image data, one or more visible triggers, including a hand-related trigger, and determine whether the trigger is associated with a person other than the user of the wearable apparatus to selectively determine whether to perform an action associated with the trigger. One such action may be to provide a feedback to user 100 via feedback-outputting unit 230 provided as part of (or in communication with) apparatus 110 or via a feedback unit 545 provided as part of computing device 120. For example, feedback-outputting unit 545 may be in communication with display 260 to cause the display 260 to visibly output information. In some embodiments, processor 210 may identify in the image data a hand-related trigger and send computing device 120 an indication of the trigger. Processor 540 may then process the received trigger information and provide an output via feedback outputting unit 545 or display 260 based on the hand-related trigger. In other embodiments, processor 540 may determine a hand-related trigger and provide suitable feedback similar to the above, based on image data received from apparatus 110. In some embodiments, processor 540 may provide instructions or other information, such as environmental information to apparatus 110 based on an identified hand-related trigger.

In some embodiments, processor 210 may identify other environmental information in the analyzed images, such as an individual standing in front user 100, and send computing device 120 information related to the analyzed information such as the name of the individual and the last time user 100 met the individual. In a different embodiment, processor 540 may extract statistical information from captured image data and forward the statistical information to server 250. For example, certain information regarding the types of items a user purchases, or the frequency a user patronizes a particular merchant, etc. may be determined by processor 540. Based on this information, server 250 may send computing device 120 coupons and discounts associated with the user's preferences.

When apparatus 110 is connected or wirelessly connected to computing device 120, apparatus 110 may transmit at least part of the image data stored in memory 550a for storage in memory 550b. In some embodiments, after computing device 120 confirms that transferring the part of image data was successful, processor 540 may delete the part of the image data. The term “delete” means that the image is marked as ‘deleted’ and other image data may be stored instead of it, but does not necessarily mean that the image data was physically removed from the memory.

As will be appreciated by a person skilled in the art having the benefit of this disclosure, numerous variations and/or modifications may be made to the disclosed embodiments. Not all components are essential for the operation of apparatus 110. Any component may be located in any appropriate apparatus and the components may be rearranged into a variety of configurations while providing the functionality of the disclosed embodiments. For example, in some embodiments, apparatus 110 may include a camera, a processor, and a wireless transceiver for sending data to another device. Therefore, the foregoing configurations are examples and, regardless of the configurations discussed above, apparatus 110 can capture, store, and/or process images.

Further, the foregoing and following description refers to storing and/or processing images or image data. In the embodiments disclosed herein, the stored and/or processed images or image data may comprise a representation of one or more images captured by image sensor 220. As the term is used herein, a “representation” of an image (or image data) may include an entire image or a portion of an image. A representation of an image (or image data) may have the same resolution or a lower resolution as the image (or image data), and/or a representation of an image (or image data) may be altered in some respect (e.g., be compressed, have a lower resolution, have one or more colors that are altered, etc.).

For example, apparatus 110 may capture an image and store a representation of the image that is compressed as a .JPG file. As another example, apparatus 110 may capture an image in color, but store a black-and-white representation of the color image. As yet another example, apparatus 110 may capture an image and store a different representation of the image (e.g., a portion of the image). For example, apparatus 110 may store a portion of an image that includes a face of a person who appears in the image, but that does not substantially include the environment surrounding the person. Similarly, apparatus 110 may, for example, store a portion of an image that includes a product that appears in the image, but does not substantially include the environment surrounding the product. As yet another example, apparatus 110 may store a representation of an image at a reduced resolution (i.e., at a resolution that is of a lower value than that of the captured image). Storing representations of images may allow apparatus 110 to save storage space in memory 550. Furthermore, processing representations of images may allow apparatus 110 to improve processing efficiency and/or help to preserve battery life.

In addition to the above, in some embodiments, any one of apparatus 110 or computing device 120, via processor 210 or 540, may further process the captured image data to provide additional functionality to recognize objects and/or gestures and/or other information in the captured image data. In some embodiments, actions may be taken based on the identified objects, gestures, or other information. In some embodiments, processor 210 or 540 may identify in the image data, one or more visible triggers, including a hand-related trigger, and determine whether the trigger is associated with a person other than the user to determine whether to perform an action associated with the trigger.

Some embodiments of the present disclosure may include an apparatus securable to an article of clothing of a user. Such an apparatus may include two portions, connectable by a connector. A capturing unit may be designed to be worn on the outside of a user's clothing, and may include an image sensor for capturing images of a user's environment. The capturing unit may be connected to or connectable to a power unit, which may be configured to house a power source and a processing device. The capturing unit may be a small device including a camera or other device for capturing images. The capturing unit may be designed to be inconspicuous and unobtrusive, and may be configured to communicate with a power unit concealed by a user's clothing. The power unit may include bulkier aspects of the system, such as transceiver antennas, at least one battery, a processing device, etc. In some embodiments, communication between the capturing unit and the power unit may be provided by a data cable included in the connector, while in other embodiments, communication may be wirelessly achieved between the capturing unit and the power unit. Some embodiments may permit alteration of the orientation of an image sensor of the capture unit, for example to better capture images of interest.

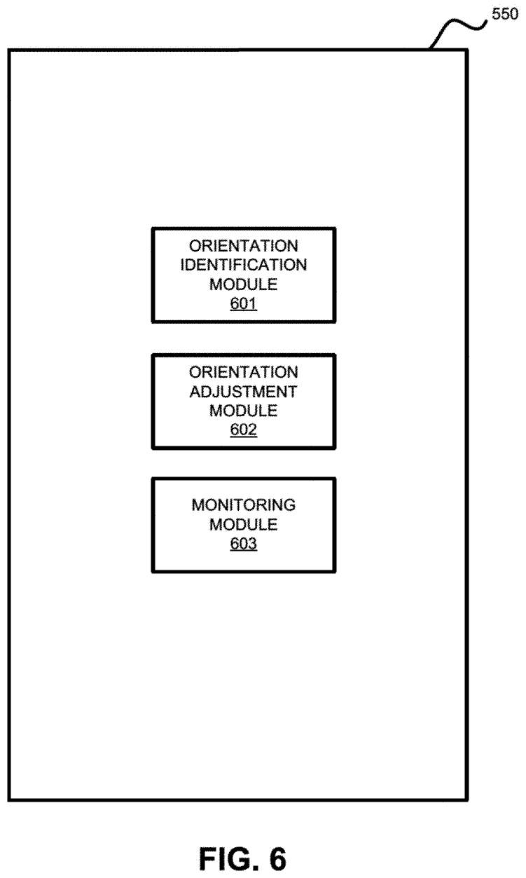

FIG. 6 illustrates an exemplary embodiment of a memory containing software modules consistent with the present disclosure. Included in memory 550 are orientation identification module 601, orientation adjustment module 602, and motion tracking module 603. Modules 601, 602, 603 may contain software instructions for execution by at least one processing device. e.g., processor 210, included with a wearable apparatus. Orientation identification module 601, orientation adjustment module 602, and motion tracking module 603 may cooperate to provide orientation adjustment for a capturing unit incorporated into wireless apparatus 110.

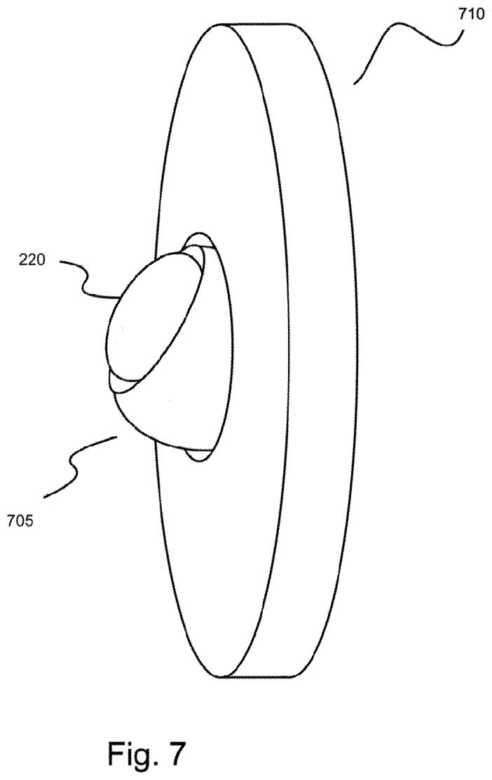

FIG. 7 illustrates an exemplary capturing unit 710 including an orientation adjustment unit 705. Orientation adjustment unit 705 may be configured to permit the adjustment of image sensor 220. As illustrated in FIG. 7, orientation adjustment unit 705 may include an eye-ball type adjustment mechanism. In alternative embodiments, orientation adjustment unit 705 may include gimbals, adjustable stalks, pivotable mounts, and any other suitable unit for adjusting an orientation of image sensor 220.

Image sensor 220 may be configured to be movable with the head of user 100 in such a manner that an aiming direction of image sensor 220 substantially coincides with a field of view of user 100. For example, as described above, a camera associated with image sensor 220 may be installed within capturing unit 710 at a predetermined angle in a position facing slightly upwards or downwards, depending on an intended location of capturing unit 710. Accordingly, the set aiming direction of image sensor 220 may match the field-of-view of user 100. In some embodiments, processor 210 may change the orientation of image sensor 220 using image data provided from image sensor 220. For example, processor 210 may recognize that a user is reading a book and determine that the aiming direction of image sensor 220 is offset from the text. That is, because the words in the beginning of each line of text are not fully in view, processor 210 may determine that image sensor 220 is tilted in the wrong direction. Responsive thereto, processor 210 may adjust the aiming direction of image sensor 220.

Orientation identification module 601 may be configured to identify an orientation of an image sensor 220 of capturing unit 710. An orientation of an image sensor 220 may be identified, for example, by analysis of images captured by image sensor 220 of capturing unit 710, by tilt or attitude sensing devices within capturing unit 710, and by measuring a relative direction of orientation adjustment unit 705 with respect to the remainder of capturing unit 710.

Orientation adjustment module 602 may be configured to adjust an orientation of image sensor 220 of capturing unit 710. As discussed above, image sensor 220 may be mounted on an orientation adjustment unit 705 configured for movement. Orientation adjustment unit 705 may be configured for rotational and/or lateral movement in response to commands from orientation adjustment module 602. In some embodiments orientation adjustment unit 705 may be adjust an orientation of image sensor 220 via motors, electromagnets, permanent magnets, and/or any suitable combination thereof.

In some embodiments, monitoring module 603 may be provided for continuous monitoring. Such continuous monitoring may include tracking a movement of at least a portion of an object included in one or more images captured by the image sensor. For example, in one embodiment, apparatus 110 may track an object as long as the object remains substantially within the field-of-view of image sensor 220. In additional embodiments, monitoring module 603 may engage orientation adjustment module 602 to instruct orientation adjustment unit 705 to continually orient image sensor 220 towards an object of interest. For example, in one embodiment, monitoring module 603 may cause image sensor 220 to adjust an orientation to ensure that a certain designated object, for example, the face of a particular person, remains within the field-of view of image sensor 220, even as that designated object moves about. In another embodiment, monitoring module 603 may continuously monitor an area of interest included in one or more images captured by the image sensor. For example, a user may be occupied by a certain task, for example, typing on a laptop, while image sensor 220 remains oriented in a particular direction and continuously monitors a portion of each image from a series of images to detect a trigger or other event. For example, image sensor 210 may be oriented towards a piece of laboratory equipment and monitoring module 603 may be configured to monitor a status light on the laboratory equipment for a change in status, while the user's attention is otherwise occupied.

In some embodiments consistent with the present disclosure, capturing unit 710 may include a plurality of image sensors 220. The plurality of image sensors 220 may each be configured to capture different image data. For example, when a plurality of image sensors 220 are provided, the image sensors 220 may capture images having different resolutions, may capture wider or narrower fields of view, and may have different levels of magnification. Image sensors 220 may be provided with varying lenses to permit these different configurations. In some embodiments, a plurality of image sensors 220 may include image sensors 220 having different orientations. Thus, each of the plurality of image sensors 220 may be pointed in a different direction to capture different images. The fields of view of image sensors 220 may be overlapping in some embodiments. The plurality of image sensors 220 may each be configured for orientation adjustment, for example, by being paired with an image adjustment unit 705. In some embodiments, monitoring module 603, or another module associated with memory 550, may be configured to individually adjust the orientations of the plurality of image sensors 220 as well as to turn each of the plurality of image sensors 220 on or off as may be required or preferred. In some embodiments, monitoring an object or person captured by an image sensor 220 may include tracking movement of the object across the fields of view of the plurality of image sensors 220.

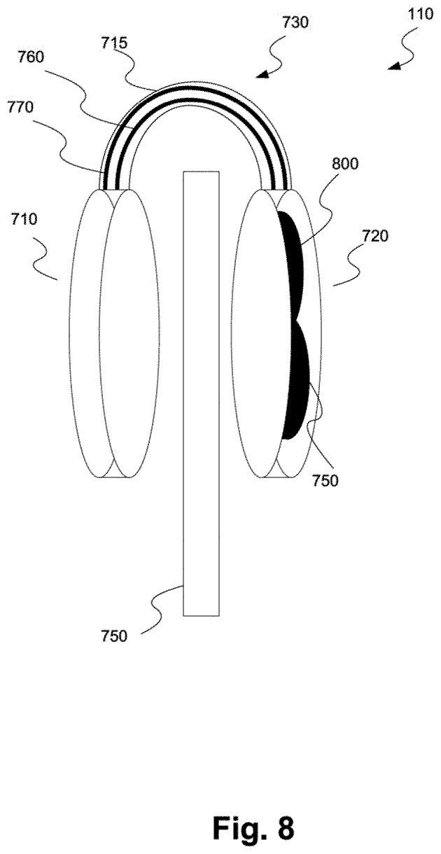

Embodiments consistent with the present disclosure may include connectors configured to connect a capturing unit and a power unit of a wearable apparatus. Capturing units consistent with the present disclosure may include least one image sensor configured to capture images of an environment of a user. Power units consistent with the present disclosure may be configured to house a power source and/or at least one processing device. Connectors consistent with the present disclosure may be configured to connect the capturing unit and the power unit, and may be configured to secure the apparatus to an article of clothing such that the capturing unit is positioned over an outer surface of the article of clothing and the power unit is positioned under an inner surface of the article of clothing. Exemplary embodiments of capturing units, connectors, and power units consistent with the disclosure are discussed in further detail with respect to FIGS. 8-14.

FIG. 8 is a schematic illustration of an embodiment of wearable apparatus 110 securable to an article of clothing consistent with the present disclosure. As illustrated in FIG. 8, capturing unit 710 and power unit 720 may be connected by a connector 730 such that capturing unit 710 is positioned on one side of an article of clothing 750 and power unit 720 is positioned on the opposite side of the clothing 750. In some embodiments, capturing unit 710 may be positioned over an outer surface of the article of clothing 750 and power unit 720 may be located under an inner surface of the article of clothing 750. The power unit 720 may be configured to be placed against the skin of a user.

Capturing unit 710 may include an image sensor 220 and an orientation adjustment unit 705 (as illustrated in FIG. 7). Power unit 720 may include mobile power source 520 and processor 210. Power unit 720 may further include any combination of elements previously discussed that may be a part of wearable apparatus 110, including, but not limited to, wireless transceiver 530, feedback outputting unit 230, memory 550, and data port 570.

Connector 730 may include a clip 715 or other mechanical connection designed to clip or attach capturing unit 710 and power unit 720 to an article of clothing 750 as illustrated in FIG. 8. As illustrated, clip 715 may connect to each of capturing unit 710 and power unit 720 at a perimeter thereof, and may wrap around an edge of the article of clothing 750 to affix the capturing unit 710 and power unit 720 in place. Connector 730 may further include a power cable 760 and a data cable 770. Power cable 760 may be capable of conveying power from mobile power source 520 to image sensor 220 of capturing unit 710. Power cable 760 may also be configured to provide power to any other elements of capturing unit 710, e.g., orientation adjustment unit 705. Data cable 770 may be capable of conveying captured image data from image sensor 220 in capturing unit 710 to processor 800 in the power unit 720. Data cable 770 may be further capable of conveying additional data between capturing unit 710 and processor 800, e.g., control instructions for orientation adjustment unit 705.

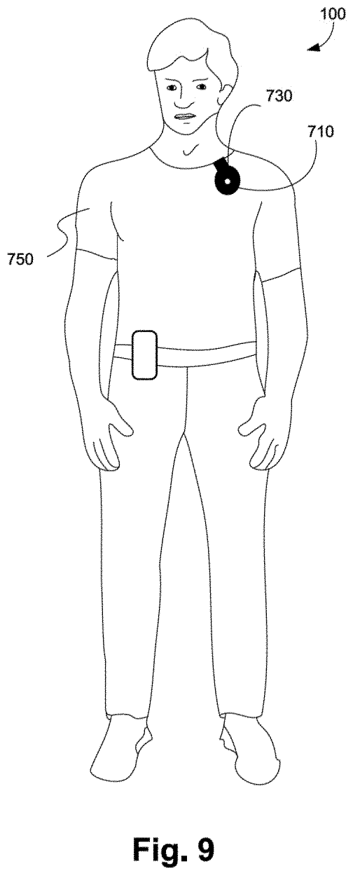

FIG. 9 is a schematic illustration of a user 100 wearing a wearable apparatus 110 consistent with an embodiment of the present disclosure. As illustrated in FIG. 9, capturing unit 710 is located on an exterior surface of the clothing 750 of user 100. Capturing unit 710 is connected to power unit 720 (not seen in this illustration) via connector 730, which wraps around an edge of clothing 750.

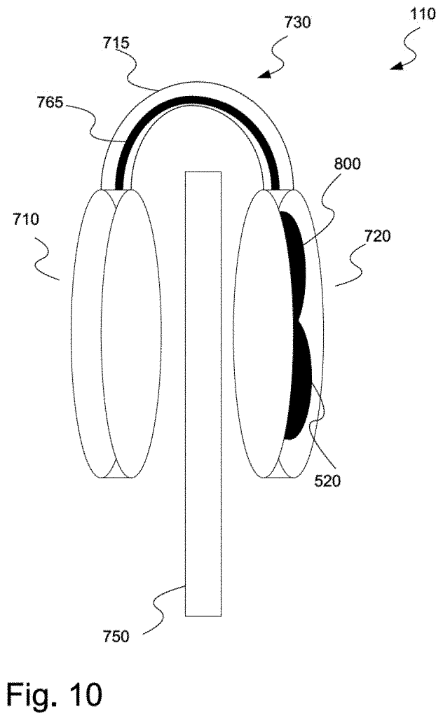

In some embodiments, connector 730 may include a flexible printed circuit board (PCB). FIG. 10 illustrates an exemplary embodiment wherein connector 730 includes a flexible printed circuit board 765. Flexible printed circuit board 765 may include data connections and power connections between capturing unit 710 and power unit 720. Thus, in some embodiments, flexible printed circuit board 765 may serve to replace power cable 760 and data cable 770. In alternative embodiments, flexible printed circuit board 765 may be included in addition to at least one of power cable 760 and data cable 770. In various embodiments discussed herein, flexible printed circuit board 765 may be substituted for, or included in addition to, power cable 760 and data cable 770.

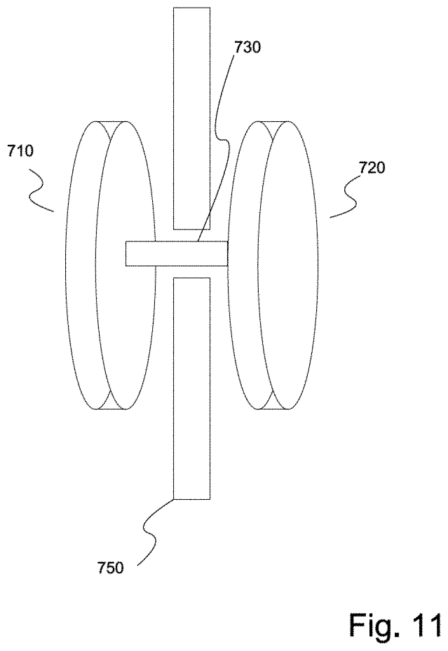

FIG. 11 is a schematic illustration of another embodiment of a wearable apparatus securable to an article of clothing consistent with the present disclosure. As illustrated in FIG. 11, connector 730 may be centrally located with respect to capturing unit 710 and power unit 720. Central location of connector 730 may facilitate affixing apparatus 110 to clothing 750 through a hole in clothing 750 such as, for example, a button-hole in an existing article of clothing 750 or a specialty hole in an article of clothing 750 designed to accommodate wearable apparatus 110.

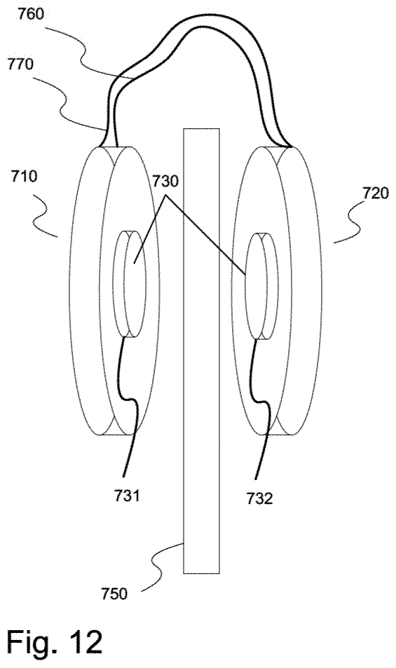

FIG. 12 is a schematic illustration of still another embodiment of wearable apparatus 110 securable to an article of clothing. As illustrated in FIG. 12, connector 730 may include a first magnet 731 and a second magnet 732. First magnet 731 and second magnet 732 may secure capturing unit 710 to power unit 720 with the article of clothing positioned between first magnet 731 and second magnet 732. In embodiments including first magnet 731 and second magnet 732, power cable 760 and data cable 770 may also be included. In these embodiments, power cable 760 and data cable 770 may be of any length, and may provide a flexible power and data connection between capturing unit 710 and power unit 720. Embodiments including first magnet 731 and second magnet 732 may further include a flexible PCB 765 connection in addition to or instead of power cable 760 and/or data cable 770. In some embodiments, first magnet 731 or second magnet 732 may be replaced by an object comprising a metal material.

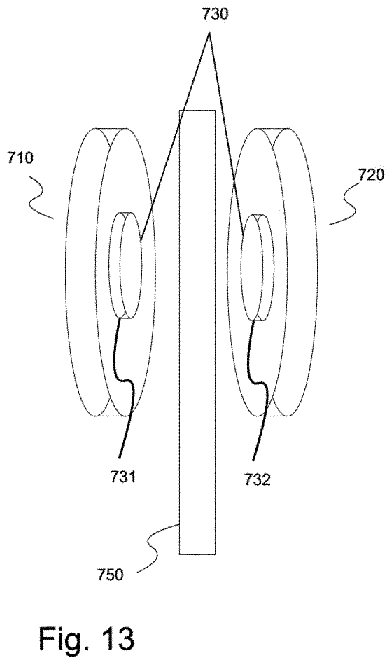

FIG. 13 is a schematic illustration of yet another embodiment of a wearable apparatus 110 securable to an article of clothing. FIG. 13 illustrates an embodiment wherein power and data may be wirelessly transferred between capturing unit 710 and power unit 720. As illustrated in FIG. 13, first magnet 731 and second magnet 732 may be provided as connector 730 to secure capturing unit 710 and power unit 720 to an article of clothing 750. Power and/or data may be transferred between capturing unit 710 and power unit 720 via any suitable wireless technology, for example, magnetic and/or capacitive coupling, near field communication technologies, radiofrequency transfer, and any other wireless technology suitable for transferring data and/or power across short distances.

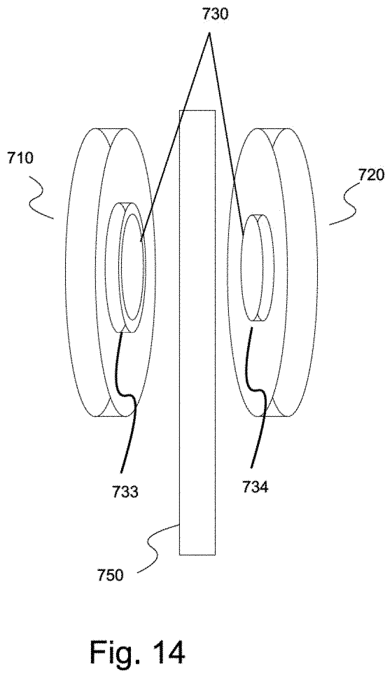

FIG. 14 illustrates still another embodiment of wearable apparatus 10 securable to an article of clothing 750 of a user. As illustrated in FIG. 14, connector 730 may include features designed for a contact fit. For example, capturing unit 710 may include a ring 733 with a hollow center having a diameter slightly larger than a disk-shaped protrusion 734 located on power unit 720. When pressed together with fabric of an article of clothing 750 between them, disk-shaped protrusion 734 may fit tightly inside ring 733, securing capturing unit 710 to power unit 720. FIG. 14 illustrates an embodiment that does not include any cabling or other physical connection between capturing unit 710 and power unit 720. In this embodiment, capturing unit 710 and power unit 720 may transfer power and data wirelessly. In alternative embodiments, capturing unit 710 and power unit 720 may transfer power and data via at least one of cable 760, data cable 770, and flexible printed circuit board 765.

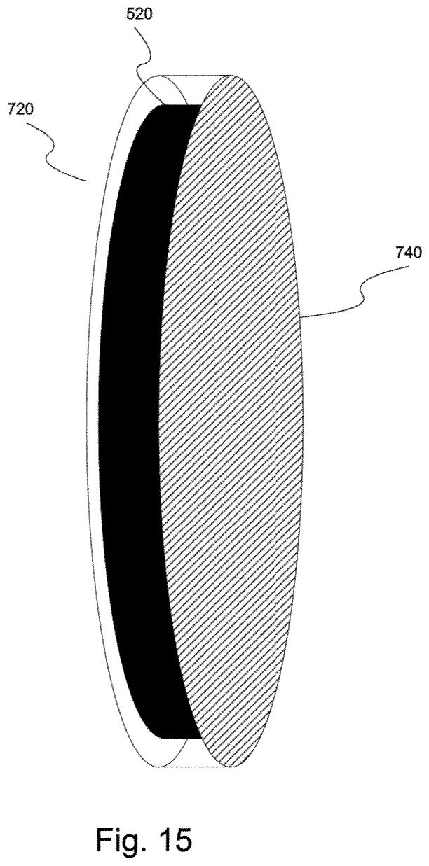

FIG. 15 illustrates another aspect of power unit 720 consistent with embodiments described herein. Power unit 720 may be configured to be positioned directly against the user's skin. To facilitate such positioning, power unit 720 may further include at least one surface coated with a biocompatible material 740. Biocompatible materials 740 may include materials that will not negatively react with the skin of the user when worn against the skin for extended periods of time. Such materials may include, for example, silicone. PTFE, kapton, polyimide, titanium, nitinol, platinum, and others. Also as illustrated in FIG. 15, power unit 720 may be sized such that an inner volume of the power unit is substantially filled by mobile power source 520. That is, in some embodiments, the inner volume of power unit 720 may be such that the volume does not accommodate any additional components except for mobile power source 520. In some embodiments, mobile power source 520 may take advantage of its close proximity to the skin of user's skin. For example, mobile power source 520 may use the Peltier effect to produce power and/or charge the power source.

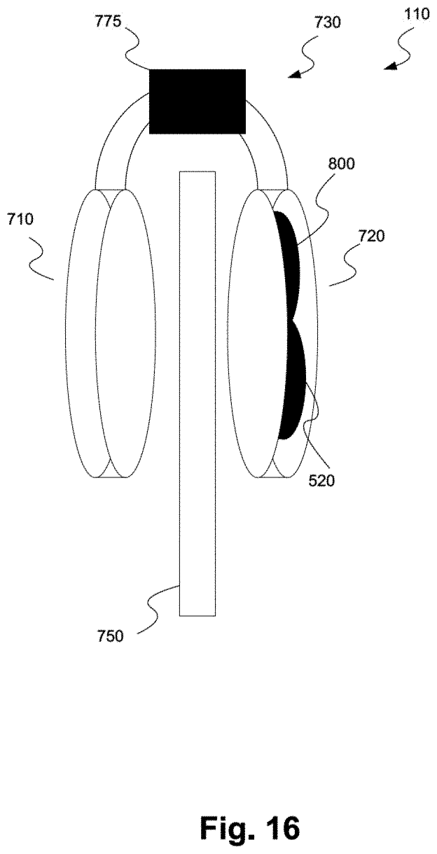

In further embodiments, an apparatus securable to an article of clothing may further include protective circuitry associated with power source 520 housed in in power unit 720. FIG. 16 illustrates an exemplary embodiment including protective circuitry 775. As illustrated in FIG. 16, protective circuitry 775 may be located remotely with respect to power unit 720. In alternative embodiments, protective circuitry 775 may also be located in capturing unit 710, on flexible printed circuit board 765, or in power unit 720.

Protective circuitry 775 may be configured to protect image sensor 220 and/or other elements of capturing unit 710 from potentially dangerous currents and/or voltages produced by mobile power source 520. Protective circuitry 775 may include passive components such as capacitors, resistors, diodes, inductors, etc., to provide protection to elements of capturing unit 710. In some embodiments, protective circuitry 775 may also include active components, such as transistors, to provide protection to elements of capturing unit 710. For example, in some embodiments, protective circuitry 775 may comprise one or more resistors serving as fuses. Each fuse may comprise a wire or strip that melts (thereby braking a connection between circuitry of image capturing unit 710 and circuitry of power unit 720) when current flowing through the fuse exceeds a predetermined limit (e.g., 500 milliamps, 900 milliamps, 1 amp, 1.1 amps, 2 amp, 2.1 amps, 3 amps, etc.) Any or all of the previously described embodiments may incorporate protective circuitry 775.

In some embodiments, the wearable apparatus may transmit data to a computing device (e.g., a smartphone, tablet, watch, computer, etc.) over one or more networks via any known wireless standard (e.g., cellular, Wi-Fi, Bluetooth®, etc.), or via near-filed capacitive coupling, other short range wireless techniques, or via a wired connection. Similarly, the wearable apparatus may receive data from the computing device over one or more networks via any known wireless standard (e.g., cellular, Wi-Fi, Bluetooth®, etc.), or via near-filed capacitive coupling, other short range wireless techniques, or via a wired connection. The data transmitted to the wearable apparatus and/or received by the wireless apparatus may include images, portions of images, identifiers related to information appearing in analyzed images or associated with analyzed audio, or any other data representing image and/or audio data. For example, an image may be analyzed and an identifier related to an activity occurring in the image may be transmitted to the computing device (e.g., the “paired device”). In the embodiments described herein, the wearable apparatus may process images and/or audio locally (on board the wearable apparatus) and/or remotely (via a computing device). Further, in the embodiments described herein, the wearable apparatus may transmit data related to the analysis of images and/or audio to a computing device for further analysis, display, and/or transmission to another device (e.g., a paired device). Further, a paired device may execute one or more applications (apps) to process, display, and/or analyze data (e.g., identifiers, text, images, audio, etc.) received from the wearable apparatus.

Some of the disclosed embodiments may involve systems, devices, methods, and software products for determining at least one keyword. For example, at least one keyword may be determined based on data collected by apparatus 110. At least one search query may be determined based on the at least one keyword. The at least one search query may be transmitted to a search engine.

In some embodiments, at least one keyword may be determined based on at least one or more images captured by image sensor 220. In some cases, the at least one keyword may be selected from a keywords pool stored in memory. In some cases, optical character recognition (OCR) may be performed on at least one image captured by image sensor 220, and the at least one keyword may be determined based on the OCR result. In some cases, at least one image captured by image sensor 220 may be analyzed to recognize: a person, an object, a location, a scene, and so firth. Further, the at least one keyword may be determined based on the recognized person, object, location, scene, etc. For example, the at least one keyword may comprise: a person's name, an object's name, a place's name, a date, a sport team's name, a movie's name, a book's name, and so forth.

In some embodiments, at least one keyword may be determined based on the user's behavior. The user's behavior may be determined based on an analysis of the one or more images captured by image sensor 220. In some embodiments, at least one keyword may be determined based on activities of a user and/or other person. The one or more images captured by image sensor 220 may be analyzed to identify the activities of the user and/or the other person who appears in one or more images captured by image sensor 220. In some embodiments, at least one keyword may be determined based on at least one or more audio segments captured by apparatus 110. In some embodiments, at least one keyword may be determined based on at least GPS information associated with the user. In some embodiments, at least one keyword may be determined based on at least the current time and/or date.

In some embodiments, at least one search query may be determined based on at least one keyword. In some cases, the at least one search query may comprise the at least one keyword. In some cases, the at least one search query may comprise the at least one keyword and additional keywords provided by the user. In some cases, the at least one search query may comprise the at least one keyword and one or more images, such as images captured by image sensor 220. In some cases, the at least one search query may comprise the at least one keyword and one or more audio segments, such as audio segments captured by apparatus 110.

In some embodiments, the at least one search query may be transmitted to a search engine. In some embodiments, search results provided by the search engine in response to the at least one search query may be provided to the user. In some embodiments, the at least one search query may be used to access a database.

For example, in one embodiment, the keywords may include a name of a type of food, such as quinoa, or a brand name of a food product; and the search will output information related to desirable quantities of consumption, facts about the nutritional profile, and so forth. In another example, in one embodiment, the keywords may include a name of a restaurant, and the search will output information related to the restaurant, such as a menu, opening hours, reviews, and so forth. The name of the restaurant may be obtained using OCR on an image of signage, using GPS information, and so forth. In another example, in one embodiment, the keywords may include a name of a person, and the search will provide information from a social network profile of the person. The name of the person may be obtained using OCR on an image of a name tag attached to the person's shirt, using face recognition algorithms, and so forth. In another example, in one embodiment, the keywords may include a name of a book, and the search will output information related to the book, such as reviews, sales statistics, information regarding the author of the book, and so forth. In another example, in one embodiment, the keywords may include a name of a movie, and the search will output information related to the movie, such as reviews, box office statistics, information regarding the cast of the movie, show times, and so forth. In another example, in one embodiment, the keywords may include a name of a sport team, and the search will output information related to the sport team, such as statistics, latest results, future schedule, information regarding the players of the sport team, and so forth. For example, the name of the sports team may be obtained using audio recognition algorithms.

A wearable apparatus consistent with the disclosed embodiments may be used in social events to identify individuals in the environment of a user of the wearable apparatus and provide contextual information associated with the individual. For example, the wearable apparatus may determine whether an individual is known to the user, or whether the user has previously interacted with the individual. The wearable apparatus may provide an indication to the user about the identified person, such as a name of the individual or other identifying information. The device may also extract any information relevant to the individual, for example, words extracted from a previous encounter between the user and the individual, topics discussed during the encounter, or the like. The device may also extract and display information from external source, such as the internet. Further, regardless of whether the individual is known to the user or not, the wearable apparatus may pull available information about the individual, such as from a web page, a social network, etc. and provide the information to the user.

This content information may be beneficial for the user when interacting with the individual. For example, the content information may remind the user who the individual is. For example, the content information may include a name of the individual, or topics discussed with the individual, which may remind the user of how he or she knows the individual. Further, the content information may provide talking points for the user when conversing with the individual, for example, the user may recall previous topics discussed with the individual, which the user may want to bring up again. In some embodiments, for example where the content information is derived from a social media or blog post, the user may bring up topics that the user and the individual have not discussed yet, such as an opinion or point of view of the individual, events in the individual's life, or other similar information. Thus, the disclosed embodiments may provide, among other advantages, improved efficiency, convenience, and functionality over prior art devices.

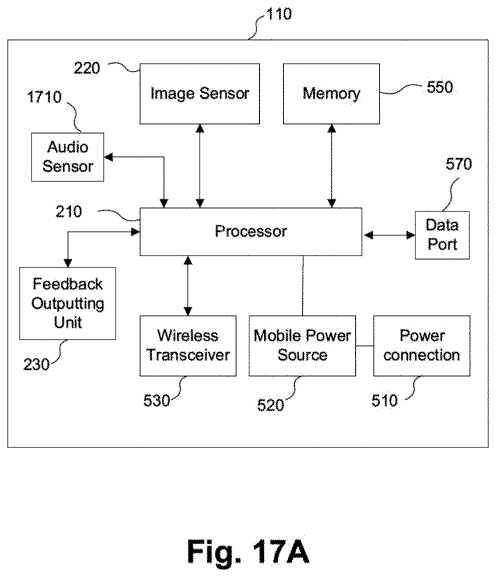

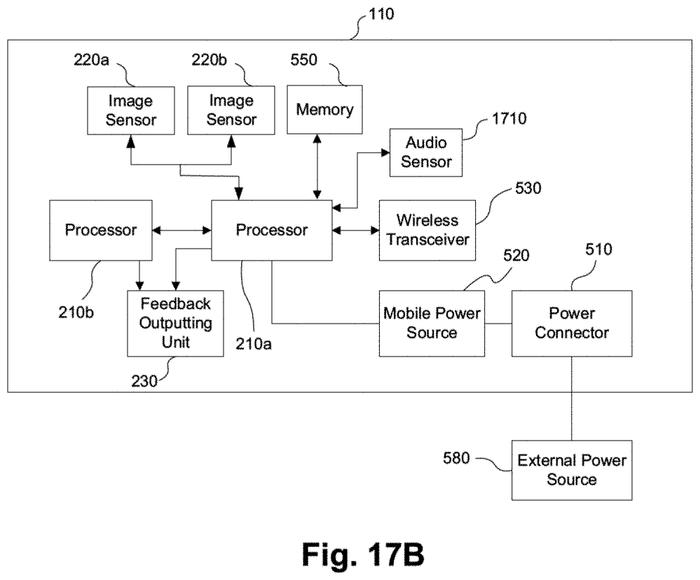

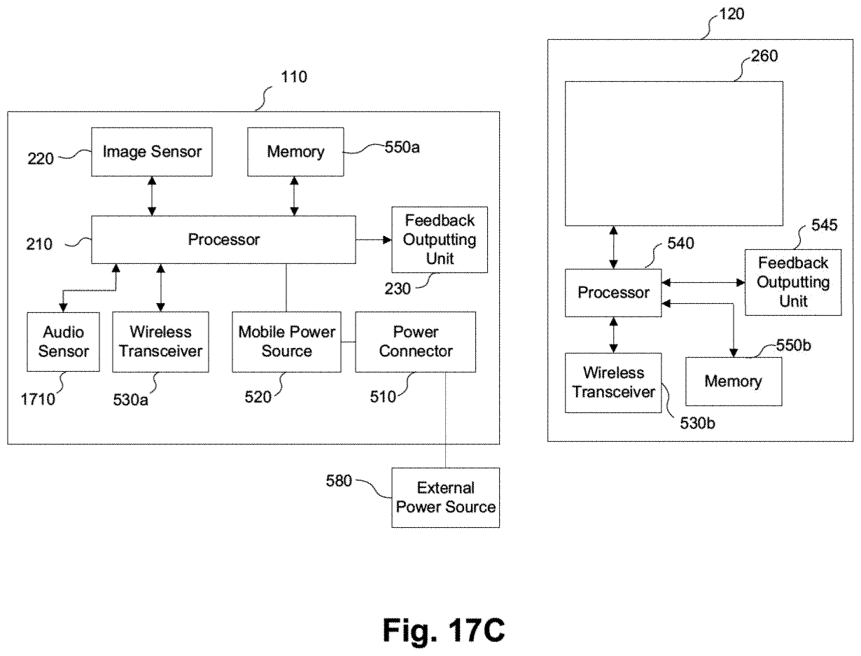

In some embodiments, apparatus 110 may be configured to use audio information in addition to image information. For example, apparatus 110 may detect and capture sounds in the environment of the user, via one or more microphones. Apparatus 110 may use this audio information instead of, or in combination with, image information to determine situations, identify persons, perform activities, or the like. FIG. 17A is a block diagram illustrating components of wearable apparatus 110 according to an example embodiment. FIG. 17A may include the features shown in FIG. 5A. For example, as discussed in greater detail above, wearable apparatus may include processor 210, image sensor 220, memory 550, wireless transceiver 530 and various other components as shown in FIG. 17A. Wearable apparatus may further comprise an audio sensor 1710. Audio sensor 1710 may be any device capable of capturing sounds from an environment of a user and converting them to one or more audio signals. For example, audio sensor 1710 may comprise a microphone or another sensor (e.g., a pressure sensor, which may encode pressure differences comprising sound) configured to encode sound waves as a digital signal. As shown in FIG. 17A, processor 210 may analyze signals from audio sensor 1710 in addition to signals from image sensor 220.

FIG. 17B is a block diagram illustrating the components of apparatus 110 according to another example embodiment. Similar to FIG. 17A, FIG. 17B includes all the features of FIG. 5B along with audio sensor 1710. Processor 210a may analyze signals from audio sensor 1710 in addition to signals from image sensors 210a and 210b. In addition, although FIGS. 17A and 17B each depict a single audio sensor, a plurality of audio sensors may be used, whether with a single image sensor as in FIG. 17A or with a plurality of image sensors as in FIG. 17B.

FIG. 17C is a block diagram illustrating components of wearable apparatus 110 according to an example embodiment. FIG. 17C includes all the features of FIG. 5C along with audio sensor 1710. As shown in FIG. 17C, wearable apparatus 110 may communicate with a computing device 120. In such embodiments, wearable apparatus 110 may send data from audio sensor 1710 to computing device 120 for analysis in addition to or in lieu of analyze the signals using processor 210.

Grouping and Tagging People by Context and Previous Interactions

As described throughout the present disclosure, a wearable camera apparatus may be configured to recognize individuals in the environment of a user. Consistent with the disclosed embodiments, a person recognition system may use context recognition techniques to enable individuals to be grouped by context. For example, the system may automatically tag individuals based on various contexts, such as work, a book club, immediate family, extended family, a poker group, or other situations or contexts. Then, when an individual is encountered subsequent to the context tagging, the system may use the group tag to provide insights to the user. For example, the system may tell the user the context in which the user has interacted with the individual, make assumptions based on the location and the identification of one or more group members, or various other benefits.

In some embodiments, the system may track statistical information associated with interactions with individuals. For example, the system may track interactions with each encountered individual and automatically update a personal record of interactions with the encountered individual. The system may provide analytics and tags per individual based on meeting context (e.g., work meeting, sports meeting, etc.). Information, such as a summary of the relationship, may be provided to the user via an interface. In some embodiments, the interface may order individuals chronologically based on analytics or tags. For example, the system may group or order individuals by attendees at recent meetings, meeting location, amount of time spent together, or various other characteristics. Accordingly, the disclosed embodiments may provide, among other advantages, improved efficiency, convenience, and functionality over prior art wearable apparatuses.

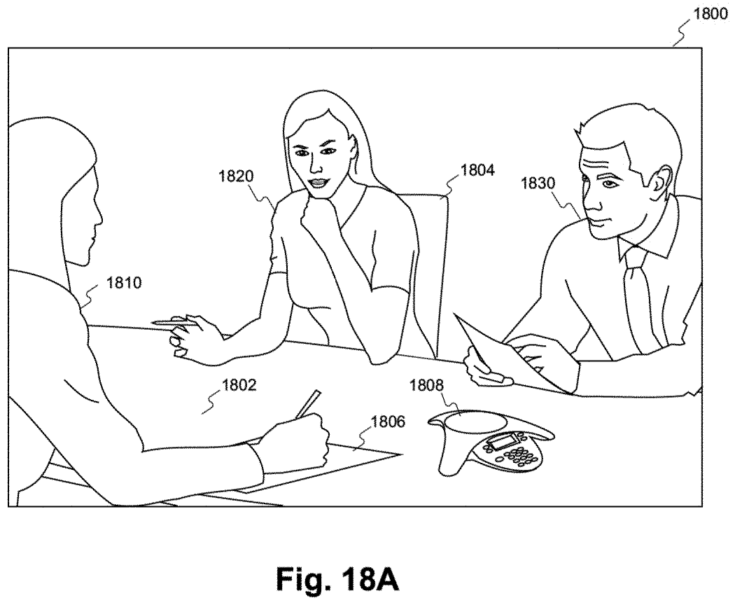

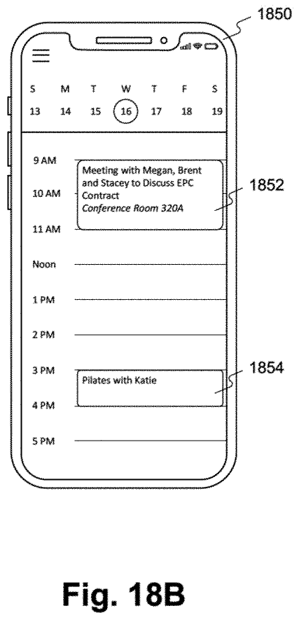

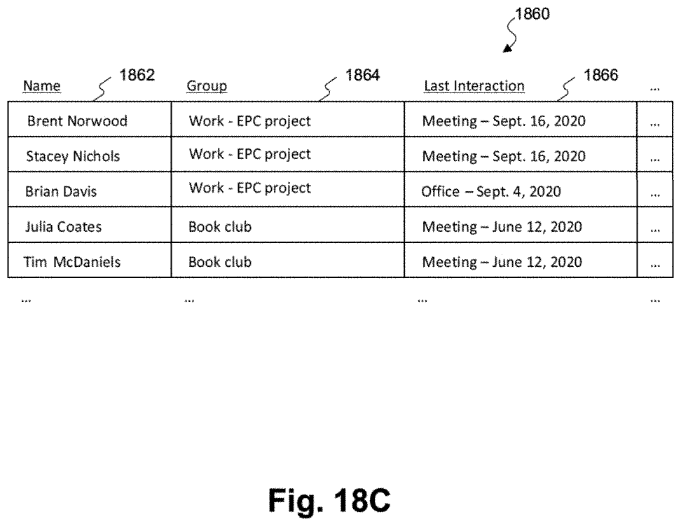

As described above, wearable apparatus 110 may be configured to capture one or more images from the environment of user 100. FIG. 18A illustrates an example image 1800 that may be captured from an environment of user 100, consistent with the disclosed embodiments. Image 1800 may be captured by image sensor 220, as described above. In the example shown in image 1800, user 100 may be in a meeting with other individuals 1810, 1820, and 1830. Image 1800 may include other elements such as objects 1802, 1804, 1806, or 1808, that may indicate a context of the interaction with individuals 1810, 1820, and 1830. Wearable apparatus 110 may also capture audio signals from the environment of user 100. For example, microphones 443 or 444 may be used to capture audio signals from the environment of the user, as described above. This may include voices of the user and/or individuals 1810, 1820, and 1830, background noises, or other sounds from the environment.

The disclosed systems may be configured to recognize at least one individual in the environment of the user. Individuals may be recognized in any manner described throughout the present disclosure. In some embodiments, the individual may be recognized based on images captured by wearable apparatus 110. For example, in image 1800, the disclosed systems may recognize one or more of individuals 1810, 1820, or 1830. The individuals may be recognized based on any form of visual characteristic that may be detected based on an image or multiple images. In some embodiments, the individuals may be recognized based on a face or facial features of the individual. Accordingly, the system may identify facial features on the face of the individual, such as the eyes, nose, cheekbones, jaw, or other features. The system may use one or more algorithms for analyzing the detected features, such as principal component analysis (e.g., using Eigenfaces), linear discriminant analysis, elastic bunch graph matching e.g., using Fisherface), Local Binary Patterns Histograms (LBPH), Scale Invariant Feature Transform (SIFT), Speed Up Robust Features (SURF), or the like. In some embodiments, the individual may be recognized based on other physical characteristics or traits. For example, the system may detect a body shape or posture of the individual, which may indicate an identity of the individual. Similarly, an individual may have particular gestures, mannerisms (e.g., movement of hands, facial movements, gait, typing or writing patterns, eye movements, or other bodily movements) that the system may use to identify the individual. Various other features that may be detected include skin tone, body shape, retinal patterns, distinguishing marks (e.g., moles, birth marks, freckles, scars, etc.), hand geometry, finger geometry, or any other distinguishing visual or physical characteristics. Accordingly, the system may analyze one or more images to detect these characteristics and recognize individuals.

In some embodiments, individuals may be recognized based on audio signals captured by wearable apparatus 110. For example, microphones 443 and/or 444 may detect voices or other sounds emanating from the individuals, which may be used to identify the individuals. This may include using one or more voice recognition algorithms, such as Hidden Markov Models. Dynamic Time Warping, neural networks, or other techniques, to recognize the voice of the individual. The individual may be recognized based on any form of acoustic characteristics that may indicate an identity of the individual, such as an accent, tone, vocabulary, vocal category, speech rate, pauses, filler words, or the like.

The system may further be configured to classify an environment of the user into one or more contexts. As used herein, a context may be any form of identifier indicating a setting in which an interaction occurs. The contexts may be defined such that individuals may be tagged with one or more contexts to indicate where and how an individual interacts with the user. For example, in the environment shown in image 1800, the user may be meeting with individuals 1810, 1820, and 1830 at work. Accordingly, the environment may be classified as a “work” context. The system may include a database or other data structure including a predefined list of contexts. Example contexts may include, work, family gatherings, fitness activities (sports practices, gyms, training classes, etc.), medical appointments (e.g., doctors' office visits, clinic visits, emergency room visits, etc.), lessons (e.g., music lessons, martial arts classes, art classes, etc.), shopping, travel, clubs (e.g., wine clubs, book clubs, etc.), dining, school, volunteer events, religious gatherings, outdoor activities, or various other contexts, which may depend on the particular application or implementation of the disclosed embodiments. The contexts may be defined at various levels of specificity and may overlap. For example, if an individual is recognized at a yoga class, the context may include one or more of “yoga class,” “fitness classes,” “classes,” “fitness,” “social/personal,” or various other degrees of specificity. Similarly, the environment image 1800 may be classified with contexts according to various degrees of specificity. If a purpose of the meeting is known, the context may be a title of the meeting. The environment may be tagged with a particular group or project name based on the identity of the individuals in the meeting. In some embodiments, the context may be “meeting,” “office,” “work” or various other tags or descriptors. In some embodiments, more than one context classification may be applied. One skilled in the art would recognize that a wide variety of contexts may be defined and the disclosed embodiments are not limited to any of the example contexts described herein.

The contexts may be defined in various ways. In some embodiments, the contexts may be prestored contexts. For example, the contexts may be preloaded in a database or memory (e.g., as default values) and wearable apparatus 110 may be configured to classify environments into one or more of the predefined contexts. In some embodiments, a user may define one or more contexts. For example, the contexts may be entirely user-defined, or the user may add, delete, or modify a preexisting list of contexts. In some embodiments the system may suggest one or more contexts, which user 100 may confirm or accept, for example, through a user interface of computing device 120.

In some embodiments, the environment may be classified according to a context classifier. A context classifier refers to any form of value or description classifying an environment. In some embodiments, the context classifier may associate information captured or accessed by wearable apparatus 110 with a particular context. This may include any information available to the system that may indicate a purpose or setting of an interaction with a user. In some embodiments, the information may be ascertained from images captured by wearable apparatus 110. For example, the system may be configured to detect and classify objects within the images that may indicate a context. Continuing with the example image 1800, the system may detect desk 1802, chair 1804, papers 1806, and/or conference room phone 1808. The context classifier may associate these specific objects or the types of the objects (e.g., chair, desk, etc.) with work or meeting environments, and the system may classify the environment accordingly. In some embodiments, the system may recognize words or text from within the environment that may provide an indication of the type of environment. For example, text from a menu may indicate the user is in a dining environment. Similarly, the name of a business or organization may indicate whether an interaction is a work or social interaction. Accordingly, the disclosed systems may include optical character recognition (OCR) algorithms, or other text recognition tools to detect and interpret text in images. In some embodiments, the context classier may be determined based on a context classification rule. As used herein, a context classification rule refers to any form of relationship, guideline, or other information defining how an environment should be classified.

In some embodiments, the system may use captured audio information, such as an audio signal received from microphones 443 or 444, to determine a context. For example, the voices of individuals 1810, 1820, and 1830 may indicate that the environment shown in image 1810 is a work environment. Similarly, the system may detect the sounds of papers shuffling, the sound of voices being played through a conference call (e.g., through conference room phone 1808), phones ringing, or other sounds that may indicate user 100 is in a meeting or office environment. In another example, cheering voices may indicate a sporting event. In some embodiments, a content of a conversation may be used to identify an environment. For example, the voices of individuals 1810, 1820, and 1830 may be analyzed using speech recognition algorithms to generate a transcript of the conversation, which may be analyzed to determine a context. For example, the system may identify various keywords spoken by user 110 and/or individuals 1810, 1820, and 1830 (e.g., “contract,” “engineers,” “drawings.” “budget.” etc.), which may indicate a context of the interaction. Various other forms of speech recognition tools, such as keyword spotting algorithms, or the like may be used.

In some embodiments, wearable apparatus 110 may be configured to receive one or more external signals that may indicate a context, in some embodiments, the external signal may be a global positioning system (GPS) signal (or signals based on similar satellite-based navigation systems) that may indicate a location of user 100. This location information may be used to determine a context. For example, the system may correlate a particular location (or locations within a threshold distance of a particular location) with a particular context. For example, GPS signals indicating the user is at or near an address associated with the user's work address may indicate the user is in a work environment. Similarly, if an environment in a particular geographic location has previously been tagged with “fitness activity,” future activities in the same location may receive the same classification. In some embodiments, the system may perform a look-up function to determine a business name, organization name, geographic area (e.g., county, town, city, etc.) or other information associated with a location for purposes of classification. For example, if the system determines the user is within a threshold distance of a restaurant, the environment may be classified as “dining” or a similar context. In some embodiments, the environment may be classified based on a Wi-Fi™ signal. For example, the system may associate particular Wi-Fi networks with one or more contexts. Various other forms of external signals may include, satellite communications, radio signals, radar signals, cellular signals (e.g., 4G, 5G, etc.), infrared signals. Bluetooth®, RFID. Zigbee®, or any other signal that may indicate a context. The signals may be received directly by wearable apparatus 110 (e.g., through transceiver 530), or may be identified through secondary devices, such as computing device 120.

Various other forms of data may be accessed for the purpose of determining context. In some embodiments, this may include calendar information associated with user 100. For example, the disclosed systems may access an account or device associated with user 100 that may include one or more calendar entries. FIG. 18B illustrates an example calendar entry 1852 that may be analyzed to determine a context, consistent with the disclosed embodiments. In the example shown in FIG. 18B, a mobile device 1850 of user 100 (which may correspond to computing device 120) may include a calendar application configured to access and/or store one or more calendar entries 1852 and 1854. The system may associate an environment with the calendar entries based on a time in which the user is in the environment. For example, if image 1800 is taken between 9:00 AM and 11:00 AM, the system may determine that the environment is associated with calendar entry 1852. The calendar entries may include metadata or other information that may indicate a context. For example, calendar entry 1852 may include a meeting title, indicating the purpose of the meeting is to discuss an “EPC contract.” The system may recognize “EPC” or “contract” and associate these keywords with a particular context. Similarly, the meeting may include attendees or location information, which may be associated with particular contexts. In some embodiments, the calendar entries may be associated with a particular account of user 100, which may indicate the context. For example, calendar entry 1852 may be associated with a work account of user 100, whereas calendar entry 1854 may be associated with a personal account. In some embodiments, the calendar entries themselves may include classifications or tags, which may be directly adopted as the environment context tags, or may be analyzed to determine an appropriate context. While a calendar invite is provided by way of example, the system may access any form of data associated with user 100 that may indicate context information. This data may include, but is not limited to, social media information, contact information (e.g., address book entries, etc.), medical records, group affiliations, stored photos, financial transaction data, account data, biometric data, application data, message data (e.g., SMS messages, emails, etc.), stored documents, media files, or any other data.

In some embodiments, the context classifier may be based on a machine learning model or algorithm. For example, a machine learning model (such as an artificial neural network, a deep learning model, a convolutional neural network, etc.) may be trained to classify environments using training examples of images, audio signals, external signals, calendar invites, or other data. The training examples may be labeled with predetermined classifications that the model may be trained to generate. Accordingly, the trained machine teaming model may be used to classify contexts based on similar types input data. Some non-limiting examples of such neural networks may include shallow artificial neural networks, deep artificial neural networks, feedback artificial neural networks, feed forward artificial neural networks, autoencoder artificial neural networks, probabilistic artificial neural networks, time delay artificial neural networks, convolutional artificial neural networks, recurrent artificial neural networks, long short-term memory artificial neural networks, and so forth. In some embodiments, the disclosed embodiments may further include updating the trained neural network model based on a classification of an environment. For example, a user may confirm that a context is correctly assigned and this may be provided as feedback to the trained model.

The disclosed embodiments may further include tagging or grouping an individual recognized in image or audio signals with the determined context. For example, the individual may be associated with the context in a database. A database may include any collection of data values and relationships among them, regardless of structure. As used herein, any data structure may constitute a database. FIG. 18C illustrates an example data structure 1860 that may be used for associating individuals with contexts, consistent with the disclosed embodiments. Data structure 1860 may include a column 1862 including identities of individuals. For example, column 1862 shown in FIG. 18C includes names of individuals. Any other form of identifying information could be used, such as alphanumeric identifiers, data obtained based on facial or voice recognition, or any other information that may identify an individual. Data structure 1860 may include context tags as shown in column 1864. By associating individuals with contexts, the system may be configured to group individuals based on context. For example, the system may identify individuals 1820 and 1830 as “Stacey Nichols” and “Brent Norwood,” respectively. The system may then access additional information to determine a context of the interaction with these individuals. For example, as described above, the information may include image analysis to detect objects 1802, 1804, 1806, and/or 1808, analysis of audio captured during the meeting, location or WiFi signal data, calendar invite 1852, or various other information. The determined context may be a relatively broad classification, such as “work” or may include more precise classifications, such as “EPC project.” The system may not necessarily know the meaning of “EPC Project” but may extract it from communications or other data associated with user 100 and/or individuals 1820 and 1830. In some embodiments, user 100 may input, modify, or confirm the context tag. As noted above, individuals may be associated with multiple contexts. For example, user 100 may know Stacey Nichols on a personal level and data structure 1860 may include additional interactions with Stacey, that may be tagged with a social context. In some embodiments, the context may not necessarily include a text description to be presented to the user. For example, the context tag may be a random or semi-random alphanumeric identifier, which may be used to group individuals within data structure 1860. Accordingly, the system may not necessarily classify an environment as “work” but may classify similar environments with the same identifier such that individuals may be grouped together.

Data structure 1860 may include any additional information regarding the environment, context, or individuals that may be beneficial for recalling contexts or grouping individuals. For example, data structure 1860 may include one or more columns 1866 including time and/or location information associated with the interaction. Continuing with the previous example, the system may include a date or time of the meeting with Brent Norwood and Stacey Nichols, which may be based on calendar event 1852, a time at which the interaction was detected, a user input, or other sources. Similarly, the data structure may include location information associated with the interaction. For example, this may include GPS coordinates, information identifying an external signal (e.g., a wireless network identifier, etc.), a description of the location (e.g., “meeting room.” “office.” etc.), or various other location identifiers. Data structure 1860 may store other information associated with the interaction, such as a duration of the interaction, a number of individuals included, objects detected in the environment, a transcript or detected words from a conversation, relative locations of one or more individuals to each other and/or the user, or any other information that may be relevant to a user or system.

Data structure 1860 is provided by way of example, and various other data structures or formats may be used. The data contained therein may be stored linearly, horizontally, hierarchically, relationally, non-relationally, uni-dimensionally, multidimensionally, operationally, in an ordered manner, in an unordered manner, in an object-oriented manner, in a centralized manner, in a decentralized manner, in a distributed manner, in a custom manner, or in any manner enabling data access. By way of non-limiting examples, data structures may include an array, an associative array, a linked list, a binary tree, a balanced tree, a heap, a stack, a queue, a set, a hash table, a record, a tagged union, ER model, and a graph. For example, a data structure may include or may be included in an XML database, an RDBMS database, an SQL database or NoSQL alternatives for data storage/search such as, for example, MongoDB™, Redis™, Couchbase™, Datastax Enterprise Graph™, Elastic Search™, Splunk™, Solr™, Cassandra™, Amazon DynamoDB™, Scylla™, HBase™, and Neo4J™. A data structure may be a component of the disclosed system or a remote computing component (e.g., a cloud-based data structure). Data in the data structure may be stored in contiguous or non-contiguous memory. Moreover, a database, as used herein, does not require information to be co-located. It may be distributed across multiple servers, for example, that may be owned or operated by the same or different entities. Thus, the terms “database” or “data structure” as used herein in the singular are inclusive of plural databases or data structures.

The system may be configured to present information from the database to a user of wearable apparatus 110. For example, user 100 may view information regarding individuals, contexts associated with the individuals, other individuals associated with the same contexts, interaction dates, frequencies of interactions, or any other information that may be stored in the database. In some embodiments, the information may be presented to the user through an interface or another component of wearable apparatus 110. For example, wearable apparatus may include a display screen, a speaker, an indicator light, a tactile element (e.g., a vibration component, etc.), or any other component that may be configured to provide information to the user. In some embodiments, the information may be provided through a secondary device, such as computing device 120. The secondary device may include a mobile device, a laptop computer, a desktop computer, a smart speaker, a hearing interface device, an in-home entertainment system, an in-vehicle entertainment system, a wearable device (e.g., a smart watch, etc.), or any other form of computing device that may be configured to present information. The secondary device may be linked to wearable apparatus 110 through a wired or wireless connection for receiving the information.

In some embodiments, user 100 may be able to view and/or navigate the information as needed. For example, user 100 may access the information stored in the database through a graphical user interface of computing device 120. In some embodiments, the system may present relevant information from the database based on a triggering event. For example, if user 100 encounters an individual in a different environment from an environment where user 100 encountered the individual previously, the system may provide to user 100 an indication of the association of the individual with the context classification for the previous environment. For example, if user 100 encounters individual 1830 at a grocery store, the system may identify the individual as Brent Norwood and retrieve information from the database. The system may then present the context of “Work—EPC project” (or other information from data structure 1860) to user 100, which may refresh the user's memory of how user 100 knows Brent or may provide valuable context information to the user.

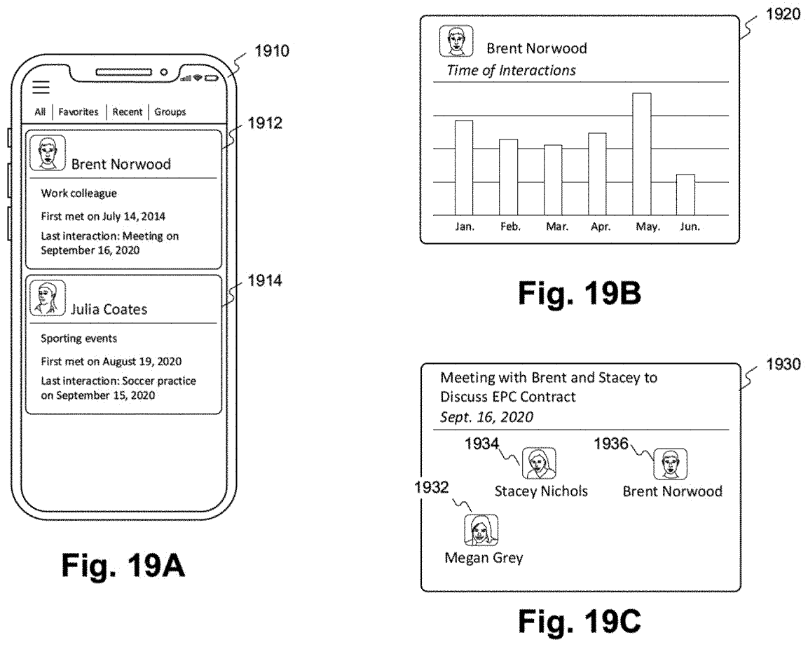

Information indicating an association of the individual with a context may be provided in a variety of different formats. FIGS. 19A. 19B, and 19C illustrate example interfaces for displaying information to a user, consistent with the disclosed embodiments. As discussed above, the display may be presented on a secondary device, such as computing device 120. FIG. 19A illustrates an example secondary device 1910 that may be configured to display information to the user. While a mobile phone is shown by way of example, secondary device 1910 may include other devices, such as a laptop computer, desktop computer, or other computing devices, as described above. In the example interface shown in FIG. 19A, secondary device 1910 may display one or more individuals from data structure 1860, as well as information about the individuals and/or associated contexts. In some embodiments, secondary device 1910 may display one or more display elements or “cards” 1912 and 1914 including information about the individual. For example, card 1912 may include context information for Brent Norwood, indicating he is a work colleague. This may include other forms of contextual information, such as an indication that Brent and user 100 work on the EPC project together. As shown in FIG. 19A, this may include other information regarding interactions with the individual, such as a time or location of a first interaction, a time or location of a most recent interaction, information about the interactions, or any other information that may be stored in data structure 1860, as described above. While contact cards are shown by way of example, various other display formats may be used, such as lists, charts, tables, graphs, or the like. In some embodiments, text messages or text alerts may be displayed on secondary device 1910 to convey any of the context information.

In some embodiments, card 1912 and 1914 may be displayed based on a triggering event. For example, if user 100 encounters an individual, Julia Coates, at a social gathering, secondary device 1910 may display card 1914, which may indicate that user 100 knows Julia in a sporting events context (e.g., having kids on the same soccer team, etc.). The system may display other individuals associated with the same context, other contexts associated with the individual, and/or any other information associated with Julia or these contexts. Other example trigger events may include, visiting a previous location where the user 100 has encountered Julia, an upcoming calendar event that Julia is associated with, or the like. While visual displays are shown by way of example, various other forms of presenting an association may be used. For example, wearable apparatus 110 or secondary device 1910 may present an audible indication of the association. For example, context information from cards 1912 and 1914 may be read to user 100. In some embodiments, a chime or other tone may indicate the context. For example, the system may use one chime for work contacts and another chime for personal contacts. As another example, a chime may simply indicate that an individual is recognized. In some embodiments, the indication of the association may be presented through haptic feedback. For example, the wearable apparatus may vibrate to indicate the individual is recognized. In some embodiments, the haptic feedback may indicate the context through a code or other pattern. For example, wearable apparatus 110 may vibrate twice for work contacts and three times for social contacts. The system may enable user 100 to customize any aspects of the visual, audible, or haptic indications.

According to some embodiments, the system may allow user 100 to navigate through the information stored in the database. For example, user 100 may filter individuals by context, allowing the user to view all “work” contacts, all individuals in a book club of the user, or various other filters. The system may also present individuals in a particular order. For example, the individuals may be presented in the order of most recent interactions, most frequent interactions, total duration spent together, or other information. In some embodiments, the system may determine a relevance ranking based on the current environment of the user, which may indicate a level of confidence that the user is associated with the current environment. The individuals may be displayed in order of the relevance ranking. In some embodiments, the relevance ranking (or confidence level) may be displayed to the user, for example, in card 1912. One skilled in the art would recognize many other types of filtering or sorting may be used, which may depend on the particular implementation of the disclosed embodiments.

Consistent with the disclosed embodiments, the information from data structure 1860 may be aggregated, summarized, analyzed, or otherwise arranged to be displayed to user 100. FIG. 19B illustrates an example graph 1920 that may be presented to user 100, consistent with the disclosed embodiments. Graph 1920 may be a bar graph indicating an amount of interaction with individual 1830 over time. For example, this may include a total duration of interactions, a number of interactions, an average interaction time, or any other information that may be useful to a user. While graph 1920 is represented as a bar graph, various other representations may be used to represent time of interactions, such as a time-series graph, a histogram, a pie chart, etc. While the data in graph 1920 pertains to a single individual, the data may similarly be grouped by context, or other categories. In some embodiments, a graph may indicate a time of interaction for a group of individuals within a certain time period. For example, instead of each month having its own column, each individual may be represented as a column in the graph. Graph 1920 is provided by way of example, and many other types of data or graphical representations of the data may be used. For example, the system may display data as a bar chart, a pie chart (e.g., showing a relative time spent with each individual), a histogram, a Venn diagram (e.g., indicating which contexts individuals belong in), a gauge (e.g., indicating a relative frequency of interactions with an individual), a heat map (e.g., indicating geographical locations where an individual is encountered), a color intensity indicator (e.g., indicating a relative frequency or time of interactions), or any other representation of data. One skilled in the art would recognize that the possible combinations of data types and representation formats are nearly limitless and may depend on the application. The present disclosure is not limited to any particular type of data or representation format.

In some embodiments, various diagrams may be generated based on a particular interaction with one or more individuals. FIG. 19C illustrates an example diagram 1930 that may be displayed, consistent with the disclosed embodiments. Diagram 1930 may display representations of individuals in the same order or relative position at the time when an image was captured. For example, diagram 1930 be associated with image 1800 and may display icons 1932, 1934, and 1936, which may indicate relative positions of individuals 1810, 1820, and 1830, respectively. Presenting information spatially in this manner may help user 100 recall aspects of the meeting, such as who was included in the meeting, what was discussed, which individuals said what during the meeting, or other information.

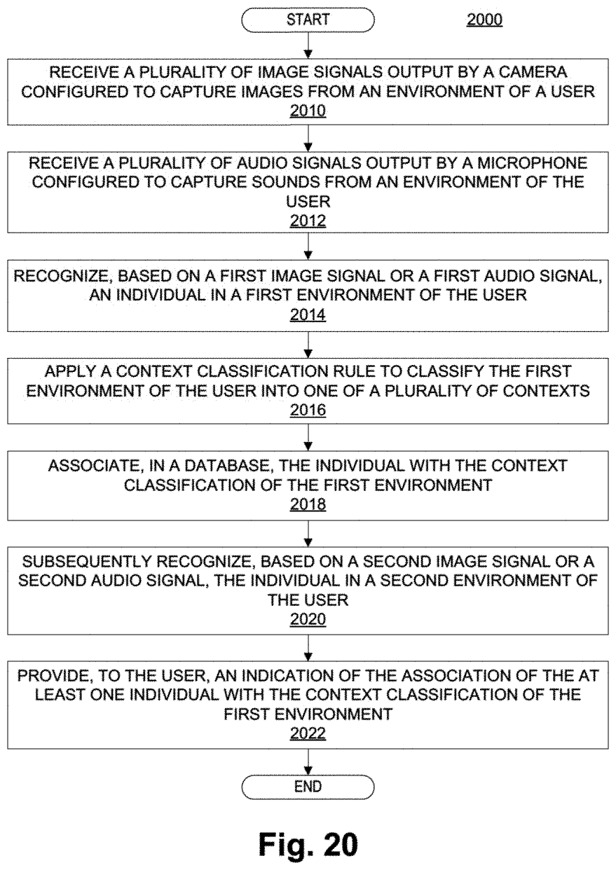

FIG. 20 is a flowchart showing an example process 2000 for associating individuals with a particular context, consistent with the disclosed embodiments. Process 2000 may be performed by at least one processing device of a wearable apparatus, such as processor 210, as described above. In some embodiments, some or all of process 200) may be performed by a different device, such as computing device 120. It is to be understood that throughout the present disclosure, the term “processor” is used as a shorthand for “at least one processor.” In other words, a processor may include one or more structures that perform logic operations whether such structures are collocated, connected, or disbursed. In some embodiments, a non-transitory computer readable medium may contain instructions that when executed by a processor cause the processor to perform process 2000. Further, process 2000 is not necessarily limited to the steps shown in FIG. 20, and any steps or processes of the various embodiments described throughout the present disclosure may also be included in process 2000, including those described above with respect to FIG. 18A, 18B, 18C, 19A, 19B, or 19C.

In step 2010, process 2000 may include receiving a plurality of image signals output by a camera configured to capture images from an environment of a user. The image signals may include one or more images captured by the camera. For example, step 2010 may include receiving an image signal including image 1800 captured by image sensor 220. In some embodiments, the plurality of image signals may include a first image signal and a second image signal. The first and second image signals may be part of a contiguous image signal stream but may be captured at different times or may be separate image signals. Although process 2000 includes receiving both image signals in step 2010, it is to be understood that the second image signal may be received after the first image signal and may be received after subsequent steps of process 2000. In some embodiments, the camera may be a video camera and the image signals may be video signals.

In step 2012, process 2000 may include receiving a plurality of audio signals output by a microphone configured to capture sounds from an environment of the user. For example, step 2012 may include receiving a plurality of audio signals from microphones 443 and/or 444. In some embodiments, the plurality of audio signals may include a first audio signal and a second audio signal. The first and second audio signals may be part of a contiguous audio signal stream but may be captured at different times or may be separate audio signals. Although process 2000 includes receiving both audio signals in step 2012, it is to be understood that the second audio signal may be received after the first audio signal and may be received after subsequent steps of process 2000. In some embodiments, the camera and the microphone may each be configured to be worn by the user. The camera and microphone can be separate devices, or may be included in the same device, such as wearable apparatus 110. Accordingly, the camera and the microphone may be included in a common housing. In some embodiments, the processor performing some or all of process 2000 may be included in the common housing. The common housing may be configured to be worn by user 100, as described throughout the present disclosure.

In step 2014, process 2000 may include recognizing at least one individual in a first environment of the user. For example, step 2014 may include recognizing one or more of individuals 1810, 1820, or 1830. In some embodiments, the individual may be recognized based on at least one of the first image signal or the first audio signal. For example, recognizing the at least one individual may comprise analyzing at least the first image signal to identify at least one of a face of the at least one individual, or a posture or gesture associated with the at least one individual, as described above. Alternatively or additionally, recognizing the at least one individual may comprise analyzing at least the first audio signal in order to identify a voice of the at least one individual. Various other examples of identifying information that may be used are described above.

In step 2016, process 2000 may include applying a context classifier to classify the first environment of the user into one of a plurality of contexts. The contexts may be any number of descriptors or identifiers of types of environments, as described above. In some embodiments, the plurality of contexts may be a prestored list of contexts. The context classifier may include any range of contexts, which may have any range of specificity, as described above. For example, the contexts may include at least a “work” context and a “social” context, such that a user may distinguish between professional and social contacts. The contexts may include other classifications, such as “family members.” “medical visits,” “book club,” “fitness activities,” or any other information that may indicate a context in which the user interacts with the individual. Various other example contexts are described above. In some embodiments, the contexts may be generated as part of process 2000 as new environment types are detected. A user, such as user 100 may provide input as to how environments should be classified. For example, this may include adding new context, adding a description of a new context identified by the processor, or confirming, modifying, changing, rejecting, rating, combining, or otherwise providing input regarding existing context classifications.

In some embodiments, the environment may be classified based on additional information. For example, this may include information provided by at least one of the first image signal, the first audio signal, an external signal, or a calendar entry, as described in greater detail above. The external signal may include one of a location signal or a Wi-Fi signal or other signal that may be associated with a particular context. In some embodiments, the context classifier may be based on a machine learning algorithm. For example, the context classifier may be based on a machine learning model trained on one or more training examples, or a neural network, as described above.

In step 2018, process 2000 may include associating, in at least one database, the at least one individual with the context classification of the first environment. This may include linking the individual with the context classification in a data structure, such as data structure 1860 described above. The database or data structure may be stored in one or more storage locations, which may be local to wearable apparatus 110, or may be external. For example, the database may be included in a remote server, a cloud storage platform, an external device (such as computing device 120), or any other storage location.

In step 2020, process 2000 may include subsequently recognizing the at least one individual in a second environment of the user. For example, the individual may be recognized based on at least one of the second image signal or the second audio signal in a second location in the same manner as described above.

In step 2022, process 2000 may include providing, to the user, at least one of an audible, visible, or tactile indication of the association of the at least one individual with the context classification of the first environment. For example, providing the indication of the association may include providing a haptic indication, a chime, a visual indicator (e.g., a notification, a LED light, etc.), or other indications as to whether the individual is known to the user. In some embodiments, the indication may be provided through an interface device of wearable apparatus 110. Alternatively, or additionally, the indication may be provided via a secondary computing device. For example, the secondary computing device may be at least one of a mobile device, a laptop computer, a desktop computer, a smart speaker, an in-home entertainment system, or an in-vehicle entertainment system, as described above. Accordingly, step 2022 may include transmitting information to the secondary device. For example, the secondary computing device may be configured to be wirelessly linked to the camera and the microphone. In some embodiments, the camera and the microphone are provided in a common housing, as noted above.

The indication of the association may be presented in a wide variety of formats and may include various types of information. For example, providing the indication of the association may include providing at least one of a start entry of the association, a last entry of the association, a frequency of the association, a time-series graph of the association, a context classification of the association, or any other types of information as described above. Further, providing the indication of the association may include displaying, on a display, at least one of a bar chart, a pie chart, a histogram, a Venn diagram, a gauge, a heat map, a color intensity indicator; or a diagram including second images of a plurality of individuals including the at least one individual, the second images displayed in a same order as the individuals were positioned at a time when the images were captured. For example, step 2022 may include displaying one or more of the displays illustrated in FIG. 19A, 19B, or 19C. The display may be included on wearable apparatus 110, or may be provided on a secondary device, as described above.

Retroactive Identification of Individuals

As described throughout the present disclosure, a wearable camera apparatus may be configured to recognize individuals in the environment of a user. In some embodiments, the system may capture images of unknown individuals and maintain one or more records associated with the unknown individuals. Once the identities of the individuals are determined (for example, based on additional information acquired by the system), the prior records may be updated to reflect the identity of the individuals. The system may determine the identities of the individuals in various ways. For example, the later acquired information may be obtained through user assistance, through automatic identification, or through other suitable means.

As an illustrative example, a particular unidentified individual encountered by a user in three meetings spanning over six months may later be identified based on supplemental information. After being identified, the system may update records associated with the prior three meetings to add a name or other identifying information for the individual. In some embodiments, the system may store other information associated with the unknown individuals, for example by tagging interactions of individuals with other individuals involved in the interaction, tagging interactions with location information, tagging individuals as being associated with other individuals, or any other information that may be beneficial for later retrieval or analysis. Accordingly, the disclosed systems may enable a user to select an individual, and determine who that individual is typically with, or where they are typically together.

In some embodiments, the disclosed system may include a facial recognition system, as described throughout the present disclosure. When encountering an unrecognized individual, the system may access additional information that may indicate an identity of the unrecognized individual. For example, the system may access a calendar of the user to retrieve a name of an individual who appears on the calendar at the time of the encounter, recognize the name from a captured name tag, or the like. An image representing a face of the unrecognized individual may subsequently be displayed together with a suggested name determined from the retrieved data. This may include associating a name with facial metadata and voice metadata; and retrieving a topic of meeting from calendar and associating it with the unrecognized individual.

Consistent with the disclosed embodiments, the system may be configured to disambiguate records associated with one or more individuals based on later acquired information. For example, the system may associate two distinct individuals with the same record based on a similar appearance, a similar voice or speech pattern, or other similar characteristics. The system may receive additional information indicating the individuals are in fact two distinct individuals, such as an image of the two individuals together. Accordingly, the system may generate a second record to maintain separate records for each individual.

As discussed above, the system may maintain one or more records associated with individuals encountered by a user. This may include storing information in a data structure, such as data structure 1860 as shown in FIG. 18C and described in greater detail above. In some embodiments, the system may generate and/or maintain records associated with unrecognized individuals. For example, a user may encounter an individual having physical or vocal features that do not match characteristic features for individuals stored in the data structure. Accordingly, the system may generate a new record associated with the unrecognized individual. Future encounters with the unrecognized individual may be associated with the same record. For example, the system may determine that an unrecognized individual later encountered by the user is the same individual that was previously unidentified and thus the system may store information regarding with the later encounter in a manner associating it with the previously unidentified individual. Accordingly, as used herein, an unrecognized individual may refer to an individual for which a name or other identifying information is unknown. Although the individual is considered to be “unrecognized” for the purposes of the current disclosure, the system may nonetheless “recognize” the individuals in the sense that the system determines that later encounters with the unrecognized individual are to be associated with the same record entry. That is, although an unrecognized individual may refer to an individual for which identity information is missing, the system may determine the unrecognized individual has been previously encountered by the user.

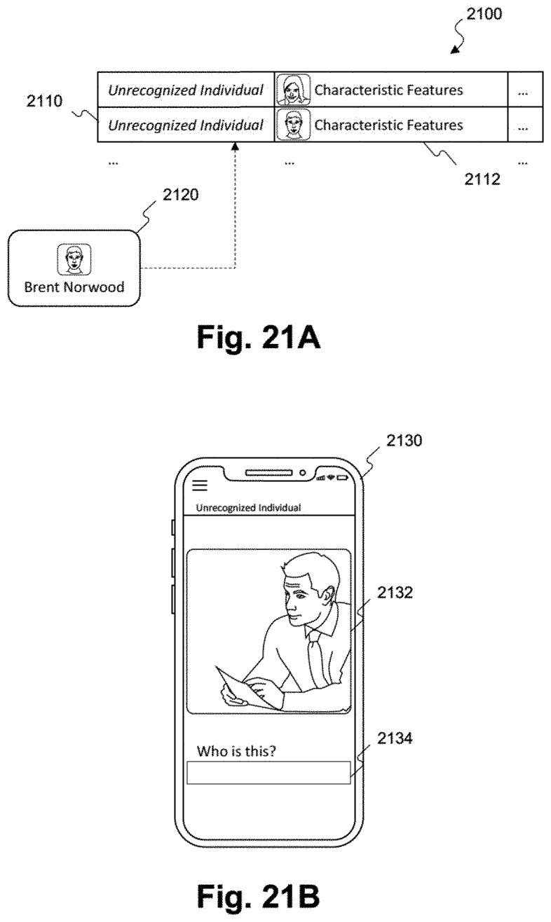

FIG. 21A illustrates an example data structure 2100 that may store information associated with unrecognized individuals, consistent with the disclosed embodiments. Data structure 2100 may take any of a variety of different forms, as discussed above with respect to data structure 1860. For example, data structure 2100 may include an array, an associative array, a linked list, a binary tree, a balanced tree, a heap, a stack, a queue, a set, a hash table, a record, a tagged union, ER model, graph, or various other formats for associating one or mom pieces of data. As shown in FIG. 21A, data structure 2100 may include records associated with unrecognized individuals, such as record 2110. According to some embodiments, data structure 2100 may be a separate data structure associated with unrecognized individuals. Alternatively, or additionally, data structure 2100 may be integrated with one or more other data structures, such as data structure 1860. For example, record 2110 may be included in the same data structure as recognized individuals. Record 2100 may include one or more blank fields for identifying information associated with the individual that is unknown. In some embodiments, the fields may include a placeholder, such as “unknown” or “unrecognized individual” that may indicate the individual is unrecognized. In some embodiments, record 2110 may include a unique identifier such that record 2110 may be distinguished from other records for recognized or unrecognized individuals. For example, the identifier may be a random or semi-random number generated by the system. In some embodiments, the identifier may be generated based on information associated with an encounter, such as a time, date, location, or other information. As another example, the identifier may be based on characteristic features of the individual, such as facial structure data, voice characteristic data, or other identifying information. The identifier may be stored in place of a name of the unrecognized individual until a name is determined, or may be a separate field.

As shown in FIG. 21A, data structure 2100 may include characteristic features associated with unrecognized individuals. For example, record 2110 may store characteristic features 2112, as shown. As used herein. “characteristic features” refers to any characteristics of an individual that may be detected using one or more inputs of the system. As one example, the characteristic feature may include facial features of an individual determined based on analysis of images captured by wearable apparatus 110. Accordingly, the system may identify facial features on the face of the individual, such as the eyes, nose, cheekbones, jaw, a relationship between two or more facial features (such as distance between the eyes, etc.), or other features. The system may use one or more algorithms for analyzing the detected features, such as principal component analysis (e.g., using Eigenfaces), linear discriminant analysis, elastic bunch graph matching (e.g., using Fisherface), Local Binary Patterns Histograms (LBPH), Scale Invariant Feature Transform (SIFT). Speed Up Robust Features (SURF), or the like. In some embodiments, the characteristic features may include other physical characteristics or traits. For example, the system may detect a body shape, posture of the individual, particular gestures or mannerisms (e.g., movement of hands, facial movements, gait, typing or writing patterns, eye movements, or other bodily movements), or biometric traits that may be analyzed and stored in data structure 2100. Various other example features that may be detected include skin tone, body shape, retinal patterns, distinguishing marks (e.g., moles, birth marks, freckles, scars, etc.), hand geometry, finger geometry, or any other distinguishing visual or physical characteristics. Accordingly, the system may analyze one or more images to detect these characteristic features.

In some embodiments, the characteristic features may be based on audio signals captured by wearable apparatus 110. For example, microphones 443 and/or 444 may detect voices or other sounds emanating from the individuals, which may be used to identify the individuals. This may include using one or more voice recognition algorithms, such as Hidden Markov Models, Dynamic Time Warping, neural networks, or other techniques, to recognize the voice of the individual. The individual may be recognized based on any form of acoustic characteristics that may indicate an identity of the individual, such as an accent, tone, vocabulary, vocal category, speech rate, pauses, filler words, or the like.

Characteristic features 2112 may be used to maintain record 2110 associated with an unrecognized individual. For example, when the unrecognized individual is encountered again by a user of wearable apparatus 110 the system may receive image and/or audio signals and detect characteristic features of the unrecognized individual. These detected characteristic features may be compared with stored characteristic features 2112. Based on a match between the detected and stored characteristic features, the system may determine that the unrecognized individual currently encountered by the user is the same unrecognized individual associated with record 2110. The system may store additional information in record 2110, such as a time or date of the encounter, a location of the encounter, a duration of the encounter, a context of the encounter, other people present during the encounter, additional detected characteristic features, or any other form of information that may be gleaned from the encounter with the unrecognized individual. Thus, data structure 2100 may include a cumulative record of encounters with the same unrecognized individual.

In some embodiments, the system may be configured to update information in data structure 2100 based on identities of previously unidentified individuals that are determined in later encounters. For example, the system may receive supplemental information 2120 including an identity of the unrecognized individual associated with record 2110. For example, this may include a name of the unrecognized individual (e.g., “Brent Norwood”), or other identifying information. In some embodiments, the identity may include a relationship to the user of wearable apparatus 110, such as an indication that the unrecognized individual is the user's manager, friend, or other relationship information.

As used herein, supplemental information may include any additional information received or determined by the system from which an identity of a previously unidentified individual may be ascertained. Supplemental information 2120 may be acquired in a variety of different ways. In some embodiments, supplemental information 2120 may include an input from a user. This may include prompting a user for a name of the unrecognized individual. Accordingly, the user may input a name or other identifying information of the individual through a user interface. For example, the user interface may be a graphical user interface of wearable apparatus 110 or another device, such as computing device 120. FIG. 21B illustrates an example user interface of a mobile device 2130 that may be used to receive an input indicating an identity of an individual, consistent with the disclosed embodiments. Mobile device 2130 may be a phone or other device associated with user 100. In some embodiments, mobile device 2130 may correspond to computing device 120. Mobile device 1230 may include an input component 2134 through which a user may input identifying information. In some embodiments, input component 2134 may include a text input field, in which a user may type a name of the individual, as shown. In other embodiments, the user may select an identity of the individual using radio buttons, checkboxes, a dropdown list, touch interface, or any other suitable user interface feature. Mobile device 1230 may also display one or more images, such as image 2132, to prompt the user to identify an unrecognized individual represented in the images. Image 2132 may be an image captured by wearable apparatus 110 and may be used to extract characteristic features of the unrecognized individual as described above.

Consistent with the disclosed embodiments, the user input may be received in various other ways. For example, the user input may include an audio input of the user. The system may prompt the user for an input through an audible signal (e.g., a tone, chime, a vocal prompt, etc.), a tactile signal (e.g., a vibration, etc.), a visual display, or other forms of prompts. Based on the prompt the user may speak the name of the individual, which may be captured using a microphone, such as microphones 443 or 444. The system may use one or more speech recognition algorithms to convert the audible input to text. In some embodiments, the user input may be received without prompting the user, for example by the user saying a cue or command comprising one or more words. For example, the user may decide an individual he or she is currently encountering should be identified by the system and may say “this is Brent Norwood” or otherwise provide an indication of the user's identity. The user may also enter the input through a user interface as described above.

Consistent with the disclosed embodiments, supplemental information 2120 may include various other identifying information for an individual. In some embodiments, the supplemental information may include a name of the individual detected during an encounter. For example, the user or another individual in the environment of the user may mention the name of the unrecognized individual. Accordingly, the system may be configured to analyze one or more audio signals received from a microphone to detect a name of the unrecognized individual. Alternatively, or additionally, the system may detect a name of the unrecognized individual in one or more images. For example, the unrecognized individual may be wearing a nametag or may be giving a presentation including a slide with his or her name. As another example, the user may view an ID card, a business card, a resume, a webpage, or another document including a photo of the unrecognized individual along with and his or her name, which the system may determine are associated with each other. Accordingly, the system may include one or more optical character recognition (OCR) algorithms for extracting text from images.

Various other forms of information may be accessed for the purpose of identifying an individual. In some embodiments, the supplemental information may include calendar information associated with user 100. For example, the disclosed systems may access an account or device associated with user 100 that may include one or more calendar entries. For example, the system may access calendar entry 1852 as shown in FIG. 18B and described above. The system may associate an unrecognized individual with the calendar entries based on a time in which the user encounters the unrecognized individual. The calendar entries may include metadata or other information that may indicate an identity of the unrecognized individual. For example, the calendar entry may include names of one or more participants of the meeting. The participant names may be included in a title of the calendar entry (e.g., “Yoga with Marissa,” “Financial Meeting with Mr. Davison from Yorkshire Capital,” etc.), a description of the event, an invitee field, a meeting organizer field, or the like. In some embodiments, the system may use a process of elimination to identify the unrecognized individual by excluding any names from the calendar entry that are already associated with known individuals. Where multiple possible candidates for names of the unrecognized individual, the system may store the possible names in data structure 2100 for resolving in the future (e.g., further narrowing of name candidates, etc.).

In some embodiments, the system may prompt user 100 to confirm an identity of the unrecognized individual. For example, the system may present a name predicted to be associated with the unrecognized individual along with an image of the unrecognized individual and may prompt the user to confirm whether the association is correct. In embodiments where the system identifies multiple potential name candidates for an unknown individual, the system may display multiple names and may prompt the user to select the correct name. The system may prompt the user through a graphical user interface on device 1230, similar to the graphical user interface shown in FIG. 21B. Alternatively, or additionally, the system may provide an audible prompt to the user, for example, asking the user “Is this individual Brent Norwood?,” or similar prompts. Accordingly, the system may receive spoken feedback from the user, such as a “Yes” spoken by user 100 and captured by microphones 443 or 444. Various other methods for receiving input may be used, such as the user nodding his or her head, the user pressing a button on wearable device 110 and/or computing device 120, or the like.

Based on the received supplemental information, the system may update one or more records associated with the previously unidentified individual to include the determined identity. For example, referring to FIG. 21A, the system may update record 2110 based on supplemental information 2120. In some embodiments, record 2110 may be identified based on characteristic features detected during an encounter with the individual being identified. As an illustrative example, the user may be in a meeting with Brent Norwood, who is previously unrecognized by the system. Based on supplemental information 2120, the system may determine the identity of Brent Norwood. For example, the system may access a calendar event associated with the meeting to determine the name of the individual user 100 is currently meeting with is named Brent Norwood. The system may then compare characteristic features of the individual with stored characteristic features in data structure 2100 and update any matching records with the newly determined identity. For example, the system may determine that characteristic features 2112 stored in data structure 2100 match characteristic features for the individual that are detected during the encounter. Accordingly, record 2110 may be updated to reflect the identity of the individual indicated by supplemental information 2120. In some embodiments, a match may not refer to a 100%, correlation between characteristic features. For example, the system may determine a match based on a comparison of the difference in characteristic features to a threshold. Therefore, if the characteristic features match by more than a threshold degree of similarity, a match may be determined. Various other means for defining a match may be used.

According to some embodiments, the system may determine whether the detected unrecognized individual corresponds to any previously unidentified individuals represented in data structure 2100 using machine learning. For example, a machine learning algorithm may be used to train a machine learning model (such as an artificial neural network, a deep learning model, a convolutional neural network, etc.) to determine matches between two or more sets characteristic features using training examples. The training examples may include sets of characteristic features that are known to be associated with the same individual. Accordingly, the trained machine learning model may be used to determine whether or not other sets of multiple characteristic features are associated with the same individual. Some non-limiting examples of such neural networks may include shallow artificial neural networks, deep artificial neural networks, feedback artificial neural networks, feed forward artificial neural networks, autoencoder artificial neural networks, probabilistic artificial neural networks, time delay artificial neural networks, convolutional artificial neural networks, recurrent artificial neural networks, long short term memory artificial neural networks, and so forth. In some embodiments, the disclosed embodiments may further include updating the trained neural network model based on feedback regarding correct matches. For example, user may confirm that two images include representations of the same individual, and this confirmation may be provided as feedback to the trained model.

In some embodiments, the system may determine a confidence level indicating a degree of certainty to which a previously unrecognized individual matches a determined identity. In some embodiments, this may be based on the form of supplemental information used. For example, an individual identified based on a calendar entry may be associated with a lower confidence score than an individual identified based on a user input. Alternatively, or additionally, the confidence level may be based on a degree of match between characteristic features, or other factors. The confidence level may be stored in data structure 2110 along with the determined identity of the individual, or may be stored in a separate location. If the system later determines a subsequent identification of the individual, the system may supplant the previous identification of the individual based on the identification having the higher confidence level. In some embodiments, the system may prompt the user to determine which identification is correct or may store both potential identifications for future confirmation, either by the user or through additional supplemental information.

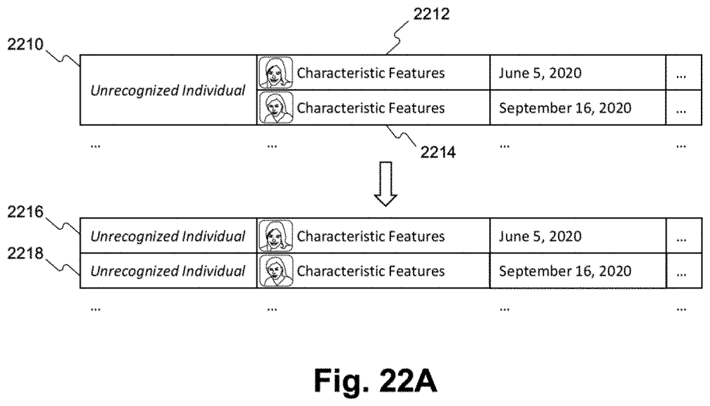

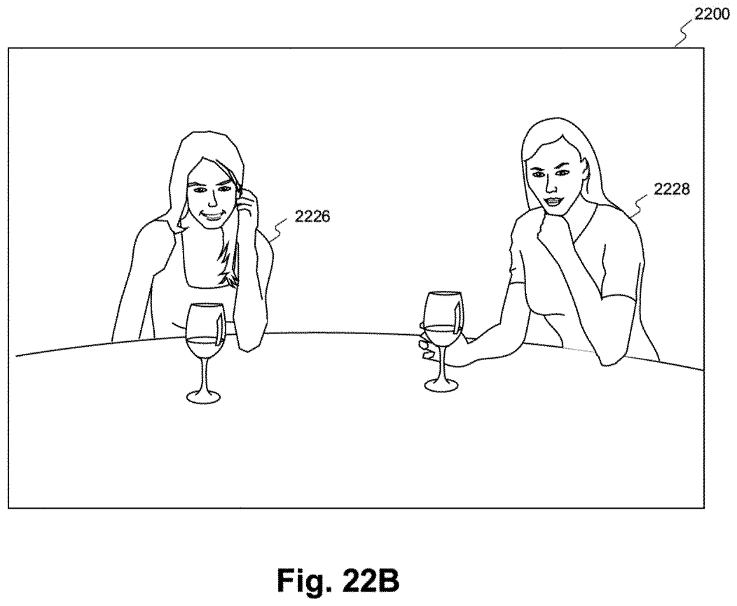

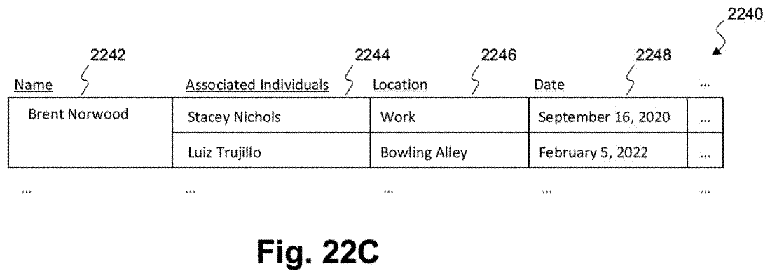

According to some embodiments of the present disclosure, the system may be configured to disambiguate entries for unrecognized individuals based on supplemental information. FIG. 22A illustrates an example record 2210 that may be disambiguated based on supplemental information, consistent with the disclosed embodiments. For example, user 100 may encounter a first unrecognized individual and may generate a record 2210 within data structure 2100 including information about the unrecognized individual, such as characteristic features 2212, as described above. In a later encounter with a second unrecognized individual, the system may mistakenly associate the second unrecognized individual with the record for the first unrecognized individual. For example, the first and second unrecognized individuals may have a similar appearance or vocal characteristics such that the characteristic features detected by the system indicate a false match. Accordingly, information regarding the second encounter may be stored in a manner associating it with the first unrecognized individual. For example, the system may store characteristic features 2214 and other information, such as a date or location of the second encounter, within record 2210. The system may then receive supplemental information indicating that the first and second individuals are separate individuals. Accordingly, the system may separate record 2210 into separate records 2216 and 2218.

The supplemental information may include any information indicating separate identities of the unrecognized individuals. In some embodiments, the supplemental information may be an image including both of the unrecognized individuals, thereby indicating they cannot be the same individual. FIG. 22B illustrates an example image 2200 showing two unrecognized individuals, consistent with the disclosed embodiments. Image 2200 may be captured by image sensor 220, as described above. In the example shown in image 2200, user 100 may be in an environment with unrecognized individuals 2226 and 2236. Individuals 2226 and 2236 may have each been previously encountered by user 100 separately and may have been associated with the same record in data structure 2100. Based on image 2200, the system may determine that individuals 2226 and 2236 are in fact two separate individuals and may separate the record entries, as shown in FIG. 22A. In some embodiments, the record may be separated, in part, based on the image. For example, the system may determine characteristic features for each of individuals 2226 and 2236 based on image 2200 and may populate record entries 2216 and 2218 based on stored characteristic features that more closely resemble characteristic features of individuals 2226 and 2228, respectively. As described above, the characteristic features may also include vocal features of individuals. Accordingly, the supplemental information may equally include audio signals including individuals 2226 and 2228, which may indicate separate individuals.

Various other forms of supplemental information may be used consistent with the disclosed embodiments. In some embodiments, the supplemental information may include an input from a user. For example, the user may notice that individuals 2226 and 2228 are associated with the same record and may provide an input indicating they are different. As another example, the system may prompt the user to confirm whether individuals 2226 and 2228 are the same (e.g., by showing side-by-side images of individuals 2226 and 2228). Based on the user's input, the system may determine the individuals are different. In some embodiments, the supplemental information may include subsequent individual encounters with one or both of individuals 2226 and 2228. The system may detect minute differences between the characteristic features and may determine that the previous association between the characteristic features is invalid or insignificant. For example, in subsequent encounters, the system may acquire more robust characteristic feature data that more clearly shows a distinction between the two individuals. This may be due to a clearer image, a closer image, an image with better lighting, an image with higher resolution, an image with a less obstructed view of the individual, or the like. Various other forms of supplemental information may also be used.

Consistent with the disclosed embodiments, the system may be configured to associate two or more identified individuals with each other. For example, the system may receive one or more images and detect a first individual and a second individual in the images. The system may then identify the individuals and access a data structure to store an indicator of the association between the individuals. This information may be useful in a variety of ways. In some embodiments, the system may provide suggestions to a user based on the stored associations. For example, when the user creates a calendar event with one individual, the system may suggest other individuals to include based on other individuals commonly encountered with the first individual. In some embodiments, the associations may assist with later identification of the individuals. For example, if the system is having trouble identifying a first individual but recognizes a second individual, the system may determine the first individual has a greater likelihood of being an individual commonly associated with the second individual. One skilled in the art would recognize various additional scenarios where associations between one or more individuals may be beneficial.

FIG. 22C illustrates an example data structure 2240 storing associations between one or more individuals, consistent with the disclosed embodiments. As with data structure 2100, data structure 2240 may include an array, an associative array, a linked list, a binary tree, a balanced tree, a heap, a stack, a queue, a set, a hash table, a record, a tagged union. ER model, graph, a database, or various other formats for associating one or more pieces of data. In some embodiments, data structure 2240 may be integrated or combined with data structure 2100 and/or 1860. Alternatively, or additionally, data structure 2240 may be separate. As shown in FIG. 22C, data structure 2240 may include the name of an identified individual 2242. Data structure 2240 may also include information associating an identity of a second individual 2244 with the first identified individual 2242. The system may store various other indicators, such as an indication of a location 2246 where individuals 2242 and 2244 were together, a date or time 2248 at which individuals 2242 and 2244 were together, additional individuals present, a context of the encounter (e.g., as described above with respect to FIG. 18C), or the like.

Various criteria for determining an association between the individuals may be used. In some embodiments, the association may be determined based on individuals appearing within the same image frame. For example, the system may receive image 2200 as shown in FIG. 22B and may determine an association between individuals 2226 and 2228. Accordingly, individuals 2226 and 2228 may be linked in data structure 2240. In some embodiments, individuals appearing in images captured within a predetermined time period may be associated with each other. For example, a first individual and second individual appearing in image frames captured within one hour (or one minute, one second, etc.) of each other may be linked. Similarly, individuals represented in images within a predetermined number of image frames (e.g., 10, 100, 1,000, etc.) may be linked in data structure 2240. In some embodiments, the association may be based on a geographic location associated with wearable apparatus 110. For example, any individuals included in images captured while the user is in a particular location may be linked together.

The system may then access data structure 2240 to determine associations between two or more individuals. In some embodiments, this may allow a user to search for individuals based on the associations. For example, user 100 may input a search query for a first individual. The system may access data structure 2240 to retrieve information about the first individual, which may include the identity of a second individual, and may provide the retrieved information to the user. In some embodiments, the information may be retrieved based on an encounter with the first individual. For example, when a user encounters the first individual, the system may provide information to the user indicating the first individual is associated with the second individual. Similarly, the information in data structure 2240 may be used for identifying individuals. For example, if the first individual and second individual are encountered together at a later date, the system may identify the second individual at least in part based on the identity of the first individual and the association between the first and second individuals stored in data structure 2240.

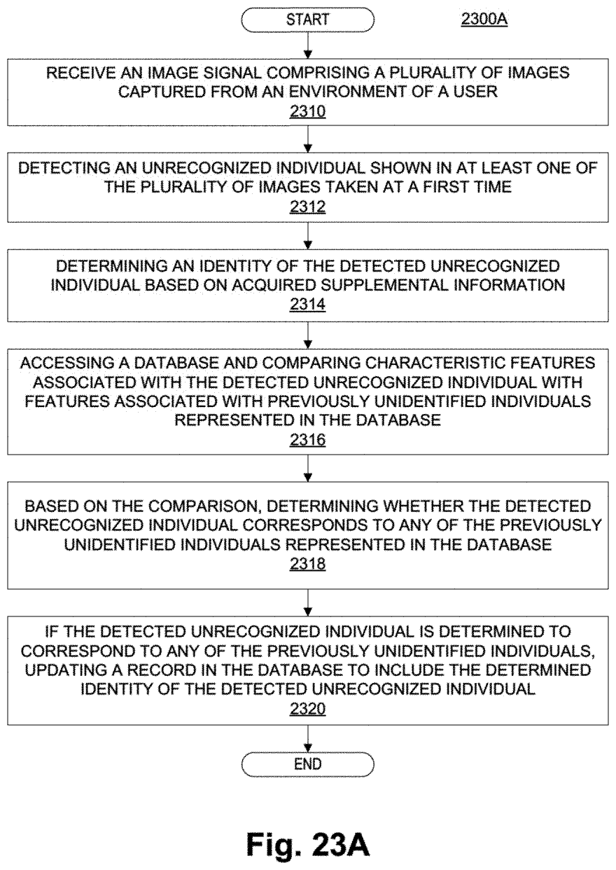

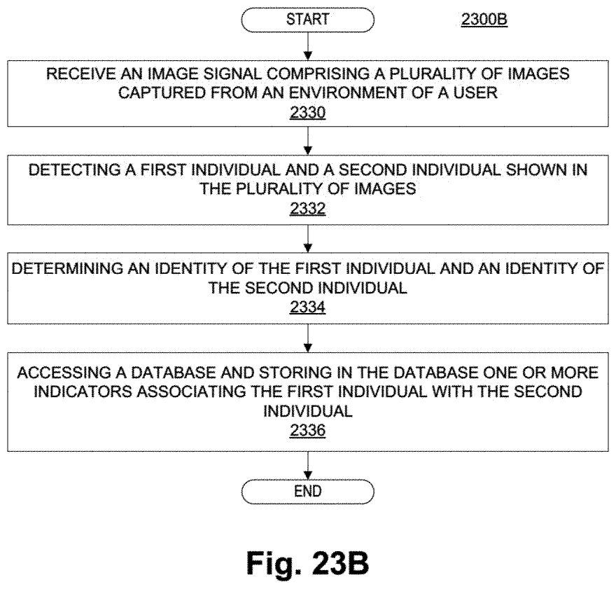

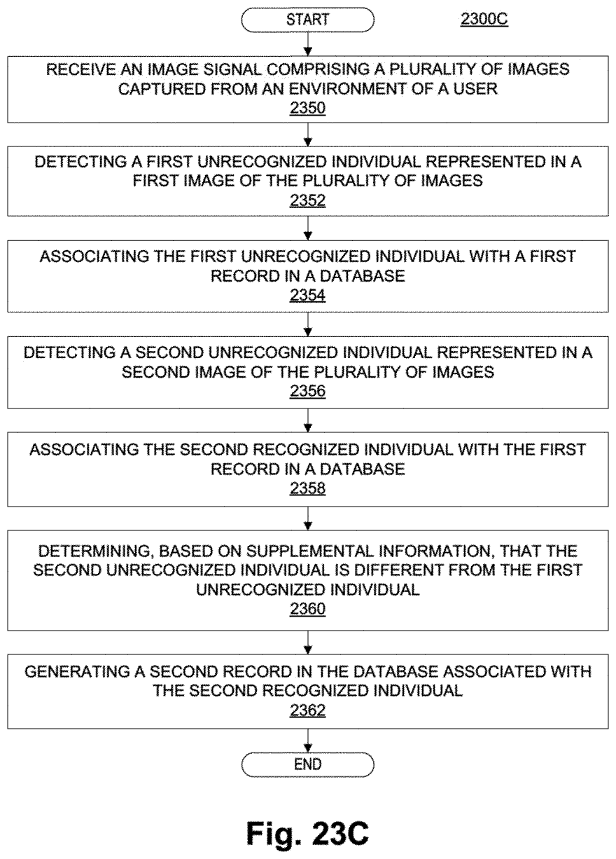

FIG. 23A is a flowchart showing an example process 2300A for retroactive identification of individuals, consistent with the disclosed embodiments. Process 2300A may be performed by at least one processing device of a wearable apparatus, such as processor 220, as described above. In some embodiments, some or all of process 2300A may be performed by a different device, such as computing device 120. In some embodiments, a non-transitory computer readable medium may contain instructions that when executed by a processor cause the processor to perform process 2300A. Further, process 2300A is not necessarily limited to the steps shown in FIG. 23A, and any steps or processes of the various embodiments described throughout the present disclosure may also be included in process 2300A, including those described above with respect to FIGS. 21A, 21B, 22A, 22B, and 22C.

In step 2310, process 2300A may include receiving an image signal output by a camera configured to capture images from an environment of a user. The image signal may include a plurality of images captured by the camera. For example, step 2310 may include receiving an image signal including images captured by image sensor 220. In some embodiments, the camera may be a video camera and the image signal may be a video signal.

In some embodiments, process 2300A may include receiving an audio signal output by a microphone configured to capture sounds from an environment of the user. For example, process 2300A may include receiving an audio signal from microphones 443 and/or 444. In some embodiments, the camera and the microphone may each be configured to be worn by the user. The camera and microphone can be separate devices, or may be included in the same device, such as wearable apparatus 110. Accordingly, the camera and the microphone may be included in a common housing. In some embodiments, the processor performing some or all of process 2300A may be included in the common housing. The common housing may be configured to be worn by user 100, as described throughout the present disclosure.

In step 2312, process 2300A may include detecting an unrecognized individual shown in at least one of the plurality of images taken at a first time. In some embodiments, this may include identifying characteristic features of the unrecognized individual based on the at least one image, as described above. The characteristic features may include any physical, biometric, or audible characteristics of an individual. For example, the characteristic features include at least one of a facial feature determined based on analysis of the image signal, or a voice feature determined based on analysis of an audio signal provided by a microphone associated with the system.

In step 2314, process 2300A may include determining an identity of the detected unrecognized individual based on acquired supplemental information. As described above, the supplemental information may include any additional information from which an identity of a previously unidentified individual may be ascertained. In some embodiments, the supplemental information may include one or more inputs received from a user of the system. For example, the one or more inputs may include a name of the detected unrecognized individual. In some embodiments, the name may be entered through a graphical user interface, such as the interface illustrated in FIG. 21B. Alternatively, or additionally, the name may be inputted by the user via a microphone associated with the system. As another example, the supplemental information may be captured from within the environment of the user. For example, the supplemental information may include a name associated with the detected unrecognized individual, which may be determined through analysis of an audio signal received from a microphone associated with the system.

As another example, the supplemental information may include information accessed from other data sources. For example, the supplemental information may include a name associated with the detected unrecognized individual, which may be determined by accessing at least one entry of an electronic calendar associated with a user of the system, as described above. For example, step 2314 may include accessing calendar entry 1852 as shown in FIG. 18B and described above. The at least one entry may be determined to overlap in time with a time at which the unrecognized individual was detected in at least one of the plurality of images. Step 2314 may further include updating at least one database with the name, at least one identifying characteristic of the detected unrecognized individual, and at least one informational aspect associated with the at least one entry of the electronic calendar associated with the user of the system. For example, the at least one informational aspect associated with the at least one entry may include one or more of a meeting place, a meeting time, or a meeting topic. Regardless of what type of supplemental information is acquired, step 2314 may further include prompting the user of the system to confirm that the name correctly corresponds to the detected unrecognized individual. The prompt may include a visual prompt on a display associated with the system, such as on computing device 120. The prompt may show the name together with the face of the detected unrecognized individual, similar to the interface shown in FIG. 21B.

In step 2316, process 2300A may include accessing at least one database and comparing one or more characteristic features associated with the detected unrecognized individual with features associated with one or more previously unidentified individuals represented in the at least one database. For example, this may include accessing data structure 2100 and comparing characteristic features detected in association with supplemental information 2120 with characteristic features 2112. As described above, these characteristic features may include a facial feature determined based on analysis of the image signal. Alternatively, or additionally, the characteristic features may include a voice feature determined based on analysis of an audio signal provided by a microphone associated with the system.

In step 2318, process 2300A may include determining, based on the comparison of step 2316, whether the detected unrecognized individual corresponds to any of the previously unidentified individuals represented in the at least one database. This may be determined in a variety of ways, as described above. In some embodiments, this may include determining whether the detected characteristic features differ from the stored features by more than a threshold amount. Alternatively, or additionally, the determination may be based on a machine learning algorithm. For example, step 2318 may include applying a machine learning algorithm trained on one or more training examples, or a neural network, as described above.

In step 2320, process 2300A may include updating at least one record in the at least one database to include the determined identity of the detected unrecognized individual. Step 2320 may be performed if the detected unrecognized individual is determined to correspond to any of the previously unidentified individuals represented in the at least one database, as determined in step 2318. For example, step 2320 may include updating record 2110 of a previously unidentified individual to include an identity ascertained from supplemental information 2120, as described in greater detail above. This may include adding a name, a relationship to the user, an identifier number, contact information, or various other forms of identifying information to record 2210. In some embodiments, process 2300A may include additional steps based on the updated record. For example, process 2300A may further include providing, to the user, at least one of an audible or visible indication associated with the at least one updated record. This may include displaying a text-based notification (e.g., on computing device 120 or wearable apparatus 110), transmitting a notification (e.g., via SMS message, email, etc.), activating an indicator light, presenting a chime or tone, or various other forms of indicators.

FIG. 23B is a flowchart showing an example process 2300B for associating one or more individuals in a database, consistent with the disclosed embodiments. Process 2300B may be performed by at least one processing device of a wearable apparatus, such as processor 220, as described above. In some embodiments, some or all of process 2300B may be performed by a different device, such as computing device 120. In some embodiments, a non-transitory computer readable medium may contain instructions that when executed by a processor cause the processor to perform process 2300B. Further, process 2300B is not necessarily limited to the steps shown in FIG. 23B, and any steps or processes of the various embodiments described throughout the present disclosure may also be included in process 2300B, including those described above with respect to FIGS. 21A, 21B, 22A, 22B, 22C, and 23A.

In step 2330, process 2300B may include receiving an image signal output by a camera configured to capture images from an environment of a user. The image signal may include a plurality of images captured by the camera. For example, step 2330 may include receiving image signal including image 2200 captured by image sensor 220. In some embodiments, the camera may be a video camera and the image signal may be a video signal.

In step 2332, process 2300B may include detecting a first individual and a second individual shown in the plurality of images. In some embodiments, the first individual and the second individual may appear together within at least one of the plurality of images. For example, step 2332 may include detecting individuals 2226 and 2228 in image 2200, as discussed above. Alternatively, or additionally, the first individual may appear in an image captured close in time to another image including the second individual. For example, the first individual may appear in a first one of the plurality of images captured at a first time, and the second individual may appear, without the first individual, in a second one of the plurality of images captured at a second time different from the first time. The first and second times may be separated by less than a predetermined time period. For example, the predetermined time period may be less than one second, less than one minute, less than one hour, or any other suitable time period.

In step 2334, process 2300B may include determining an identity of the first individual and an identity of the second individual. In some embodiments, the identity of the first and second individuals may be determined based on analysis of the plurality of images. For example, determining the identity of the first individual and the identity of the second individual may include comparing one or more characteristics of the first individual and the second individual with stored information from the at least one database. The one or more characteristics include facial features determined based on analysis of the plurality of images. The one or more characteristics may include any other features of the individuals that may be identified within one or more images, such as a body shape or posture of the individual, particular gestures or mannerisms, skin tone, retinal patterns, distinguishing marks (e.g., moles, birth marks, freckles, scars, etc.), hand geometry, finger geometry, or any other distinguishing physical or biometric characteristics. In some embodiments, the one or more characteristics include one or more voice features determined based on analysis of an audio signal provided by a microphone associated with the system. For example, process 2300H may further include receiving an audio signal output by a microphone configured to capture sounds from an environment of the user, and the identity of the first and second individuals may be determined based on the audio signal.

In step 2336, process 2300B may include accessing at least one database and storing in the at least one database one or more indicators associating at least the first individual with the second individual. For example, this may include accessing data structure 2240 as shown in FIG. 22C. The indicators may be any form of data linking the first and second individuals, as described in greater detail above. For example, the one or more indicators may include a time or date during which the first individual and the second individual were encountered together. Alternatively, or additionally, the one or more indicators may include a place at which the first individual and the second individual were encountered together. As another example, the one or more indicators may include information from at least one entry of an electronic calendar associated with the user.

Process 2300B may include additional steps beyond those shown in FIG. 23B. For example, this may include steps of using the information stored in the at least one databased associating the first and second individuals. In some embodiments, the system may be configured to identify associated individuals based on a search query. For example, process 2300B may include receiving a search query from a user of the system, such as user 100. The search query may indicate the first individual. Based on the query, process 2300B may further include accessing the at least one database to retrieve information about the first individual, which may include at least an identity of the second individual. For example, this may include accessing data structure 2240 as described above. Process 2300B may then include providing the retrieved information to the user.

As another example, when encountering a first individual the system performing process 2300B may provide information about other individuals associated with the first individual. For example, process 2300B may further include detecting a subsequent encounter with the first individual through analysis of the plurality of images. Then, process 2300B may include accessing the at least one database to retrieve information about the first individual, which may include at least an identity of the second individual. Process 2300B may then include providing the retrieved information to the user. For example, this may include displaying information indicating that the second individual is associated with the first individual. In some embodiments, this may include displaying or presenting other information, such as the various indicators described above (e.g., location, date, time, context, or other information).

In some embodiments, the system may be configured to determine an identity of an individual based on associations with other individuals identified by the system. For example, this may be useful if a representation of one individual in an image is obstructed, is blurry, has a low resolution (e.g., if the individual is far away), or the like. Process 2300B may include detecting a plurality of individuals through analysis of the plurality of images. Process 2300B may further include identifying the first individual from among the plurality of individuals by comparing at least one characteristic of the first individual, determined based on analysis of the plurality of images, with information stored in the at least one database. Then, process 2300B may include identifying at least the second individual from among the plurality of individuals based on the one or more indicators stored in the at least one database associating the second individual with the first individual.

FIG. 23C is a flowchart showing an example process 2300C for disambiguating unrecognized individuals, consistent with the disclosed embodiments. Process 2300C may be performed by at least one processing device of a wearable apparatus, such as processor 220, as described above. In some embodiments, some or all of process 2300C may be performed by a different device, such as computing device 120. In some embodiments, a non-transitory computer readable medium may contain instructions that when executed by a processor cause the processor to perform process 2300C. Further, process 2300C is not necessarily limited to the steps shown in FIG. 23C, and any steps or processes of the various embodiments described throughout the present disclosure may also be included in process 2300C, including those described above with respect to FIGS. 21A, 21B, 22A, 22B, 22C, 23A, and 23B.

In step 2350, process 2300C may include receiving an image signal output by a camera configured to capture images from an environment of a user. The image signal may include a plurality of images captured by the camera. For example, step 2350 may include receiving an image signal including images captured by image sensor 220. In some embodiments, the camera may be a video camera and the image signal may be a video signal.

In some embodiments, process 2300C may include receiving an audio signal output by a microphone configured to capture sounds from an environment of the user. For example, process 2300C may include receiving an audio signal from microphones 443 and/or 444. In some embodiments, the camera and the microphone may each be configured to be worn by the user. The camera and microphone can be separate devices, or may be included in the same device, such as wearable apparatus 110. Accordingly, the camera and the microphone may be included in a common housing. In some embodiments, the processor performing some or all of process 2300C may be included in the common housing. The common housing may be configured to be worn by user 100, as described throughout the present disclosure.

In step 2352, process 2300C may include detecting a first unrecognized individual represented in a first image of the plurality of images. In some embodiments, step 2352 may include identifying characteristic features of the first unrecognized individual based on the first image. The characteristic features may include any physical, biometric, or audible characteristics of an individual. For example, the characteristic features include at least one of a facial feature determined based on analysis of the image signal, or a voice feature determined based on analysis of an audio signal provided by a microphone associated with the system.

In step 2354, process 2300C may include associating the first unrecognized individual with a first record in a database. For example, this may include associating individual 2226 with record 2210 in data structure 2100, as shown in FIG. 22A. Step 2354 may further include storing additional information, such as characteristic features 2212 that may be identified based on the plurality of images. This may include other information, such as a date or time of the encounter, location information, a context of the encounter, or the like.

In step 2356, process 2300C may include detecting a second unrecognized individual represented in a second image of the plurality of images. For example, this may include detecting individual 2228 in a same image or in a separate image. In some embodiments, step 2352 may include identifying characteristic features of the second unrecognized individual based on the second image.

In step 2358, process 2300C may include associating the second unrecognized individual with the first record in a database. For example, this may include associating individual 2228 with record 2210 in data structure 2100. As with step 2354, step 2358 may further include storing additional information, such as characteristic features 2214 that may be identified based on the plurality of images. This may include other information, such as a date or time of the encounter, location information, a context of the encounter, or the like.

In step 2360, process 2300C may include determining, based on supplemental information, that the second unrecognized individual is different from the first unrecognized individual. The supplemental information may include any form of information indicating the first and second unrecognized individuals are not the same individual. In some embodiments, the supplemental information may comprise a third image showing both the first unrecognized individual and the second unrecognized individual. For example, step 2360 may include receiving image 2200 showing individual 2226 and 2228 together, which would indicate they are two separate individuals. Additionally, or alternatively, the supplemental information may comprise an input from the user, as described above. For example, step 2360 may include prompting the user to determine whether the first and second unrecognized individuals are the same. In other embodiments, the user may provide input without being prompted to do so. In some embodiments, the supplemental information may comprise a minute difference detected between the first unrecognized individual and the second unrecognized individual. For example, the system may capture and analyze additional characteristic features of the first or second unrecognized individual which may indicate a distinction between the two individuals. The minute difference may include a difference in height, a difference in skin tone, a difference in hair color, a difference in facial expressions or other movements, a difference in vocal characteristics, presence or absence of a distinguishing characteristic (e.g., a mole, a birth mark, wrinkles, scars, etc.), biometric information, or the like.

In step 2362, process 2300C may include generating a second record in the database associated with the second recognized individual. For example, this may include generating record 2218 associated with individual 2228. Step 2362 may also generate a new record 2216 for individual 2226. In some embodiments, record 2216 may correspond to record 2210. Step 2362 may further include transferring some of the information associated with the second recognized individual stored in record 2210 to new record 2218, as described above. This may include determining, based on the supplemental information, which information is associated with the first individual and which information is associated with the second individual. In some embodiments, process 2300C may further include updating a machine learning algorithm or other algorithm for associating characteristic features with previously unidentified individuals. Accordingly, the supplemental information may be used to train a machine learning model to more accurately correlate detected individuals with records stored in a database, as discussed above.

Social Map and Timeline Graphical Interfaces

As described throughout the present disclosure, a wearable camera apparatus may be configured to recognize individuals in the environment of a user. The apparatus may present various user interfaces displaying information regarding recognized individuals and connections or interactions with the individuals. In some embodiments, this may include generating a timeline representation of interactions between the user and one or more individuals. For example, the apparatus may identify an interaction involving a group of people and extract faces to be displayed in a timeline. The captured and extracted faces may be organized according to a spatial characteristic of the interaction (e.g., location of faces around a meeting mom table, in a group of individuals at a party, etc.). The apparatus may further capture audio and parse audio for keywords within a time period (e.g., during a detected interaction) and populate a timeline interface with the keywords. This may help a user remember who spoke about a particular keyword and when. The system may further allow a user to pre-designate words of interest.

In some embodiments, the apparatus may present a social graph indicating connections between the user and other individuals, as well as connections between the other individuals. The connections may indicate, for example, whether the individuals know each other, whether they have been seen together at the same time, whether they are included in each other's contact lists, etc. The apparatus may analyze social connections and suggest a route to contact people based on acquaintances. This may be based on a shortest path between two individuals. For example, the apparatus may recommend contacting an individual directly rather than through a third party if the user has spoken to the individual in the past. In some embodiments, the connections may reflect a mood or tone of an interaction. Accordingly, the apparatus may prefer connections through which the conversation is analyzed to be most pleasant. The disclosed embodiments therefore provide, among other advantages, improved efficiency, convenience, and functionality over prior art audio recording techniques.

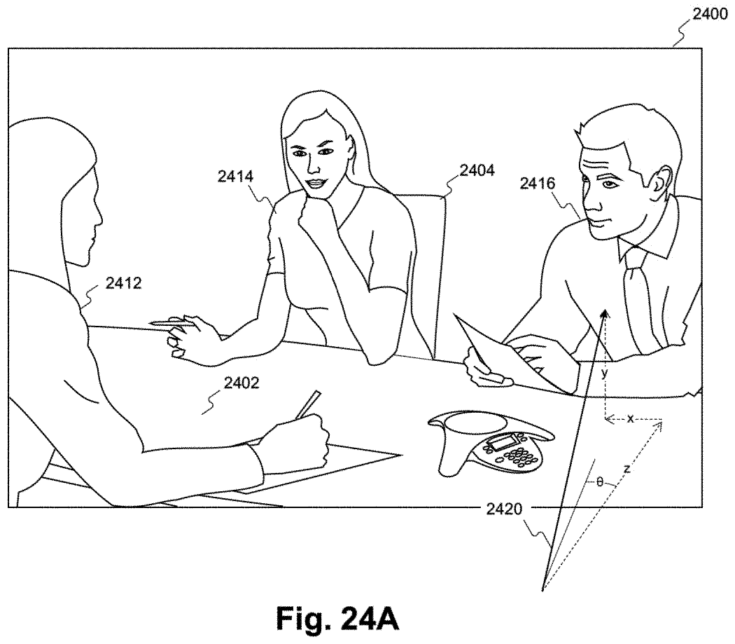

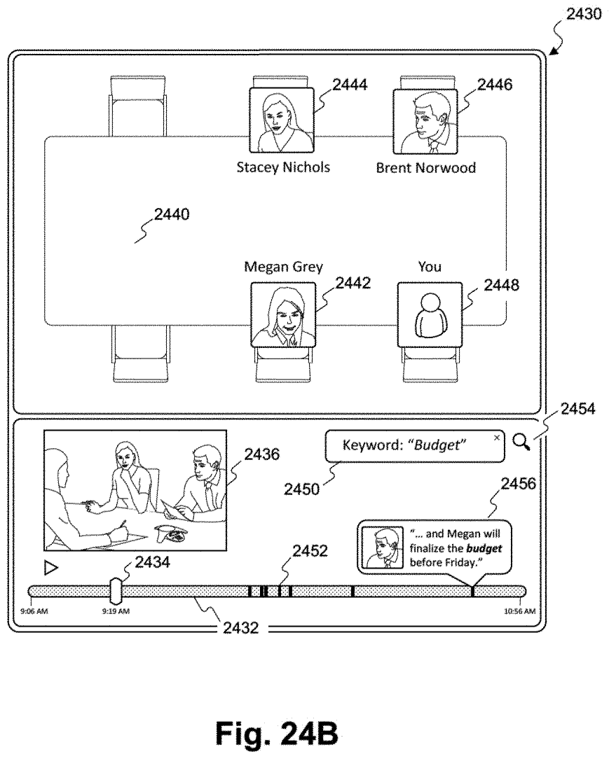

As described above, wearable apparatus 110 may be configured to capture one or more images from the environment of user 100. FIG. 24A illustrates an example image 2600 that may be captured from an environment of user 100, consistent with the disclosed embodiments. Image 2600 may be captured by image sensor 220, as described above. In the example shown in image 2600, user 100 may be in a meeting with other individuals 2412, 2414, and 2416. Image 2600 may include other elements such as objects 2602 and 2604, that may help define relative positions of the user and individuals 2412, 2414, and 2416. Wearable apparatus 110 may also capture audio signals from the environment of user 100. For example, microphones 443 or 444 may be used to capture audio signals from the environment of the user, as described above. This may include voices of the user and/or individuals 2412, 2414, and 2416, background noises, or other sounds from the environment.

The apparatus may be configured to detect individuals represented in one or more images captured from the environment of user 100. For example, the apparatus may detect representations of individuals 2412, 2414, and/or 2416 within image 2600. This may include applying various object detection algorithms such as frame differencing, Statistically Effective Multi-scale Block Local Binary Pattern (SEMB-LBP), Hough transform, Histogram of Oriented Gradient (HOG), Single Shot Detector (SSD), a Convolutional Neural Network (CNN), or similar techniques. In some embodiments, the apparatus may be configured to recognize or identify the individuals using various techniques described throughout the present disclosure. For example, the apparatus may identify facial features on the face of the individual, such as the eyes, nose, cheekbones, jaw, or other features. The apparatus may use one or more algorithms for analyzing the detected features, such as principal component analysis (e.g., using Eigenfaces), linear discriminant analysis, elastic bunch graph matching (e.g., using Fisherface), Local Binary Patterns Histograms (LBPH), Scale invariant Feature Transform (SIFT), Speed Up Robust Features (SURF), or the like. In some embodiments, the individuals may be identified based on other physical characteristics or traits such as a body shape or posture of the individual, particular gestures or mannerisms, skin tone, retinal patterns, distinguishing marks (e.g., moles, birth marks, freckles, scars, etc.), hand geometry, finger geometry, or any other distinguishing physical or biometric characteristics.

Consistent with the present disclosure, the apparatus may further determine spatial characteristics associated with individuals in the environment of user 100. As used herein, a spatial characteristic includes any information indicating a relative position or orientation of an individual. The position or orientation may be relative to user 100, the environment of user 100, an object in the environment of user 100, other individuals, or any other suitable frame of reference. Referring to FIG. 24A, the apparatus may determine spatial characteristic 2420, which may include a relative position and/or orientation of individual 2416. In the example shown, spatial characteristic may be a position of individual 2416 relative to user 100 represented as a distance and direction from user 100. In some embodiments, the distance and direction may be broken into multiple components. For example, the distance and direction may be broken into x, y, and z components, as shown in FIG. 24A. Similarly, spatial characteristic 2420 may include an angular orientation between the user and individual 2416, as indicated by angle θ. Spatial characteristic 2420 may be defined based on various forms of coordinate systems. For example, the coordinate system may be defined relative to image 2400, wearable apparatus 110, a user of wearable apparatus 110, table 2402, or various other coordinate systems.

The apparatus may be configured to generate an output including a representation of a face of the detected individuals together with the spatial characteristics. The output may be generated in any format suitable for correlating representations of faces of the individuals with the spatial characteristics. For example, the output may include a table, array, or other data structure correlating image data to spatial characteristics. In some embodiments, the output may include images of the faces with metadata indicating the spatial characteristics. For example, the metadata may be included in the image files, or may be included as separate files. In some embodiments, the output may include other data associated with an interaction with the individuals, such as identities of the individuals (e.g., names, alphanumeric identifiers, etc.), timestamp information, transcribed text of a conversation, detected words or keywords, video data, audio data, context information, location information, previous encounters with the individual, or any other information associated with an individual described throughout the present disclosure.

The output may enable a user to view information associated with an interaction. Accordingly, the apparatus may then transmit the generated output for causing a display to present information to the user, in some embodiments, this may include a timeline view of interactions between the user and the one or more individuals. As used herein, a timeline view may include any representation of events presented in a chronological format. In some embodiments, the timeline view may be associated with a particular interaction between the user and one or more individuals. For example, the timeline view may be associated with a particular event, such as a meeting, an encounter with an individual, asocial event, a presentation, or similar events involving one or more individuals. Alternatively, or additionally, the timeline view may be associated with a broader range of time. For example, the timeline view may be a global timeline (e.g., representing a user's lifetime, a time since the user began using wearable apparatus 110, etc.), or various subdivisions of time (e.g., the past 24 hours, the previous week, the previous month, the previous year, etc.). The timeline view may be represented in various formats. For example, the timeline view may be represented as a list of text, images, and/or other information presented in chronological order. As another example, the timeline view may include a graphical representation of a time period, such as a line or bar, with information presented as points or ranges of points along the graphical representation. In some embodiments, the timeline view may be interactive such that the user may zoom in or out, move or scroll along the timeline, change which information is displayed in the timeline, edit or modify the displayed information, select objects or other elements of the timeline to display additional information, search or filter information, activate playback of information (e.g., an audio or video file associated with the timeline), or various other forms of interaction. While various example timeline formats are provided, it is to be understood that the present disclosure is not limited to any particular format of timeline.

FIG. 24B illustrates an example timeline view 2430 that may be displayed to a user, consistent with the disclosed embodiments. Timeline view 2430 may be a chronological representation of a particular interaction between user 100 and individuals 2412, 2414, and 2416. Accordingly, image 2400 may be captured during the interaction represented by timeline view 2430. Timeline view 2430 may include a timeline element 2432, which may be a graphical representation of a period of time associated with an interaction. For example, the interaction with individuals 2412, 2414, and 2416 may be a meeting and timeline element 2432 may be a graphical representation of the duration of the meeting. In this example, the beginning of the interaction is represented by the left-most portion of timeline element 2432 and the ending of the interaction is represented by the right-most portion of timeline element 2432. The beginning and end points of the interaction may be specified in various ways. For example, if the interaction corresponds to a calendar event (e.g., calendar event 1852 shown in FIG. 18B), the begin and end times of timeline element 2432 may be defined based on the begin and end times of the calendar invite. The beginning and ending of the interaction may be defined based on other factors, such as when user 100 arrives at the interaction location, when at least one other individual enters the environment of user 100, when a topic of conversation changes, or various other triggers.

Timeline element 2432 may include a position element 2434 indicating a position in time along timeline element 2432. Timeline view 2430 may be configured to display information based on the position of position element 2434. For example, user 100 may drag or move position element 2434 along timeline element 2432 to review the interaction. The display may update information presented in timeline view 2430 based on the position of position element 2434. In some embodiments, timeline view 2430 may also allow for playback of one or more aspects of the interaction, such as audio and/or video signals recorded during the interaction. For example, timeline view 2430 may include a video frame 2436 allowing a user to review images and associated audio captured during the interaction. The video frames may be played back at the same rate they were captured, or at a different speed (e.g., slowed down, sped up, etc.). In these embodiments, position element 2434 may correspond to the current image frame shown in video frame 2436. Accordingly, a user may drag position element 2434 along timeline element 2432 to review images captured at times associated with a current position of position element 2434.

In some embodiments, the timeline view may include representations of individuals. For example, the representations of the individuals may include images of the individuals (e.g., of a face of the individual), a name of the individual, a title of the individual, a company or organization associated with the individual, or any other information that may be relevant to the interaction. The representations may be arranged according to identified spatial characteristics described above. For example, the representations may be positioned spatially on the timeline view to correspond with respective positions of the individuals during the interaction. For example, as shown in FIG. 24B, timeline view 2430 may include representations 2442, 2444, and 2446 associated with individuals 2412, 2414, and 2416, respectively. Representations 2442, 2444, and 2446 may include images of faces of individuals 2412, 2414, and 2416 along with corresponding names. The images may be images or portions of images captured by wearable apparatus 110, either during the interaction with user 100 represented in timeline view 2430, or in earlier representations. In some embodiments, the images may be default images for the individual, which may be selected by a user or the individual, accessed from a database, accessed from an external source (e.g., a contact list, a social media profile, etc.), or various other images of the individual. Timeline view 2430 may further include a representation 2448 of user 100. Representation 2448 may include a standard icon representing user 100, or may be an image of user 100. In some embodiments, representations 2442, 2444, 2446, and 2448 may include an arrow or other directional indicator representing a looking or facing direction of individuals 2412, 2414, and 2416 user 100, which may be determined based on analysis of image 2400.

Representations 2442, 2444, 2446, and 2448 may be arranged spatially in timeline view 2430 to correspond to the relative positions between individuals 2412, 2414, and 2416 relative to user 100 as captured in image 2400. For example, based on spatial characteristic 2420, the system may determine that individual 2416 was sitting across from user 100 during the meeting and therefore may position representation 2446 across from representation 2448. Representations 2442 and 2444 may similarly be positioned within timeline view according to spatial characteristics determined from image 2400. In some embodiments, timeline view 2430 may also include a representation of other objects detected in image 2400, such as representation 2440 of table 2402. In some embodiments, the appearance of representation 2440 may be based on table 2402 in image 2400. For example, representation 2440 may have a shape, color, size, or other visual characteristics based on table 2402 in image 2400. In some embodiments, representation 2440 may be a standard or boilerplate graphical representation of a table that is included based on table 2402 being recognized in image 2400. Representation 2440 may include a number of virtual “seats” where representations of individuals may be placed, as shown. The number of virtual seats may correspond to the number of actual seats at table 2402 (e.g., by detecting seat 2404, etc. in image 2400), a number of individuals detected, or various other factors.

In some embodiments, the positions of representations 2442, 2444, 2446, and/or 2448 may be time-dependent. For example, the positions of individuals 2412, 2414, and 2416 may change during the course of an interaction as individuals move around, take different seats, stand in different positions relative to user 100, leave the environment of user 100, etc. Accordingly, the respective positions of representation of the individuals may also change positions. In the example shown in FIG. 24B, the arrangement of representations 2442, 2444, 2446, and/or 2448 may correspond to the positions of individuals 2412, 2414, and 2416 and user 100 at a time corresponding to the position of position element 2434 along timeline element 2432. For example, if individual 2414 leaves the meeting halfway through the meeting, representation 2444 may be removed from timeline view 2430 while position element 2434 is positioned along timeline element 2432 corresponding to a time when individual 2414 was absent from the meeting. Similarly, representations of other individuals may be added to timeline view 2430 as they enter the environment of user 100. Representations 2442, 2444, 2446, and/or 2448 may not necessarily be limited to virtual seats and may move around within timeline view 2430 to correspond to the relative positions of individuals 2412, 2414, and 2416 and user 100. Similarly, representation 2440 may move around or be removed from timeline view 2430 as the environment of user 100 changes. For example, the interaction with individuals 2412, 2414, and 2416 may continue as user 100 leaves the meeting room. In some embodiments, the spatial view including representations of individuals may be interactive. Accordingly, a user may zoom in or out, pan around the environment, rotate the view in 3D space, or otherwise navigate the displayed environment. While a bird's-eye view is shown by way of example in FIG. 24B, various other perspectives or display formats may be used. For example, representations 2442, 2444, and 2446 may be positioned based on a first-person perspective of user 100, similar to the positions of individuals 2412, 2414, and 2416 in image 2400.

According to some embodiments, representations 2440, 2442, 2444, 2446, and/or 2448 may be interactive. For example, selecting a representation of an individual may cause a display of additional information associated with the individual. For example, this may include context of a relationship with the individual, contact information for the individual, additional identification information, an interaction history between user 100 and the individual, or the like. This additional information may include displays similar to those shown in FIGS. 19A-19C and described in greater detail above. As another example, selecting a representation of an individual may allow a user to contact an individual, either by displaying contact options (e.g., email links, phone numbers, etc.) or automatically initiating a communication session (e.g., beginning a phone call, opening a chat or email window, starting a video call, etc.). Various other actions may be performed by selecting a representation of an individual, such as generating a meeting invitation, muting or attenuating audio associated with the individual, conditioning audio associated with the individual, presenting options for audio conditioning associated with the individual, highlighting portions of timeline element 2432 associated with the individual (e.g., times when the individual is present, times when the individual is speaking, etc.), or various other actions. Similar actions may be performed when a user selects representation 2448. Selecting representation 2440 may cause a display of information associated with a meeting room or meeting location. For example, selecting representation 2440 may cause the display of a calendar view of a meeting room and may allow a user to schedule future meetings in the same room or view past meeting schedules.

Consistent with the present disclosure, timeline view 2430 may include representations of keywords or other contextual information associated with an interaction. For example, the system may be configured to detect words (e.g., keywords) or phrases spoken by user 100 or individuals 2412, 2414, and/or 2416. The system may be configured to store the words or phrases in association with other information pertaining to an interaction. For example, this may include storing the words or phrases in an associative manner with a characteristic of the speaker, a location of the user where the word or phrase was detected, a time when the word or phrase was detected, a subject related to the word or phrase, or the like. Information representing the detected words or phrases may be displayed relative to the timeline. For example, timeline 2430 may include a keyword element 2452 indicating a keyword detected by the system. In the example shown in FIG. 24B, the keyword may be the word “budget.” Timeline element 2432 may include graphical indications of times where the keyword was detected during the interaction. For example, timeline element 2432 may include markers 2452 positioned along timeline element 2432 to correspond with times when the word “budget” was uttered by an individual (which may include user 100). Accordingly, a user may visualize various topics of conversation along the timeline. In some embodiments, timeline view 2430 may include indications of who uttered the keyword or phrase. In some embodiments, each marker 2452 may also include an icon or other graphic representing the individual who uttered the keyword (e.g., displayed above the marker, displayed as different color markers, different marker icons, etc.). As another example, regions of timeline element 2432 may be highlighted to show a current speaker. For example, each individual may be associated with a different color, a different shading or pattern, or other visual indicators.

In some embodiments, the markers may be interactive. For example, selecting a marker may cause an action, such as advancing video or audio playback to the position of the marker (or slightly before the marker). As another example, selecting a marker may cause display of additional information. For example, selecting a marker may cause display of a pop-up 2456, which may include a snippet of transcribed text surrounding the keyword and an image of the individual who uttered the keyword. Alternatively, or additionally, pop-up 2456 may include other information, such as a time associated with the utterance, a location of the utterance, other keywords spoken in relation to the utterance, information about the individual who uttered the keyword, or the like.

The keyword displayed in keyword element 2450 may be determined in various ways. For example, timeline view 2430 may include a search element 2454 through which a user may enter one or more keywords or phrases. In the example shown, search element 2454 may be a search bar and when the user enters the word “budget” in the search bar, keyword element 2450 may be displayed along with markers 2452. Closing keyword element 2450 may hide keyword element 2450 and markers 2452 and cause the search bar to be displayed again. Various other forms of inputting a keyword may be used, such as voice input from a user, or the like. In some embodiments, the system may identify list of keywords that are determined to be relevant. For example, a user of the system may select a list of keywords of interest. In other embodiments, the keywords may be preprogrammed into the system, for example, as default keywords, in some embodiments, the keywords may be identified based on analysis of audio associated with the interaction. For example, this may include the most commonly spoken words (which, in some embodiments, may exclude common words such as prepositions, pronouns, possessive, articles, modal verbs, etc.). As another example, this may include words determined to be associated with a context of the interaction. For example, if the context of an interaction is financial in nature, words relating to finance (e.g., budget, spending, cost, etc.) may be identified as keywords. This may be determined based on natural language processing algorithms or other techniques for associating context with keywords.

According to some embodiments, the apparatus may be configured to collect and store data for generating a graphical user interface representing individuals and contextual information associated with the individuals. As used herein, contextual information refers to any information captured during an interaction with an individual that provides context of the interaction. For example, contextual information may include, but is not limited to, whether an interaction between an individual and the user was detected; whether interactions between two or more other individuals is detected; a name associated with an individual; a time at which the user encountered an individual; a location where the user encountered the individual; an event associated with an interaction between the user and an individual; a spatial relationship between the user and the one or more individuals; image data associated with an individual; audio data associated with an individual; voiceprint data; or various other information related to an interaction, including other forms of information described throughout the present disclosure.

For example, the apparatus may analyze image 2400 (and/or other associated images and audio data) to determine whether user 100 interacts with individuals 2412, 2414, and/or 2416. Similarly, the apparatus may determine interactions between 2412, 2414, and/or 2416. In this context, an interaction may include various degrees of interaction. For example, an interaction may include a conversation between two or more individuals. As another example, an interaction may include a proximity between two or more individuals. For example, an interaction may be detected based on two individuals being detected in the same image frame together, within a threshold number of image frames together, within a predetermined time period of each other, within a geographic range of each other at the same time, or the like. In some embodiments, the apparatus may track multiple degrees or forms of interaction. For example, the apparatus may detect interactions based on proximity of individuals to each other as one form of interaction, with speaking engagement between the individuals as another form of interaction. The apparatus may further determine context or metrics associated with interactions, such as a duration of an interaction, a number of separate interactions, a number of words spoken between individuals, a topic of conversation, or any other information that may give further context to an interaction. In some embodiments, the apparatus may determine a tone of an interaction, such as whether the interaction is pleasant, confrontational, private, uncomfortable, familiar, formal, or the like. This may be determined based on analysis of captured speech of the individuals to determine a tempo, an agitation, an amount of silence, silence between words, a gain or volume of, overtalking between individuals, an inflection, key words or phrases spoken, emphasis of certain words or phrases, or any other vocal or acoustic characteristics that may indicate a tone. In some embodiments, the tone may be determined based on visual cues, such as facial expressions, body language, a location or environment of the interaction, or various other visual characteristics.

The apparatus may store the identities of the individuals along with the corresponding contextual information. In some embodiments, the information may be stored in a data structure such as data structure 1860 as described above with respect to FIG. 18C. The data structure may include other information described throughout the present disclosure. As described above with respect to data structure 1860, the data may be stored linearly, horizontally, hierarchically, relationally, non-relationally, uni-dimensionally, multidimensionally, operationally, in an ordered manner, in an unordered manner, in an object-oriented manner, in a centralized manner, in a decentralized manner, in a distributed manner, in a custom manner, or in any manner enabling data access. The data structure may include an array, an associative array, a linked list, a binary tree, a balanced tree, a heap, a stack, a queue, a set, a hash table, a record, a tagged union, ER model, and a graph. For example, a data structure may include an XML database, an RDBMS database, an SQL database or NoSQL alternatives for data storage/search such as, for example, MongoDB™, Redis™, Couchbase™, Datastax Enterprise Graph™, Elastic Search™, Splunk™, Solr™, Cassandra™, Amazon DynamoDB™, Scylla™, HBase®, and Neo4J™. A data structure may be a component of the disclosed system or a remote computing component (e.g., a cloud-based data structure). Data in the data structure may be stored in contiguous or non-contiguous memory. Moreover, a database, as used herein, does not require information to be co-located. It may be distributed across multiple servers, for example, that may be owned or operated by the same or different entities. Thus, the terms “database” or “data structure” as used herein in the singular are inclusive of plural databases or data structures.

The apparatus may cause generation of a graphical user interface including a graphical representation of individuals and corresponding contextual information. A wide variety of formats for presenting the graphical representations of individuals and the contextual information may be used. For example, the graphical user interface may be presented as a series of “cards” (e.g., as shown in FIG. 19A), a list, a chart, a table, a tree, or various other formats. In some embodiments, the graphical user interface may be presented in a network arrangement. For example, the individuals may be represented as nodes in a network and the contextual information may be presented as connections between the nodes. For example, the connections may indicate interactions, types of interactions, degrees of interactions, or the like.

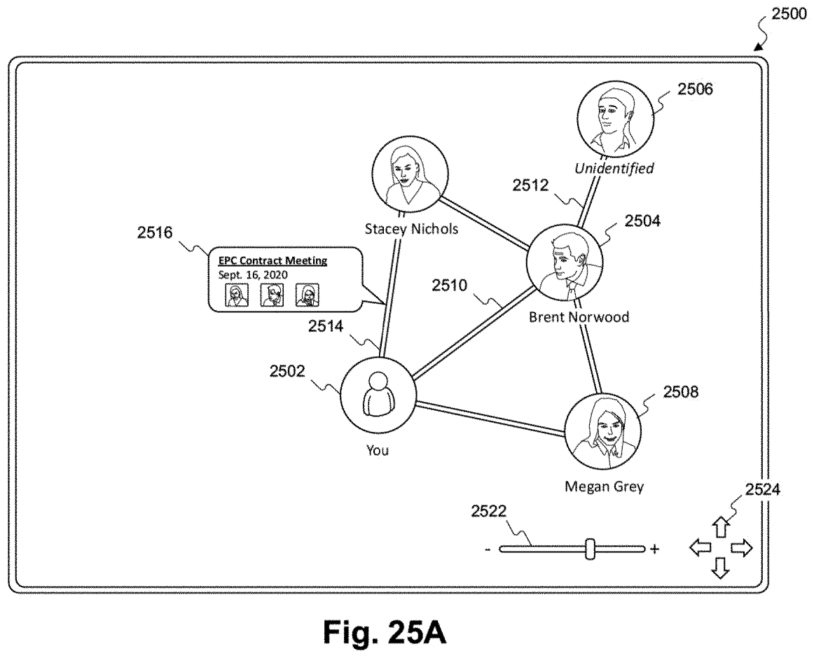

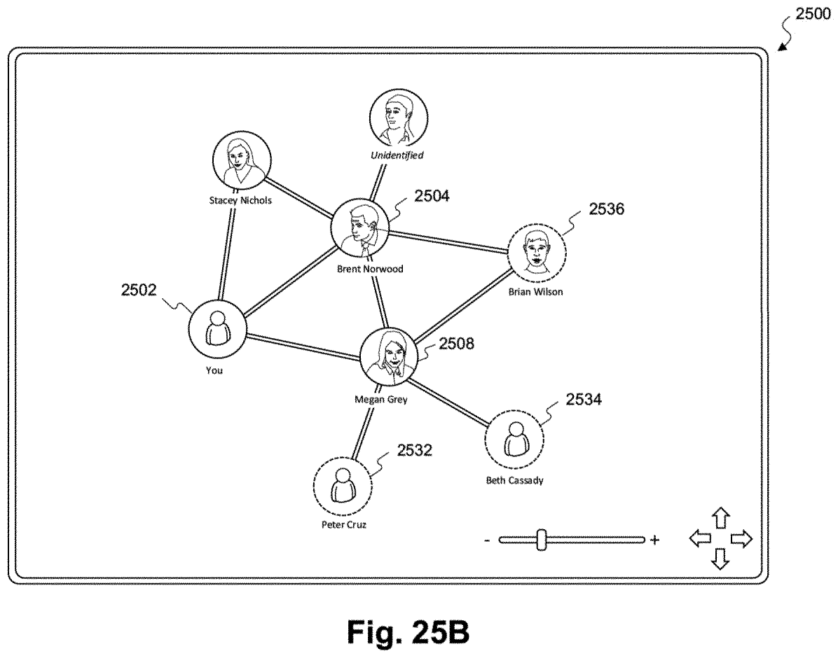

FIG. 25A illustrates an example network interface 2500, consistent with the disclosed embodiments. Network interface 2500 may include a plurality of nodes representing individuals within a social network of user 100. For example, network interface 2500 may include a node 2502 associated with user 100 and nodes 2504, 2506, and 2508 associated with individuals detected within the environment of user 100. Network interface 2500 may also display other identifying information associated with an individual, such as a name of the individual, a tide, a company or organization associated with the individual, a date, time, or location of a previous encounter, or any other information associated with an individual. In some embodiments, network 2500 may include unidentified individuals detected in the environment of user 100. These individuals may be represented by nodes, such as node 2506, similar to recognized individuals. As described above with respect to FIGS. 21A and 21B, the system may later update node 2506 with additional information as it becomes available.

In some embodiments, network interface 2500 may not be limited to individuals detected in the environment of user 100. Accordingly, the system may be configured to access additional data to populate as social or professional network of user 100. For example, this may include accessing a local memory device (e.g., included in wearable apparatus 110, computing device 120, etc.), an external server, a website, a social network platform, a cloud-based storage platform, or other suitable data sources. Accordingly, network interface 2500 may also include nodes representing individuals identified based on a social network platform, a contact list, a calendar event, or other sources that may indicate connections between user 100 and other individuals.

Network interface 2500 may also display connections between nodes representing contextual information. For example, connection 2510 may represent a detected interaction between user 100 (represented by node 2502) and individual 2416 (represented by node 2504). As described above, an interaction may be defined in various ways. For example, connection 2510 may indicate that user 100 has spoken with individual 2416, was in close proximity to individual 2416, or various other degrees of interaction. Similarly, connection 2512 may indicate a detected interaction between individuals represented by nodes 2504 and 2506. Depending on how an interaction is defined, network interface 2500 may not include a connection between node 2502 and node 2506 (e.g., if user 100 has not spoken with the individual represented by node 2506 but has encountered individuals represented by nodes 2504 and 2506 together). In some embodiments, the appearance of the connection may indicate additional contextual information. For example, network interface 2500 may display connections with varying color, thickness, shape, patterns, lengths, multiple connectors, or other visual attributes based on contextual information, such as degrees of interaction, tone of interactions, a number of interactions, durations of interactions, or other factors.

As shown in FIG. 25A, network interface 2500 may have navigation elements, such as zoom bar 2522 and directional arrows 2524. Accordingly, network interface 250) may be interactive to allow a user to navigate the displayed network of individuals. For example, zoom bar 2522 may be a slider allowing a user to zoom in and out of the displayed network. Directional arrows 2524 may allow a user to pan around the displayed network. In some embodiments, network interface 2500 may be presented as a three-dimensional interface. Accordingly, the various nodes and connections between nodes may be represented in a three-dimensional space. Accordingly, network interface 2500 may include additional navigation elements allowing a user to rotate the displayed network, and/or move toward and away from the displayed network.

Network interface 2500 may allow a user to filter or search the displayed information. For example, in some embodiments, network interface 2500 may be associated with a particular timeframe, such as a particular interaction or event, a time period selected by a user, a predetermined time range (e.g., the previous 24 hours, the past day, the past week, the past year, etc.). Accordingly, only individuals or contextual information within the time range may be displayed. Alternatively, or additionally, network interface 2500 may be cumulative and may display a data associated with user 100 collected over a lifetime of user 100 (or since user 100 began using wearable apparatus 110 and/or associated systems). Network interface 2500 may be filtered in various other ways. For example, the interface may allow a user to show only social contacts, only work contacts, or various other groups of contacts. In some embodiments, network interface 2500 may be filtered based on context of the interactions. For example, a user may filter the network based on a particular topic of conversation, which may be determined based on analyzing audio or transcripts of conversations. As another example, network interface 2500 may be filtered based on a type or degree of interaction. For example, network interface 2500 may display only interactions where two individuals spoke to each other, or may be limited to a threshold number of interactions between the individual, a duration of the interaction, a tone of the interaction, etc.

In some embodiments, various elements of network interface 2500 may be interactive. For example, the user may select nodes or connections (e.g., by clicking on them, tapping them, providing vocal commands, etc.) and, in response, network interface 2500 may display additional information. In some embodiments, selecting a node may bring up additional information about an individual. For example, this may include displaying a context of a relationship with the individual, contact information for the individual, additional identification information, an interaction history between user 100 and the individual, or the like. This additional information may include displays similar to those shown in FIGS. 19A-19C and described in greater detail above. As another example, selecting a node may allow a user to contact an individual, either by displaying contact options (e.g., email links, phone numbers, etc.) or automatically initiating a communication session (e.g., beginning a phone call, opening a chat or email window, starting a video call, etc.). Various other actions may be performed based on selecting a node, such as generating a meeting invitation, displaying an expanded social network of the selected individual (described further below), displaying a chart or graph associated with the individual, center a view on the node, or various other actions.

Similarly, selecting a connection may cause network interface 2500 to display information related to the connection. For example, this may include a type of interaction between the individuals, a degree of interaction between the individuals, a history of interactions between the individuals, a most recent interaction between the individuals, other individuals associated with the interaction, a context of the interaction, location information (e.g., a map or list of locations where interactions have occurred), date or time information (e.g., a list, timeline, calendar, etc.), or any other information associated with an interaction. As shown in FIG. 25A, selecting connection 2514 may cause pop-up 2516 to be displayed, which may include information about a previous interaction with the associated individual. In some embodiments, the information may be derived from a calendar event or other source. As another example, selecting a connector may bring up a timeline of interactions with the individual, such as timeline view 2430, or similar timeline displays.

In some embodiments, the apparatus may further be configured to aggregate information from two or more networks for display to a user. This may allow a user to view an expanded social network beyond the individuals included in his or her own social network. For example, network interface 2500 may show individuals associated with a first user, individuals associated with a second user, and individuals shared by both the first user and the second user.

FIG. 25B illustrates another example network interface 2500 displaying an aggregated social network, consistent with the disclosed embodiments. In the example shown in FIG. 25B, network interface 2500 may include the individuals within the social network of user 100, as described above with respect to FIG. 25A. The apparatus may also access a network associated with individual 2412 (represented by node 2508). For example, a network for individual 2412 may include additional nodes 2532, 2534, and 2536. Accordingly, the example network interface shown in FIG. 25B may therefore represent an aggregated network based on a network for user 100 and a network for individual 2412 (associated with node 2508).

Individuals that are common to both networks may be represented by a single node. For example, if user 100 and individual 2412 are both associated with individual 2416, a single node 2504 may be used to represent the individual. In some instances, the system may not initially determine that two individuals in the network are the same individual and therefore may include two nodes for the same individual. As described above with respect to FIGS. 22A-22C, the apparatus may be configured to disambiguate two or more nodes based on supplemental information.

The network associated with node 2508 may be obtained in a variety of suitable manners. In some embodiments, individual 2412 may use a wearable apparatus that is the same as or similar to wearable apparatus 110 and the network for node 2508 may be generated in the same manner as the network for node 2502. Accordingly, the network for node 2508 may be generated by accessing a data structure storing individuals encountered by individual 2412 along with associated contextual information. The data structure may be a shared data structure between all users, or may include a plurality of separate data structures (e.g., associated with each individual user, associated with different geographical regions, etc.). Alternatively, or additionally, the network for node 2508 may be identified based on a contacts list associated with individual 2412, a social media network associated with individual 2412, one or more query responses from individual 2412, publicly available information (e.g., public records, etc.), or various other data sources that may include information linking individual 2412 to other individuals.

In some embodiments, the apparatus may be configured to visually distinguish individuals within the network of user 100 and individuals displayed based on an aggregation of networks. For example, as shown in FIG. 25B, nodes 2532, 2534, and 2536 may be represented with dashed outlines, indicating they are not directly linked with user 100. In some embodiments, common nodes such as node 2504, may be highlighted as well. The appearance of the nodes and connections shown in FIG. 25B are provided by way of example, and various other means of displaying nodes may be used, including varying shapes, colors, line weights, line styles, etc. In some embodiments, selecting a particular node in an aggregated network may highlight individuals included in the network for that node. For example, the system may temporarily hide, minimize, grey out, or otherwise differentiate nodes outside the network associated with the selected node.

According to some embodiments of the present disclosure, the apparatus may generate recommendations based on network interface 250). For example, if user 100 wishes to contact individual Brian Wilson represented by node 2536, the apparatus may suggest contacting either individual 2416 (node 2504) or individual 2412 (node 2508). In some embodiments, the system may determine a best route for contacting the individual based on stored contextual information. For example, the apparatus may determine that interactions between user 100 and individual 2416 (or interactions between individual 2416 and Brian Wilson) are more pleasant (e.g., based on analysis of audio and image data captured during interactions) and therefore may recommend contacting Brian Wilson through individual 2416. Various other factors may be considered, including the number of intervening nodes, the number of interactions between individuals, the time since the last interaction with individuals, the context of interactions between individuals, the duration of interactions between individuals, geographic locations associated with individuals, or any other relevant contextual information. The recommendations may be generated based on various triggers. For example, the apparatus may recommend a way of contacting an individual based on a selection of the individual in network interface 2500 by a user. As another example, the user may search for an individual using a search bar or other graphical user interface element. In some embodiments, the recommendation may be based on contextual information associated with an individual. For example, a user may express an interest in contacting someone regarding “environmental species surveys,” and based on detected interactions between Brian Wilson and other individuals, website data, user profile information, or other contextual information, the system may determine that Brian Wilson is associated with this topic.

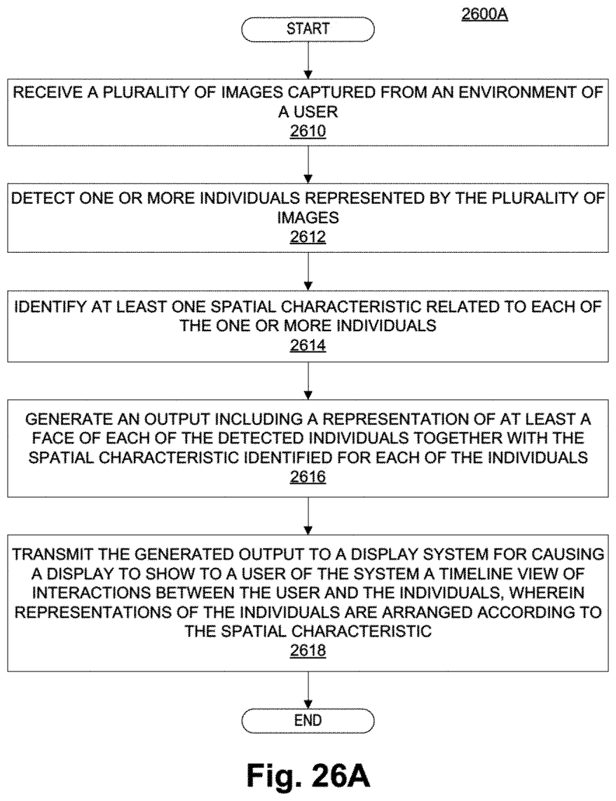

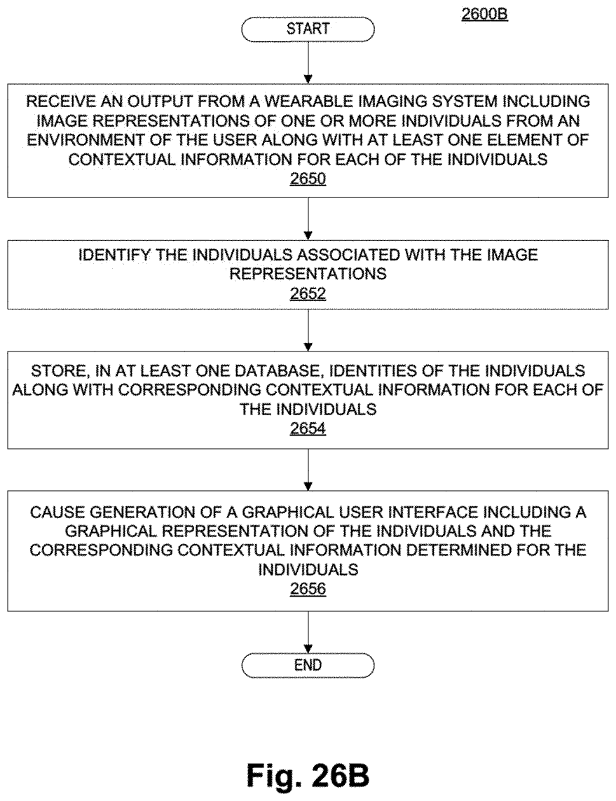

FIG. 26A is a flowchart showing an example process 2600A, consistent with the disclosed embodiments. Process 2600A may be performed by at least one processing device of a wearable apparatus, such as processor 220, as described above. In some embodiments, some or all of process 2600A may be performed by a different device, such as computing device 120. In some embodiments, a non-transitory computer readable medium may contain instructions that when executed by a processor cause the processor to perform process 2600A. Further, process 2600A is not necessarily limited to the steps shown in FIG. 26A, and any steps or processes of the various embodiments described throughout the present disclosure may also be included in process 2600A, including those described above with respect to FIGS. 24A and 24B.

In step 2610, process 2600A may include receiving a plurality of images captured from an environment of a user. For example, step 2610 may include receiving images including image 2400, as shown in FIG. 24A. The images may be captured by a camera or other image capture device, such as image sensor 220. Accordingly, the camera and at least one processor performing process 2600A may be included in a common housing configured to be worn by the user, such as wearable apparatus 110. In some embodiments, the system may further include a microphone included in the common housing. In some embodiments, the plurality of images may be part of a stream of images, such as a video signal. Accordingly, receiving the plurality of images may comprise receiving a stream of images including the plurality of images, the stream of images being captured at a predetermined rate.

In step 2612, process 2600A may include detecting one or more individuals represented by one or more of the plurality of images. For example, this may include detecting representations of individuals 2412, 2414, and 2416 from image 2400. As described throughout the present disclosure, this may include applying various object detection algorithms such as frame differencing, Statistically Effective Multi-scale Block Local Binary Pattern (SEMB-LBP), Hough transform, Histogram of Oriented Gradient (HOG), Single Shot Detector (SSD), a Convolutional Neural Network (CNN), or similar techniques.

In step 2614, process 2600A may include identifying at least one spatial characteristic related to each of the one or more individuals. As described in greater detail above, the spatial characteristic may include any information indicating a relative position or orientation of an individual. In some embodiments, the at least one spatial characteristic may be indicative of a relative distance between the user and each of the one or more individuals during encounters between the user and the one or more individuals. For example, this may be represented by spatial characteristic 2420 shown in FIG. 24A. Similarly, the at least one spatial characteristic is indicative of an angular orientation between the user and each of the one or more individuals during encounters between the user and the one or more individuals. In some embodiments, the at least one spatial characteristic may be indicative of relative locations between the one or more individuals during encounters between the user and the one or more individuals. In the example shown in image 2400, this may include the relative positions of individuals 2412, 2414, and 2416 within the environment of user 100. In some embodiments this may be in reference to an object in the environment. In other words, the at least one spatial characteristic may be indicative of an orientation of the one or more individuals relative to a detected object in the environment of the user during at least one encounter between the user and the one or more individuals. For example, the detected object may include a table, such as table 2402 as shown in FIG. 24A.

In step 2616, process 2600A may include generating an output including a representation of at least a face of each of the detected one or more individuals together with the at least one spatial characteristic identified for each of the one or more individuals. The output may be generated in various formats, as described in further detail above. For example, the output may be a table, array, list, or other data structure correlating the face of the detected individuals to the spatial characteristics. The output may include other information, such as a name of the individual, location information, time and/or date information, other identifying information, or any other information associated with the interaction.

In step 2618, process 2600A may include transmitting the generated output to at least one display system for causing a display to show to a user of the system a timeline view of interactions between the user and the one or more individuals. In some embodiments, the display may be included on a device configured to wirelessly link with a transmitter associated with the system. For example, the display may be included on computing device 120, or another device associated with user 100. In some embodiments, the device may include a display unit configured to be worn by the user. For example, the device may be a pair of smart glasses, a smart helmet, a heads-up-display, or another wearable device with a display. In some embodiments, the display may be included on wearable apparatus 110.

The timeline may be any form of graphical interface displaying elements in a chronological fashion. For example, step 2618 may include transmitting the output for display as shown in timeline view 2430. In some embodiments, the timeline view shown to the user may be interactive. For example, the timeline view maybe scrollable in time, as described above. Similarly, a user may be enabled to zoom in or out of the timeline and pan along various timeframes. The representations of each of the one or more individuals may be arranged on the timeline according to the identified at least one spatial characteristic associated with each of the one or more individuals. The representations of each of the one or more individuals may include at least one of face representations or textual name representations of the individuals. For example, this may include displaying representations 2442, 2444, and 2446 associated with individuals 2412, 2414, and 2416, as shown in FIG. 24B. As described in further detail above, the representations of the individuals may be interactive. For example, selecting a representation of a particular individual among the one or more individuals shown on the timeline may cause initiation of a communication session between the user and the particular individual, or other actions.

In some embodiments, the timeline view may also display keywords, phrases, or other content determined based on the interaction. For example, as described above, a system implementing process 2600A may include a microphone configured to capture sounds from the environment of the user and to output an audio signal. In these embodiments, process 2600A may further include detecting, based on analysis of the audio signal, at least one key word spoken by the user or by the one or more individuals and including in the generated output a representation of the detected at least one key word. In some embodiments, this may include storing the at least one key word in association with at least one characteristic selected from the speaker, a location of the user where the at least one key word was detected, a time when the at least one key word was detected, a subject related to the at least one key word. Process 2600A may further include transmitting the generated output to the at least one display system for causing the display to show to the user of the system the timeline view together with a representation of the detected at least one key word. For example, this may include displaying keyword element 2450, markers 2452, and/or pop-up 2456, as described above.

FIG. 26B is a flowchart showing an example process 2600B, consistent with the disclosed embodiments. Process 2600B may be performed by at least one processing device of a graphical interface system. In some embodiments, the graphical interface system may be configured to interface either directly or indirectly with a plurality of wearable apparatus devices, such as wearable apparatus 110. For example, the graphical interface system may be a remote server or other central computing device. In some embodiments the graphical interface system may be a device, such as computing device 120. In some embodiments, a non-transitory computer readable medium may contain instructions that when executed by a processor cause the processor to perform process 2600B. Further, process 2600B is not necessarily limited to the steps shown in FIG. 26B, and any steps or processes of the various embodiments described throughout the present disclosure may also be included in process 2600B, including those described above with respect to FIGS. 25A and 25B.

In step 2650, process 2600B may include receiving, via an interface, an output from a wearable imaging system including at least one camera. For example, this may include receiving an output from wearable apparatus 110. The output may include image representations of one or more individuals from an environment of the user along with at least one element of contextual information for each of the one or more individuals. For example, the output may include image 2400 including representations of individuals 2412, 2414, and 2416, as shown in FIG. 24A. As described further above, the contextual information may include any information about the individuals or interactions with or between the individuals. For example, the at least one element of contextual information for each of the one or more individuals may include one or more of: whether an interaction between the one or more individuals and the user was detected; a name associated with the one or more individuals; a time at which the user encountered the one or more individuals; a place where the user encountered the one or more individuals; an event associated with an interaction between the user and the one or more individuals; or a spatial relationship between the user and the one or more individuals. In some embodiments, the one or more individuals may include at least two individuals, and the at least one element of contextual information may indicate whether an interaction was detected between the at least two individuals.

In step 2652, process 2600B may include identifying the one or more individuals associated with the image representations. The individuals may be identified using any of the various methods described throughout the present disclosure. In some embodiments, the identity of the individuals may be determined based on analysis of the plurality of images. For example, identifying the one or more individuals may include comparing one or more characteristics of the individuals with stored information from at least one database. The characteristics may include facial features determined based on analysis of the plurality of images. For example, the characteristics may include a body shape or posture of the individual, particular gestures or mannerisms, skin tone, retinal patterns, distinguishing marks (e.g., moles, birth marks, freckles, scars, etc.), hand geometry, finger geometry, or any other distinguishing physical or biometric characteristics. In some embodiments, the characteristics include one or more voice features determined based on analysis of an audio signal provided by a microphone associated with the system. For example, process 2600B may further include receiving an audio signal output by a microphone configured to capture sounds from an environment of the user, and the identity of the individuals may be determined based on the audio signal.

In step 2654, process 2600B may include storing, in at least one database, identities of the one or more individuals along with corresponding contextual information for each of the one or more individuals. For example, this may include storing the identities in a data structure, such as data structure 1860, which may include contextual information associated with the individuals. In some embodiments, the system may also store information associated with unrecognized individuals. For example, step 2654 may include storing, in the at least one database, image representations of unidentified individuals along with the at least one element of contextual information for each of the unidentified individuals. As described further above, process 2600B may further include updating the at least one database with later-obtained identity information for one or more of the unidentified individuals included in the at least one database. The later-obtained identity information may be determined based on at least one of a user input, a spoken name captured by a microphone associated with the wearable imaging system, image matching analysis performed relative to one or more remote databases, or various other forms of supplemental information.

In step 2656, process 2600B may include causing generation on the display of a graphical user interface including a graphical representation of the one or more individuals and the corresponding contextual information determined for the one or more individuals. For example, the graphical user interface may display the one or more individuals in a network arrangement, such as network interface 2500, as shown in FIGS. 25A and 25B. The graphical representation of the one or more individuals may convey the at least one element of contextual information for each of the one or more individuals. For example, the at least one element of contextual information for each of the one or more individuals includes one or more of: a name associated with the one or more individuals; a time at which the user encountered the one or more individuals; a place where the user encountered the one or more individuals; an event associated with an interaction between the user and the one or more individuals; or a spatial relationship between the user and the one or more individuals.

In some embodiments, process 2600B may further include enabling user controlled navigation associated with the one or more individuals graphically represented by the graphical user interface, as described above. The user controlled navigation may include one or more of: scrolling in at least one direction relative to the network, changing an origin of the network from the user to one of the one or more individuals, zooming in or out relative to the network, or hiding selected portions of the network. Hiding of selected portions of the network may be based on one or more selected filters associated with the contextual information associated with the one or more individuals, as described above. In some embodiments, the network arrangement may be three-dimensional, and the user controlled navigation includes rotation of the network arrangement. In some embodiments, the graphical representation of the one or more individuals may be interactive. For example, process 2600B may further include receiving a selection of an individual among the one or more individuals graphically represented by the graphical user interface. Based on the selection, the processing device performing process 2600B may initiate a communication session relative to the selected individual, filter the network arrangement, change a view of the network arrangement, display information associated with the selection, or various other actions.

In some embodiments, process 2600B may include aggregating multiple social networks. While the term “social network” is used throughout the present disclosure, it is to be understood that this is not limiting to any particular context or type of relationship. For example, the social network may include personal contacts, professional contacts, family, or various other types of relationships. Process 2600B may include aggregate, based upon access to the one or more databases, at least a first social network associated with a first user with at least a second social network associated with a second user different from the first user. For example, this may include social networks associated with user 100 and individual 2412, as discussed above. Process 2600B may further include displaying to at least the first or second user a graphical representation of the aggregated social network. For example, the aggregated network may be displayed in network interface 2500 as shown in FIG. 25B. Accordingly, the graphical display of the aggregated social network identifies individual contacts associated with the first user, individual contacts associated with the second user, and individual contacts shared by the first and second users. In some embodiments, the graphical user interface may allow user controlled navigation relative to the graphical display of the aggregated social network, as described above.

Tagging Characteristics of an Interpersonal Encounter Based on Vocal Features

As described above, images and/or audio signals captured from within the environment of a user may be processed prior to presenting some or all of that information to the user. This processing may include identifying one or more characteristics of an interpersonal encounter of a user of the disclosed system with one or more individuals in the environment of the user. For example, the disclosed system may tag one or more audio signals associated with the one or more individuals with one or more predetermined categories. For example, the one or more predetermined categories may represent emotional states of the one or more individuals and may be based on one or mom voice characteristics. In some embodiments, the disclosed system may additionally or alternatively identify a context associated with the environment of the user. For example, the disclosed system may determine that the environment pertains to a social interaction or a workplace interaction. The disclosed system may associate the one or more individuals in the environment with a category and/or context. The disclosed system may provide the user with information regarding the individuals and/or their associations. In some embodiments, the user may also be provided with indicators in the form of charts or graphs to illustrate the frequency of an individual's emotional state in various contexts or an indication showing how the emotional state changed over time. It is contemplated that this additional information about the user's environment and/or the individuals present in that environment may help the user tailor the user's actions and/or speech during any interpersonal interaction with the identified individuals.

In some embodiments, user 100 may wear a wearable device, for example, apparatus 110 that is physically connected to a shirt or other piece of clothing of user 100, as shown. Consistent with the disclosed embodiments, apparatus 110 may be positioned in other locations, as described previously. For example, apparatus 110 may be physically connected to a necklace, a belt, glasses, a wrist strap, a button, etc. Additionally or alternatively apparatus 110 may be configured to send information such as audio, images, video, textual information, etc. to a paired device, such as computing device 120. As discussed above, computing device 120 may include, for example, a smartphone, a smartwatch, etc. Additionally or alternatively, apparatus 110 may be configured to communicate with and send information to an audio device such as a Bluetooth earphone, etc. In these embodiments, the additional information may be provided to the paired apparatus 110 instead of or in addition to providing the additional information to the hearing aid device.

As discussed above, apparatus 110 may be worn by user 100 in various configurations, including being physically connected to a shirt, necklace, a belt, glasses, a wrist strap, a button, or other articles associated with user 100. Accordingly, one or more of the processes or functions described herein with respect to apparatus 110 or processor 210 may be performed by computing device 120 and/or processor 540.

In some embodiments, the disclosed system may include a camera configured to capture images from an environment of a user and output an image signal. For example, as discussed above, apparatus 110 may comprise one or more image sensors such as image sensor 220 that may be part of a camera included in apparatus 110. It is contemplated that image sensor 220 may be associated with a variety of cameras, for example, a wide angle camera, a narrow angle camera, an IR camera, etc. In some embodiments, the camera may include a video camera. The one or more cameras may be configured to capture images from the surrounding environment of user 100 and output an image signal. For example, the one or more cameras may be configured to capture individual still images or a series of images in the form of a video. The one or more cameras may be configured to generate and output one or more image signals representative of the one or more captured images. In some embodiments, the image signal includes a video signal. For example, when image sensor 220 is associated with a video camera, the video camera may output a video signal representative of a series of images captured as a video image by the video camera.

In some embodiments the disclosed system may include a microphone configured to capture voices from an environment of the user and output an audio signal. As discussed above, apparatus 110 may also include one or more microphones to receive one or more sounds associated with the environment of user 100. For example, apparatus 110 may comprise microphones 443, 444, as described with respect to FIGS. 4F and 4G. Microphones 443 and 444 may be configured to obtain environmental sounds and voices of various speakers communicating with user 100 and output one or more audio signals. Microphones 443, 444 may comprise one or more directional microphones, a microphone array, a multi-port microphone, or the like. The microphones shown in FIGS. 4F and 4G are by way of example only, and any suitable number, configuration, or location of microphones may be used.

In some embodiments, the camera and the at least one microphone are each configured to be worn by the user. By way of example, user 100 may wear an apparatus 110 that may include a camera (e.g., image sensor system 220) and/or one or more microphones 443, 444 (See FIGS. 2, 3A, 4D, 4F, 4G). In some embodiments the camera and the microphone am included in a common housing. By way of example, as illustrated in FIGS. 4D, 4F, and 4G, the one or more image sensors 220 and microphones 443, 444 may be included in body 435 (common housing) of apparatus 110. In some embodiments, the common housing is configured to be worn by a user. For example, as illustrated in FIGS. 1B, 1C, 1D, 4C, and 9, user 100 may wear apparatus 110 that includes common housing or body 435 (see FIG. 4D). In some embodiments, at least one processor is included in the common housing. By way of example, as discussed above, apparatus 110 may include processor 210 (see FIG. 5A). As also discussed above, processor 210 may include any physical device having an electric circuit that performs a logic operation on input or inputs. For example, the processor may include one or more integrated circuits, microchips, microcontrollers, microprocessors, all or part of a central processing unit (CPU), graphics processing unit (GPU), digital signal processor (DSP), field-programmable gate array (FPGA), or other circuits suitable for executing instructions or performing logic operations.

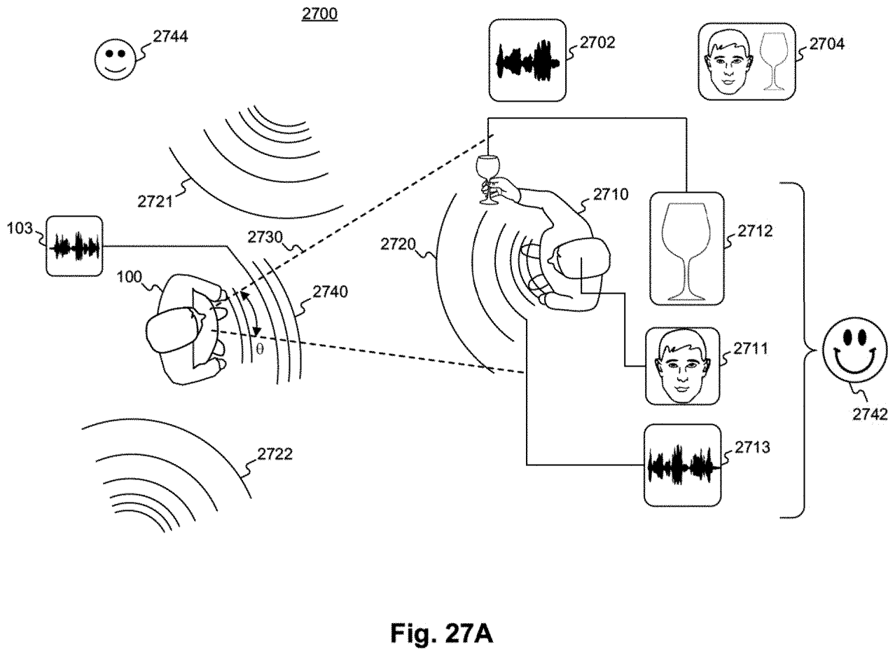

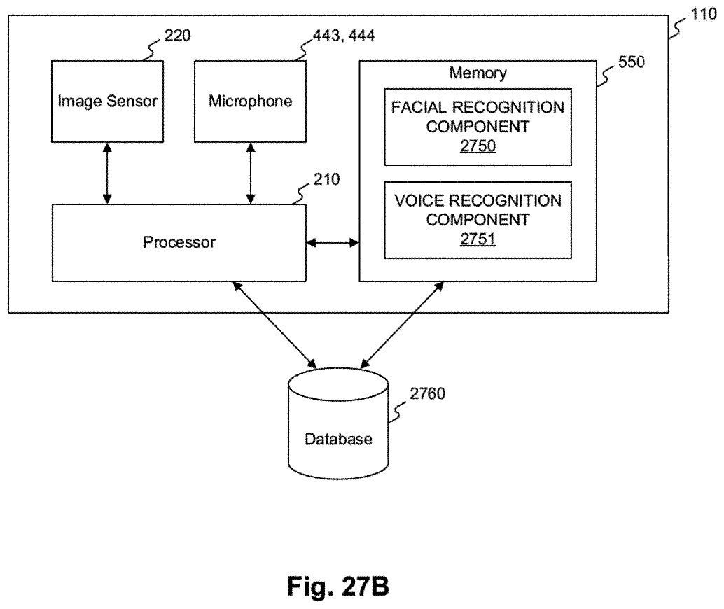

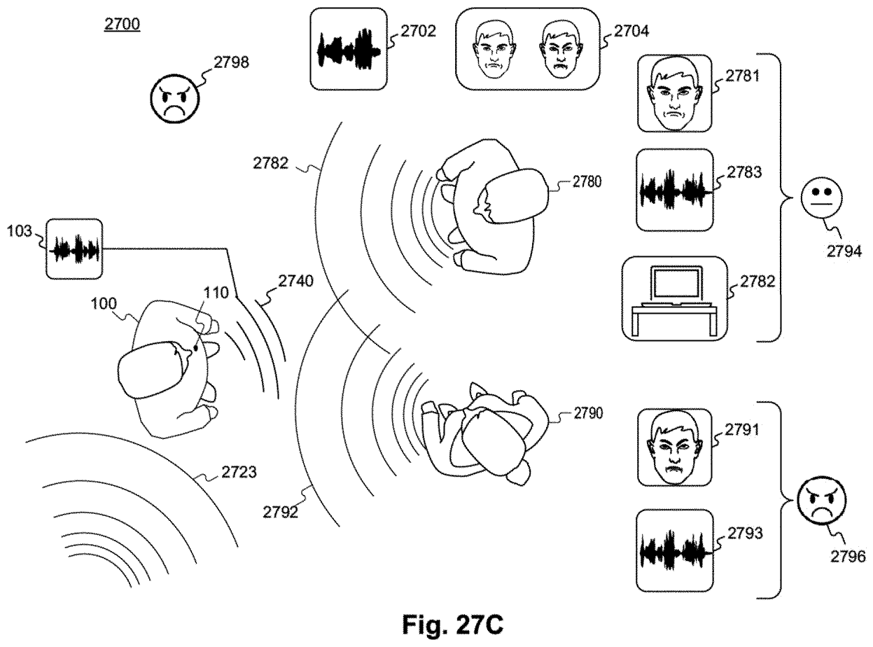

Apparatus 110 may be configured to recognize an individual in the environment of user 100. Recognizing an individual may include identifying the individual based on at least one of an image signal or an audio signal received by apparatus 110. FIG. 27A illustrates an exemplary environment 2700 of user 100 consistent with the present disclosure. As illustrated in FIG. 27A, environment 2700 may include individual 2710 and user 100 may be interacting with individual 2710, for example, speaking with individual 2710. Apparatus 110 may receive at least one audio signal 2702 generated by the one or more microphones 443, 444, and at least one image signal 2704 generated by the one or more image sensors 220 (i.e., one or more cameras).

As further illustrated in FIG. 27A, user 100 may be speaking and audio signal 2702 may include audio signal 101 representative of sound 2740, associated with user 100, captured by the one or more microphones 443, 444. Likewise, individual 2710 may be speaking and audio signal 2702 may include audio signal 2713 representative of sound 2720, associated with individual 2710, captured by the one or more microphones 443, 444. It is contemplated that audio signal 2702 may include audio signals representative of other sounds (e.g., 2721, 2722) in environment 2700. Similarly, the one or more cameras associated with apparatus 110 may generate an image signal 2704 that may include image signals representative of, for example, one or more faces and/or objects in environment 2700. For example, as illustrated in FIG. 27A, image signal 2704 may include image signal 2711 representative of a face of individual 2710. Inage signal 2704 may also include image signal 2712 representative of an image of a wine glass that individual 2710 may be holding.

Apparatus 110 may be configured to recognize a face or voice associated with individual 2710 within the environment of user 100. For example, apparatus 110 may be configured to capture one or more images of environment 2700 of user 100 using a camera associated with image sensor 220. The captured images may include a representation (e.g., image of a face) of a recognized individual 2710, who may be a friend, colleague, relative, or prior acquaintance of user 100. In one embodiment the disclosed system may include at least one processor programmed to execute a method comprising: identifying, based on at least one of the image signal or the audio signal, at least one individual speaker in a first environment of the user. For example, processor 210 (and/or processors 210a and 210b) may be configured to analyze the captured audio signal 2702 and/or image signal 2704 and detect a recognized individual 2710 using various facial recognition techniques. Accordingly, apparatus 110, or specifically memory 550, may comprise one or more facial or voice recognition components.

FIG. 27B illustrates an exemplary embodiment of apparatus 110 comprising facial and voice recognition components consistent with the present disclosure. Apparatus 110 is shown in FIG. 27B in a simplified form, and apparatus 110 may contain additional elements or may have alternative configurations, for example, as shown in FIGS. 5A-5C. Memory 550 (or 550a or 550b) may include facial recognition component 2750 and voice recognition component 2751. These components may be instead of or in addition to orientation identification module 601, orientation adjustment module 602, and motion tracking module 603 as shown in FIG. 6. Components 2750 and 2751 may contain software instructions for execution by at least one processing device, e.g., processor 210, included with a wearable apparatus. Components 2750 and 2751 are shown within memory 550 by way of example only, and may be located in other locations within the system. For example, components 2750 and 2751 may be located in a hearing aid device, in computing device 120, on a remote server, or in another associated device.

In some embodiments, identifying the at least one individual comprises recognizing a face of the at least one individual. For example, facial recognition component 2750 may be configured to identify one or more faces within the environment of user 100. By way of example, facial recognition component 2750 may identify facial features, such as the eyes, nose, cheekbones, jaw, or other features, on a face of individual 2710 as represented by image signal 2711. Facial recognition component 2750 may then analyze the relative size and position of these features to identify the user. Facial recognition component 2750 may use one or more algorithms for analyzing the detected features, such as principal component analysis (e.g., using eigenfaces), linear discriminant analysis, elastic bunch graph matching e.g., using Fisherface), Local Binary Patterns Histograms (LBPH), Scale Invariant Feature Transform (SIFT). Speed Up Robust Features (SURF), or the like. Other facial recognition techniques such as 3-Dimensional recognition, skin texture analysis, and/or thermal imaging may also be used to identify individuals. Other features besides facial features may also be used for identification, such as the height, body shape, posture, gestures or other distinguishing features of individual 2710.

Facial recognition component 2750 may access database 2760 or data associated with user 100 to determine if the detected facial features correspond to a recognized individual. For example, processor 210 may access a database 2760 containing information about individuals known to user 100 and data representing associated facial features or other identifying features. Such data may include one or more images of the individuals, or data representative of a face of the user that may be used for identification through facial recognition. Database 2760 may be any device capable of storing information about one or more individuals, and may include a hard drive, a solid state drive, a web storage platform, a remote server, or the like. Database 2760 may be located within apparatus 110 (e.g., within memory 550) or external to apparatus 110, as shown in FIG. 27B. In some embodiments, database 2760 may be associated with a social network platform, such as Facebook™, LinkedIn™, Instagram™, etc. Facial recognition component 2750 may also access a contact list of user 100, such as a contact list on the user's phone, a web-based contact list (e.g., through Outlook™, Skype™, Google™, SalesForce™, etc.) or a dedicated contact list associated with apparatus 110. In some embodiments, database 2760 may be compiled by apparatus 110 through previous facial recognition analysis. For example, processor 210 may be configured to store data associated with one or more faces recognized in images captured by apparatus 110 in database 2760. Each time a face is detected in the images, the detected facial features or other data may be compared to previously identified faces in database 2760. Facial recognition component 2750 may determine that an individual is a recognized individual of user 100 if the individual has previously been recognized by the system in a number of instances exceeding a certain threshold, if the individual has been explicitly introduced to apparatus 110, or the like.

In some embodiments, user 100 may have access to database 2750, such as through a web interface, an application on a mobile device, or through apparatus 110 or an associated device. For example, user 100 may be able to select which contacts are recognizable by apparatus 110 and/or delete or add certain contacts manually. In some embodiments, a user or administrator may be able to train facial recognition component 2750. For example, user 100 may have an option to confirm or reject identifications made by facial recognition component 2750, which may improve the accuracy of the system. This training may occur in real time, as individual 2710 is being recognized, or at some later time.

Other data or information may also be used in the facial identification process. In some embodiments, identifying the at least one individual may comprise recognizing a voice of the at least one individual. For example, processor 210 may use various techniques to recognize a voice of individual 2710, as described in further detail below. The recognized voice pattern and the detected facial features may be used, either alone or in combination, to determine that individual 2710 is recognized by apparatus 110.

Processor 210 may further be configured to determine whether individual 2710 is recognized by user 100 based on one or more detected audio characteristics of sound 2720 associated with individual 2710. Returning to FIG. 27A, processor 210 may determine that sound 2720 corresponds to a voice of user 2010. Processor 210 may analyze audio signals 2713 representative of sound 2720 captured by microphone 443 and/or 444 to determine whether individual 2710 is recognized by user 100. This may be performed using voice recognition component 2751 (FIG. 2713) and may include one or more voice recognition algorithms, such as Hidden Markov Models, Dynamic Time Warping, neural networks, or other techniques. Voice recognition component 2751 and/or processor 210 may access database 2760, which may further include a voiceprint of one or more individuals. Voice recognition component 2751 may analyze audio signal 2713 representative of sound 2720 to determine whether audio signal 2713 matches a voiceprint of an individual in database 2760. Accordingly, database 2760 may contain voiceprint data associated with a number of individuals, similar to the stored facial identification data described above. After determining a match, individual 2710 may be determined to be a recognized individual of user 100. This process may be used alone, or in conjunction with the facial recognition techniques described above. For example, individual 2710 may be recognized using facial recognition component 2750 and may be verified using voice recognition component 2751, or vice versa.

In some embodiments, apparatus 110 may further determine whether individual 2710 is speaking. For example, processor 210 may be configured to analyze images or videos containing representations of individual 2710 to determine when individual 2710 is speaking, for example, based on detected movement of the recognized individual's lips. This may also be determined through analysis of audio signals received by microphone 443, 444, for example based on audio signal 2713 associated with individual 2710.

In some embodiments, processor 210 may determine a region 2730 associated with individual 2710. Region 2730 may be associated with a direction of individual 2710 relative to apparatus 110 or user 100. The direction of individual 2710 may be determined using image sensor 220 and/or microphone 443, 444 using the methods described above. As shown in FIG. 27A, region 2730 may be defined by a cone or range of directions based on a determined direction of individual 2710. The range of angles may be defined by an angle, θ, as shown in FIG. 27A. The angle, θ, may be any suitable angle for defining a range for conditioning (e.g., amplifying or attenuating) sounds within the environment of user 100 (e.g., 10 degrees, 20 degrees, 45 degrees). Region 2730 may be dynamically calculated as the position of individual 2710 changes relative to apparatus 110. For example, as user 100 turns, or if individual 2710 moves within the environment, processor 210 may be configured to track individual 2710 within the environment and dynamically update region 2730. Region 2730 may be used for selective conditioning, for example by amplifying sounds associated with region 2730 and/or attenuating sounds determined to be emanating from outside of region 2730.

Although the above description discloses how processor 210 may identify an individual using the one or more images obtained via image sensor 220 or audio captured by microphone 443, 444, it is contemplated that processor 210 may additionally or alternatively identify one or more objects in the one or more images obtained by image sensor 220. For example, processor 210 may be configured to detect edges and/or surfaces associated with one or more objects in the one or more images obtained via image sensor 220. Processor 210 may use various algorithms including, for example, localization, image segmentation, edge detection, surface detection, feature extraction, etc., to detect one or more objects in the one or more images obtained via image sensor 220. It is contemplated that processor 210 may additionally or alternatively employ algorithms similar to those used for facial recognition to detect objects in the one or more images obtained via image sensor 220. In some embodiments, processor 210 may be configured to compare the one or more detected objects with images or information associated with a plurality of objects stored in, for example, database 2760. Processor 210 may be configured to identify the one or more detected objects based on the comparison. For example, processor 210 may identify objects such as a wine glass (FIG. 27A) based on image signal 2712. By way of another example, processor 210 may identify objects such as a desk, a chair, a computer, a telephone, seats in a movie theater, an animal, a plant or a tree, food items, etc. in the one or more images (represented by image signals 2704, 2711, 2712, etc.) obtained by camera 220. It is to be understood that this list of objects is non-limiting and processor 210 may be configured to identify other objects that may be encountered by user 100 in the user's environment.

In some embodiments, the at least one processor may be programmed to analyze the at least one audio signal to distinguish voices of two or more different speakers represented by the audio signal. For example, processor 210 may receive audio signal 2702 that may include audio signals 103, 2713, and/or other audio signals representative of sounds 2721, 2722. Processor 210 may have access to one or more voiceprints of individuals, identification of one or more speakers (e.g., user 100, individual 2710, etc.) in environment 2700 of user 100. In some embodiments, the at least one processor may be programmed to distinguishing a component of the audio signal representing a voice of the user, if present among the two or more speakers, from a component of the audio signal representing a voice of the at least one individual speaker. For example, processor 210 may compare a component (e.g. audio signal 2713) of audio signal 2702, with voiceprints stored in database 2760 to identify individual 2710 as being associated with audio signal 2713. Similarly, processor 210 may compare a component (e.g., audio signal 103) of audio signal 2702 with voiceprints stored in database 2760 to identify user 100 as being associated with audio signal 103. Having a speaker's voiceprint, and a high quality voiceprint in particular, may provide for fast and efficient way of separating user 100 and individual 2710 within environment 2700.

A high quality voice print may be collected, for example, when user 100 or individual 2710 speaks alone, preferably in a quiet environment. By having a voiceprint of one or more speakers, it may be possible to separate an ongoing voice signal almost in real time, e.g., with a minimal delay, using a sliding time window. The delay may be, for example 10 ms, 20 ms, 30 ms, 50 ms, 100 ms, or the like. Different time windows may be selected, depending on the quality of the voice print, on the quality of the captured audio, the difference in characteristics between the speaker and other speaker(s), the available processing resources, the required separation quality, or the like. In some embodiments, a voice print may be extracted from a segment of a conversation in which an individual (e.g., individual 2710) speaks alone, and then used for separating the individual's voice later in the conversation, whether the individual's voice is recognized or not.

Separating voices may be performed as follows: spectral features, also referred to as spectral attributes, spectral envelope, or spectrogram may be extracted from a clean audio of a single speaker and fed into a pre-trained first neural network, which generates or updates a signature of the speaker's voice based on the extracted features. The audio may be for example, of one second of a clean voice. The output signature may be a vector representing the speaker's voice, such that the distance between the vector and another vector extracted from the voice of the same speaker is typically smaller than the distance between the vector and a vector extracted from the voice of another speaker. The speaker's model may be pre-generated from a captured audio. Alternatively or additionally, the model may be generated after a segment of the audio in which only the speaker speaks, followed by another segment in which the speaker and another speaker (or background noise) is heard, and which it is required to separate.

Then, to separate the speaker's voice from additional speakers or background noise in a noisy audio, a second pre-trained neural network may receive the noisy audio and the speaker's signature, and output an audio (which may also be represented as attributes) of the voice of the speaker as extracted from the noisy audio, separated from the other speech or background noise. It will be appreciated that the same or additional neural networks may be used to separate the voices of multiple speakers. For example, if there are two possible speakers, two neural networks may be activated, each with models of the same noisy output and one of the two speakers. Alternatively, a neural network may receive voice signatures of two or more speakers, and output the voice of each of the speakers separately. Accordingly, the system may generate two or more different audio outputs, each comprising the speech of a respective speaker. In some embodiments, if separation is impossible, the input voice may only be cleaned from background noise.

By way of another example, FIG. 27C illustrates an exemplary environment 2700 of user 100 consistent with the present disclosure. As illustrated in FIG. 27C, environment 2700 may include user 100, individual 2780, and individual 2790, and user 100 may be interacting with one or both individuals 2780 and 2790. Although only two individuals 2780 and 2790 are illustrated in FIG. 27C, it is contemplated that environment 2700 may include any number of individuals. As illustrated in FIG. 27B, user 100 may be speaking and audio signal 2702 may include audio signal 103 representative of sound 2740, associated with user 100, captured by the one or more microphones 443, 444. Likewise, individual 2780 may be speaking and audio signal 2702 may include audio signal 2783 representative of sound 2782, associated with individual 2780, captured by the one or more microphones 443, 444. Individual 2790 may also be speaking and audio signal 2702 may include audio signal 2793 representative of sound 2792, associated with individual 2790, captured by the one or more microphones 443, 444. It is contemplated that audio signal 2702 may include audio signals representative of other sounds (e.g., 2723) in environment 2700. Similarly, the one or more cameras associated with apparatus 110 may generate an image signal 2704 that may include image signals representative of, for example, one or mom faces and/or objects in environment 2700. For example, as illustrated in FIG. 27A, image signal 2704 may include image signal 2781 representative of a face of individual 2780, image signal 2782 representative of an object in environment 2700, and image signal 2791 representative of a face of individual 2790.

As discussed above, having a speaker's voiceprint, and a high quality voiceprint in particular, may provide for fast and efficient way of separating user 100 and individuals 2780 and 2790 within environment 2700. In some embodiments, processor 210 may be configured to identify mom than one individual (e.g., 2780, 2790) in environment 2700. Processor 210 may employ one or more image recognition techniques discussed above to identify, for example, individuals 2780 and 2790 based on their respective faces as represented in image signals 2781 and 2791, respectively. In other embodiments, processor 210 may be configured to identify individuals 2780 and 2790 based on audio signals 2783 and 2793, respectively. Processor 210 may identify individuals 2780 and 2790 based on voiceprints associated with those individuals, which may be stored in database 2760.

In addition to recognizing voices of individuals speaking to user 100, the systems and methods described above may also be used to recognize the voice of user 100. For example, voice recognition unit 2751 may be configured to analyze audio signal 103 representative of sound 2740 collected from the user's environment 2700 to recognize a voice of user 100. Similar to the selective conditioning of the voice of recognized individuals, audio signal 103 associated with user 100 may be selectively conditioned. For example, sounds may be collected by microphone 443, 444, or by a microphone of another device, such as a mobile phone (or a device linked to a mobile phone). Audio signal 103 corresponding to a voice of user 100 may be selectively transmitted to a remote device, for example, by amplifying audio signal 103 of user 100 and/or attenuating or eliminating altogether sounds other than the user's voice. Accordingly, a voiceprint of one or more users 100 of apparatus 110 may be collected and/or stored to facilitate detection and/or isolation of the user's voice 2719, as described in further detail above. Thus, processor 210 may be configured to identify one or more of individuals 2710, 2780, and/or 2790 in environment 2700 based on one of or a combination of image processing or audio processing of the images and audio signals obtained from environment 2700. As also discussed above, processor 210 may be configured to separate and identify a voice of user 100 from the sounds received from environment 2700.

In some embodiments, identifying the at least one individual may comprise recognizing at least one of a posture, or a gesture of the at least one individual. By way of example, processor 210 may be configured to determine at least one posture of individual 2710, 2780, or 2790 in images corresponding to, for example, image signals 2711, 2781, or 2791, respectively. The at least one posture or gesture may be associated with the posture of a single hand of the user, of both hands of the user, of part of a single arm of the user, of parts of both arms of the user, of a single arm of the user, of both arms of the user, of the head of the user, of parts of the head of the user, of the torso of the user, of the entire body of the user, and so forth. A posture may be identified, for example, by analyzing one or more images for a known posture. For example, with respect to a hand, a known posture may include the position of a knuckle, the contour of a finger, the outline of the hand, or the like. By way of further example, with respect to the neck, a known posture may include the contour of the throat, the outline of a side of the neck, or the like. Processor 210 may also have a machine analysis algorithm incorporated such that a library of known postures is updated each time processor 210 identifies a posture in an image.

In some embodiments, one or more posture or gesture recognition algorithms may be used to identify a posture or gesture associated with, for example, individual 2710, 2780, or 2790. For example, processor 210 may use appearance based algorithms, template matching based algorithms, deformable templates based algorithms, skeletal based algorithms, 3D models based algorithms, detection based algorithms, active shapes bused algorithms, principal component analysis based algorithms, linear fingertip models based algorithms, causal analysis based algorithms, machine learning based algorithms, neural networks based algorithms, hidden Markov models based algorithms, vector analysis based algorithms, model free algorithms, indirect models algorithms, direct models algorithms, static recognition algorithms, dynamic recognition algorithms, and so forth.

Processor 210 may be configured to identify individual 2710, 2780, 2790 as a recognized individual 2710, 2780, or 2790, respectively based on the identified posture or gesture. For example, processor 210 may access information in database 2760 that associates known postures or gestures with a particular individual. By way of example, database 2760 may include information indicating that individual 2780 tilts their head to the right while speaking. Processor 210 may identify individual 2780 when it detects a posture showing a head tilted to the right in image signal 2702 while individual 2780 is speaking. By way of another example, database 2760 may associate a finger pointing gesture with individual 2710. Processor may identify individual 2710 when processor 210 detects a finger pointing gesture in an image, for example, in image signal 2702. It will be understood that processor 210 may identify one or more of individuals 2710, 2780, and/or 2790 based on other types of postures or gestures associated with the respective individuals.

In some embodiments, the at least one processor may be programmed to apply a voice classification model to classify at least a portion of the audio signal into one of a plurality of voice classifications based on at least one voice characteristic, the voice classifications denoting an emotional state of the individual speaker. Voice classification may be a way of classifying a person's voice into one or more of a plurality of categories that may be associated with an emotional state of the person. For example, a voice classification may categorize a voice as being loud, quiet, soft, happy, sad, aggressive, calm, singsong, sleepy, boring, commanding, shrill, etc. It is to be understood that this list of voice classifications is non-limiting and processor 210 may be configured to assign other voice classifications to the voices in the user's environment.

In one embodiment, processor 210 may be configured to classify at least a portion of the audio signal into one of the voice classifications. For example, processor 210 may be configured to classify a portion of audio signal 2702 into one of the voice classifications based on a voice classification model. The portion of audio signal 2702 may be one of audio signal 103 associated with a voice of user 100, audio signal 2713 associated with a voice of individual 2710, audio signal 2783 associated with a voice of individual 2780, or audio signal 2793 associated with a voice of individual 2790. In some embodiments, the voice classification model may include one or more voice classification rules. Processor 210 may be configured to use the one or more voice classification rules to classify, for example, one or more of audio signals 103, 2713, 2783, or 2793 into one or more classifications or categories. In one embodiment, the one or more voice classification rules may be stored in database 2760.

In some embodiments, applying the voice classification rule comprises applying the voice classification rule to the component of the audio signal representing the voice of the user. By way of example, process or 210 may be configured to use one or more voice classification rules to classify audio signal 103 representing the voice of user 100. In some embodiments, applying the voice classification rule comprises applying the voice classification rule to the component of the audio signal representing the voice of the at least one individual. By way of example, process or 210 may be configured to use one or more voice classification rules to classify audio signal 2713 representing the voice of individual 2710 in environment 2700 of user 100. By way of another example, process or 210 may be configured to use one or more voice classification rules to classify audio signal 2783 representing the voice of individual 2780 in environment 2700 of user 100. As yet another example, process or 210 may be configured to use one or more voice classification rules to classify audio signal 2793 representing the voice of individual 2790 in environment 2700 of user 100.

In some embodiments, a voice classification rule may relate one or more voice characteristics to the one or more classifications. In some embodiments, the one or more voice characteristics may include a pitch of the speaker's voice, a tone of the speaker's voice, a rate of speech of the speaker's voice, a volume of the speaker's voice, a center frequency of the speaker's voice, a frequency distribution of the speaker's voice, or a responsiveness of the speaker's voice. It is contemplated that the speaker's voice may represent a voice associated with user 100, or a voice associated with one of individuals 2710, 2780, 2790, or another individual present in environment 2700. Processor 210 may be configured to identify one or more voice characteristics such as pitch, tone, rate of speech, volume, a center frequency, a frequency distribution, or responsiveness of a voice of user 100, individuals 2710, 2780, 2790, present in environment 2700 by analyzing audio signals 103, 2713, 2783, and 2793, respectively. It is to be understood that the above-identified list of voice characteristics is non-limiting and processor 210 may be configured to determine other voice characteristics associated with the one or more voices in the user's environment

By way of example, a voice classification rule may assign a voice classification of “shrill” when the pitch of a speaker's voice is greater than a predetermined threshold pitch. By way of another example, a voice classification rule may assign a voice classification of “bubbly” or “excited” when the rate of speech of a speaker's voice exceeds a predetermined rate of speech. It is contemplated that many other types of voice classification rules may be constructed using the one or more voice characteristics.

In other embodiments, the one or more voice classification rules may be a result of training a machine learning algorithm or neural network on training examples. Examples of such machine learning algorithms may include support vector machines, Fisher's linear discriminant, nearest neighbor, k nearest neighbors, decision trees, random forests, neural networks, and so forth. By way of further example, the one or more voice classification rules may include one or more heuristic classification rules. By way of example, a set of training examples may include audio samples having, for example, identified voice characteristics and an associated classification. For example, the training example may include an audio sample having a voice with a high volume and a voice classification of “loud.” By way of another example, the training example may include an audio sample having a voice that alternately has a high volume and a low volume and a voice classification of “singsong.” It is contemplated that the machine learning algorithm may be trained to assign a voice classification based on these and other training examples. It is further contemplated that the trained machine learning algorithm may be configured to output a voice classification when presented with one or more voice characteristics as inputs. It is also contemplated that a trained neural network for assigning voice classifications may be a separate and distinct neural network or may be an integral part of the other neural networks discussed above.

In some embodiments, the at least one processor may be programmed to apply a context classification model to classify environment 2700 of the user into one of a plurality of contexts, based on information provided by at least one of the image signal, the audio signal, an external signal, or a calendar entry. For example, a context classification may classify environment 270M as social, workplace, religious, academic, sports, theater, party, friendly, hostile, tense, etc, based on a context classification model. It will be appreciated that the contexts are not necessarily mutual exclusive, and environment 2700 may be classified to two or more contexts, for example workplace and tense, it is to be understood that this list of context classifications is non-limiting and processor 210 may be configured to assign other context classifications to the user's environment.

In some embodiments, a context classification model may include one or more context classification rules. Processor 210 may be configured to determine a context classification based on one or more image signals associated with environment 2700, user 100, and/or one or more individuals 2710, 2780, 2790, etc. In some embodiments, the plurality of contexts include at least a work context and a social context. By way of example, processor 210 may classify a context of environment 2700 in FIG. 27A as “social” or “party” based on identifying wine glass associated with individual 2710 in image signal 2712. By way of another example, with reference to FIG. 27C, processor 210 may identify a work desk and/or computer terminal in image signal 2782 and may assign a context classification of “workplace.” to environment 2700 in FIG. 27C. It is contemplated that processor 210 may be configured to classify environment 2710 into any number of other contexts based on analysis of one or more image signals 2702, 2711, 2712, 2781, 2782, 2791, etc.

In some embodiments, processor 210 may be configured to determine a context classification based on a content of the one or more audio signals (e.g., 103, 2713, 2783, 2793, etc.). For example, processor 210 may perform speech analysis on the one or more audio signals and identify one or more words or phrases that may indicate a context for environment 2700. By way of example, if the one or more audio signals include words such as “project.” “meeting,” “deliverable,” etc., processor 210 may classify the context of environment 2700 as “workplace.” As another example, if the one or more audio signals include words such as “birthday,” “anniversary,” “dinner,” “party,” etc., processor 210 may classify the context of environment 2700 as “social.” As yet another example, if the one or more audio signals include words such as “movie” or “play,” processor 210 may classify the context of environment 2700 as “theater.”

In other embodiments, processor 210 may be configured to classify the context of environment 2700 based on external signals. For example, processor 210 may identify sounds associated with typing or ringing of phones in environment 2700 and may classify the context of environment 2700 as “workplace.” As another example, processor 210 may identify sounds associated with running water or birds chirping and classify the context of environment 2700 as “nature” or “outdoors.” Other signals may include for example, change in foreground or background lighting in one or more image signals 2702, 2711, 2712, 2781, 2782, 2791, etc., associated with environment 2700, the rate at which the one or more images change over time, or presence or absence of objects in the foreground or background of the one or more images. Processor 210 may use one or more of these other signals to classify environment 2700 into a context.

In some embodiments, processor 210 may determine a context for environment 2700 based on a calendar entry for one or more of user 100, and/or individuals 2710, 2780, 2790, etc. For example, processor 210 may identify user 100 and/or one or more of individuals 2710, 2780, 2790 based on one or more of audio signals 103, 2702, 2713, 2783, 2793, and or image signals 2704, 2711, 2781, 2791 as discussed above. Processor 210 may also access, for example, database 2760 to retrieve calendar information for user 100 and/or one or more of individuals 2710, 2780, 2790. In some embodiments, processor 210 may access one or more devices (e.g., phones, tablets, laptops, computers, etc.) associated with user 100 and/or one or more of individuals 2710, 2780, 2790 to retrieve the calendar information. Processor 210 may determine a context for environment 2700 based on a calendar entry associated with user 100 and/or one or more of individuals 2710, 2780, 2790. For example, if a calendar entry for user 100 indicates that user 100 is scheduled to attend a social event at a current time, processor 210 may classify environment 2700 of user 100 as “social.” Processor 210 may also be configured to determine the context based on calendar entries associated with more than one person (e.g., user 100 and/or individuals 2710, 2750, and/or 2760). By way of example, if calendar entries for user 100 and individual 2710 indicate that both are scheduled to attend the same meeting at a current time, processor 210 may classify environment 2700 in FIG. 27A, for example, as “workplace” or “meeting.”

Processor 210 may be configured to use one or more context classification rules, or models or algorithms (collectively referred to as “models”) to classify environment 2700 into one or more context classifications or categories, in one embodiment, the one or more context classification models may be stored in database 2760 and may relate one or more sounds, images, objects in images, foreground or background colors or lighting in images, rate of change of images or movement in images, characteristics of audio in the one or more audio samples (e.g., pitch, volume, amplitude, frequency, etc.), calendar entries, etc. to one or more contexts.

In some embodiments, the context classification model is based on or uses at least one of: a neural network or a machine learning algorithm trained on one or more training examples. By way of example, the one or more context classification models may be a result of training a machine or neural network on training examples. Examples of such machines may include support vector machines, Fisher's linear discriminant, nearest neighbor, k nearest neighbors, decision trees, random forests, neural networks, and so forth. By way of further example, the one or more context classification models may include one or more heuristic classification models.

By way of example, a set of training examples may include a set of audio samples and/or images having, for example, an associated context classification. For example, the training example may include an audio sample including speech related to a project or a meeting and an associated context classification of “workplace.” As another example the audio sample may include speech related to birthday or anniversary and an associated context classification of “social.” By way of another example, the training example may include an image of an office desk, whiteboard, or computer and an associated context classification of “workplace.” It is contemplated that the machine learning model may be trained to assign a context classification based on these and other training examples. It is further contemplated that the trained machine learning model may be configured to output a context classification when presented with one or more audio signals, image signals, external signals, or calendar entries. It is also contemplated that a trained neural network for assigning context classifications may be a separate and distinct neural network or may be an integral part of the other neural networks discussed above.

In some embodiments, the at least one processor may be programmed to apply an image classification model to classify at least a portion of the image signal representing at least one of the user, or the at least one individual, into one of a plurality of image classifications based on at least one image characteristic. Image classification may be a way of classifying the image into one or more of a plurality of categories. In some embodiments, the categories may be associated with an emotional state of the person. For example, an image classification may include identifying whether the image includes people, animals, trees, or objects. By way of another example, an image classification may include a type of activity shown in the image, for example, sports, hunting, shopping, driving, swimming, etc. As another example, an image classification may include determining whether user 100 or individual 2710, 2750, or 2760 in the image is happy, sad, angry, bored, excited, aggressive, etc. It is to be understood that the exemplary image classifications discussed above are non-limiting and non-mutual and processor 210 may be configured to assign other image classifications to an image signal associated with user 100 or individual 2710, 2750, or 2760.

In one embodiment, processor 210 may be configured to classify at least a portion of the image signal into one of the image classifications. For example, processor 210 may be configured to classify a portion of image signal 2704 into one of the image classifications. The portion of image signal 2704 may include, for example, image signal 2711 or 2712 associated with individual 2710, image signal 2781 or 2782 associated with individual 2780, or image signal 2791 associated with individual 2790. Processor 210 may be configured to use one or more image classification rules to classify, for example, image signals 2711, 2712, 2781, 2782, 2791, etc. into one or more image classifications or categories. In one embodiment, the one or more image classification rules may be stored in database 2760.

In some embodiments, an image classification model may include one or more image classification rules. An image classification rule may relate one or more image characteristics to the one or more classifications. By way of example, the one or more image characteristics may include, a facial expression of the speaker, a posture of the speaker, a movement of the speaker, an activity of the speaker, or an image temperature of the speaker. It is contemplated that the speaker may represent user 100, or one of individuals 2710, 2780, 2790, or another individual present in environment 2700. It is to be understood that the above-identified list of image characteristics is non-limiting and processor 210 may be configured to determine other image characteristics associated with the one or more voices in the user's environment

By way of an example, an image classification rule may assign an image classification of “happy” when the facial expression indicates, for example, a “smile.” As another example, an image classification rule may assign an image classification of “exercise” when an activity or movement of for example individual 2710, 2780, 2790 in image signals 2711, 2781, 2791, respectively, relates to running, lifting weights, etc. In some embodiments, processor 210 may assign an image classification based on the image temperature (or color temperature) of the images represented by image signals 2711, 2781, or 2791. For example, a low color temperature may indicate bright fluorescent lighting and processor 2710 may assign an image classification of “indoor lighting.” As another example, a high color temperature may indicate a clear blue sky and processor 2710 may assign an image classification of “outdoor” or “nature.” It is contemplated that many other types of image classification rules may be constructed using the one or more image characteristics.

In other embodiments, the one or more image classification rules may be a result of training a machine learning model or neural network on training examples. Examples of such machines may include support vector machines. Fisher's linear discriminant, nearest neighbor, k nearest neighbors, decision trees, random forests, neural networks, and so forth. By way of further example, the one or more image classification models may include one or more heuristic classification models. By way of example, a set of training examples may include images having, for example, identified image characteristics and an associated classification. For example, the training example may include an image showing a face having a sad facial expression and an associated image classification of “sad.” By way of another example, the training example may include an image of a puppy and an image classification of “pet” or “animal.” it is contemplated that the machine learning algorithm may be trained to assign an image classification based on these and other training examples. It is further contemplated that the trained machine learning algorithm may be configured to output an image classification when presented with one or more image characteristics as inputs. It is also contemplated that a trained neural network for assigning image classifications may be a separate and distinct neural network or may be an integral part of the other neural networks discussed above.

In some embodiments, the at least one processor may be programmed to determining an emotional situation within an interaction between the user and the individual speaker. For example, processor 210 may determine an emotional situation for a particular interaction of user 100 with, for example, one or more of individuals 2710, 2780, 2790, etc. An emotional situation may include, for example, classifying the interaction as happy, sad, angry, boring, normal, etc. 11 is to be understood that this list of emotional situations is non-limiting and processor 210 may be configured to identify other emotional situations that may be encountered by user 100 in the user's environment. Processor 210 may be configured to use one or more rules to classify, for example, an interaction between user 100 and individual 2710 into one or more classifications or categories. In one embodiment, the one or more rules may be stored in database 2760. By way of example, processor 210 may classify the interaction between user 100 and individual 2710 in FIG. 27A as a happy situation 2744 based on a happy voice and/or image classification 2742 for individual 2710 and a “social” context classification for environment 2700. By way of another example, processor 210 may classify the interaction between user 100 and individuals 2780 and 2790 in FIG. 27C as an angry or tense emotional situation 2798 based on a “serious” or “angry” voice or image classification 2794 or 2796, associated with individuals 2780 or 2790, respectively, and a “workplace” context classification for environment 2700. It is to be noted that processor 210 may employ numerous other and different rules to classify an interaction between user 100 and one or more of individuals 2710, 2780, and/or 2790 based on image and/or voice classifications associated with individuals 2710, 2780, and/or 2790, respectively, and/or context classifications associated with environment 2700.

In other embodiments, the one or more rules for classifying an interaction may be a result of training a machine learning model or neural network on training examples. Examples of such machines may include support vector machines. Fisher's linear discriminant, nearest neighbor, k nearest neighbors, decision trees, random forests, neural networks, and so forth. By way of further example, the one or more models may include one or more heuristic classification models. By way of example, a set of training examples may include audio samples having, for example, identified voice characteristics and an associated voice classification, image samples having, for example, image characteristics and an associated image classification, and/or environments having, for example, associated context classifications.

In some embodiments, the at least one processor may be programmed to avoid transcribing the interaction, thereby maintaining privacy of the user and the individual speaker. For example, apparatus 110 and or processor 210 may be configured not to record or store one or more of audio signals 103, 2713, 2783, and/or 2793 or one or more of image signals 2711, 2712, 2781, 2782, 2791. Further, as discussed above, processor 210 may identify one or more words or phrases in the one or more audio signals 103, 2713, 2783, and/or 2793. In some embodiments, processor 210 may be configured not to record or store the identified words or phrases or any portion of speech included in the one or more audio signals 103, 2713, 2783, and/or 2793. Processor 210 may be configured to avoid storing information related to the image or audio signals associated with user 100 and/or one or more of individuals 2710, 2780, and/or 2790 to maintain privacy of user 100 and/or one or more of individuals 2710, 2780, and/or 2790.

In some embodiments, the at least one processor may be programmed to associate, in at least one database, the at least one individual speaker with one or more of a voice classification, an image classification, and/or a context classification of the first environment. For example, processor 210 may store a voice classification assigned to audio signal 2713, an image classification assigned to image signal 2711, and a context classification assigned to environment 2700 in association with individual 2710 in database 2760. In one embodiment, processor 210 may store an identifier of individual 2710 (e.g., name, address, phone number, employee id, etc.) and one or more of the image, voice, and/or context classifications in a record in, for example, database 2760. Additionally or alternatively, processor 210 may store one or more links between the identifier of individual 2710 and the image, voice, and/or context classifications in database 2760. It is contemplated that processor may associate individual 2710 with one or more image, voice and/or context classifications in database 2760 using other ways of associating or correlating information. Although an association between individual 2710 and image/voice/context classifications is described above, it is contemplated that processor 210 may be configured to store associations between user 100 and/or one or more number of other individuals 2710, 2780, 2790, etc. with one or more image, voice, and/or context classifications in database 2760.

In some embodiments, the at least one processor may be programmed to provide, to the user, at least one of an audible, visible, or tactile indication of the association. By way of example, processor 210 may control feedback outputting unit 230 to provide an indication to user 100 regarding the association between one or more individuals 2710, 2780, 2790 and any associated voice, image, or context classifications. In some embodiments, providing an indication of the association comprises providing the indication via a secondary computing device. For example, as discussed above, feedback outputting unit 230 may include one or more systems for providing the indication to user 100. In the disclosed embodiments, the audible or visual indication may be provided via any type of connected audible or visual system or both. It is contemplated that the connected audible or visual system may be embodied in a secondary computing device. In some embodiments, the secondary computing device comprises at least one of: a mobile device, a smartphone, a laptop computer, a desktop computer, a smart speaker, an in-home entertainment system, or an in-vehicle entertainment system. For example, audible indication may be provided to user 100 using a Bluetooth™ or other wired or wirelessly connected speaker, a smart speaker, an in-home or in-vehicle entertainment system, or a bone conduction headphone. Feedback outputting unit 230 of some embodiments may additionally or alternatively produce a visible output of the indication to user 100, for example, as part of an augmented reality display projected onto a lens of glasses 130 or provided via a separate heads up display in communication with apparatus 110, such as a display 260. For example, display 260 for providing a visual indication may be provided as part of computing device 120, which may include an onboard automobile heads up display, an augmented reality device, a virtual reality device, a smartphone, a laptop, a desktop computer, tablet, etc. In some embodiments, feedback outputting unit 230 may include interfaces that provide tactile cues, vibrotactile stimulators, etc. for providing the indication to user 100. As also discussed above, in some embodiments, the secondary computing device (e.g., Bluetooth headphone, laptop, desktop computer, smartphone, etc.) is configured to be wirelessly linked to apparatus 110 including the camera and the microphone.

In some embodiments, providing an indication of the association comprises providing at least one of a first entry of the association, a last entry of the association, a frequency of the association, a time-series graph of the association, a context classification of the association, or a voice classification of the association. By way of example, the indication may refer to a first entry in database 2760 relating an individual (e.g., 2710, 2780, or 2790, etc.) with a voice classification and/or a context classification. For example, the first entry may identify individual 2710 as having a voice classification of “happy” in a context classification of “social.” By way of another example, the first entry for individual 2780 may identify individual 2780 as having a voice classification of “serious” in a context classification of “workplace.” It is contemplated that processor 210 may be configured to instead provide a last or the latest entry relating one or more of individuals 2710, 2780, 2790 with a voice and/or context classification. It is also contemplated that the indication may include only the voice classification, only the context classification, or both associated with one or more of individuals 2710, 2780, 2790.

In some exemplary embodiments, processor 210 may be configured to provide a time-series graph showing how the voice and or context classifications for an individual 2710 have changed over time. Processor 210 may be configured to retrieve association data for an individual (e.g., 2710, 2780, 2790) from database 2760 and employ one or more graphing algorithms to prepare the time-series graph. In some exemplary embodiments, processor 210 may be configured to provide an illustration showing a frequency of various voice and/or context classifications associated with an individual 2710 have changed over time. By way of example, processor 210 may display a number of times individual 2710 had a “happy,” “sad,” or “angry” voice classification. Processor 210 may be further configured to display, for example, how many times individual 2710 had a happy voice classification in one or more of context classifications “workplace,” “social,” etc. It is contemplated that processor 210 may be configured to provide these indications for one or more of individuals (e.g., 2710, 2780, 2790) concurrently, sequentially, or in any order selected by user 100.

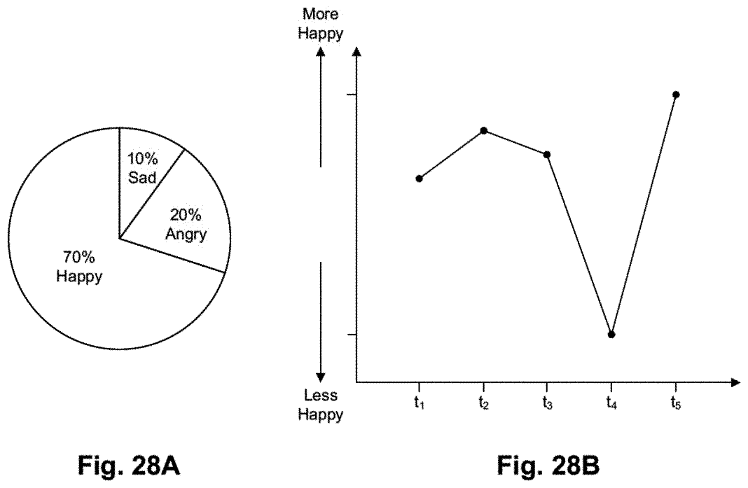

In some embodiments, providing an indication of the association comprises showing, on a display, at least one of: a bar chart, a pie chart, a histogram, a Venn diagram, a gauge, a heat map, or a color intensity indicator. For example, processor 210 may be configured to display associations between one or more of individuals 2710, 2780, 2790 and one or more voice/context classifications using various graphical techniques such as line graphs, bar chart, pie charts, histograms, or Venn diagrams. By way of example. FIG. 28A illustrates a pie chart showing, for example, voice classifications associated with individual 2710 (or 2780 or 2790). As illustrated in FIG. 28A, the pie chart shows, for example, that individual 2710 has a happy voice classification 70% of the time, a sad voice classification 10% of the time, and an angry voice classification 20% of the time. User 100 may use the information in the pie chart to tailor user 100's interaction with, for example, individual 2710. Although FIG. 28A has been described as discussing voice classifications, it is contemplated that processor 210 may be configured to generate a pie chart using image classifications, or illustrating the % of time individual 2710 is associated with, for example a “workplace” context, a “social” context, an “outdoors” context etc.

By way of another example, FIG. 28B illustrates a time-series graph showing, for example, a variation of a voice classification of, for example, individual 2710 over time. As shown in FIG. 28B, the abscissa axis represents times t₁, t₂, t₃, t₄, t₅, etc. and the ordinate axis includes a representation of voice classification. For example, the voice classification is increasingly happy along an increasing ordinate and increasingly sad along the decreasing ordinate axis. The time-series chart illustrates that individual 2710 had a generally happy voice classification initially, followed by sudden and large variations in the individuals voice classifications. User 100 may be able to use this information to tailor user 100's interaction with individual 2710 by recognizing, for example, that some recent events may have caused the sudden changes in the voice classifications of individual 2710.

It is also contemplated that in some embodiment, processor 210 may instead generate a heat map or color intensity map, with brighter hues and intensities representing a higher level or degree of a voice classification (e.g., a degree of happiness). For example, processor 210 may display a correlation between voice classifications and context classifications for an individual using a heat map. As one example, the heat map may illustrate areas of high intensity or bright hues associated with a voice classification of “happy” and a context classification of “social,” whereas lower intensities or dull hues may be present in areas of the map associated with a voice classification of “serious” and a context classification of “workplace.” it is to be noted that processor 210 may generate heat maps or color intensity maps showing only one or more voice classifications, only one or more image classifications, only one or more context classifications, or correlations between one or more voice, image, and/or context classifications.

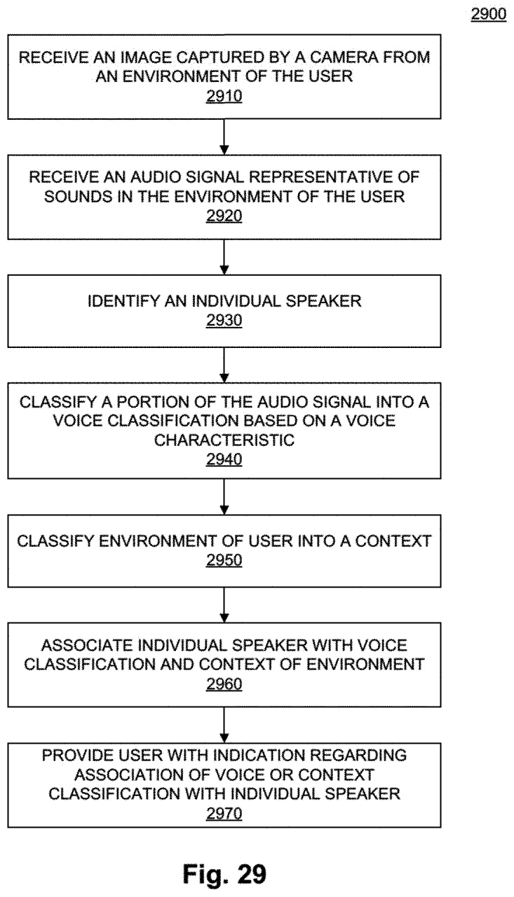

FIG. 29 is a flowchart showing an exemplary process 2900 for selectively tagging an interaction between a user and one or more individuals. Process 2900 may be performed by one or more processors associated with apparatus 110, such as processor 210. The processor(s) may be included in the same common housing as microphone 443, 444 and image sensor 220 (camera), which may also be used for process 2900. In some embodiments, some or all of process 2900 may be performed on processors external to apparatus 110, which may be included in a second housing. For example, one or more portions of process 2900 may be performed by processors in hearing aid device 230, or in an auxiliary device, such as computing device 120. In such embodiments, the processor may be configured to receive the captured images via a wireless link between a transmitter in the common housing and receiver in the second housing.

In step 2910, process 2900 may include receiving one or more images captured by a camera from an environment of a user. For example, the image may be captured by a wearable camera such as a camera including image sensor 220 of apparatus 110. In step 2920, process 2900 may include receiving one or more audio signals representative of the sounds captured by a microphone from the environment of the user. For example, microphones 443, 444 may capture one or more of sounds 2720, 2721, 2722, 2782, 2792, etc., from environment 2700 of user 100.

In step 2930, process 2900 may include identifying an individual speaker. In some embodiments, processor 210 may be configured to identify individuals, for example, individuals 2710, 2780, 2790 based on image signals 2702, 2711, 2781, 2791 etc. The individual may be identified using various image detection algorithms, such as Haar cascade, histograms of oriented gradients (HOG), deep convolution neural networks (CNN), scale-invariant feature transform (SIFT), or the like as discussed above. In step 2930, process 2900 may additionally or alternatively include identifying an individual, based on analysis of the sounds captured by the microphone. For example, processor 210 may identify audio signals 103, 2713, 2783, 2793 associated with, for example, sounds 2740, 2720, 2782, 2792, respectively, representing the voice of user 100 or individuals 2710, 2780, 2790. Processor 210 may analyze the sounds received from microphones 443, 444 to separate voices of user 100 and/or one or more of individuals 2710, 2780, 2790, and/or background noises using any currently known or future developed techniques or algorithms. In some embodiments, processor 210 may perform further analysis on one or more of audio signals 103, 2713, 2783, and/or 2793, for example, by determining the identity of user 100 and/or individuals 2710, 2780, 2790 using available voiceprints thereof. Alternatively, or additionally, processor 210 may use speech recognition tools or algorithms to recognize the speech of the individuals.

In step 2940, process 2900 may include classifying a portion of the audio signal into a voice classification based on a voice characteristic. In step 2940, processor 210 may identify audio signals 103, 2713, 2783, and/or 2793 from audio signal 2702, where each of audio signals 103, 2713, 2783, and/or 2793 may be a portion of audio signal 2702. Processor 210 may identify one or more voice characteristics associated with the one or more audio signals 103, 2713, 2783, and/or 2793. For example, processor 210 may determine one or more of a pitch, a tone, a rate of speech, a volume, a center frequency, a frequency distribution, responsiveness, etc., of the one or more audio signals 103, 2713, 2783, and/or 2793. Processor 210 may also use one of more voice classification rules, models, and or trained machine learning models or neural networks to classify the one or more audio signals 103, 2713, 2783, and/or 2793 with a voice classification. By way of example, voice classifications may include classifications such as loud, quiet, soft, happy, sad, aggressive, calm, singsong, sleepy, boring, commanding, shrill, etc. Processor 210 may employ one or more techniques discussed above to determine a voice classification for the one or more audio signals received from environment 2700. It is contemplated that once an individual has been identified, additional voice classifications may be associated with the identified individual. These additional classifications may be determined based on audio signals obtained during previous interactions of the individual with user 100 even though the individual may not have been identified or recognized during the previous interactions. Thus, retroactive assignment of voice classification may also be provided.

In step 2950, process 2900 may include classifying an environment of the user into a context. In step 2950, processor may rely on one or mom context classification rules, models, machine learning models, and/or neural networks to classify environment 2700 of user 100 into a context classification. By way of example, processor 210 may determine the context classification based on an analysis of one or more image and audio signals discussed above. The context classifications for the environment may include, for example, social, workplace, religious, academic, sports, theater, party, friendly, hostile, tense, etc. Processor 210 may employ one or more techniques discussed above to determine a context for environment 2700.

In step 2960, process 2900 may include associating an individual speaker with voice classification and context classification of the user's environment. In step 2960, processor 210 may be configured to store in database 2760 an identity of the one or more individuals 2710, 2780, and/or 2790 in association with a voice classification, an image classification, and/or a context classification according to one or more techniques described above.

In step 2970, process 2900 may include providing to the user at least one of an audible, visible, or tactile indication of the association. In step 2970, processor 210 may be configured to control feedback outputting unit 230 to provide an indication to user 100 regarding the association between one or more individuals 2710, 2780, 2790 and any associated image, voice, or context classifications. Thus, for example, processor 210 may provide an audible indication sing a Bluetooth™, or other wired or wirelessly connected speaker, a smart speaker, an in-home or in-vehicle entertainment system, or a bone conduction headphone. Additionally or alternatively, processor 210 may provide a visual indication by displaying the image, voice, and/or context classifications on a secondary computing device such as an onboard automobile heads up display, an augmented reality device, a virtual reality device, a smartphone, a laptop, a desktop computer, tablet, etc. It is also contemplated that in some embodiments, processor 210 may provide information regarding the voice, image, and/or context classifications using interfaces that provide tactile cues, and/or vibrotactile stimulators.

Variable Image Capturing Based on Vocal Context

As described above, images and/or audio signals may be captured from within the environment of a user. The amount and/or quality of image information captured from the environment may be adjusted based on context determined from the audio signals. For example, the disclosed system may identify a vocal component in the audio signals captured from the environment and determine one or more characteristics of the vocal component. One or more settings of a camera configured to capture the images from the user's environment may be adjusted based on the one or more characteristics. By way of example, a vocal context, such as one or more keywords detected in the audio signal, may trigger a higher frame rate on the camera. As another example, an excited tone (e.g., having a high rate of speech) may trigger the frame rate to increase. The disclosed system may estimate the importance of the conversation and change the amount of data collection based on the estimated importance.

In some embodiments, user 100 may wear a wearable device, for example, apparatus 110 that is physically connected to a shirt or other piece of clothing of user 100. Consistent with the disclosed embodiments, apparatus 110 may be positioned in other locations, as described previously. For example, apparatus 110 may be physically connected to a necklace, a belt, glasses, a wrist strap, a button, etc. Additionally or alternatively apparatus 110 may be configured to send information such as audio, images, video, textual information, etc. to a paired device, such as computing device 120. As discussed above, computing device 120 may include, for example, a laptop computer, a desktop computer, a tablet, a smartphone, a smartwatch, etc. Additionally or alternatively, apparatus 110 may be configured to communicate with and send information to an audio device such as a Bluetooth earphone, etc.

As discussed above, apparatus 110 may be worn by user 100 in various configurations, including being physically connected to a shirt, necklace, a belt, glasses, a wrist strap, a button, or other articles associated with user 100. Accordingly, one or more of the processes or functions described herein with respect to apparatus 110 or processor 210 may be performed by computing device 120 and/or processor 540.

In some embodiments, the disclosed system may include a camera configured to capture a plurality of images from an environment of a user. For example, as discussed above, apparatus 110 may comprise one or more image sensors such as image sensor 220 that may be part of a camera included in apparatus 110. It is contemplated that image sensor 220 may be associated with different types of cameras, for example, a wide angle camera, a narrow angle camera, an IR camera, etc. In some embodiments, the camera may include a video camera. The one or more cameras may be configured to capture images from the surrounding environment of user 100 and output an image signal. For example, the one or more cameras may be configured to capture individual still images or a series of images in the form of a video. The one or more cameras may be configured to generate and output one or more image signals representative of the one or more captured images. In some embodiments, the image signal includes a video signal. For example, when image sensor 220 is associated with a video camera, the video camera may output a video signal representative of a series of images captured as a video image by the video camera.

In some embodiments the disclosed system may include a microphone configured to capture sounds from the environment of the user. As discussed above, apparatus 110 may include one or more microphones to receive one or more sounds associated with the environment of user 100. For example, apparatus 110 may comprise microphones 443, 444, as described with respect to FIGS. 4F and 4G. Microphones 443 and 444 may be configured to obtain environmental sounds and voices of various speakers communicating with user 100 and output one or more audio signals. Microphones 443, 444 may comprise one or more directional microphones, a microphone array, a multi-port microphone, or the like. The microphones shown in FIGS. 4F and 4G are by way of example only, and any suitable number, configuration, or location of microphones may be used.

In some embodiments, the disclosed system may include a communication device configured to transmit an audio signal representative of the sounds captured by the microphone. In some embodiments, wearable apparatus 110 (e.g., a communications device) may include an audio sensor 1710, which may be any device capable of converting sounds captured from an environment by microphone 443, 444 to one or more audio signals. By way of example, audio sensor 1710 may comprise a sensor (e.g., a pressure sensor), which may encode pressure differences as an audio signal. Other types of audio sensors capable of converting the captured sounds to one or more audio signals are also contemplated.

In some embodiments, the camera and the microphone may be included in a common housing configured to be worn by the user. By way of example, user 100 may wear an apparatus 110 that may include a camera (e.g., image sensor system 220) and/or one or more microphones 443, 444 (See FIGS. 2, 3A, 4D, 4F, 4G). In some embodiments the camera and the microphone may be included in a common housing. By way of example, as illustrated in FIGS. 4D, 4F, and 4G, the one or more image sensors 220 and microphones 443, 444 may be included in body 435 (common housing) of apparatus 110. As illustrated in FIGS. 1B, 1C, 1D, 4C, and 9, user 100 may wear apparatus 110 that includes common housing or body 435 (see FIG. 4D). In some embodiments, the communications device and at least one processor are included in the common housing. By way of example, as discussed above, apparatus 110 may include processor 210 (see FIG. 5A). As also discussed above, processor 210 may include any physical device having an electric circuit that performs a logic operation on input or inputs. For example, the processor may include one or more integrated circuits, microchips, microcontrollers, microprocessors, all or pan of a central processing unit (CPU), graphics processing unit (GPU), digital signal processor (DSP), field-programmable gate array (FPGA), or other circuits suitable for executing instructions or performing logic operations. As also discussed above, apparatus 110 (communication device) may include audio sensor 1710, which may also be included in a common housing of apparatus 110 together with processor 210.

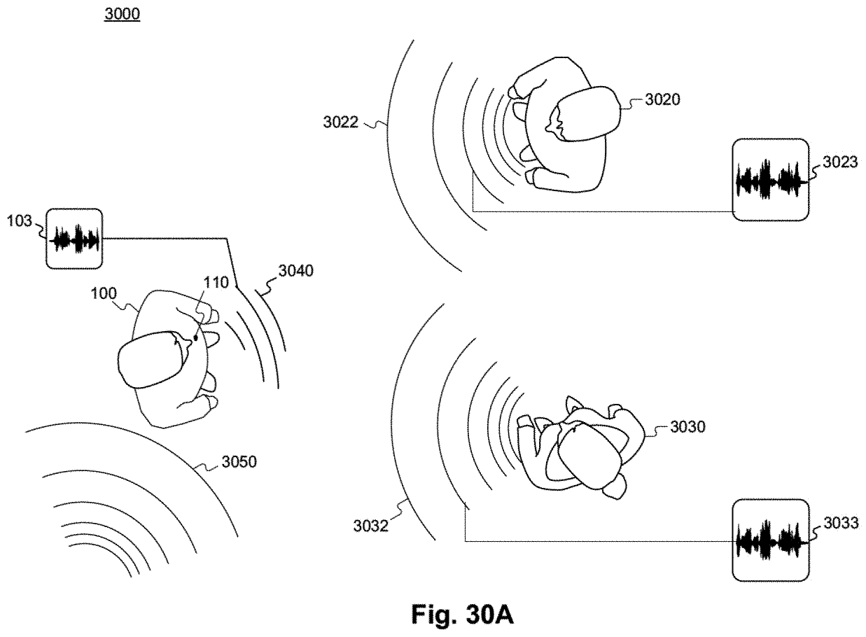

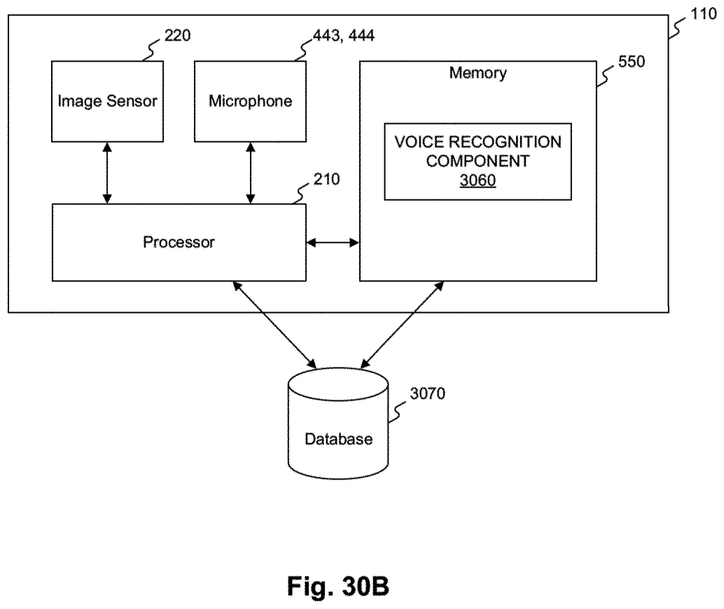

In some embodiments, the at least one processor may be programmed to execute a method comprising identifying a vocal component of the audio signal. For example, processor 210 may be configured to identify speech by one or more persons in the audio signal generated by audio sensor 1710. FIG. 30A illustrates an exemplary environment 3000 of user 100 consistent with the present disclosure. As illustrated in FIG. 30A, environment 3000 may include user 100, individual 3020, and individual 3030. User 100 may be interacting with one or both of individuals 3020 and 3030, and for example, speaking with one or both of individual 3020 and 3030. Although only two other individuals 3020 and 3030 are illustrated in FIG. 30A, it should be understood that environment 3000 may include any number users and/or other individuals.

Apparatus 110 may receive at least one audio signal generated by the one or more microphones 443, 444. Sensor 1710 of apparatus 110 may generate an audio signal based on the sounds captured by the one or more microphones 443, 444. For example, the audio signal may be representative of sound 3040 associated with user 100, sound 3022 associated with individual 3020, sound 3032 associated with individual 3030, and/or other sounds such as 3050 that may be present in environment 3000. Similarly, the one or more cameras associated with apparatus 110 may capture images representative of objects and/or people (e.g., individuals 3020, 3030, etc.), pets, etc., present in environment 3000.

In some embodiments, identifying the vocal component may comprise analyzing the audio signal to recognize speech included in the audio signal or to distinguish voices of one or more speakers in the audio signal. It is also contemplated that in some embodiments, analyzing the audio signal may comprise distinguishing a component of the audio signal representing a voice of the user. In some embodiments, the vocal component may represent a voice of the user. For example, the audio signal generated by sensor 1710 may include audio signals corresponding to one or more of sound 3040 associated with user 100, sound 3022 associated with individual 3020, sound 3032 associated with individual 3030, and/or other sounds such as 3050. It is also contemplated that in some cases the audio signal generated by sensor 1710 may include only a voice of user 100. The vocal component of the audio signal generated by sensor 1710 may include voices or speech by one or more of user 100, individuals 3020, 3030, and/or other speakers in environment 30000.

Apparatus 110 may be configured to recognize a voice associated with one or more of user 100, individuals 3020 and/or 3030, or other speakers present in environment 3000. Accordingly, apparatus 110, or specifically memory 550, may comprise one or more voice recognition components. FIG. 30B illustrates an exemplary embodiment of apparatus 110 comprising voice recognition components consistent with the present disclosure. Apparatus 110 is shown in FIG. 30B in a simplified form, and apparatus 110 may contain additional or alternative elements or may have alternative configurations, for example, as shown in FIGS. 5A-5C. Memory 550 (or 550a or 550b) may include voice recognition component 3060 instead of or in addition to orientation identification module 601, orientation adjustment module 602, and motion tracking module 603 as shown in FIG. 6. Component 3060 may contain software instructions for execution by at least one processing device. e.g., processor 210, included with a wearable apparatus. Component 3060 is shown within memory 550 by way of example only, and may be located in other locations within the system. For example, component 3060 may be located in a hearing aid device, in computing device 120, on a remote server 250, or in another associated device. Processor 210 may use various techniques to distinguish and recognize voices or speech of user 100, individual 3020, individual 3030, and/or other speakers present in environment 3000, as described in further detail below.

Returning to FIG. 30A, processor 210 may receive an audio signal including representations of a variety of sounds in environment 3000, including one or mom of sounds 3040, 3022, 3032, and 3050. The audio signal may include, for example, audio signals 103, 3023, and/or 3033 that may be representative of speech by user 100, individual 3020, and/or individual 3030, respectively. Processor 210 may analyze the received audio signal captured by microphone 443 and/or 444 to identify vocal components (e.g., speech) by various speakers (e.g., user 100, individual 3020, individual 3030, etc.) Processor 210 may be programmed to distinguish and identify the vocal components using voice recognition component 3060 (FIG. 30B) and may use one or more voice recognition algorithms, such as Hidden Markov Models, Dynamic Time Warping, neural networks, or other techniques. Voice recognition component 3060 and/or processor 210 may access database 3070, which may include a voiceprint of user 100 and/or one or more individuals 3020, 3030, etc. Voice recognition component 3060 may analyze the audio signal to determine whether portions of the audio signal (e.g., signals 103, 3023, and/or 3033) match one or more voiceprints stored in database 3070. Accordingly, database 3070 may contain voiceprint data associated with a number of individuals. When processor 210 determines a match between, for example, signals 103, 3023, and/or 3033 and one or more voiceprints stored in database 3070, processor 210 may be able to distinguish the vocal components (e.g., audio signals associated with speech) of, for example, user 1001, individual 3020, individual 3030, and/or other speakers in the audio signal received from the one or more microphones 443, 444.

Having a speaker's voiceprint, and a high-quality voiceprint in particular, may provide a fast and efficient way of determining the vocal components associated with, for example, user 100, individual 3020, and individual 3030 within environment 3000. A voice print may be collected, for example, when user 100, individual 3020, or individual 3030 speaks alone, preferably in a quiet environment. By having a voiceprint of one or more speakers, it may be possible to separate an ongoing voice signal almost in real time. e.g., with a minimal delay, using a sliding time window. The delay may be, for example 10 ms, 20 ms, 30 ms, 50 ms, 100 ms, or the like. Different time windows may be selected, depending on the quality of the voice print on the quality of the captured audio, the difference in characteristics between the speaker and other speaker(s), the available processing resources, the required separation quality, or the like. In some embodiments, a voice print may be extracted from a segment of a conversation in which an individual (e.g., individual 3020 or 3030) speaks alone, and then used for separating the individual's voice later in the conversation, whether the individual's voice is recognized or not.

Separating voices may be performed as follows: spectral features, also referred to as spectral attributes, spectral envelope, or spectrogram may be extracted from a clean audio of a single speaker and fed into a pre-trained first neural network, which generates or updates a signature of the speaker's voice based on the extracted features. The audio may be for example, of one second of a clean voice. The output signature may be a vector representing the speaker's voice, such that the distance between the vector and another vector extracted from the voice of the same speaker is typically smaller than the distance between the vector and a vector extracted from the voice of another speaker. The speaker's model may be pre-generated from a captured audio. Alternatively or additionally, the model may be generated after a segment of the audio in which only the speaker speaks, followed by another segment in which the speaker and another speaker (or background noise) is heard, and which it is required to separate.

Then, to separate the speaker's voice from additional speakers or background noise in a noisy audio, a second pre-trained neural network may receive the noisy audio and the speaker's signature, and output an audio (which may also be represented as attributes) of the voice of the speaker as extracted from the noisy audio, separated from the other speech or background noise. It will be appreciated that the same or additional neural networks may be used to separate the voices of multiple speakers. For example, if there are two possible speakers, two neural networks may be activated, each with models of the same noisy output and one of the two speakers. Alternatively, a neural network may receive voice signatures of two or more speakers, and output the voice of each of the speakers separately. Accordingly, the system may generate two or more different audio outputs, each comprising the speech of a respective speaker. In some embodiments, if separation is impossible, the input voice may only be cleaned from background noise.

In some embodiments, the at least one processor may be programmed to execute a method comprising determining at least one characteristic of the vocal component and further determining whether at least one characteristic of the vocal component meets a prioritization criteria for the at least one characteristic. By way of example, processor 210 may be configured to identify one or more characteristics of the vocal component (e.g., speech) of one or more of user 100, individual 3020, individual 3030, and/or other voices identified in the audio signal. In some embodiments, the one or more voice characteristics may include a pitch of the vocal component, a tone of the vocal component, a rate of speech of the vocal component, a volume of the vocal component, a center frequency of the vocal component, or a frequency distribution of the vocal component. It is contemplated that the speaker's voice may represent a voice associated with user 100, or a voice associated with one of individuals 3020, 3030, or another individual present in environment 300). Processor 210 may be configured to identify one or more voice characteristics such as pitch, tone, rate of speech, volume, a center frequency, a frequency distribution, based on the detected vocal component or speech of user 100, individual 3020, individual 3030, and/or other speakers present in environment 3000 by analyzing audio signals 103, 3023, 3033, etc. It is to be understood that the above-identified list of voice characteristics is non-limiting and processor 210 may be configured to determine other voice characteristics associated with the one or more voices in the user's environment.

In some embodiments, the at least one characteristic of the vocal component comprises occurrence of at least one keyword in the recognized speech. For example, processor 210 may be configured to identify or recognize one or more keywords in the one or more audio signals (e.g., 103, 3023, 3033, etc.) associated with speech of user 100, individual 3020, and/or individual 3030, etc. For example, the at least one keyword may include a person's name, an object's name, a place's name, a date, a sport team's name, a movie's name, a hook's name, and so forth. As another example, the at least one keyword may include a description of an event or activity (e.g., “game,” “match,” “race,” etc.), an object (e.g., “purse,” “ring,” “necklace,” “watch,” etc.), or a place or location (e.g. “office.” “theater,” etc.).

In some embodiments, the at least one processor may be programmed to execute a method comprising adjusting at least one control setting of the camera when the at least one characteristic meets the prioritization criteria. For example, processor 210 may be configured to adjust (e.g., increase, decrease, modify, etc.) one or more control settings (e.g., settings that control operation) of image sensor 220 based on the one or more characteristics identified above. In some embodiments, the one or more control settings that may be adjusted by processor 210 may include, for example, an image capture rate, a video frame rate, an image resolution, an image size, a zoom setting, an ISO setting, or a compression method used to compress the captured images. In some embodiments, adjusting the at least one setting of the camera may include at least one of increasing or decreasing the image capture rate, increasing or decreasing the video frame rate, increasing or decreasing the image resolution, increasing or decreasing the image size, increasing or decreasing the ISO setting, or changing a compression method used to compress the captured images to a higher-resolution compression method or a lower-resolution compression method. By way of example, when processor 210 detects a keyword, such as, “sports.” “game,” “match.” “race,” etc. in the audio signal, processor 210 may be configured to increase a frame rate of the camera (e.g., image sensor 220) to ensure that any high speed movements associated with the sporting or racing event are accurately captured by the camera. As another example, when processor 210 detects a keyword such as “painting” or “purse.” or “ring.” etc., processor 210 may adjust a zoom setting of the camera to, for example, zoom in to the object of interest (e.g., painting, purse, or ring, etc.) It is to be understood that the above-identified list of camera control settings or adjustments to those settings is non-limiting and processor 210 may be configured to adjust these or other camera settings in many other ways.

It is contemplated that processor 210 may adjust one or more control settings of the camera based on other criteria (e.g., prioritization criteria) associated with one or more characteristics of one or more vocal components in the audio signal. In some embodiments, determining whether the at least one characteristic meets the prioritization criteria may include comparing the at least one characteristic to a prioritization difference threshold for the at least one characteristic. For example, processor 210 may be configured to compare the one or more characteristics (e.g., pitch, tone, rate of speech, volume of speech, etc.) with respective thresholds. Thus, for example, processor 210 may compare a pitch (e.g., maximum or center frequency) associated with the speech of, for example, user 100, individual 3020, individual 3030, etc., with a pitch threshold. As discussed above, processor 210 may determine the pitch based on, for example, an analysis of one or more of audio signals 103, 3023, 3033, etc., identified in the audio signal generated by microphones 443, 444. Processor 210 may adjust one or more settings of the camera, for example, when the determined pitch is greater than, less than, or about equal to a pitch threshold. By way of another example, processor 210 may compare a rate of speech (e.g., number of words spoken per second or per minute) of user 100, individual 3020, individual 3030, etc., with a rate threshold. Processor 210 may adjust one or more settings of the camera when, for example, the determined rate of speech is greater than, less than, or about equal to a rate threshold. By way of example, processor 210 may be configured to increase a frame rate of the camera when the determined rate of speech is greater than or about equal to a rate threshold.

In some embodiments, determining whether the at least one characteristic meets the prioritization criteria may further include determining that the at least one characteristic meets the prioritization criteria when the at least one characteristic is about equal to or exceeds the prioritization difference threshold. For example, processor 210 may determine whether the identified pitch is about equal to a pitch threshold and adjust one or more settings of the camera when the identified pitch is about equal to a pitch threshold. As another example, processor 210 may determine whether the determined rate of speech is about equal to a rate of speech threshold and adjust one or more settings of the camera when the determined rate of speech pitch is about equal to a rate of speech threshold.

It is contemplated that processor 210 may determine whether the at least one characteristic meets the prioritization criteria in other ways. In some embodiments, determining whether the at least one characteristic of the vocal component meets the prioritization criteria for the characteristic may include determining a difference between the at least one characteristic and a baseline for the at least one characteristic. Thus, for example, processor 210 may identify a pitch associated with a speech of any of user 100, individual 3020, and/or individual 3030. Processor 210 may be configured to determine a difference between the identified pitch and a baseline pitch that may be stored, for example, in database 3070. As another example, processor may identify a volume of speech associated with, for example, user 100, individual 3020, and/or individual 3030. Processor 210 may be configured to determine a difference between the identified volume and a baseline volume that may be stored, for example, in database 3070.

In some embodiments, determining whether the at least one characteristic of the vocal component meets the prioritization criteria for the characteristic may include comparing the difference to a prioritization threshold for the at least one characteristic and determining that the at least one characteristic meets the prioritization criteria when the difference is about equal to the prioritization threshold. For example, processor 210 may be configured to compare the difference between the identified pitch and the baseline pitch with a pitch difference threshold (e.g., prioritization threshold). Processor 210 may be configured to adjust one or more settings of the camera when the difference (e.g., between the identified pitch and the baseline pitch) is about equal to a pitch difference threshold. By doing so, processor 210 may ensure that the camera control settings are adjusted only when the pitch associated with a speech of, for example, user 100, individual 3020 or individual 3030 exceeds the baseline pitch by a predetermined amount (e.g., the pitch difference threshold). By way of another example, processor 210 may be configured to compare the difference (e.g., between the identified volume and the baseline volume) with a volume difference threshold (e.g., prioritization threshold). Processor 210 may be configured to adjust one or more settings of the camera when the difference between the identified volume and the baseline volume is about equal to a volume difference threshold. By doing so, processor 210 may ensure that the camera control settings are adjusted only when the volume associated with a speech of, for example, user 100, individual 3020 or individual 3030 exceeds a predetermined or baseline volume by at least the volume difference threshold. For example, if individual 3020 is speaking loudly, processor 210 may be configured to adjust a zoom setting of the camera so that the images captured by the camera include more of individual 3020 and that individual's surroundings than, for example, individual 3030 and individual 3030's surroundings. However, to avoid unnecessary control setting changes, for example as a result of minor changes in a speaker's volume, processor 210 may be configured to adjust the zoom setting only when the volume of individual 3020's speech exceeds a baseline volume by at least the volume threshold. Although the above examples indicate that the camera control settings may be adjusted when a characteristic or its difference from a baseline are about equal to a corresponding threshold, it is also contemplated that in some embodiments, processor 210 may be configured to adjust one or more camera control settings when the above-identified characteristics or their differences from their respective baselines are less than or greater than their corresponding thresholds.

In some embodiments, the at least one processor may be programmed to select different settings for a characteristic based on different thresholds or different difference thresholds. Thus, the processor may be programmed to set the at least one setting of the camera to a first setting when the at least one characteristic is about equal to a first prioritization threshold of the plurality of prioritization thresholds, or when a difference of a characteristic from a baseline is about equal to or exceeds a first difference threshold. Further, the processor may be programmed to set the at least one setting of the camera to a second setting, different from the first setting, when the at least one characteristic is about equal to a second prioritization threshold of the plurality of prioritization thresholds, or when a difference of the characteristic from the baseline is about equal to or exceeds a second difference threshold. By way of example, processor 210 may compare a pitch (e.g., maximum or center frequency) associated with the speech of, for example, user 100, individual 3020, individual 3030, etc., with a plurality of pitch thresholds. When the determined pitch is greater than or about equal to a first pitch threshold, processor 210 may adjust one or more settings of the camera (e.g., frame rate) to a first setting (e.g., to a first frame rate). When the determined pitch, however, is greater than or about equal to a second pitch threshold, processor 210 may adjust the one or more settings of the camera (e.g., frame rate) to a second setting (e.g., to a second frame rate different from the first frame rate). By way of another example, processor 210 may be configured to compare the difference (e.g., between the identified volume and the baseline volume) with a plurality of volume difference thresholds (e.g., prioritization thresholds). When the difference between the identified volume and the baseline volume is about equal to or greater than a first volume difference threshold, processor 210 may be configured to adjust one or more settings of the camera (e.g., resolution) to a first resolution. When the difference between the identified volume and the baseline volume is about equal to or greater than a second volume difference threshold, processor 210 may be configured to adjust the one or more settings of the camera (e.g., resolution) to a second resolution different from the first resolution. Thus, processor 210 may be configured to select different setting levels based on different thresholds.

In some embodiments, the at least one processor may be programmed to execute a method comprising the foregoing adjustment of the at least one control setting when the at least one characteristic does not meet the prioritization criteria. For example, processor 210 may be configured to leave the one or more control settings of the camera unchanged if the one or more characteristics do not meet the prioritization criteria. As discussed above, the prioritization criteria may include comparing the characteristic to a threshold or comparing a difference between the characteristic and a baseline value to a threshold difference. Thus, for example, processor 210 may not adjust control settings of the camera (e.g., image sensor 220) when a pitch associated with a speech of, for example, user 100, individual 3020, or individual 3030 is not equal to a threshold pitch (the prioritization criteria being pitch should equal the threshold pitch). As another example, processor 210 may not adjust control settings of the camera (e.g., image sensor 220) when, for example, a difference between a volume of a speech of user 100, individual 3020, or individual 3030 and a baseline volume is less than a threshold volume (the prioritization criteria being difference in volume should equal the threshold volume). It should be understood that processor 210 may forego adjusting one or more of the camera control settings when only one characteristic does not meet the prioritization criteria, when more than one characteristic does not meet the prioritization criteria, or when all the characteristics do not meet the prioritization criteria.

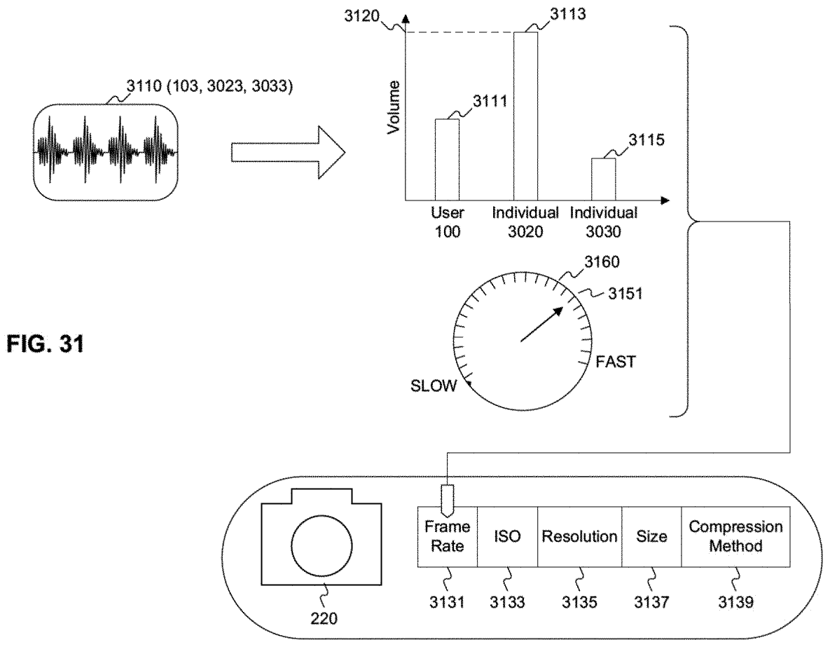

By way of example, FIG. 31 schematically illustrates how processor 210 may determine a characteristic of a vocal component and adjust a camera control setting based on that characteristic. For example, as illustrated in FIG. 31, processor 210 may analyze an audio signal 3110 that may include one or more of audio signals 103, 3023, 3033, etc., associated with a speech of user 100, individual 3020, individual 3030, etc. Processor 210 may determine a volume associated with the speech of, for example, user 100, individual 3020, individual 3030, etc. As illustrated in FIG. 31, for example, volume 3111 associated with a speech of user 100 and volume 3115 associated with a speech of individual 3030 may be less than a volume threshold 3120. As further illustrated in FIG. 31, however, volume 3113 associated with a speech of individual 3020 may be about equal to volume threshold 3120. Processor 210 may therefore, adjust one or more of the camera settings (e.g., frame rate 3131, ISO 3133, image resolution 3135, image size 3137, or compression method 3139, etc.). By way of another example, processor 210 may compare a rate of speech of, for example, individual 3030 with a rate of speech threshold. As illustrated in FIG. 31, a rate of speech 3151 of, for example, individual 3030 may be higher than a rate of speech threshold 3160. As a result, processor 210 may adjust one or more of the camera settings (e.g., frame rate 3131, ISO 3133, image resolution 3135, image size 3137, or compression method 3139, etc.).

Although the above examples refer to processor 210 of apparatus 110 as performing one or more of the disclosed functions, it is contemplated that one or more of the above-described functions may be performed by a processor included in a secondary device. Thus, in some embodiments, the at least one processor is included in a secondary computing device wirelessly linked to the camera and the microphone. For example, as illustrated in FIG. 2, the at least one processor may be included in computing device 120 (e.g., a mobile or tablet computer) or in device 250 (e.g., a desktop computer, a server, etc.). In some embodiments, the secondary computing device may include at least one of a mobile device, a laptop computer, a desktop computer, a smartphone, a smartwatch, a smart speaker, an in-home entertainment system, or an in-vehicle entertainment system. The secondary computing device may be linked to a camera (e.g., image sensor 220) and/or a microphone (e.g., microphones 443, 444) via a wireless connection. For example, the at least one processor of the secondary device may communicate and exchange data and information with the camera and/or microphone via a Bluetooth™, NFC, Wi-Fi, WiMAX, cellular, or other form of wireless communication. In some embodiments, the camera may comprise a transmitter configured to wirelessly transmit the captured images to a receiver coupled to the at least one processor. By way of example, one or more images captured by image sensor 220 and/or one or more audio signals generated by audio sensor 1710, and/or microphones 443, or 444 may be wirelessly transmitted via transceiver 530 (see FIGS. 17A, 17B) to a secondary device. The secondary device (e.g., computing device 120, server 250, etc.) may include a receiver configured to receive the wireless signals transmitted by transceiver 530. The at least one processor of the secondary device may be configured to analyze the audio signals received from transceiver 530 and determine whether one or more camera control settings should be adjusted. The at least one processor of the secondary device may also be configured to wirelessly transmit, for example, control signals to adjust the one or more settings associated with image sensor 220 (e.g., camera).

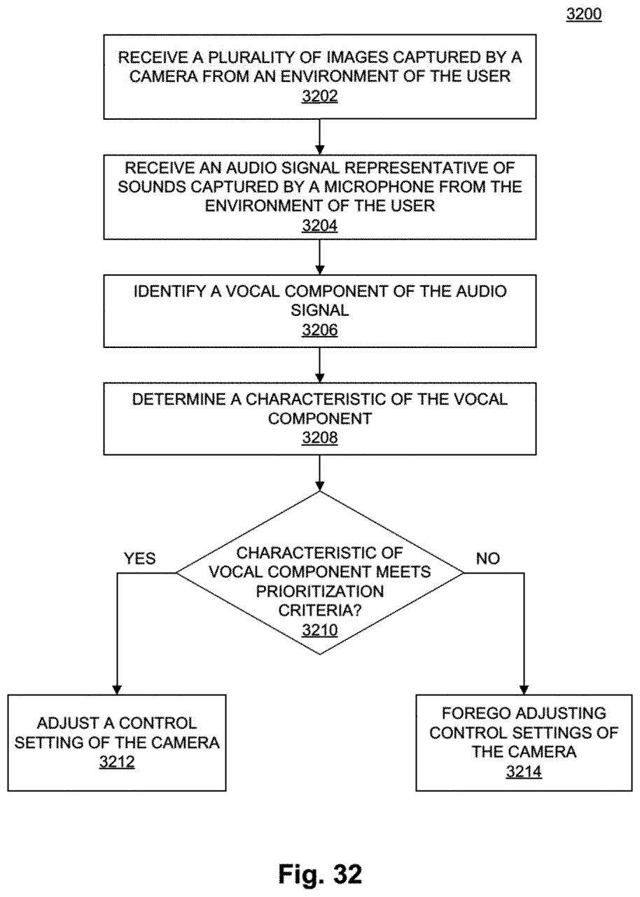

FIG. 32 is a flowchart showing an exemplary process 3200 for variable image capturing. Process 3200 may be performed by one or more processors associated with apparatus 110, such as processor 210 or by one or more processor associated with a secondary device, such as computing device 120 and/or server 250. In some embodiments, the processor(s) (e.g., processor 210) may be included in the same common housing as microphone 443, 444 and image sensor 220 (camera), which may also be used for process 3200. In other embodiments, the processor(s) may additionally or alternatively be included in computing device 120 and/or server 250. In some embodiments, some or all of process 3200 may be performed on processors external to apparatus 110 (e.g., processors of computing device 110, server 250, etc.), which may be included in a second housing. For example, one or more portions of process 3200 may be performed by processors in hearing aid device 230, or in an auxiliary device, such as computing device 120 or server 250. In such embodiments, the processor may be configured to receive the captured images and/or an audio signal generated by, for example, audio sensor 1710, via a wireless link between a transmitter in the common housing and receiver in the second housing.

In step 3202, process 3200 may include receiving a plurality of images captured by a camera from an environment of a user. For example, the images may be captured by a wearable camera such as a camera including image sensor 220 of apparatus 110. In step 3204, process 3200 may include receiving one or more audio signals representative of the sounds captured by a microphone from the environment of the user. For example, microphones 443, 444 may capture one or mom of sounds 3022, 3032, 3040, 3050, etc., from environment 3000 of user 100. Microphones 443, 444, or audio sensor 1710 may generate the audio signal in response to the captured sounds.

In step 3206, process 3200 may include identifying a vocal component of the audio signal. As discussed above, the vocal component may be associated with a voice or speech of one or more of user 100, individual 3020, individual 3030, and/or other speakers or sound in environment 3000 of user 100. For example, processor 210 may analyze the received audio signal captured by microphone 443 and/or 444 to identify vocal components (e.g., speech) by various speakers (e.g., user 100, individual 3020, individual 3030, etc.) by matching one or more of audio signals 103, 3023, 3033, etc., with voice prints stored in database 3070. Processor 210 may use one or more voice recognition algorithms, such as Hidden Markov Models, Dynamic Time Warping, neural networks, or other techniques to distinguish the vocal components associated with, for example, user 100, individual 3020, individual 3030, and/or other speakers in the audio signal.

In step 3208, process 3200 may include determining a characteristic of the vocal component. In step 3208, processor 210 may identify one or more characteristics associated with the one or more audio signals 103, 3023, 3033, etc. For example, processor 210 may determine one or more of a pitch, a tone, a rate of speech, a volume, a center frequency, a frequency distribution, etc., of the one or more audio signals 103, 3023, 3033. In some embodiments, processor 210 may identify a keyword in the one or more audio signals 103, 3023, 3033.

In step 3210, process 3200 may include determining whether the characteristic of the vocal component meets a prioritization criteria. In step 3210, as discussed above, processor 210 may be configured to compare the one or more characteristics (e.g., pitch, tone, rate of speech, volume of speech, etc.) with one or more respective thresholds. Processor 210 may also be configured to determine whether the one or more characteristics are about equal or exceed one or more respective thresholds. For example, processor 210 may compare a pitch associated with audio signal 3023 with a pitch threshold and determine that the vocal characteristic meets the prioritization criteria when the pitch associated with audio signal 3023 is about equal to or exceeds the pitch threshold. As also discussed above, processor 210 may determine a volume associated with, for example, audio signal 3033 (e.g., for speech of individual 3030). Processor 210 may determine a difference between the volume associated with audio signal 3033 and a baseline volume. Processor 210 may also compare the difference with a volume threshold and determine that the characteristic meets the prioritization criteria when the difference in the volume is about equal to the volume difference threshold. As further discussed above, processor 210 may also determine that the characteristic meets the prioritization criteria, for example, when the audio signal includes a predetermined keyword.

In step 3210, when processor 210 determines that a characteristic of a vocal component associated with, for example, user 100, individual 3020, individual 3030, etc., meets the prioritization criteria (Step 3210: Yes), process 3200 may proceed to step 3212. When processor 210 determines, however, that a characteristic of a vocal component associated with, for example, user 100, individual 3020, individual 3030, etc., does not meet the prioritization criteria (Step 3210: No), process 3200 may proceed to step 3214.

In step 3212, process 3200 may include adjusting a control setting of the camera. For example, as discussed above, processor 210 may adjust one or more settings of the camera. These settings may include, for example, an image capture rate, a video frame rate, an image resolution, an image size, a zoom setting, an ISO setting, or a compression method used to compress the captured images. As also discussed above, to adjust one or more of these settings, processor 210 may be configured to increase or decrease the image capture rate, increase or decrease the video frame rate, increase or decrease the image resolution, increase or decrease the image size, increase or decrease the ISO setting, or change a compression method used to compress the captured images to a higher-resolution or a lower-resolution. In contrast, in step 3214, processor 210 may not adjust one or more of the camera control settings. It should be understood that processor 210 may forego adjusting some or all of the camera control settings when only one characteristic does not meet the prioritization criteria, when more than one characteristic does not meet the prioritization criteria, or when all the characteristics do not meet the prioritization criteria.

Tracking Sidedness of Conversation

As described above, one or more audio signals may be captured from within the environment of a user. These audio signals may be processed prior to presenting some or all of the audio information to the user. The processing may include determining sidedness of one or more conversations. For example, the disclosed system may identify one or more voices associated with one or more speakers engaging in a conversation and determine an amount of time for which the one or more speakers were speaking during the conversation. The disclosed system may display the determined amount of time for each speaker as a percentage of the total time of the conversation to indicate sidedness of the conversation. For example if one speaker spoke for most of the time (e.g., over 70% or 80%) then the conversation would be relatively one-sided weighing in favor of that speaker. The disclosed system may display this information to a user to allow the user to, for example, direct the conversation to allow another speaker to participate or to balance out the amount of time used by each speaker.

In some embodiments, user 100 may wear a wearable device, for example, apparatus 110 that is physically connected to a shirt or other piece of clothing of user 100. Consistent with the disclosed embodiments, apparatus 110 may be positioned in other locations, as described previously. For example, apparatus 110 may be physically connected to a necklace, a belt, glasses, a wrist strap, a button, etc. Additionally or alternatively apparatus 110 may be configured to send information such as audio, images, video, textual information, etc. to a paired device, such as computing device 120. As discussed above, computing device 120 may include, for example, a laptop computer, a desktop computer, a tablet, a smartphone, a smartwatch, etc. Additionally or alternatively, apparatus 110 may be configured to communicate with and send information to an audio device such as an earphone, etc.

Apparatus 110 may include processor 210 (see FIG. 5A). As also discussed above, processor 210 may include any physical device having an electric circuit that performs a logic operation on input or inputs. For example, the processor may include one or more integrated circuits, microchips, microcontrollers, microprocessors, all or part of a central processing unit (CPU), graphics processing unit (GPU), digital signal processor (DSP), field-programmable gate array (FPGA), or other circuits suitable for executing instructions or performing logic operations. One or more of the processes or functions described herein with respect to apparatus 110 or processor 210 may be performed by computing device 120 and/or processor 540.

In some embodiments the disclosed system may include a microphone configured to capture sounds from the environment of the user. As discussed above, apparatus 110 may include one or more microphones to receive one or more sounds associated with the environment of user 100. For example, apparatus 110 may comprise microphones 443, 444, as described with respect to FIGS. 4F and 4G. Microphones 443 and 444 may be configured to obtain environmental sounds and voices of various speakers communicating with user 100 and output one or more audio signals. In some embodiments, the microphone may include a least one of a directional microphone or a microphone array. For example, microphones 443, 444 may comprise one or more directional microphones, a microphone array, a multi-port microphone, or the like. The microphones shown in FIGS. 4F and 4G are by way of example only, and any suitable number, configuration, or location of microphones may be used.

In some embodiments, the disclosed system may include a communication device configured to provide at least one audio signal representative of the sounds captured by the microphone. For example, wearable apparatus 110 (e.g., a communications device) may include an audio sensor 1710, for converting the captured sounds to one or more audio signals. Audio sensor 1710 may comprise any one or more of microphone 443, 444. Audio sensor 1710 may comprise a sensor (e.g., a pressure sensor), which may encode pressure differences comprising sound as an audio signal. Other types of audio sensors capable of convening the captured sounds to one or more audio signals are also contemplated.

In some embodiments, audio sensor 1710 and the processor may be included in a common housing configured to be worn by the user. By way of example, user 100 may wear an apparatus 110 that may include one or more microphones 443, 444 (See FIGS. 2, 3A, 4D, 4F, 4G). In some embodiments the processor (e.g., processor 210) and the microphone may be included in a common housing. By way of example, as illustrated in FIGS. 4D, 4F, and 4G, the one or more microphones 443, 444 and processor 210 may be included in body 435 (common housing) of apparatus 110. As illustrated in FIGS. 1B, 1C, 1D, 4C, and 9, user 100 may wear apparatus 110 that includes common housing or body 435 (see FIG. 4D).

In some embodiments, the microphone may comprise a transmitter configured to wirelessly transmit the captured sounds to a receiver coupled to the at least one processor and the receiver may be incorporated in a hearing aid. For example, microphones 443, 444 may communicate data to feedback-outputting unit 230, which may include any device configured to provide information to a user 100. Feedback outputting unit 230 may be provided as part of apparatus 110 (as shown) or may be provided external to apparatus 110 and may be communicatively coupled thereto. For example, feedback-outputting unit 230 may comprise audio headphones, a hearing aid type device, a speaker, a bone conduction headphone, interfaces that provide tactile cues, vibrotactile stimulators, etc. In some embodiments, processor 210 may communicate signals with an external feedback outputting unit 230 via a wireless transceiver 530, a wired connection, or some other communication interface.

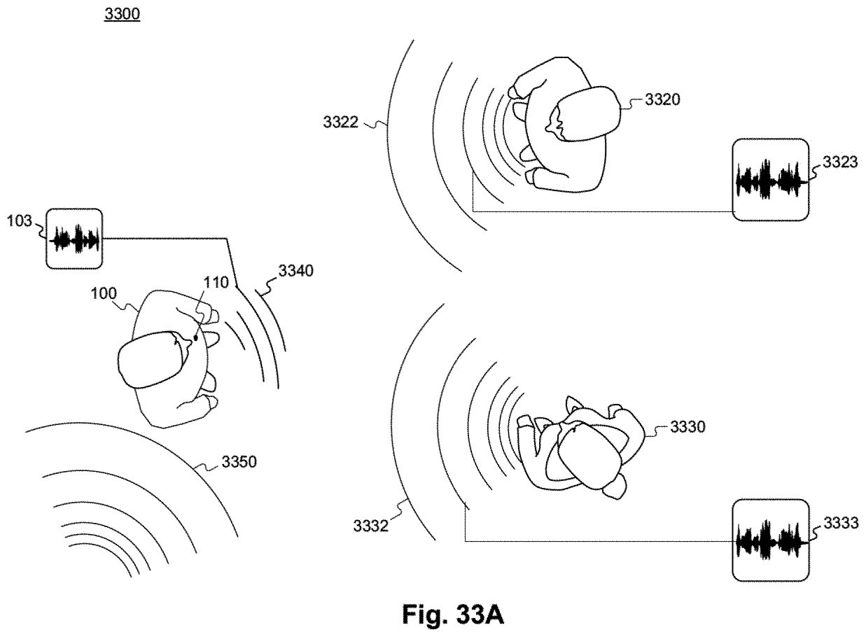

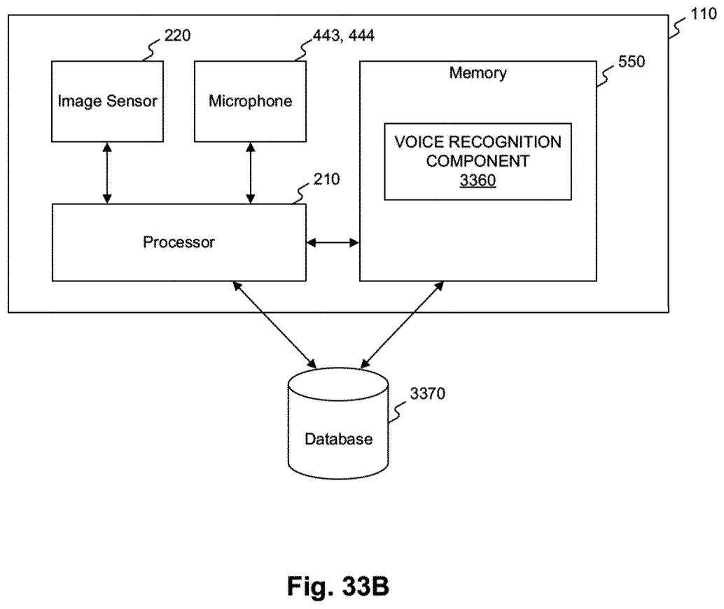

In some embodiments, the at least one processor may be programmed to execute a method comprising analyzing the at least one audio signal to distinguish a plurality of voices in the at least one audio signal. It is also contemplated that in some embodiments, the at least one processor may be programmed to execute a method comprising identifying a first voice among the plurality of voices. For example, processor 210 may be configured to identify voices of one or more persons in the audio signal generated by audio sensor 1710. FIG. 33A illustrates an exemplary environment 3300 of user 100 consistent with the present disclosure. As illustrated in FIG. 33A, environment 3300 may include user 100, individual 3320, and individual 3330. User 100 may be interacting with one or both of individuals 3320 and 3330, for example, conversing with one or both of individual 3320 and 3330. One or both individuals 3320 and 3330 may also speak during the conversation with user 100. Although only two other individuals 3320 and 3330 are illustrated in FIG. 30A, it should be understood that environment 3300 may include any number of users and/or other individuals, pets, objects, etc.

Apparatus 110 may receive at least one audio signal generated by the one or more microphones 443, 444. Sensor 1710 of apparatus 110 may generate the at least one audio signal based on the sounds captured by the one or more microphones 443, 444. For example, the audio signal may be representative of sound 3340 associated with user 100, sound 3322 associated with individual 3320, sound 3332 associated with individual 3330, and/or other sounds such as 3350 that may be present in environment 3300.

In some embodiments, identifying the first voice may comprise identifying a voice of the user among the plurality of voices. For example, the audio signal generated by sensor 1710 may include audio signals corresponding to one or more of sound 3340 associated with user 100, sound 3322 associated with individual 3320, sound 3332 associated with individual 3330, and/or other sounds such as 3350. Thus, for example, the audio signal generated by sensor 1710 may include audio signal 103 associated with a voice of user 100, audio signal 3323 associated with a voice of individual 3320, and/or audio signal 3333 associated with a voice of individual 3330. It is also contemplated that in some cases the audio signal generated by sensor 1710 may include only a voice of user 100.

Apparatus 110 may be configured to recognize a voice associated with one or more of user 100, individuals 3320 and/or 3330, or other speakers present in environment 3300. Accordingly, apparatus 110, or specifically memory 550, may comprise one or more voice recognition components. FIG. 33B illustrates an exemplary embodiment of apparatus 110 comprising voice recognition components consistent with the present disclosure. Apparatus 110 is shown in FIG. 33B in a simplified form, and apparatus 110 may contain additional or alternative elements or may have alternative configurations, for example, as shown in FIGS. 5A-5C. Memory 550 (or 550a or 550b) may include voice recognition component 3360 instead of or in addition to orientation identification module 601, orientation adjustment module 602, and motion tracking module 603 as shown in FIG. 6. Component 3360 may contain software instructions for execution by at least one processing device (e.g., processor 210) included in a wearable apparatus. Components 3360 is shown within memory 550 by way of example only, and may be located in other locations within the system. For example, component 3360 may be located in a hearing aid device, in computing device 120, on a remote server 250, or in another associated device. Processor 210 may use various techniques to distinguish and recognize voices or speech of user 100, individual 3320, individual 3330, and/or other speakers present in environment 3300, as described in further detail below.

Returning to FIG. 33A, processor 210 may receive an audio signal including representations of a variety of sounds in environment 3300, including one or mom of sounds 3340, 3322, 3332, and 3350. The audio signal may include, for example, audio signals 103, 3323, and/or 3333 that may be representative of voices of user 100, individual 3320, and/or individual 3330, respectively. Processor 210 may analyze the received audio signal captured by microphone 443 and/or 444 to identify the voices of various speakers (e.g., user 100, individual 3320, individual 3330, etc.) Processor 210 may be programmed to distinguish and identify the voices using voice recognition component 3360 (FIG. 33B) and may use one or more voice recognition algorithms, such as Hidden Markov Models, Dynamic Time Warping, neural networks, or other techniques. Voice recognition component 3360 and/or processor 210 may access database 3370, which may include a voiceprint of user 100 and/or one or more individuals 3320, 3330, etc. Voice recognition component 3360 may analyze the audio signal to determine whether portions of the audio signal (e.g., signals 103, 3323, and/or 3333) match one or more voiceprints stored in database 3370. Accordingly, database 3370 may contain voiceprint data associated with a number of individuals. When processor 210 determines a match between, for example, signals 103, 3323, and/or 3333 and one or more voiceprints sowed in database 3370, processor 210, may be able to distinguish the vocal components (e.g., audio signals associated with speech) of, for example, user 100, individual 3320, individual 3330, and/or other speakers in the audio signal received from the one or more microphones 443, 444.

Having a speaker's voiceprint, and a high-quality voiceprint in particular, may provide for fast and efficient way of determining the vocal components associated with, for example, user 100, individual 3320, and individual 3330 within environment 3300. A high-quality voice print may be collected, for example, when user 100, individual 3320, or individual 3330 speaks alone, preferably in a quiet environment. By having a voiceprint of one or more speakers, it may be possible to separate an ongoing voice signal almost in real time. e.g., with a minimal delay, using a sliding time window. The delay may be, for example 10 ms, 20 ms, 30 ms, 50 ms, 100 ms, or the like. Different time windows may be selected, depending on the quality of the voice print, on the quality of the captured audio, the difference in characteristics between the speaker and other speaker(s), the available processing resources, the required separation quality, or the like. In some embodiments, a voice print may be extracted from a segment of a conversation in which an individual (e.g., individual 3320 or 3330) speaks alone, and then used for separating the individual's voice later in the conversation, whether the individual's voice is recognized or not.

Separating voices may be performed as follows: spectral features, also referred to as spectral attributes, spectral envelope, or spectrogram may be extracted from a clean audio of a single speaker and fed into a pre-trained first neural network, which generates or updates a signature of the speaker's voice based on the extracted features. It will be appreciated that the voice signature may be generated using any other engine or algorithm, and is not limited to a neural network. The audio may be for example, of one second of a clean voice. The output signature may be a vector representing the speaker's voice, such that the distance between the vector and another vector extracted from the voice of the same speaker is typically smaller than the distance between the vector and a vector extracted from the voice of another speaker. The speaker's model may be pre-generated from a captured audio. Alternatively or additionally, the model may be generated after a segment of the audio in which only the speaker speaks, followed by another segment in which the speaker and another speaker (or background noise) is heard, and which it is required to separate. Thus, separating the audio signals and associating each segment with a user may be performed whether any one or more of the speakers is known and a voiceprint thereof is pre-existing, or not.

Then, to separate the speaker's voice from additional speakers or background noise in a noisy audio, a second pre-trained engine, such as a neural network may receive the noisy audio and the speaker's signature, and output an audio (which may also be represented as attributes) of the voice of the speaker as extracted from the noisy audio, separated from the other speech or background noise. It will be appreciated that the same or additional neural networks may be used to separate the voices of multiple speakers. For example, if there are two possible speakers, two neural networks may be activated, each with models of the same noisy output and one of the two speakers. Alternatively, a neural network may receive voice signatures of two or more speakers, and output the voice of each of the speakers separately. Accordingly, the system may generate two or more different audio outputs, each comprising the speech of a respective speaker. In some embodiments, if separation is impossible, the input voice may only be cleaned from background noise.

In some embodiments, identifying the first voice may comprise at least one of matching the first voice to a known voice or assigning an identity to the first voice, for example, processor 210 may use one or more of the methods discussed above to identify one or more voices in the audio signal by matching the one or more voices represented in the audio signal with known voices (e.g., by matching with voiceprints stored in, for example, database 3370). It is also contemplated that additionally or alternatively, processor 210 may assign an identity to each identified voice. For example, database 3370 may store the one or more voiceprints in association with identification information for the speakers associated with the stored voiceprints. The identification information may include, for example, a name of the speaker, or another identifier (e.g., number, employee number, badge number, customer number, a telephone number, an image, or any other representation of an identifier that associates a voiceprint with a speaker). It is contemplated that after identifying the one or more voices in the audio signal, processor 210 may additionally or alternatively assign an identifier to the one or more identified voices.

In some embodiments, identifying the first voice may comprise identifying a known voice among the voices present in the audio signal, and assigning an identity to an unknown voice among the voices present in the audio signal. It is contemplated that in some situations, processor 210 may be able to identify some, but not all, voices in the audio signal. For example, in FIG. 33A, there may be one or more additional speakers in environment 3300 in addition to user 100, individual 3320, and individual 3330. Processor 210 may be configured to identify the voices of user 100, individual 3320, and individual 3330 based on, for example, their voiceprints stored in database 3370 or using any of the voice recognition techniques discussed above. However, processor 210 may also distinguish one or more additional voices in the audio signal received environment 3300 but processor 210 may not be able to assign an identifier to those voices. This may occur, for example, when processor 210 cannot match the one or more additional voices with voiceprints stored in database 3370. In some embodiment, processor 210 may assign identifiers to the unidentified voices. For example, processor 210 may assign an identifier “unknown speaker” to a first unidentified voice, “unknown speaker 2” to a second unidentified voice and so on.

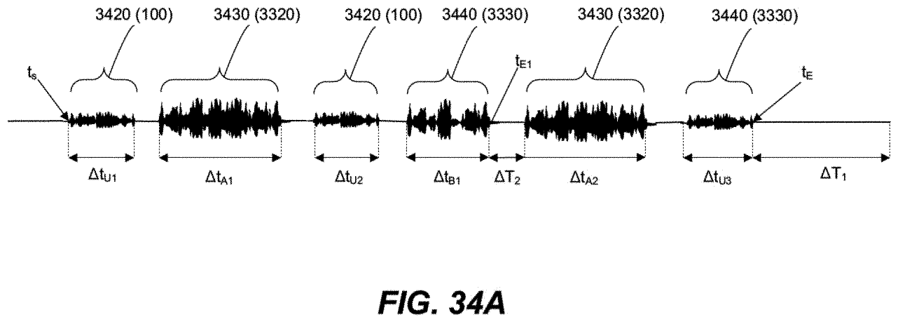

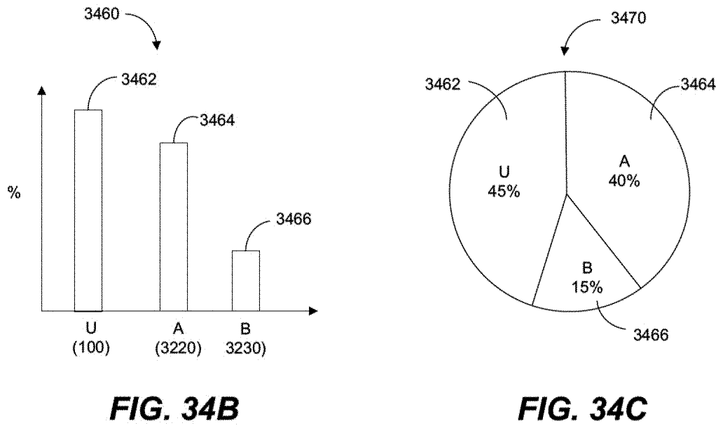

In some embodiments, the at least one processor may be programmed to execute a method comprising determining, bused on the analysis of the at least one audio signal, a start of a conversation between the plurality of voices. It is contemplated that in some embodiments, determining the start of a conversation between the plurality of voices may comprise determining a start time at which any voice is first present in the audio signal. By way of example, processor 210 may analyze an audio signal received from environment 3300 and determine a start time at which a conversation begins between, for example, user 100, one or more individuals 3320, 3330, and/or other speakers. FIG. 34A illustrates an exemplary audio signal 3410 representing, for example, sounds 3322, 3332, 3340, 3350, etc., in environment 3300. Processor 210 may be configured to identify the voices of, for example, user 100, individual 3320, individual 3330, and/or other speakers in audio signal 3410, whether they are pre-identified or not, using one or more techniques such as the techniques discussed above. For example, as illustrated in FIG. 34A, processor 210 may identify voice 3420 as being associated with user 100, voice 3430 as being associated with individual 3320, and voice 3440 as being associated with individual 3330. Voices 3420, 3430, and 3440 in audio signal 3410 may represent a conversation between user 100, individual 3320, and individual 3330. As also illustrated in FIG. 34A, some of voices 3420, 3430, and 3440 may appear in audio signal 3410 more than once depending on how many times user 100, individual 3320, or individual 3330 speak during the conversation. Processor 210 may be configured to determine a start time is of the conversation. For example, processor 210 may determine a time at which at least one of voices 3420, 3430, and 3440 is first present in audio signal 3410. In audio signal 3410 of FIG. 34A, for example, processor 210 may determine that voice 3420 of user 100 is first present in audio signal 3410 at time t₅ and that none of voices 3420, 3430, 3440 or any other voice is present in audio signal 3410 before time t₅. Processor 210 may identify time t₅ as a start of a conversation.

In some embodiments, the processor may be programmed to execute a method comprising determining, based on the analysis of the at least one audio signal, an end of the conversation between the plurality of voices. It is contemplated that in some embodiments, determining the end of the conversation between the plurality of voices comprises determining an end time at which any voice is last present in the audio signal. For example, processor 210 may be configured to determine an end time t_{E} of the conversation. Processor 210 may be configured to determine time t_{E} as a time after which none of voices 3420, 3430, 3440, or any other voice is present in audio signal 3410. In audio signal 3410 of FIG. 34A, for example, processor 210 may determine that none of voices 3420, 3430, 3440, or any other voice is present in audio signal 3410 after time t_{B}. Processor 210 may identify time tit as an end of the conversation represented in audio signal 3410.

In some embodiments, determining the end time may comprise identifying a period in the audio signal longer than a threshold period in which no voice is present in the audio signal. For example, as illustrated in FIG. 34A, processor 210 may determine a time t_{E} at which none of voices 3420, 3430, 3440, or any other voice is detected in audio signal 3410. Processor 210 may determine a period DT₃ following time t_{E} during which none of voices 3420, 3430, 3440 is present in audio signal 3410. Processor 210 may be configured to compare the period DT₁ with a threshold time period DT_{Max}. Processor 210 may determine that time t_{E} represents an end of the conversation when the period DT₁ is equal to or greater than threshold time period DT_{Max}. By way of another example, in the exemplary audio signal 3410 of FIG. 34A, processor 210 may detect time t_{E1} after which there may be a time period DT₂ during which none of the voices 3420, 3430, 3440, or any other voice is detected in audio signal 3410. Processor 210 may compare period DT₂ with threshold time period DT_{Max} and may determine that time period DT₂ is smaller than threshold time period DT_{Max}. Therefore, in this example, processor 210 may determine that time t_{E1} is not the end time.

In some embodiments, the processor may be programmed to execute a method comprising determining, based on the analysis of the at least one audio signal, a duration of time, between the start of the conversation and the end of the conversation. For example, processor 210 may be configured to determine a duration of a conversation in the received audio signal. In the example of FIG. 34A, processor 210 may determine the duration of the conversation as a time period between the start time is of the conversation and the end time t_{E} of the conversation. For example, processor 210 may determine the duration of time (e.g., duration of the conversation), DTₜₒₜₐₗ, by a difference t_{E}−t_{S}. It is contemplated, however, that processor 210 may determine the duration of the conversation in other ways, for example, by ignoring the periods of silence between voices 3420, 3430, 3440, etc., in audio signal 3410. Thus, for example, with reference to FIG. 34A, processor 210 may be configured to determine the duration of time DTₜₒₜₐₗ as a sum of the times DT_{U1}, DT_{A1}, DT_{U1}, DT_{B1}, DT_{A2}, and DT_{U3}, without including the gaps between voices 3420, 3430, and 3440 in audio signal 3410.

In some embodiments, the processor may be programmed to execute a method comprising determining, based on the analysis of the at least one audio signal, a percentage of the time, between the start of the conversation and the end of the conversation, for which the first voice is present in the audio signal. For example, processor 210 may be configured to determine a percentage of time for which one or more of the speakers was speaking during a conversation. By way of example, processor 210 may determine a percentage of time for which voice 3420 of user 100 was present in audio signal 3410 relative to a duration of a conversation DTₜₒₜₐₗ. With reference to FIG. 34A, processor 210 may determine a total time for which user 100 was speaking as a sum of the times DT_{O1}, DT_{O2}, and DT_{O3}, for example, because user 100 is illustrated as having spoken thrice during the conversation. Processor 210 may also determine a percentage of time user 100 was speaking (or during which voice 3420 of user 100 was present in audio signal 3410) based on the total duration, DTₜₒₜₐₗ, of the conversation determined, for example, as discussed above. By way of example, processor 210 may determine the percentage of time user 100 was speaking (or during which voice 3420 of user 100 was present in audio signal 3410) as a ratio given by (DT_{U1}+DT_{U2}+DT_{U3})/DTₜₒₜₐₗ. As another example, processor 210 may determine the percentage of time individual 3230 was speaking (or during which voice 3430 of individual 3230 was present in audio signal 3410) as a ratio given by (DT_{A1}+DT_{A2})/DTₜₒₜₐₗ, for example, because individual 3230 is illustrated as having spoken twice during the conversation.

In some embodiments, the processor may be programmed to execute a method comprising determining percentages of time for which the first voice is present in the audio signal over a plurality of time windows. By way of example, processor 210 may be configured to determine a percentage of time during which voice 3430 of individual 3230 was present in audio signal 3410 over a first time window from tₛ to t_{E3}. For example, as illustrated in FIG. 34A, processor 210 may determine a first percentage as a ratio given by DT_{A1}/(t_{E1}−t_{S}). Processor 210 may also determine the percentage of time during which voice 3430 of individual 3230 was present in audio signal 3410 over a second time window from t_{E1} to t_{E2}. Thus, for example, processor 210 may determine a second percentage as a ratio given by DT_{A2}/(t_{E2}−t_{E1}). Doing so my allow processor 210 to provide information about how the percentage of time individual 3230 was changing varied over time. It is to be understood that processor 210 may be configured to use time windows of equal or unequal durations for some or all or the speakers. It is to be further understood that processor 210 may be configured to determine the percentage of time each of the speakers was speaking in a conversation over a plurality of time windows.

In some embodiments, the at least one processor may be programmed to execute a method comprising providing, to the user, an indication of the percentage of the time for which the first voice is present in the audio signal. It is also contemplated that in some embodiments, the at least one processor may be programmed to execute a method comprising providing an indication of the percentage of the time for which each of the identified voices is present in the audio signal. It is further contemplated that in some embodiments, providing an indication may comprise providing at least one of an audible, visible, or haptic indication to the user. For example, as discussed above, feedback outputting unit 230 may include one or more systems for providing an indication to user 100 of the percentage of time one or more of user 100, individual 3230, individual 3230, or other speakers were speaking during a conversation. Processor 210 may be configured to control feedback outputting unit 230 to provide an indication to user 100 regarding the one or mom percentages associated with the one or more identified voices. In the disclosed embodiments, the audible, visual, or haptic indication may be provided via any type of connected audible, visual, and/or haptic system. For example, audible indication may be provided to user 100 using a Bluetooth™ or other wired or wirelessly connected speaker, a smart speaker, an in-home or in-vehicle entertainment system, or a bone conduction headphone. Feedback outputting unit 230 of some embodiments may additionally or alternatively produce a visible output of the indication to user 100, for example, as part of an augmented reality display projected onto a lens of glasses 130 or provided via a separate heads up display in communication with apparatus 110, such as a display 260. For example, display 260 for providing a visual indication may be provided as part of computing device 120, which may include an onboard automobile heads up display, an augmented reality device, a virtual reality device, a smartphone, a laptop, a desktop computer, tablet, etc. In some embodiments, feedback outputting unit 230 may include interfaces that provide tactile cues, vibrotactile stimulators, etc. for providing a haptic indication to user 100. As also discussed above, in some embodiments, the secondary computing device (e.g., Bluetooth headphone, laptop, desktop computer, smartphone, etc.) is configured to be wirelessly linked to apparatus 110.

In some embodiments, providing an indication may comprise displaying a representation of the percentage of the time for which the first voice is present in the audio signal. It is contemplated that in some embodiments, displaying the representation may comprise displaying at least one of a text, a bar chart, a pie chart, a histogram, a Venn diagram, a gauge, a heat map, or a color intensity indicator. Processor 210 may be configured to determine the one or more percentages associated with the one or more voices identified in an audio signal and generate a visual representation of the percentages for presentation to a user. For example, processor 210 may be configured to use one or more graphing algorithms to prepare bar charts or pie charts displaying the percentages. By way of example. FIG. 34B illustrates a bar chart 3460 showing the percentages of time 3462, 3464, and 3466 for which, for example, user 100 (U), individual 3230 (A) and individual 3240 (B) were speaking during a conversation represented by audio signal 3410. By way of another example, FIG. 34C illustrates the percentages of time 3462, 3464, and 3466 in the form of a pie chart 3470. As illustrated in FIG. 34C, pie chart 3470 shows, for example, that user 100 was speaking for 45% of the duration of the conversation, individual 3420 was speaking for 40% of the duration, and individual 3330 was speaking for 15% of the duration of the conversation based on an analysis of audio signal 3410 illustrated in FIG. 34A. It is also contemplated that in some embodiment, processor 210 may instead generate a heat map or color intensity map, with brighter hues and intensities representing higher percentage values and duller hues or lower intensities representing lower percentage values.

In some embodiments, the at least one processor may be programmed to execute a method comprising providing, to the user, an indication of the percentages of time for which the first voice is present in the audio signal during a plurality of time windows. As discussed above, processor 210 may be configured to determine the percentages of time for which user 100 or individual 3320, 3330 was speaking over a plurality of time windows. Processor 210 may be further configured to generate a visual representation of the percentages for a particular speaker (e.g. user 100 or individuals 3320, 3330) during a plurality of time windows. Thus, for example, processor 210 may generate, a text, a bar chart, a pie chart, a trend chart, etc., showing how the percentage of time varied during the course of a conversation.

Although the above examples refer to processor 210 of apparatus 110 as performing one or more of the disclosed functions, it is contemplated that one or more of the above-described functions may be performed by a processor included in a secondary device. Thus, in some embodiments, the at least one processor may be included in a secondary computing device wirelessly linked to the at least one microphone. For example, as illustrated in FIG. 2, the at least one processor may be included in computing device 120 (e.g., a mobile or tablet computer) or in device 250 (e.g., a desktop computer, a server, etc.). In some embodiments, the secondary computing device may include at least one of a mobile device, a smartphone, a smartwatch, a laptop computer, a desktop computer, a smart television, an in-home entertainment system, or an in-vehicle entertainment system. The secondary computing device may be linked to microphone (e.g., microphones 443, 444) via a wireless connection. For example, the at least one processor of the secondary device may communicate and exchange data and information with the microphone via a Bluetooth™, NFC, Wi-FL, WiMAX, cellular, or other form of wireless communication. By way of example, one or more audio signals generated by audio sensor 1710, and/or microphones 443, or 444 may be wirelessly transmitted via transceiver 530 (see FIGS. 17A, 17B) to a secondary device. The secondary device (e.g., computing device 120, server 250, etc.) may include a receiver configured to receive the wireless signals transmitted by transceiver 530. The at least one processor of the secondary device may be configured to analyze the audio signals received front transceiver 530 as described above.

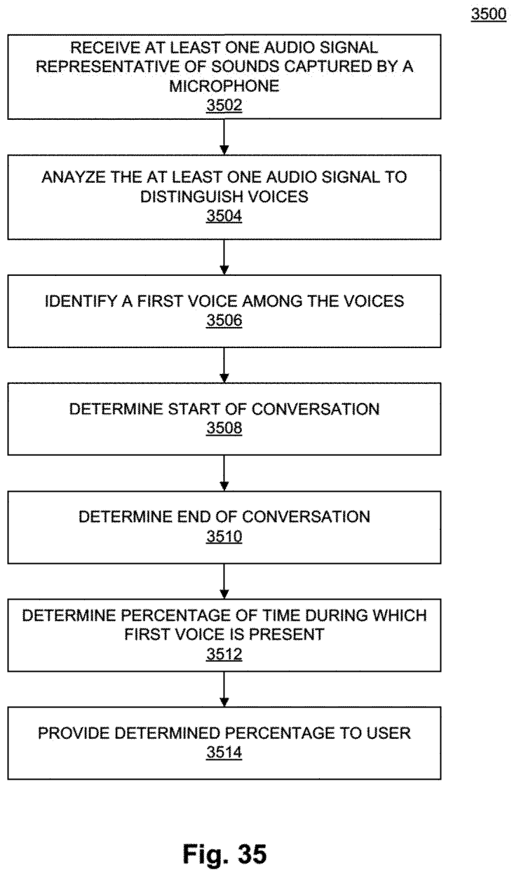

FIG. 35 is a flowchart showing an exemplary process 350) for tracking sidedness of a conversation. Process 3500 may be performed by one or more processors associated with apparatus 110, such as processor 210 or by one or more processors associated with a secondary device, such as computing device 120 and/or server 250. In some embodiments, the processor(s) (e.g., processor 210) may be included in the same common housing as microphone 443, 444, which may also be used for process 3500. In other embodiments, the processor(s) may additionally or alternatively be included in computing device 120 and/or server 250. In some embodiments, some or all of process 3500 may be performed on processors external to apparatus 110 (e.g., processors of computing device 110, server 250, etc.), which may be included in a second housing. For example, one or more portions of process 3500 may be performed by processors in hearing aid device 230, or in an auxiliary device, such as computing device 120 or server 250. In such embodiments, the processor may be configured to receive the audio signal generated by, for example, audio sensor 1710, via a wireless link between a transmitter in the common housing and receiver in the second housing.

In step 3502, process 3500 may include receiving at least one audio signal representative of the sounds captured by a microphone from the environment of the user. For example, microphones 443, 444 may capture one or more of sounds 3322, 3332, 3340, 3350, etc., from environment 3300 of user 100. Microphones 443, 444, or audio sensor 1710 may generate the audio signal in response to the captured sounds. Processor 210 may receive the audio signal generated by microphones 443, 444 and/or audio sensor 1710.

In step 3504, process 3500 may include analyzing the at least one audio signal to distinguish a plurality of voices in the at least one audio signal. For example, processor 210 may analyze the received audio signal (e.g., audio signal 3410 of FIG. 34A) captured by microphone 443 and/or 444 to identify voices of various speakers (e.g., user 100, individual 3320, individual 3330, etc.) by matching one or more of audio signals 103, 3323, 3333, etc., with voice prints stored in database 3370 or generated form earlier captured audio signals. Processor 210 may use one or more voice recognition algorithms, such as Hidden Markov Models, Dynamic Time Warping, neural networks, or other techniques to distinguish the voices associated with, for example, user 100, individual 3320, individual 3330, and/or other speakers in the audio signal.

In step 3506, process 3500 may include identifying a first voice among the plurality of voices. In step 3506, processor 210 may assign an identifier to the one or more voices recognized in the audio signal. For example, with reference to the exemplary audio signal 3410 of FIG. 34A, processor 210 may identify voice 3420 as belonging to user 100, voice 3430 as belonging to individual 3320, and voice 3440 belonging to individual 3330. As also discussed above, in some embodiments, processor 210 may also be configured to assign identifiers to any other voices distinguished but not recognized in audio signal 3410. For example, processor 210 may assign an identifier “unknown speaker 1” to a first unidentified voice, “unknown speaker 2” to a second unidentified voice and so on.

In step 3508, process 3500 may include determining a start of a conversation. For example, processor 210 may analyze an audio signal received from environment 3300 and determine a start time at which a capturing begins of a conversation between, for example, user 100, one or more individuals 3320, 3330, and/or other speakers. As discussed above, with reference to FIG. 34A, for example, processor 210 may determine a time at which one of voices 3420, 3430, 3440, or any other voice is first present in audio signal 3410. In FIG. 34A, for example, processor 210 may determine that voice 3420 of user 100 is first present in audio signal 3410 at time tₛ and that none of voices 3420, 3430, 3440, or any other voice is present in audio signal 3410 before time t_{S}. Processor 210 may identify time tₛ as a start of a conversation represented in audio signal 3410.

In step 3510, process 3500 may include determining an end of the conversation. For example, Processor 210 may be configured to determine time t_{E} as a time after which none of voices 3420, 3430, 3440, or any other voice is present in audio signal 3410, or capturing ended. With reference to the example of FIG. 34A, processor 210 may determine that none of voices 3420, 3430, 3440 is present in audio signal 3410 after time t_{E}. Processor 210 may identify time t_{E} as an end of the conversation represented in audio signal 3410. In some embodiments, determining end time t_{E} may include identifying a period in the audio signal longer than a threshold period in which no voice is present in the audio signal. For example, as illustrated in FIG. 34A, processor 210 may determine a time t_{E} at which none of voices 3420, 3430, 3440, or any other voice is detected in audio signal 3410. Processor 210 may determine a period DT₃ following time t_{E} during which none of voices 3420, 3430, 3440 is present in audio signal 3410. Processor 210 may be configured to compare the period DT₁ with a threshold time period DT_{Max}. Processor 210 may determine that time t_{E} represents an end of the conversation when the period DT₁ is equal to or greater than threshold time period DT_{Max}.

In step 3512, process 3500 may include determining a percentage of time during which a first voice is present in the conversation. For example, processor 210 may be configured to determine a duration of a conversation in the received audio signal. With reference to the example of FIG. 34A, processor 210 may determine the duration of conversation as the time period between the start of the conversation t_{S} and the end of the conversation t_{E}. Processor 210 may use one or more of the techniques discussed above to determine the duration of time, DTₜₒₜₐₗ, between the start time and end time of the conversation. In step 3512, processor 210 may be configured to determine a percentage of time for which one or more of the voices identified in the audio signal are present in the audio signal. By way of example, processor 210 may determine a percentage of time for which voice 3420 of user 100 is present in audio signal 3410 relative to a duration of a conversation DTₜₒₜₐₗ. With reference to FIG. 34A, processor 210 may determine a total time for which user 100 was speaking as a sum of the times DT_{U1}, DT_{U2}, and DT_{U3}. Processor 210 may also determine a percentage of time user 100 was speaking (or during which voice 3420 of user 100 was present in audio signal 3410) based on the total duration of the conversation determined, for example, as discussed above. By way of example, processor 210 may determine the percentage of time user 100 was speaking (or during which voice 3420 of user 100 was present in audio signal 3410) as a ratio given by (DT_{U1}+DT_{U2}+DT_{U3})/Dₜₒₜₐₗ. As another example, processor 210 may determine the percentage of time individual 3240 was speaking (or during which voice 3430 of individual 3230 was present in audio signal 3410) as a ratio given by DT_{B1}/DTₜₒₜₐₗ.

In step 3514, process 3500 may include providing the one or more determined percentages to the user. For example, processor 210 may be configured to provide an audible, a visual, or a haptic indication of the one or more percentages determined, for example, in step 3512 to user 100. For example, audible indication may be provided to user 100 using a Bluetooth™ or other wired or wirelessly connected speaker, a smart speaker, an in-home or in-vehicle entertainment system, or a bone conduction headphone. Additionally or alternatively, visual indication may be provided to user 100 using an augmented reality display projected onto a lens of glasses 130 or provided via a separate heads up display in communication with apparatus 110, such as a display 260. For example, display 260 for providing a visual indication may be provided as part of computing device 120, which may include an onboard automobile heads up display, an augmented reality device, a virtual reality device, a smartphone, a laptop, a desktop computer, tablet, etc. In some embodiments, feedback outputting unit 230 may include interfaces that provide tactile cues, vibrotactile stimulators, etc. for providing a haptic indication to user 100. As also discussed above, the indications may take the form of one or more of a text, a bar chart (e.g., FIG. 34B), a pie chart (e.g., FIG. 34C), a histogram, a Venn diagram, a gauge, a heat map, or a color intensity indicator.

Correlating Events and Subsequent Behaviors Using Image Recognition and Voice Detection

In some embodiments, systems and methods of the current disclosure may be used to correlate events and subsequent behaviors of a user using image recognition and/or voice detection. FIG. 36 is an illustration showing an exemplary user 3610 engaged in an exemplary activity (e.g., drinking coffee) with two friends 3620, 3630. Although not visible in FIG. 36, user 3610 is wearing an exemplary apparatus 110. Apparatus 110 may be worn by user 3610 in any manner. For example, apparatus 110 may be worn by user 3610 in a manner as described above with reference to any of FIGS. 1A-17C. In the discussion below, the configuration of the user's apparatus 110 will be described with reference to FIG. 17C. However, it should be noted that this is only exemplary, and apparatus 110 may have any of the previously described configurations. As previously described, apparatus 110 include, among other components, an image sensor 220, an audio sensor 1710, a processor 210, and a wireless transceiver 530a. In some embodiments, apparatus 110 may include multiple image and/or audio sensors and other sensors (e.g., temperature sensor, pulse sensor, accelerometer, etc.). Apparatus 110 may be operatively coupled (wirelessly via transceiver 530a or using a wire) to a computing device 120.

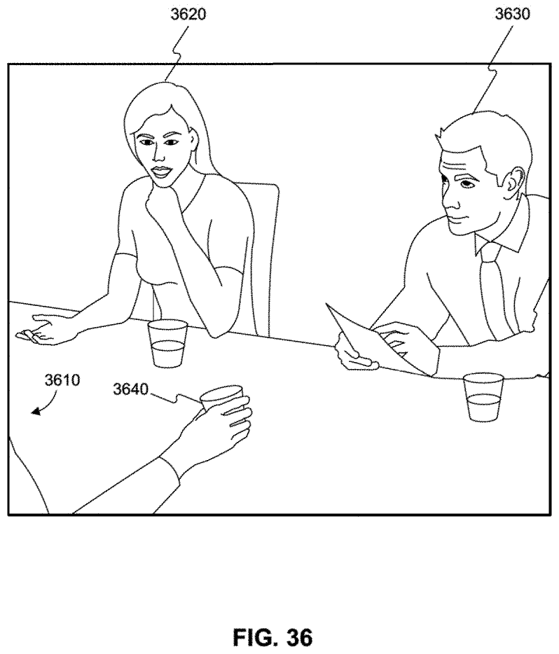

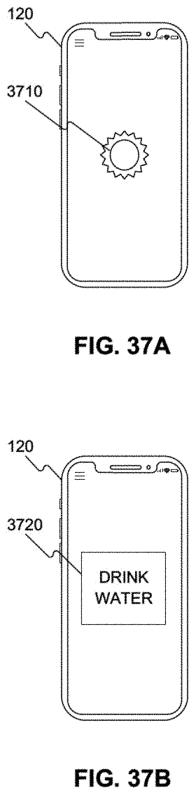

Computing device 120 may be any type of electronic device spaced apart from apparatus 110 and having a housing separate from apparatus 110. In some embodiments, computing device 120 may be a portable electronic device associated with the user, such as, for example, a mobile electronic device (e.g., cell phone, smartphone, tablet, smart watch, etc.), a laptop computer, etc. In some embodiments, computing device 120 may be a desktop computer, a smart speaker, an in-home entertainment system, an in-vehicle entertainment system, etc. In some embodiments, computing device 120 may be operatively coupled to a remotely located computer server (e.g., server 250 of FIG. 2) via a communication network 240. It is also contemplated that, in some embodiments, computing device 120 may itself be (or be a part of) the computer server 250 coupled to apparatus 110 via the communication network 240. FIGS. 37A and 37B illustrate an exemplary computing device 120 in the form of a cell phone that may be operatively coupled to apparatus 110.

Apparatus 110 (alone or in conjunction with computing device 120) may be used to correlate an action of the user (user action) with a subsequent behavior of the user (user state) using image recognition and/or voice detection. When the user is engaged in activities while wearing (or otherwise supporting) apparatus 110, image sensor 220 may capture a plurality of images (photos, video, etc.) of the environment of the user. For example, when the user is engaged in any activity (e.g., walking, reading, talking, eating, etc.) while wearing apparatus 110, the image sensor 220 of the apparatus 110 may take a series of images during the activity. In embodiments where image sensor 220 is a video camera, the image sensor 220 may captures a video that comprises a series of images or frames during the activity.

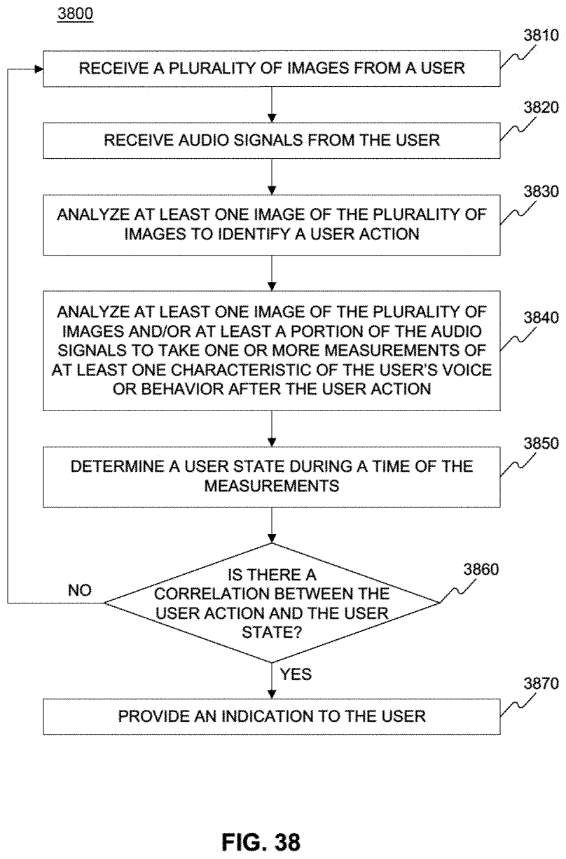

In FIG. 36, user 3610 is shown drinking a cup 3640 of a beverage (for example, coffee) with two friends 3620, 3630. FIG. 38 is a flowchart of an exemplary method 3800 used to correlate an action of the user (e.g., drinking coffee) with a subsequent behavior of the user, consistent with some embodiments. In the discussion below, reference will be made to FIGS. 36-38. While user 3610 is engaged with friends 3620, 3630, image sensor 220 of apparatus 110 may capture images of the user's environment (i.e., the scene in the field of view of the image sensor 220, for example, the table in front of user 3610, friends 3620, 3630, cup 3640, etc.) at different times. Meanwhile, audio sensor 1710 of apparatus 110 may record sound from the vicinity of apparatus 110. The sound recorded by audio sensor 1710 may include sounds produced by user 3610 and ambient noise (e.g., sounds produced by friends 3620, 3630, other people, air conditioning system, passing vehicles, etc.) from the vicinity of user 3610. Image sensor 220 may provide digital signals representing the captured plurality of images to processor 210, and audio sensor 1710 may provide audio signals representing the recorded sound to processor 210. Processor 210 receives the plurality of images from image sensor 220 and the audio signals from audio sensor 1710 (steps 3810 and 3820).

Processor 210 may analyze the images captured by image sensor 220 to identify the activity that the user is engaged in and/or an action of the user (i.e., user action) during the activity (step 3830). That is, based on an analysis of the captured images while user 3610 is engaged with friends 3620, 3630, processor 210 may identify or recognize that the user action is drinking coffee. Processor 210 may identify that user 3610 is drinking coffee based on the received image(s) by any known method (image analysis, pattern recognition, etc.). For example, in some embodiments, processor 210 may compare one or more images of the captured plurality of images (or characteristics such as color, pattern, shapes, etc. in the captured images) to a database of images/characteristics stored in memory 550a of apparatus 110 (and/or memory 550b of computing device 120) to identify that the user is drinking coffee. In some embodiments, processor 210 (or processor 540 of computing device 120) may transmit the images to an external server (e.g., server 250 of FIG. 2), and the server may compare the received images to images stored in a database of the external server and transmit results of the comparison back to apparatus 110. In some embodiments, processor 210 may detect the type of beverage that user 3610 is drinking and/or track the quantity of the beverage consumed by user 3610.

With reference to FIG. 38, processor 210 may measure one or more parameters of one or more characteristics in the received audio signal to detect or measure the effect of the user action (e.g., the effect of drinking coffee on the user's voice or behavior) (step 3840). For example, after recognizing that the user is drinking coffee (or engaged in any other user action), processor 210 may measure parameter(s) of one or more characteristics in the audio signal recorded by audio sensor 1710. In general, the measured parameters may be associated with any characteristic of the user's voice that indicates a change in the user's voice resulting from the user action. These characteristics may include, for example, pitch of the user's voice, tone of the user's voice, rate of speech of the user's voice, volume of the use's voice, center frequency of the user's voice, frequency distribution of the user's voice, responsiveness of the user's voice, and particular sounds (e.g., yawn, etc.) in the user's voice. Any parameter(s) associated with one or more of these characteristics (e.g., strength, frequency, variation of amplitude, etc. of the audio signal) may be measured by processor 210. In some embodiments, based on analysis of the received audio signal, processor 210 may distinguish (e.g., filter) the sound of the user's voice from other sounds captured by the audio sensor 1710, and measure parameters of the desired characteristics of the user's voice from the filtered audio signal. For example, processor 210 may first strip ambient noise from the received audio signal (e.g., by passing the audio signal through filters) and then measure the parameters from the filtered signal. In some embodiments, the user's voice may be separated from other captured sounds, such as voices of other people in the environment. In some embodiments, processor 210 may track the progression of the measured parameters) over time.

In some embodiments, in step 3840, processor 210 may measure one or more parameters of one or more characteristics in the captured plurality of images to detect the effect of the user action (e.g., drinking coffee) on the user's behavior. That is, instead of or in addition to measuring the parameters of the user's voice after drinking coffee to detect the effect of coffee on the user, processor 210 may measure parameters from one or more images captured by image sensor 220 after the user action to detect the effect of coffee on the user. For example, after recognizing that the user is drinking coffee (or engaged in any other user action), processor 210 may measure one or more parameters of characteristics in subsequent image(s) captured by image sensor 220. In general, the measured characteristics may include any parameter(s) in the images that indicates a change in the user's behavior resulting from the user action. The measured characteristics may be indicative of, for example, hyper-activity by the user, yawning by the user, shaking of the user's hand (or other body part), whether the user is lying down, a period of time the user is lying down, gesturing differently, whether the user takes a medication, hiccups, etc. In some embodiments, processor 210 may track the progression of the measured parameters) over time. In some embodiments, a single parameter (e.g., frequency) of a characteristic (pitch of the user's voice) may be measured, while in some embodiments, multiple parameters of one or more characteristics may be measured (e.g., frequency, amplitude, etc. pitch of the user's voice, length of time the user is lying down, shaking of the user's hand, etc.). In some embodiments, in step 3840, processor 210 may measure both the parameters of characteristics in the audio signal and parameters of characteristics in the captured images to detect the effect of drinking coffee on the user.

Based on the measured parameter(s) of the characteristic(s) in the audio signal and/or the images, processor 210 may determine a state of the user (e.g., hyper-active state, etc.) when the measurements were taken (step 3850). In some embodiments, to determine the state of the user (or user state), processor 210 may classify the measured parameters and/or characteristic(s) of the user's voice or behavior based on a classification rule corresponding to the measured parameter or characteristic. In some embodiments, the classification rule may be based on one or more machine learning algorithms (e.g., based on training examples) and/or may be based on the outputs of one or more neural networks. For example, in embodiments where the pitch of the user's voice is measured after drinking coffee, based on past-experience (and or knowledge in the art), variations in the pitch of a person's (or the user's) voice after drinking different amounts of coffee may be known or measured. Based on this preexisting knowledge, processor 210 may be trained to recognize the variation in the pitch of user's speech after coffee. In some embodiments, processor 210 may track the variation of the user state (e.g., hyper-activity) with the amount of coffee that user 3610 has drunk. In some embodiments, memory 550a (and/or memory 550b) may include a database of the measured parameter and/or characteristic and different levels of user state (e.g., hyper-activity levels), and processor 210 may determine the user state by comparing the measured parameter with those stored in memory 550a.

In some embodiments, the measured parameters may be input into one or more neural networks and the output of the neural networks may indicate the state of the user. Any type of neural network known in the art may be used. In some embodiments, the measured parameter(s) may be scored and compared with known range of scores to determine the user state. For example, in embodiments where the pitch of the user's voice is measured, the measured pitch may be compared to values (or ranges of values stored in memory 550a) that is indicative of a hyperactive state, in some embodiments, the state of the user may be determined based on a comparison of one or more parameters measured after drinking coffee (or other user action) with those measured before drinking coffee. For example, the pitch of the user's voice measured after drinking coffee may be compared to the pitch measured before drinking coffee, and if the pitch after drinking coffee varies from the pitch before drinking coffee by a predetermined amount (e.g., 10%, 20%, 50%, etc.), the user may be determined to be in a hyperactive state. It should be noted that the above-described methods of determining the user state based on the measured parameter(s)/characteristic(s) are exemplary. Since other suitable methods are known in the art, they are not extensively described herein. In general, any suitable method known in the art may be used to detect the state of the user based on the measured parameter(s) of the characteristic(s) in the audio signal and/or the images.

After determining the user state, processor 210 may determine whether there is a correlation between the user action (e.g., drinking coffee) and the determined user state (step 3860). That is, processor 210 may determine if there is correlation between the user drinking coffee and being in a hyperactive state. In some embodiments, processor 210 may determine whether there is a correlation by first classifying the user action based on a first classification rule (e.g., by analyzing one or more captured images and then classifying the analyzed one or more images) and then classifying the measured parameters based on a second classification rule corresponding to the characteristic of the measure parameter. Processor 210 may determine that there is a correlation between the user action and the user state if the user action and the measured parameters are classified in corresponding classes. In some embodiments, memory 550a (and/or memory 550b) may include a database that indicates different parameter values for different user actions and user states, and processor 210 may determine if there is a correlation between the user action and the user state by comparing the measured parameter values with those stored in memory. For example, memory 550a (and/or memory 550b) may store typical values of pitch (volume, etc.) of the user's voice for different levels of hyperactivity, and if the detected user action is drinking coffee, processor 210 may compare the measured pitch (or volume) with those stored in memory to determine if there is a correlation between the user action and the user state. In some embodiments, similar to determining the user state in step 3850, the classification rule for determining if there is a correlation between the user action and the user state may also be based on one or more machine learning algorithms trained on training examples and/or based on the outputs of one or more neural networks.

In some embodiments, if it is determined that there is a correlation between the user action and the user state (i.e., step 3860=YES), processor 210 may provide to the user an indication of the correlation (step 3870). If it is determined that there is no correlation between the user action and the user state (i.e., step 3860=NO), processor 210 may continue to receive and analyze the images and audio signals. In some embodiments, in step 3870, the indication may be an audible indication (alarm, beeping sound, etc.) or a visible indication (blinking lights, textual display, etc.). In some embodiments, the indication may be a tactile (e.g., vibratory) indication. In some embodiments, multiple types of indication (e.g., visible and audible, etc.) may be simultaneously provided to the user. In general, the indication may be provided via apparatus 110, computing device 120, or another device associated with the apparatus 110 and/or computing device 120. For example, in some embodiments, an audible, visible, and/or tactile indication may be provided via apparatus 110. Alternatively, or additionally, an audible, visible, and/or tactile indication may be provided via computing device 120. For example, in some embodiments, as illustrated in FIG. 37A, when processor 210 determines that user 3610 is in a hyper-active state because of drinking coffee, a blinking indicator 3710 may be activated in computing device 120 to indicate to user 3610 that hyperactivity has been detected. In some embodiments, the indication may be provided on another device that is operatively connected to apparatus 110 and/or computing device 120. For example, in some embodiments, the indication may be an audible signal provided to a hearing aid or a headphone/earphone of the user. It is also contemplated that, in some embodiments, the indication may be provided to another electronic device (e.g., phone, etc.) that is associated with the user. For example, in embodiments where computing device 120 is the user's cell phone, the indication may be provided to a second cell phone (e.g., an automated call to the second cell phone) enabled and authorized to receive such indications. As another example, the indication may be provided to another person (e.g., calling a relative, spouse, etc., of the user). In yet another example, the user may receive a warning at a time in the future (e.g., hours, days, weeks, months, etc.) so that the user alters his or her behavior and does not become hyperactive. Accordingly, the at least one of the audible or the visible indication of the correlation is provided a predetermined amount of time after capturing the at least one image.

The indication provided to the user may have any level of detail. For example, in some embodiments, the indication may merely be a signal (audible, visual, or tactile signal) that indicates that the user is, for example, hyperactive. In some embodiments, the indication may also provide more details, such as, for example, the level of hyperactivity, etc. It is also contemplated that, in some embodiments, the indication may also include addition information related to the determined user action and user state. For example, when the determined user action is drinking coffee and the determined user state is hyperactivity, the additional information provided to user 3610 may include information on how to reduce the detected level of hyperactivity, etc. In some embodiments, as illustrated in FIG. 37B, the additional information may be provided to user 3610 as a text indicator 3720 in computing device 120. In some embodiments, processor 210 may analyze patterns over time, and provide feedback to user 3610. For example, if after drinking milk (i.e., the user action is drinking milk), the user's energy (i.e., user state is energy level) is frequently lower, the text indicator 3720 may provide a warning that user 3610 may be allergic to milk.

Any type of user action and user state may be determined by processor 210. Typically, the type of user state depends on the type of user action determined. Without limitation, the types of user action determined by processor 210 may include whether the user is consuming a specific food or beverage such as coffee, alcohol, sugar, gluten, or the like, meeting with a specific person, taking part in a specific activity such as a sport, using a specific tool, going to a specific location, etc. The determined user state may be any state of the user that results from the user action and that may be determined based on the images from image sensor 220 and/or audio signals from audio sensor 1710. For example, if the user is engaged in exercise (e.g., running, etc.), the user state may include irregular or rapid breathing detected from the audio signals, unsteady gait, etc. detected from the images, etc.

Although processor 210 of apparatus 110 is described as receiving and analyzing the images and audio signals, this is only exemplary. In some embodiments, image sensor 220 and audio sensor 1710 of apparatus 110 may transmit the recorded images and audio signals to computing device 120 (e.g., via wireless transceivers 530a and 530b). Processor 540 of computing device 120 may receive and analyze these images and audio signals using a method as described with reference to FIG. 38. In some embodiments, processor 540 of computing device 120 may assist processor 210 of apparatus 110 in performing the analysis and notifying the user. For example, apparatus 110 may transmit a portion of the recorded images and audio signals to computing device 120. Any portion of the recorded images and audio signals may be transmitted. In some embodiments, the captured images may be transmitted to computing device 120 for analysis and the recorded audio signals may be retained in apparatus 110 for analysis. In some embodiments, the audio signals may be transmitted to computing device 120 and the captured images may be retained in apparatus 110. Processor 210 analyzes the portion of the signals retained in apparatus 110, and processor 540 analyzes the portion of the signal received in computing device 120. Apparatus 110 and computing device 120 may communicate with each other and exchange data during the analysis. After the analysis, if it is determined that there is a correlation between the user action and the user state, apparatus 110 or computing device 120 provides an indication of the correlation to the user.

In some embodiments, apparatus 110 and/or computing device 120 may also transmit and exchange information/data with a remotely located computer server 250 (see FIG. 2) during the analysis. In some such embodiments, computer sever 250 may communicate with, and analyze data from, multiple apparatus 110 each worn by a different user to inform each user of a correlation between that user's action and state. In such embodiments, the apparatus 110 associated with each user collects data (plurality of images and audio signals) associated with that user and transmits at least a portion of the collected data to computer server 250. Computer server 250 then performs at least a portion of the analysis using the received data. After the analysis, if there is a correlation between the determined user action and user state, an indication of the correlation is provided to the individual user via the users apparatus 10 (or another associated device, such as, for example, a cell phone, tablet, laptop, etc.).

In summary, the disclosed systems and methods used to correlate user actions with subsequent behaviors of the user using image recognition and/or voice detection may use one or more cameras to identify a behavior impacting action of the user (e.g., exercising, socializing, eating, smoking, talking, etc.), capture the users voice for a period of time after the event, based on the audio signals and/or image analysis, characterize how the action impacts subsequent behavior of the user, and provide feedback.

Alertness Analysis Using Hybrid Voice-Image Detection

In some embodiments, systems and methods of the current disclosure may identify an event (e.g., driving a car, attending a meeting) that the user is currently engaged in from images acquired by a wearable apparatus 110 that the user is wearing, analyze the voice of user to determine an indicator of alertness of the user, track how the determined alertness indicator changes over time relative to the event; and output one or more analytics that provide a correlation between the event and the user's alertness. For example, the user's alertness may correspond to the user's energy level, which may be determined based on user's speed of speech, tone of user's speech, responsiveness of the user, etc.

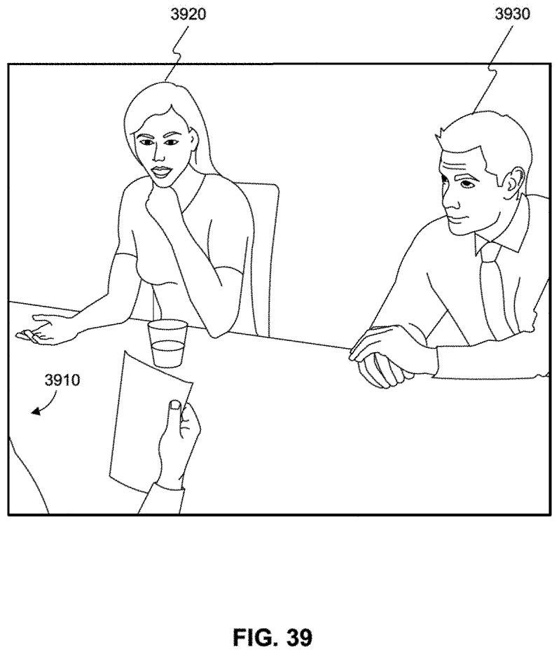

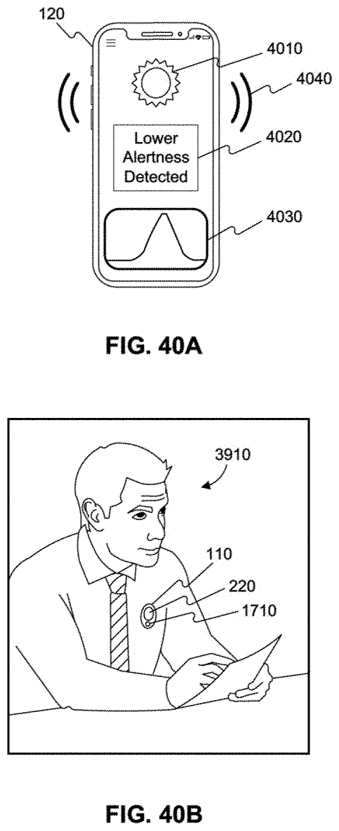

In the discussion below, reference will be made to FIGS. 39-41. FIG. 39 is an illustration showing an exemplary user 3910 participating in an exemplary event: a meeting with two colleagues 3920, 3930. FIG. 40B illustrates a view of the user 3910 at this meeting. As seen in FIG. 40B, user 3910 is wearing an exemplary apparatus 110. Apparatus 110 may be worn by user 3910 in any manner. For example, apparatus 110 may be worn by user 3910 in a manner as described above with reference to any of FIGS. 1A-17C. In the discussion below, the configuration of the user's apparatus 110 will be described with reference to FIG. 17C. However, it should be noted that this is only exemplary, and apparatus 110 may have any of the previously described configurations. As previously described, apparatus 110 may include, among other components, an image sensor 220, an audio sensor 1710, a processor 210, and a wireless transceiver 530a. In some embodiments, apparatus 110 may include multiple image and/or audio sensors and other sensors (e.g., temperature sensor, pulse sensor, etc.) incorporated thereon. Apparatus 110 may be operatively coupled (wirelessly via transceiver 530a or using a wire) to a computing device 120. In some embodiments, apparatus 110 may include a microphone or a plurality of microphones or a microphone array.

Computing device 120 may be any type of electronic device spaced apart from apparatus 110 and having a housing separate from apparatus 110. In some embodiments, computing device 120 may be a portable electronic device associated with the user, such as, for example, a mobile electronic device (cell phone, smart phone, tablet, smart watch, etc.), a laptop computer, etc. In some embodiments, computing device 120 may be a desktop computer, a smart speaker, an in-home entertainment system, an in-vehicle entertainment system, etc. In some embodiments, computing device 120 may be operatively coupled to a remotely located computer server (e.g., server 250 of FIG. 2) via a communication network 240. It is also contemplated that, in some embodiments, computing device 120 may itself be (or be a part of) computer server 250 coupled to apparatus 110 via the communication network 240. FIG. 40A illustrates an exemplary computing device 120 in the form of a cell phone that may be operatively coupled to apparatus 110.

Apparatus 110 (alone or in conjunction with computing device 120) may be used to identify an event that the user 3910 is engaged in, track alertness of the user 3910 during the event, and provide an indication of the tracked alertness to the user. When the user is engaged in any activity or event while wearing (or otherwise supporting) apparatus 110, image sensor 220 of apparatus 110 may capture a plurality of images (photos, video, etc.) of the environment of the user. For example, when the user is engaged in any activity (e.g., participating in a meeting, walking, reading, talking, eating, driving a car, engaging in a conversation with at least one other individual etc.) while wearing apparatus 110, image sensor 220 of apparatus 110 may capture images during the activity. In embodiments where image sensor 220 is a video camera, the image sensor 220 may capture a video that comprises images or frames during the activity. Similarly, when the user is engaged in any activity or event while wearing (or otherwise supporting) apparatus 110, audio sensor 1710 of apparatus 110 may capture audio signals from the environment of the user.

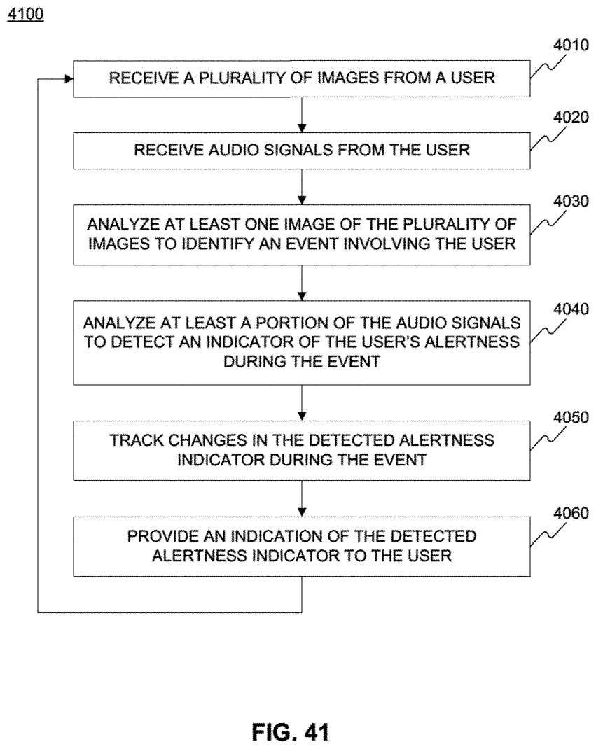

In FIG. 39, user 3910 is shown to be engaged in an exemplary event (i.e., a meeting with colleagues 3920, 3930). FIG. 41 is a flowchart of an exemplary method 4100 used to track alertness of the user 3910 during the meeting and provide an indication of alertness to the user 3910. While user 3910 is participating in the meeting, image sensor 220 of apparatus 110 may capture images of the user's environment (i.e., the scene in the field of view of image sensor 220 and, for example, images of colleagues 3920, 3930 at the meeting, images of the user's hands that move into the field of view of image sensor 220, etc.). Meanwhile, audio sensor 1710 of apparatus 110 may record sound from the vicinity of apparatus 110. The sound recorded by audio sensor 1710 may include sounds (e.g., speech and other noises) produced by user 3910, sounds produced by colleagues 3920, 3930, and ambient noise (e.g., sounds produced by other people, air conditioning system, etc.) from the vicinity of user 3910. Image sensor 220 may provide digital signals representing the captured plurality of images to processor 210, and audio sensor 1710 may provide audio signals representing the recorded sound to processor 210. Processor 210 may receive the plurality of images from image sensor 220 and the audio signals from audio sensor 1710 (steps 4010 and 4020).

Processor 210 may analyze the images acquired by image sensor 220 to identify the event that the user is engaged in (user event) currently (step 4030). That is, based on analysis of the images while user 3910 is engaged in the meeting with colleagues 3920, 3930, processor 210 may identify or recognize that user 3910 is participating in a meeting. Processor 210 may identify that user 3910 is engaged in a meeting based on the received image(s) by any known method (image analysis, pattern recognition, etc.). For example, in some embodiments, processor 210 may compare one or more images of the captured plurality of images (or characteristics such as color, pattern, shapes, etc. in the captured images) to a database of images/characteristics stored in memory 550a of apparatus 110 (and/or memory 550b of computing device 120) to identify that the user is participating in a meeting. In some embodiments, processor 210 (or processor 540 of computing device 120) may transmit the images to an external server (e.g., server 250 of FIG. 2), and the server may compare the received images to images stored in a database of the external server and transmit results of the comparison back to apparatus 110.

Processor 210 may analyze at least a portion of the audio signal received from audio sensor 1710 of apparatus 110 (in step 4020) to detect an indicator of the user's alertness during the meeting (step 4040). For example, after recognizing that the user is engaged in a meeting (or in any other user event), processor 210 may detect or measure parameter(s) of one or more characteristics in the audio signal recorded by audio sensor 1710. In general, the measured parameters may be associated with any characteristic of the user's voice or speech that is indicative of alertness of the user 3910, or a change in the user's alertness, during the meeting. These characteristics may include, for example, a rate of speech of the user, a tone associated with the user's voice, a pitch associated with the user's voice, a volume associated with the user's voice, a responsiveness level of the user, frequency of the user's voice, and particular sounds (e.g., yawn, etc.) in the user's voice. Any parameter(s) (such as, for example, amplitude, frequency, variation of amplitude and/or frequency, etc.) associated with one or more of the above-described characteristics may be detected/measured by processor 210 and used as an indicator of the user's alertness. In some embodiments, processor 210 may detect the occurrence of particular sounds (e.g., sound of a yawn) in the received audio signal (in step 4020), and use the occurrence (or frequency of occurrence) of these sounds as an indicator of the user's alertness. In some embodiments, processor 210 may distinguish (e.g., filter) the sound of the user's voice from other sounds in the received audio signal, and measure parameters of the desired characteristics of the user's voice from the filtered audio signal. For example, processor 210 may first strip the sounds of colleagues 3920, 3930 and ambient noise from the received audio signal (e.g., by passing the audio signal through filters) and then measure parameters from the filtered signal to detect the user's alertness.

In some embodiments, processor 210 may measure the user's responsiveness level during the meeting and use it as an indicator of alertness. An average length of time between conclusion of speech by an individual other than the user (e.g., one of colleagues 3920, 3930) and initiation of speech by the user 3910 may be used an indicator of the user's responsiveness. In some embodiments, processor 210 may measure or detect the time duration between the end of a colleague's speech and the beginning of the user's speech, and use this time duration as an indicator of the user's alertness. For example, a shorter time duration may indicate that the user is more alert than a longer time duration. In some embodiments, processor 210 may use a time duration that the user does not speak as an indication of the user's alertness. In some such embodiments, processor 210 may first filter ambient noise from the received audio signal (in step 4020) and then measure time duration from the filtered audio signal (e.g., relative to a baseline of the user's past environments).

Processor 210 may track the detected parameter (in step 4040) over time during the meeting to detect changes in the user's alertness during this time (step 4050). In some embodiments, a single parameter (e.g., frequency) of a characteristic (e.g., pitch of the user's voice) may be measured and used as an indicator of the user's alertness. In other embodiments, processor 210 may measure multiple parameters (amplitude, frequency, etc.) of one or more characteristics (pitch, tone, etc.) in the received audio signal (in step 4020) to detect and track (steps 4040 and 4050) the change in user's alertness during the meeting. In some embodiments, the measured parameter(s) (in steps 4040 and 4050) may be input into one or more models such as neural networks and the output of the neural networks may indicate the alertness of the user. Any type of neural network known in the art may be used, in some embodiments, the user's alertness may be determined based on a comparison of the measure parameters over time. For instance, the pitch (or volume, responsiveness, etc.) of the user's voice at any time during the meeting may be compared to the pitch measured at the beginning of the meeting (or at prior events or times, or averaged over a plurality of times, and stored in memory) and used as an indicator of the user's alertness. For example, if the pitch during the meeting varies from the pitch at the beginning of the meeting or the stored pitch by at least a predetermined amount (e.g., 10%, 20%, 50%, etc.), processor 210 may determine that the user's alertness is decreasing or lower. It should be noted that the above-described methods of determining alertness level of the user 3910 are only exemplary. Any suitable method known in the art may be used to detect the user's alertness based on any parameter associated with the received audio signals.

Processor 210 may provide an indication of the detected alertness to user 3910 (step 4060). The indication may be an audible indication (alarm, beeping sound, etc.) or a visible indication (blinking lights, textual display, etc.). In some embodiments, the indication may be a tactile indication (e.g., vibration of apparatus 110, etc.). In some embodiments, multiple types of indication (e.g., visible and audible, etc.) may be simultaneously provided to user 3910. The indication may be provided in apparatus 110, computing device 120, or another device associated with the apparatus 110 and/or computing device 120. For example, in some embodiments, an audible, visible, and/or tactile indication may be provided on apparatus 110 worn by user 3910 (see FIG. 40B). Alternatively, or additionally, an audible, visible, and/or tactile indication may be provided on computing device 120.

In some embodiments, an indication of the user's alertness may be provided irrespective of the level of the detected alertness. For example, an indication may be provided to user (in step 4060) whether the detected alertness level is high or low. In some embodiments, an indication may be provided to user (in step 4060) if the detected alertness level is below a predetermined level. For example, when processor 210 determines that the alertness level of user 3910 is below a predetermined value, or has decreased by a threshold amount (e.g., 20%, 40%, etc. relative to the user's alertness at the beginning of the meeting), an indication may be provided to user 3910. As illustrated in FIG. 40A, the indication of step 4060 may be provided by activating a blinking indicator 4010 and/or a sound indicator 4020 in computing device 120 to notify user 3910 that a decrease in alertness has been detected. In some embodiments, the indication may be provided on another device that is operatively connected to apparatus 110 and/or computing device 120. For example, in some embodiments, the indication may be an audible signal (or a tactile signal) provided to a hearing aid or a headphone/earphone of user 3910. It is also contemplated that, in some embodiment, the indication may be provided to another electronic device (e.g., phone, etc.) that is associated with user 3910. For example, in embodiments where computing device 120 is the user's cell phone, the indication may be provided to a second cell phone (e.g., an automated call to the second cell phone) enabled and authorized to receive such indications.

The indication provided to the user may have any level of detail. For example, in some embodiments, the indication may be a signal (audible, visual, or tactile signal) that indicates that the alertness of user 3910 is decreasing. In some embodiments, the indication may provide more details, such as, for example, the level of alertness, the amount of decrease detected, variation of the detected alertness over time, characteristics computed using the detected alertness parameter, the time when a decrease exceeding a threshold value was first measured, etc. For example, as illustrated in FIG. 40A, the indication may include a textual indicator 4020 that notifies the user that alertness is decreasing. In some embodiments, the detected decrease in the alertness level may also be indicated as a textual indicator 4020. In some embodiments, the indication provided to user 3910 may include a graphical representation 4030 of the variation or trend of the user's alertness during the event. It is also contemplated that, in some embodiments, the indication may also include additional information related to the determined user event and alertness level. For example, when the determined user event is a meeting and it is detected that the user's alertness is decreasing (or has decreased below a threshold value), the additional information provided to user 3910 may include information on how to increase alertness, etc. In some embodiments, processor 210 may analyze patterns over time, and provide feedback to user 3910. For example, if the detected alertness increased while drinking coffee, the indication may notify user 3910 of this observation.

It should be noted that, although the user's alertness level is described as being monitored in the description above, this is only exemplary. Any response of the user during an event may be monitored. Typically, the monitored response depends on the activity or the event that the user is engaged in. For example, if user 3910 is engaged in exercise (e.g., running, etc.), processor 210 may detect the breathing of user 3910 from the received audio signals to detect irregular or rapid breathing, etc.

Although processor 210 of apparatus 110 is described as receiving and analyzing the images and audio signals (steps 4010, 4020), this is only exemplary. In some embodiments, image sensor 220 and audio sensor 1710 of apparatus 110 may transmit the recorded images and audio signals to computing device 120 (e.g., via wireless transceivers 530a and 530b). Processor 540 of computing device 120 may receive and analyze these images and audio signals as described above (steps 4030-4050). In some embodiments, processor 540 of computing device 120 may assist processor 210 of apparatus 110 in performing the analysis and notifying the user. For example, apparatus 110 may transmit a portion of the recorded images and audio signals to computing device 120. Any portion of the recorded images and audio signals may be transmitted. In some embodiments, the captured images may be transmitted to computing device 120 for analysis and the recorded audio signals may be retained in apparatus 110 for analysis. In some embodiments, the audio signals may be transmitted to computing device 120 and the captured images may be retained in apparatus 110. Processor 210 may analyze the portion of the signals retained in apparatus 110, and processor 540 may analyze the portion of the signal received in computing device 120. Apparatus 110 and computing device 120 may communicate with each other and exchange data during the analysis. After the analysis, apparatus 110 or computing device 120 may provide an indication of the detected alertness to user 3910 (step 4060).

In some embodiments, apparatus 110 and/or computing device 120 may also transmit and exchange information/data with a remotely located computer server 250 (see FIG. 2) during the analysis. In some such embodiments, computer sever 250 may communicate with, and analyze data from, multiple apparatus 110 each worn by a different user to notify each user of a detected alertness indicator of that user. In such embodiments, apparatus 110 associated with each user may collect data (plurality of images and audio signals) associated with that user and transmit at least a portion of the collected data to computer server 250 (directly or via an intermediate computing device 120). Computer server 250 may perform at least a portion of the analysis on the received data. After the analysis, the user's apparatus 110 or a computing device 120 associated with the user's apparatus 110 (for example, a cell phone, tablet, laptop, etc.) may provide an indication of the detected alertness to the user.

In summary, the disclosed systems and methods may identify an event that the user is currently engaged in from the images captured by wearable apparatus 110, analyze audio signals from the user during the event to determine the user's alertness, and notify the user of the detected alertness.

Personalized Keyword Log

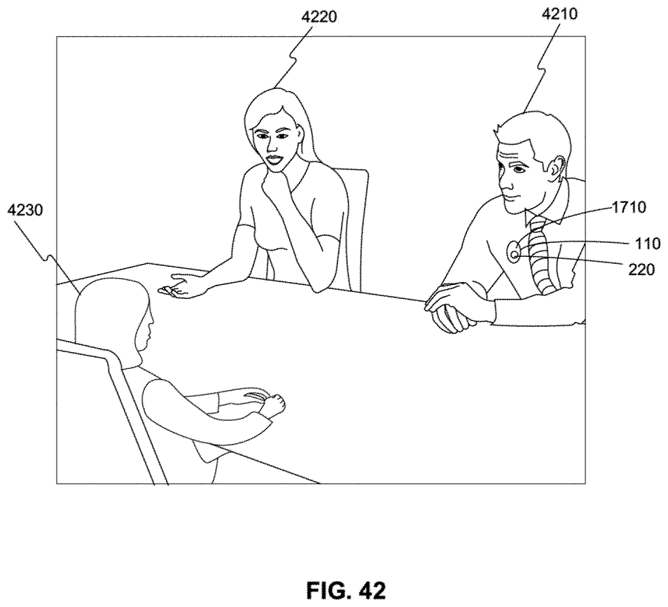

In some embodiments, systems and methods of the current disclosure may enable a user to select a list of key words, listen to subsequent conversations, identify the utterance of the selected key words in the conversation, and create a log with details of the conversation and the uttered key words. FIG. 42 is an illustration showing an exemplary user 4210 engaged in an activity (e.g., socializing) with other individuals (e.g., two friends 4220, 4230). As illustrated in FIG. 42, user 4210 is wearing an exemplary apparatus 110. Apparatus 110 may be worn by user 4210 in any manner. For example, apparatus 110 may be worn by user 4210 in a manner as described above with reference to any of FIGS. 1A-17C. In the discussion below, the configuration of the user's apparatus 110 will be described with reference to FIG. 17C. However, it should be noted that this is only exemplary, and apparatus 110 may have any of the previously described configurations. As previously described, apparatus 110 includes, among other components, an image sensor 220, an audio sensor 1710, a processor 210, and a wireless transceiver 530a. In some embodiments, apparatus 110 may include multiple image and/or audio sensors and other sensors. Apparatus 110 may be operatively coupled (wirelessly via transceiver 530a or using a wire) to a computing device 120.

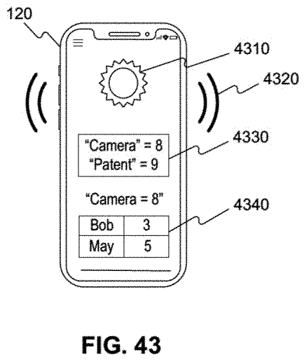

Computing device 120 may be any type of electronic device spaced apart from apparatus 110 and having a housing separate from apparatus 110. In some embodiments, computing device 120 may be a portable electronic device associated with the user, such as, for example, a mobile electronic device (e.g., cell phone, smart phone, tablet, smart watch, laptop computer, etc. In some embodiments, computing device 120 may be a desktop computer, a smart speaker, an in-home entertainment system, an in-vehicle entertainment system, etc. In some embodiments, computing device 120 may be operatively coupled to a remotely located computer server (e.g., server 250 of FIG. 2) via a communication network 240. It is also contemplated that, in some embodiments, computing device 120 may itself be (or be a part of) the computer server 250 coupled to apparatus 110 via the communication network 240. FIG. 43 illustrates an exemplary computing device 120 in the form of a cell phone that may be operatively coupled to apparatus 110.

With reference to FIG. 42, apparatus 110 (alone or in conjunction with computing device 120 and/or computer server 250) may be used to capture audio signals of conversations between user 4210 and friends 4220, 4230, identify the utterance of key words in these conversations, and create a log of the conversations in which the key words were spoken. In some embodiments, user 4210 may select a list of key words for apparatus 110 to monitor. Although described as a key “word,” as used in the current disclosure, a key word may include any word, phrase, or sentence, and these key words may be selected in any manner. In some embodiments, user 4210 (or another person) may select one or more key words from a list of words (phrases, etc.) presented, for example, on a display of computing device 120, computer server 250, etc. In some embodiments, user 4210 (or another person) may utter and record one or more words (for example, using audio sensor 1710 of apparatus 110) that are desired to be used as key words. In some embodiments, user 4210 (or another person) may type one or more words (for example, for example using computing device 120 or another computing platform) that am desired to be used as key words. Thus, a key word may include any predetermined or preselected word or phrase.

Processor 210 (processor 540 of computing device 120 or another processor) may digitize one or more audio signals corresponding to one or more recorded or typed words and use them as key words. In some embodiments, when user 4210 is engaged in any event (e.g., socializing with friends 4220 and 4230), and apparatus 110 is recording the conversation during the event, user 4210 may press (otherwise activate) function button 430 of apparatus 110 (see FIG. 4B). In response to this activation, apparatus 110 may use the immediately preceding word (or immediately succeeding word) in the conversation as a key word. For example, user 4210 may bear (for example) the name “David,” being repeatedly mentioned during the discussion and may wish to keep a record of how many times this name is mentioned (by whom, in what context, the tone, etc.). Therefore, the next time someone mentions “David,” user 4210 may activate function button 430 to indicate to apparatus 110 that the immediately preceding word (i.e., “David”) is a key word. Apparatus 110 may then monitor the conversation (at the event) to identify and catalog subsequent mentions of the key word. “David.” In some embodiments, processor 210 of apparatus 110 may dynamically identify a key word based, for example, on a word (or string of words) spoken by a participant at the event. It should be noted that the above-described methods of selecting key words for apparatus 110 to monitor are only exemplary. In general, the key words may be selected in any manner. It should also be noted that although user 4210 is described as selecting the key words to be monitored, in general, the key words can be selected by any person, apparatus (e.g., computer, etc.), or algorithm.

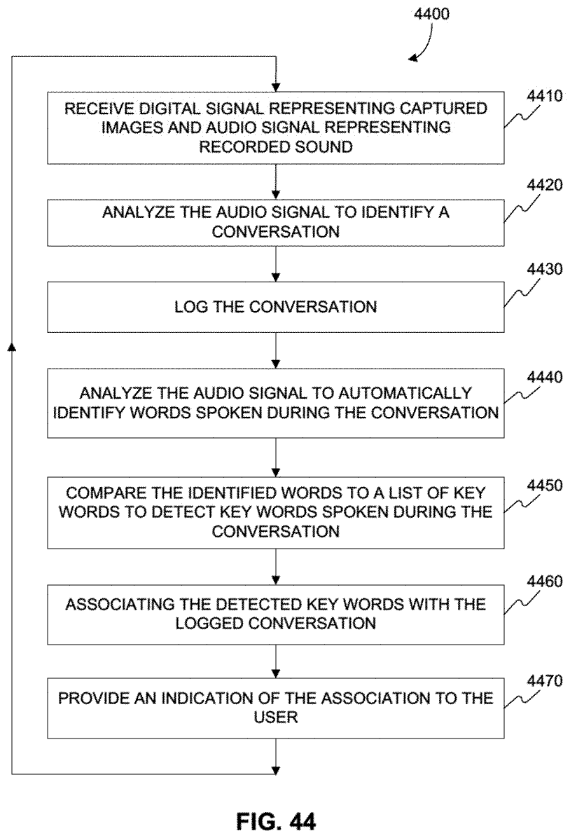

With reference to FIG. 42, when user 4210 is socializing (or engaged in any other activity) with friends 4220, 4230 while wearing (or otherwise supporting) apparatus 110, audio sensor 1710 of apparatus 110 may record sound from the vicinity of apparatus 110 during the event. The sound recorded by audio sensor 1710 may include sounds produced by user 4210 and friends 4220, 4230 (e.g., the conversation between them) and other sounds from the vicinity of user 4210 (e.g., other people talking, sound from air conditioning system, etc.). Meanwhile, image sensor 220 of apparatus 110 may capture a plurality of images (photos, video, etc.) of the environment of the user during the event. For example, image sensor 220 may take a series of images at different times (or video) of people and objects in the field of view of image sensor 220. While listening to the conversation between user 4210 and friends 4220, 4230, apparatus 110 and/or computing device 120) may identify (or recognize) each time one of the previously selected key words is mentioned during the conversation, and create a log associating the identified key words with different aspects of the conversation. FIG. 44 is a flowchart of an exemplary method 4400 that may be used to identify key words in the conversation and to associate the identified key words with the different aspects (uttered or spoken by who, when, in what context, tone of speech, emotion, etc.) of the conversation. In the discussion below, reference will be made to FIGS. 42-44.

When user 4210 is engaged with friends 4220, 4230, image sensor 220 may provide digital signals representing the captured plurality of images to processor 210. Audio sensor 1710 may provide audio signals representing the recorded sound to processor 210. Processor 210 may receive the plurality of images from image sensor 220 and the audio signals from audio sensor 1710 (step 4410. Processor 210 may then analyze the received audio signals from audio sensor 1710 to recognize or identify that user 4210 is engaged in a conversation (step 4420). In some embodiments, in step 4420, processor 210 may also identify the context or the environment of the event (type of meeting, location of meeting, etc.) during the conversation based on the received audio and/or image signals. For example, in some embodiments, processor 210 may identity the type of event (e.g., professional meeting, social conversation, party, etc.) that user 4210 is engaged in, based on, for example, the identity of participants, number of participants, type of recorded sound (amplified speech, normal speech, etc.), etc. Additionally. or alternatively, in some embodiments, processor 210 may rely on one or more of the images received from image sensor 220 during the event to determine the type of event. Additionally, or alternatively, in some embodiments, processor 210 may use another external signal (e.g., a GPS signal indicating the location, a WiFi signal, a signal representing a calendar entry, etc.) to determine the type of event that user 4210 is engaged in and/or the location of the event. For example, a signal from a GPS sensor may indicate to processor 210 that user 4210 is at a specific location at the time of the recorded conversion. The GPS sensor may be a part of apparatus 110 or computing device 120 or may be separate from apparatus 110 and computing device 120. In some embodiments, a signal representative of a calendar entry (e.g., schedule) of user 4210 (e.g., received directly or indirectly from computing device 120) may indicate to processor 210 that the recorded conversation is during, for example, a staff meeting. In some embodiments, processor 210 may apply a context classification rule to classify the environment of the user into one of a plurality of contexts, based on information provided by at least one of the audio signal, an image signal, an external signal, or a calendar entry. In some embodiments, the context classification rule may be based on, for example, a neural network, a machine learning algorithm, etc. For example, based on training examples run on the neutral network or algorithm, processor 210 may recognize the environment of user 4210 based on the inputs received.

Processor 210 may then store a record of, or log, the identified conversation (step 4430). The conversation may be stored in a database in apparatus 110 (e.g., in memory 550a), in computing device 120 (e.g., in memory 550b), or in computer server 250 (of FIG. 2). For example, when processor 210 recognizes that user 4210 is engaged in a conversation (step 4420), processor 210 may store parameters associated with the conversation (such as, for example, start time of the conversation, end time of the conversation, participants in the conversation, etc.). In some embodiments, processor 210 may also analyze the received sounds from audio sensor 1710 and/or image sensor 220 to classify the conversation based on the context of the conversation (e.g., meeting, party, work context, social context, etc.) and store this context information in the database.

Processor 210 may then analyze the received audio signal to automatically identify words spoken during the conversation (step 4440). During this step, processor 210 may distinguish the voices of the user 4210 and other participants at the event from other sounds in the received audio signal. Any known method (pattern recognition, speech to text algorithms, small vocabulary spotting, large vocabulary transcription, etc.) may be used to recognize or identify the words spoken during the conversation. In some embodiments, processor 210 may break down the received audio signals into segments or individual sounds and analyze each sound using algorithms (e.g., natural language processing software, deep learning neural networks, etc.) to find the most probable word fit. In some embodiments, processor 210 may recognize the participants at the event and associate portions of the audio signal (e.g., words, sentences, etc.) with different participants. In some embodiments, processor 210 may recognize the participants based on an analysis of the received audio signals. For example, processor 210 may measure one or more voice characteristics (e.g., a pitch, tone, rate of speech, volume, center frequency, frequency distribution, responsiveness) in the audio signal and compare the measured characteristics to values stored in a database to recognize different participants and associate portions of the audio signals with different participants.

In some embodiments, processor 210 may apply a voice characterization rule to associate the different portions of the audio signals with different participants. The voice characterization rule may be based, for example, on a neural network or a machine learning algorithm trained on one or more training examples. For example, neural network or machine learning algorithm may be trained using previously recorded voices/speech of different people to recognize the measured voice characteristics in the received audio signal and associate different portions of the audio signals to different participants.

Alternatively, or additionally, in some embodiments, processor 210 may recognize the participants at the event and associate portions of the audio signal with different participants based on the received image data from image sensor 220. In some embodiments, processor 210 may recognize different participants in the received image data by comparing aspects of the images with aspects stored in a database. In some embodiments, processor 210 may recognize the different participants based on one or more of the face, facial features, posture, gesture, etc. of the participants from the image data. In some embodiments, processor 210 may measure one or more image characteristics (e.g., distance between features of the face, color, size, etc.) and compare the measured characteristics to values stored in a database to recognize different participants and associate portions of the audio signals to different participants. In some embodiments, processor 210 may recognize different participants by their names (e.g., Bob, May, etc.). In some embodiments, processor 210 may not recognize the different participants by their names, hut instead, label the different participants using generic labels (e.g., participant 1, participant 2, etc.) and associate different portions of the audio signal with the assigned labels based on measured voice or image characteristics. In some such embodiments, the user 4210 (or another person, computer, or algorithm) may associate participant names with the different processor-assigned labels (i.e., participant 1=Bob, participant 2=May, etc.).

In some embodiments, processor 210 may also apply a voice classification rule to classify at least a portion of the received audio signal into different voice classifications (or mood categories), that are indicative of a mood of the speaker, based on one or more of the measured voice characteristics (e.g., a pitch, tone, rate of speech, volume, center frequency, frequency distribution, responsiveness, etc.). The voice classification rule may classify a portion of the received audio signal as, for example, sounding calm, angry, irritated, sarcastic, laughing, etc. In some embodiments, processor 210 may classify portions of audio signals associated with the user and other participants into different voice classifications by comparing one or more of the measured voice characteristics with different values stored in a database, and associating a portion of the audio signal with a particular classification if the measured characteristic corresponding to the audio signal portion is within a predetermined range of scores or values. For example, a database may list different ranges of values, for example, for the expected pitch associated with different moods (calm, irritated, angry, level of excitement, laughter, snickering, yawning etc.). Processor 210 may compare the measured pitch of the user's voice (and other participant's voices) with the ranges stored in the database, and determine the user's mood based on the comparison.

In some embodiments, the voice classification rule may be based, for example, on a neural network or a machine learning algorithm trained on one or more training examples. For example, a neural network or machine learning algorithm may be trained using previously recorded voices/speech of different people to recognize the mood of the speaker from voice characteristics in the received audio signal and associate different portions of the audio signals to different voice classifications (or mood categories) based on the output of the neural network or algorithm. In some embodiments, processor 210 may also record the identified mood (i.e., the identified voice characterization) of the different participants in the conversation log.

Processor 210 may compare the automatically identified words in step 4440 with the list of previously identified key words to recognize key words spoken during the conversation (step 4450). For example, if the word “Patent” was previously identified as a key word, processor 210 compares the words spoken by the different participants during the conversation to identify every time the word “Patent” is spoken. In this step, processor 210 may separately identify the key words spoken by the different participants (i.e., user 4210 and friends 4220, 4230). Processor 210 may also measure one or more voice characteristics (e.g., a pitch, tone, rate of speech, volume, center frequency, frequency distribution, responsiveness, etc.) from the audio signals associated with the key word, and based on one or more of the measured voice characteristics, determine the voice classification (e.g., mood of the speaker) when the key word was spoken. In some embodiments, processor 210 may also determine the intonation of the speaker when a key word is spoken. For example, processor 210 may identify the key words spoken by different users and further identify the mood of the speaker when these key words were spoken and the intonation of the speaker when the key word was spoken. In some embodiments, processor 210 may also determine the voice characteristics of other participants after one or more of the key words were spoken. For example, based on the measured voice characteristics of the audio signals received after a key word is spoken, processor 210 may determine the identity and mood of the speaker upon hearing the key word. It is also contemplated that, in some embodiments, processor 210 may also associate one or more visual characteristics of the speaker and/or other participants (e.g., demeanor, gestures, etc. from the image data) at the time (and/or after the time) one or more key words were spoken.

Processor 210 may then associate the identified key word, and its voice classification, with the conversation log of step 4430 (step 4460). In some embodiments, the database of the logged conversation may include one or more of the start time of the conversation, end time of the conversation, the participants in the conversation, a context classification (e.g., meeting, social gathering, etc.) of the conversation, time periods at which different participants spoke, number of times each key word was spoken, which participant uttered the key words, time at which each key word was spoken, voice classification of (e.g., mood) of the speaker when the key word was spoken, voice classification of the other participants when listening to the key words, etc.).

Processor 210 may then provide to the user an indication of the association between the identified key word and the logged conversation (step 4470). In some embodiments, in step 4470, the indication may be an audible indication (alarm, beeping sound, etc.) and/or a visible indication (blinking lights, textual display, etc.). In some embodiments, the indication may be a tactile (e.g., vibratory) indication. In some embodiments, multiple types of indication (e.g., visible, audible, tactile, etc.) may be simultaneously provided to the user. In general, the indication may be provided via apparatus 110, computing device 120, or another device associated with apparatus 110 and/or computing device 120. For example, in some embodiments, an audible, visible, and/or tactile indication may be provided via apparatus 110. Alternatively, or additionally, an audible, visible, and/or tactile indication may be provided via computing device 120. For example, in some embodiments, as illustrated in FIG. 43, when processor 210 identifies a key word in a conversation, a blinking indicator 4310 may be activated in computing device 120 to indicate to user 4210 that a key word has been uttered. In some embodiments, an audible indicator 4320 may indicate when a key word has been uttered. In some embodiments, the indication may be provided on another device that is operatively connected to apparatus 110 and/or computing device 120. For example, in some embodiments, the indication may be an audible signal provided to a hearing aid or a headphone/earphone of the user. It is also contemplated that, in some embodiments, the indication may be provided to another electronic device (e.g., smart watch, earphone, etc.) that is associated with the user.

The indication provided to the user may have any level of detail. For example, in some embodiments, the indication may be a signal (audible, visual, or tactile signal) that indicates that a key word has been spoken. In some embodiments, an indication (e.g., textual indication 4330) may also provide more details, such as, for example, the number of times each key word was uttered. For example, if the words. “camera” and “patent” were identified as key words, processor 210 may monitor the conversation and provide a textual indication 4330 that indicates the number of times the key words were spoken. The textual indication may updated or revised dynamically. For example, the next time the word “camera” is spoken, the textual indication may automatically update to indicate the revised data. In some embodiments, a textual indicator 4340 may also indicate the person who spoke a key word. For example, if during a conversation, the key word “camera” was spoken by one of the participants (e.g., Bob) three times and another participant (e.g., May) live times, textual indicator 4340 may show a tabulation of this data.

It should be noted that the specific types of indicators, and their level of detail, illustrated in FIG. 43 are only exemplary. The indication provided to user 4210 may have any level of detail, in general, any data included in the conversation log database may be provided to the user as an indication of the association between the identified key word and the logged conversation (step 4470). For example, in some embodiments, one or more of the start time of the conversation, end time of the conversation, the participants in the conversation, a context classification (e.g., meeting, social gathering, etc.) of the conversation, time periods at which different participants spoke, number of times each key word was spoken, which participant spoke the key words, time at which each key word was spoken, voice classification of (e.g., mood) of the speaker when the key word was spoken, voice classification of the other participants when or after the key words were spoken, etc. may be included in the indication provided to user 4210.

In some embodiments, at least one of an audible or a visible indication of an association between a spoken key word and a logged conversation may be provided after a predetermined time period. For example, during a future encounter (e.g., a time period later, such as, for example, an hour later, a day later, a week later, etc.), an indication may be provided to user 4210 of one or more key words that were previously logged. The indication may be provided as audio and/or displayed on a display device.

In general, processor 210 may determine any number of key words spoken by the participants during any event (meeting, social gathering, etc.). Although processor 210 of apparatus 110 is described as receiving and analyzing the images and audio signals, this is only exemplary. In some embodiments, image sensor 220 and audio sensor 1710 of apparatus 110 may transmit (a portion of or all) the recorded images and audio signals to computing device 120 (e.g., via wireless transceivers 530a and 530b). Processor 540 of computing device 120 may receive and analyze these images and audio signals using the method 4400 described with reference to FIG. 44. In some embodiments, processor 540 of computing device 120 may assist processor 210 of apparatus 110 in performing the analysis and notifying user 4210. For example, apparatus 110 may transmit a portion of the recorded images and audio signals to computing device 120. Any portion of the recorded images and audio signals may be transmitted. In some embodiments, the captured images may be transmitted to computing device 120 for analysis and the recorded audio signals may be retained in apparatus 110 for analysis. In some embodiments, the audio signals may be transmitted to computing device 120 and the captured images may be retained in apparatus 110. In some embodiments, after processing the audio signals and/or captured images and storing the keywords, the audio and image may be discarded. Processor 210 may analyze the portion of the signals retained in apparatus 110, and processor 540 may analyze the portion of the signal received in computing device 120. Apparatus 110 and computing device 120 may communicate with each other and exchange data during the analysis. After the analysis, apparatus 110 or computing device 120 may provide an indication of the association between the identified key word and the logged conversation to user 4210.

In some embodiments, apparatus 110 and/or computing device 120 may also transmit and exchange information/data with the remotely located computer server 250 (see FIG. 2) during the analysis. In some such embodiments, computer sever 250 may communicate with, and analyze data from, multiple apparatus 110 each worn by a different user to monitor conversations that each user is engaged in. In such embodiments, apparatus 110 associated with each user may collect data (plurality of images and audio signals) from events that the user is involved in and transmit at least a portion of the collected data to computer server 250. Computer server 250 may then perform at least a portion of the analysis using the received data. After the analysis, an indication of the association between identified key word and the logged conversation may then be provided to the individual user via the user's apparatus 110 (or another associated device, such as, for example, a cell phone, tablet, laptop, smart watch, etc.).

In summary, the disclosed systems and methods may enable a user to select a list of key words; listen to subsequent conversations; and create a log of conversations in which the key words were spoken. In some embodiments, the conversation log may be prepared without an indication of the context or indicating other words spoken along with the key word. In some embodiments, recording only the key words without providing context may have privacy advantages. For example, if a conversation includes statements like “I agree with (or do not agree with) Joe Smith.” and the system only notes that the key word “Joe Smith” was mentioned, the speaker's thoughts on Joe Smith will not be disclosed. In some embodiments, only certain types of key words and/or other audio and visual indicators (e.g., actions, gestures, emotion, etc.) may be recorded in the conversation log. The system may be configured such that a user can specify what audio and/visual indictors to be (or not to be) logged.

Sharing and Preloading Facial Metadata on Wearable Devices

Wearable device may be designed to improve and enhance a user's interactions with his or her environment, and the user may rely on the wearable device during daily activities. However, different users may require different levels of aid depending on the environment. In some cases, users may benefit from wearable devices in the fields of business, fitness and healthcare, or social research. However, typical wearable devices may not connect with or recognize people within a user's network (e.g., business network, fitness and healthcare network, social network, etc.). Therefore, there is a need for apparatuses and methods for automatically identifying and sharing information related to people connected to a user based on recognizing facial features.

The disclosed embodiments include wearable devices that may be configured to identify and share information related to people in a network. The devices may be configured to detect a facial feature of an individual from images captured from the environment of a user and share information associated with the recognized individual with the user. For example, a camera included in the device may be configured to capture a plurality of images from an environment of a user and output an image signal that includes the captured plurality of images. The wearable device may include at least one processor programmed to detect, in at least one image of the plurality of captured images, a face of an individual represented in the at least one image of the plurality of captured images. In some embodiments, the individual may be recognized as an individual that has been introduced to the user, an individual that has possibly interacted with the user in the past (e.g., a friend, colleague, relative, prior acquaintance, etc.), or an individual that has possibly interacted with a personal connection (e.g., a friend, colleague, relative, prior acquaintance, etc.) of the user in the past.

The wearable device may execute instructions to isolate at least one facial feature (e.g., eye, nose, mouth, etc.) of the detected face of an individual and share a record including the face or the at least one facial feature with one or more other devices. The devices to share the recording with may include all contacts of user 100, one or more contacts of user 100, or contacts selected according to the context (e.g., work contacts during work hours, friends during leisure time, or the like). The wearable device may receive a response including information associated with the individual. For example, the response provided by one of the other devices. The wearable device may then provide, to the user, at least some information including at least one of a name of the individual, an indication of a relationship between the individual and the user, an indication of a relationship between the individual and a contact associated with the user, a job title associated with the individual, a company name associated with the individual, or a social media entry associated with the individual. The wearable device may display to the user a predetermined number of responses. For example, if the individual is recognized by two of the user's friends, there may be no need to present and the information over and over again.

FIG. 45 is a schematic illustration showing an exemplary environment including a wearable device consistent with the disclosed embodiments. In some embodiments, the wearable device may be a user device (e.g., apparatus 110). In some embodiments apparatus 110 may include voice and/or image recognition. In some embodiments, apparatus 110 may be connected in a wired or wireless manner with a hearing aid. In some embodiments, a camera (e.g., a wearable camera of apparatus 110) may be configured to capture a plurality of images from an environment of user 100 using an image sensor (e.g., image sensor 220). In some embodiments, the camera may output an image signal that includes the captured plurality of images. In some embodiments, the camera may be a video camera and the image signal may be a video signal. In some embodiments, the camera and at least one processor (e.g., process 210) may be included in a common housing and the common housing may be configured to be worn by user 100.

In some embodiments, a system (e.g., a database associated with apparatus 110 or one or more other devices 4520) may store images and/or facial features of a recognized person to aid in recognition. For example, when an individual (e.g., individual 4501) enters the field of view of apparatus 110, the individual may be recognized as an individual that has been introduced to user 110, an individual that has possibly interacted with user 100 in the past (e.g., a friend, colleague, relative, prior acquaintance, etc.), or an individual that has possibly interacted with a personal connection (e.g., a friend, colleague, relative, prior acquaintance, etc.) of user 100 in the past. In some embodiments, facial features (e.g., eye, nose, mouth, etc.) associated with the recognized individual's face may be isolated and/or selectively analyzed relative to other features in the environment of user 100.

In some embodiments, processor 210 may be programmed to detect, in at least one image 4511 of the plurality of captured images, a face of an individual 4501 represented in the at least one image 4511 of the plurality of captured images. In some embodiments, processor 210 may isolate at least one facial feature (e.g., eye, nose, mouth, etc.) of the detected face of individual 4501. In some embodiments, processor 210 may store, in a database, a record including the face or the at least one facial feature of individual 4501. In some embodiments, the database may be stored in at least one memory (e.g., memory 550) of apparatus 110. In some embodiments, the database may be stored in at least one memory device accessible to apparatus 110 via a wireless connection.

In some embodiments, processor 210 may share the record including the face or the at least one facial feature of individual 4501 with one or more other devices 4520. In some embodiments, sharing the record with one or more other devices 4520 may include providing one or more other devices 4520 with an address of a memory location associated with the record. In some embodiments, sharing the record with one or more other devices 4520 may include forwarding a copy of the record to one or more other devices 4520. In some embodiments, sharing the record with one or more other devices 4520 may include identifying one or more contacts of user 100. In some embodiments, apparatus 110 and one or more other devices 4520 may be configured to be wirelessly linked via a wireless data connection. In some embodiments, the database may be stored in at least one memory accessible to both apparatus 110 and one or more other devices 4520. In some embodiments, one or more other devices 4520 include at least one of a mobile device, server, personal computer, smart speaker, in-home entertainment system, in-vehicle entertainment system, or device having a same or similar device type as apparatus 110.

In some embodiments, processor 210 may receive a response including information associated with individual 4501, where the response may be provided by one or more other devices 4520. In some embodiments, the response may be triggered based on a positive identification of individual 4501 by one or more processors associated with one or more other devices 4520 based on analysis of the record shared by apparatus 110 with one or more other devices 4520. In some embodiments, the information associated with individual 4501 may include at least a portion of an itinerary associated with individual 4501. For example, the itinerary may include a detailed plan for a journey, a list of places to visit, plans of travel, etc. associated with individual 4501.

In some embodiments, processor 210 may update the record with the information associated with individual 4501 received from one or more other devices 4520. For example, processor 210 may modify the record to include the information associated with individual 4501 received from one or more other devices 4520. In some embodiments, processor 210 may provide, to user 100, at least some of the information included in the updated record. In some embodiments, the at least some of the information provided to user 100 includes at least one of a name of individual 4501, an indication of a relationship between individual 4501 and user 100, an indication of a relationship between individual 4501 and a contact associated with user 100, a job title associated with individual 4501, a company name associated with individual 4501, or a social media entry associated with individual 4501. In some embodiments, the at least some of the information provided to user 100 may be provided audibly via a speaker (e.g., feedback-outputting unit 230) wirelessly connected to apparatus 110. In some embodiments, the speaker may be included in a wearable earpiece. In some embodiments, the at least some of the information provided to user 100 may be provided visually via a display device (e.g., display 260) wirelessly connected to apparatus 110. In some embodiments, the display device may include a mobile device (e.g., computing device 120). In some embodiments, providing, to user 100, at least some of the information included in the updated record may include providing at least one of an audible or visible representation of the at least some of the information.

In some embodiments, processor 210 may be programmed to cause the at least some information included in the updated record to be presented to user 100 via a secondary computing device (e.g., computing device 120) in communication with apparatus 110. In some embodiments, the secondary computing device may include at least one of a mobile device, laptop computer, desktop computer, smart speaker, in-home entertainment system, or in-vehicle entertainment system.

In some embodiments, apparatus 110 may include a user input device (e.g., a keyboard, a mouse-type device, a gesture sensor, an action sensor, a physical button, an oratory input, etc.) and process 210 may be programmed to receive, via the user input device, additional information regarding individual 4501. In some embodiments, the additional information may be related to an itinerary (a detailed plan for a journey, a list of places to visit, plans of travel, etc.) of individual 4501. In some embodiments, processor 210 may be programmed to determine a location in which at least one image (e.g., image 4511) was captured. For example, processor 210 may determine a location (e.g., location coordinates) in which image 4511 was captured based on metadata associated with image 4511. In some embodiments, processor 210 may determine the location based on at least one of a location signal, location of apparatus 110, an identity of apparatus 110 (e.g., an identifier of apparatus 110), or a feature of the at least one image (e.g., a feature of an environment included in the at least one image). In some embodiments, processor 210 may determine whether the determined location correlates with the itinerary. For example, the itinerary may include at least one location to which individual 4501 plans to travel. In some embodiments, if processor 210 determines that the location does not correlate with the itinerary, processor 210 may provide, to user 100, an indication that the location does not correlate with the itinerary. For example, based on a determination that the location does not correlate with the itinerary, user 100 may guide individual 4501 to a location associated with the itinerary. In some embodiments, processor 210 may update the record with the additional information input via the user input device and sham the updated record with one or more other devices 4520. For example, processor 210 may modify the record to include the additional information.

FIG. 46 is a schematic illustration showing an exemplary image obtained by a wearable device consistent with the disclosed embodiments. A camera (e.g., a wearable camera of apparatus 110) may be configured to capture a plurality of images from an environment of user 100 using an image sensor (e.g., image sensor 220). In some embodiments, a system (e.g., a database associated with apparatus 110 or one or more other devices 4520) may store images and/or facial features of a recognized person to aid in recognition. For example, when individual 4501 enters the field of view of apparatus 110, individual 4501 may be recognized as an individual that has been introduced to user 100, an individual that has possibly interacted with user 100 in the past (e.g., a friend, colleague, relative, prior acquaintance, etc.), or an individual that has possibly interacted with a personal connection (e.g., a friend, colleague, relative, prior acquaintance, etc.) to user 100 in the past. Accordingly, facial features (e.g., eye, nose, mouth, etc.) associated with the recognized individual's face may be isolated and/or selectively analyzed relative to other features in the environment of user 100.

In some embodiment, processor 210 may be programmed to detect, in at least one image 4511 of the plurality of captured images, a face of an individual 4501 represented in the at least one image 4511 of the plurality of captured images. In some embodiments, processor 210 may isolate at least one image feature or facial feature 4601 (e.g., eye, nose, mouth, etc.) of the detected face of individual 4501. In some embodiments, processor 210 may store, in the database, a record including at least one image feature or facial feature 4601 of individual 4501.

In some embodiments, at least one processor associated with one or more other devices 4520 may receive at least one image 4511 captured by the camera and may identify, based on analysis of at least one image 4511, individual 4501 in the environment of user 100. The at least one processor associated with one or more other devices 4520 may be configured to analyze captured image 4511 and detect features of a body part or a face part (e.g., facial feature 4601) of at least individual 4501 using various image detection or processing algorithms (e.g., using convolutional neural networks (CNN) scale-invariant feature transform (SIFT), histogram of oriented gradients (HOG) features, or other techniques). Based on the detected representation of a body part or a face pad of at least one individual 4501, at least one individual 4501 may be identified. In some embodiments, the at least one processor associated with one or more other devices 4520 may be configured to identify at least one individual 4501 using facial recognition components.

For example, a facial recognition component may be configured to identify one or more faces within the environment of user 100. The facial recognition component may identify facial features on the faces of individuals, such as the eyes, nose, cheekbones, jaw, or other features. The facial recognition component may analyze the relative size and position of these features to identify the individual. In some embodiments, the facial recognition component may utilize one or more algorithms for analyzing the detected features, such as principal component analysis (e.g., using eigenfaces), linear discriminant analysis, elastic bunch graph matching (e.g., using Fisherface), Local Binary Patterns Histograms (LBPH), Scale Invariant Feature Transform (SIFT), Speed Up Robust Features (SURF), or the like. Additional facial recognition techniques, such as 3-Dimensional recognition, skin texture analysis, and/or thermal imaging, may be used to identify individuals. Other features, besides facial features of individuals may also be used for identification, such as the height, body shape, or other distinguishing features of the individuals. In some embodiments, image features may also be useful in identification.

The facial recognition component may access a database or data associated with one or more other devices 4520 to determine if the detected facial features correspond to a recognized individual. For example, at least one processor associated with one or more other devices 4520 may access a database containing information about individuals known to user 100 or a user associated with one or more other devices 4520 and data representing associated facial features or other identifying features. Such data may include one or more images of the individuals, or data representative of a face of the user that may be used for identification through facial recognition. The facial recognition component may also access a contact list of user 100 or a user associated with one or more other devices 4520, such as a contact list on the user's phone, a web-based contact list (e.g., through Outlook™, Skype™, Google™, SalesForce™, etc.), etc. In some embodiments, a database associated with one or more other devices 4520 may be compiled by one or more other devices 4520 through previous facial recognition analysis. For example, at least one processor associated with one or more other devices 4520 may be configured to store data associated with one or more faces recognized in images captured by apparatus 110 in the database associated with one or more other devices 4520. After a face is detected in the images, the detected facial features or other data may be compared to previously identified faces or features in the database. The facial recognition component may determine that an individual is a recognized individual of user 100 or a user associated with one or more other devices 4520 if the individual has previously been recognized by the system in a number of instances exceeding a certain threshold, if the individual has been explicitly introduced to apparatus 110, if the individual has been explicitly introduced to one or more other devices 4520, or the like.

One or more other devices 4520 may be configured to recognize an individual (e.g., individual 4501) in the environment of user 100 based on the received plurality of images captured by the wearable camera. For example, one or more other devices 4520 may be configured to recognize a face associated with individual 4501 based on the record including at least one facial feature 4601 received from apparatus 110. For example, apparatus 110 may be configured to capture one or more images of the surrounding environment of user 100 using a camera. The captured images may include a representation of a recognized individual (e.g., individual 4501), which may be a friend, colleague, relative, or prior acquaintance of user 100 or a user associated with one or more other devices 4520. At least one processor associated with one or more other devices 4520 may be configured to analyze facial feature 4601 and detect the recognized individual using various facial recognition techniques. Accordingly, one or more other devices 4520 may comprise one or more facial recognition components (e.g., software programs, modules, libraries, etc.).

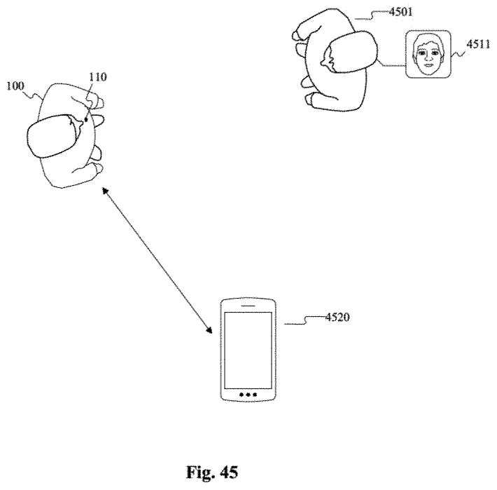

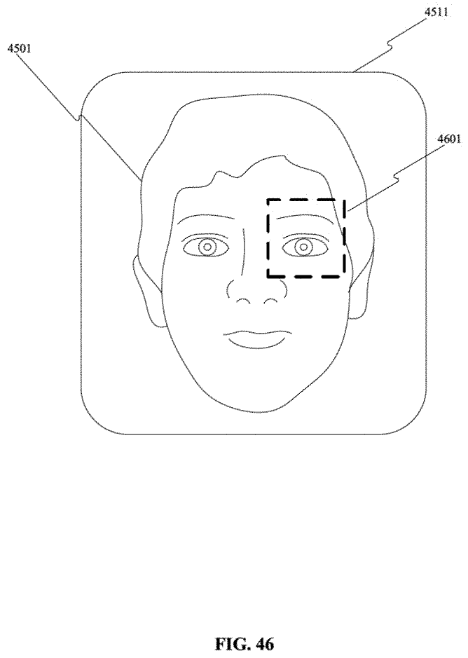

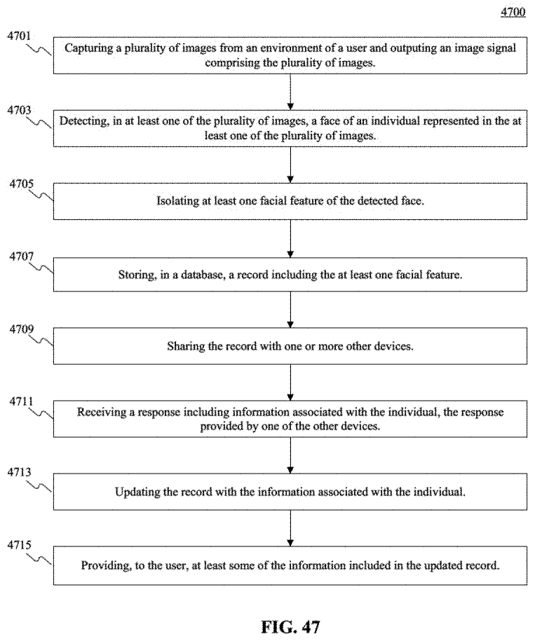

FIG. 47 is a flowchart showing an exemplary process 4700 for identifying and sharing information related to people consistent with the disclosed embodiments. Wearable device systems may be configured to detect a facial feature of an individual from images captured from the environment of a user and share information associated with the recognized individual with the user, for example, according to process 4700.

In step 4701, a camera (e.g., a wearable camera of apparatus 110 or a user device) may be configured to capture a plurality of images (e.g., image 4511) from an environment of user 100 using an image sensor (e.g., image sensor 220). In some embodiments, the camera may output an image signal that includes the captured plurality of images. In some embodiments, the camera may be a video camera and the image signal may be a video signal. In some embodiments, the camera and at least one processor (e.g., process 210) may be included in a common housing and the common housing may be configured to be worn by user 100.

In step 4703, processor 210 may be programmed to detect, in at least one image 4511 of the plurality of captured images, a face of an individual 4501 represented in the at least one image 4511 of the plurality of captured images. In some embodiments, a wearable device system (e.g., a database associated with apparatus 110 or one or more other devices 4520) may store images and/or facial features (e.g., facial feature 4601) of a recognized person to aid in recognition. For example, when an individual (e.g., individual 4501) enters the field of view of apparatus 110, the individual may be recognized as an individual that has been introduced to user 110, an individual that has possibly interacted with user 100 in the past (e.g., a friend, colleague, relative, prior acquaintance, etc.), or an individual that has possibly interacted with a personal connection (e.g., a friend, colleague, relative, prior acquaintance, etc.) to user 100 in the past.

In step 4705, processor 210 may isolate at least one facial feature (e.g., eye, nose, mouth, etc.) of the detected face of individual 4501. In some embodiments, facial features associated with the recognized individual's face may be isolated and/w selectively analyzed relative to other features in the environment of user 100.

In step 4707, processor 210 may store, in a database, a record including the at least one facial feature of individual 4501. In some embodiments, the database may be stored in at least one memory (e.g., memory 550) of apparatus 110. In some embodiments, the database may be stored in at least one memory linked to apparatus 110 via a wireless connection.

In step 4709, processor 210 may share the record including the at least one facial feature of individual 4501 with one or more other devices 4520. In some embodiments, sharing the record with one or more other devices 4520 may include providing one or more other devices 4520 with an address of a memory location associated with the record. In some embodiments, sharing the record with one or more other devices 4520 may include forwarding a copy of the record to one or more other devices 4520, in some embodiments, apparatus 110 and one or more other devices 4520 may be configured to be wirelessly linked via a wireless data connection. In some embodiments, the database may be stored in at least one memory accessible to both apparatus 110 and one or more other devices 4520. In some embodiments, one or more other devices 4520 include at least one of a mobile device, server, personal computer, smart speaker, in-home entertainment system, in-vehicle entertainment system, or device having a same device type as apparatus 110. Sharing may be with a certain group of people. For example, if the meeting was at work, the image/feature may be sent to work colleagues. If no response is received within a predetermined period of time, the image/feature may be forwarded to further devices.

In step 4711, processor 210 may receive a response including information associated with individual 4501, where the response may be provided by one of the other devices 4520, in some embodiments, the response may be triggered based on a positive identification of individual 4501 by one or more processors associated with one or more other devices 4520 based on analysis of the record shared by apparatus 110 with one or more other devices 4520. In some embodiments, the information associated with individual 4501 may include at least a portion of an itinerary (e.g., a detailed plan for a journey, a list of places to visit, plans of travel, etc.) associated with individual 4501.

In step 4713, processor 210 may update the record with the information associated with individual 4501. For example, processor 210 may modify the record to include the information associated with individual 4501 received from one or more other devices 4520.

In step 4715, processor 210 may provide, to user 100, at least some of the information included in the updated record. In some embodiments, the at least some of the information provided to user 100 includes at least one of a name of individual 4501, an indication of a relationship between individual 4501 and user 100, an indication of a relationship between individual 4501 and a contact associated with user 100, a job title associated with individual 4501, a company name associated with individual 4501, or a social media entry associated with individual 4501. In some embodiments, the at least some of the information provided to user 100 may be provided audibly via a speaker (e.g., feedback-outputting unit 230) wirelessly connected to apparatus 110. In some embodiments, the speaker may be included in a wearable earpiece. In some embodiments, the at least some of the information provided to user 100 may be provided visually via a display device (e.g., display 260) wirelessly connected to apparatus 110. In some embodiments, the display device may include a mobile device (e.g., computing device 120). In some embodiments, providing, to user 100, at least some of the information included in the updated record may include providing at least one of an audible or visible representation of the at least some of the information.

In some embodiments, processor 210 may be programmed to cause the at least some information included in the updated record to be presented to user 100 via a secondary computing device (e.g., computing device 120) in communication with apparatus 110. In some embodiments, the secondary computing device may include at least one of a mobile device, laptop computer, desktop computer, smart speaker, in-home entertainment system, or in-vehicle entertainment system.

It will be appreciated that in some embodiments, the image/feature may be shared with a plurality of other devices, and responses may be received from a plurality thereof. Processor 210 may be configured to stop updating the records and displaying to the user after a predetermined number of responses, for example after three responses (especially if they are the same), as the user does not need more than that.

In some embodiments, a system may include a user device. The user device may include a camera configured to capture a plurality of images from an environment of a user and output an image signal comprising the plurality of images. The system may further include at least one processor programmed to detect, in at least one of the plurality of images, a face of an individual represented in the at least one of the plurality of images; based on the detection of the face, share a record with one or more other devices; receive a response including information associated with the individual, the response provided by one of the other devices; update the record with the information associated with the individual; and provide, to the user, at least some of the information included in the updated record. In some embodiments, the at least one processor is programmed to isolate at least one facial feature of the detected face and store the at least one facial feature in the record.

Preloading Wearable Devices with Contacts

A wearable device may be designed to improve and enhance a user's interactions with his or her environments, and the users may rely on the wearable device during daily activities. Different users may require different levels of aid depending on the environment. In some cases, users may be new to an organization and benefit from wearable devices in environments related to work, conferences, or industry groups. However, typical wearable devices may not connect with or recognize people within a user's organization (e.g., work organization, conference, industry group, etc.), thereby resulting in the user remaining unfamiliar with the individuals in their organization. Therefore, there is a need for apparatuses and methods for automatically identifying and sharing information related to people in an organization related to a user based on images captured from an environment of the user.

The disclosed embodiments include wearable devices that may be configured to identify and share information related to people in an organization related to a user, based on images captured from an environment of the user. For example, a wearable camera-based computing device may include a camera configured to capture a plurality of images from an environment of a user (e.g., the user may be a new employee, a conference attendee, a new member of an industry group, etc.) and output an image signal including the plurality of images. The wearable device may include a memory unit including a database configured to store information related to each individual included in a plurality of individuals (e.g., individuals in a work organization, conference attendees, members of an industry group, etc.). The stored information may include one or more facial characteristics and at least one of a name, a place of employment, a job title, a place of residence, a birthplace, an age, an indication of expertise, a name of a college or university attended by the individual, one or more interests shared by the user and the individual, one or more likes or dislikes shared by the user and the individual, or an indication of at least one relationship between the individual and a third person with whom the user also has a relationship.

The wearable camera-based computing device may include at least one processor programmed to detect, in at least one of the plurality of images, a face represented in the at least one of the plurality of images; compare at least one aspect of the detected face with at least some of the one or more facial characteristics stored in the database for the plurality of individuals to identify a recognized individual associated with the detected face; retrieve at least some of the stored information for the recognized individual from the database; and cause the at least some of the stored information retrieved for the recognized individual to be automatically conveyed to the user (e.g., via a user device, computing device, etc.).

FIG. 48 is a schematic illustration showing an exemplary environment including a wearable camera-based computing device consistent with the disclosed embodiments. In some embodiments, the wearable device may be a first device (e.g., apparatus 110). In some embodiments apparatus 110 may include a wearable camera-based computing device (e.g., a company wearable device) with voice and/or image recognition. In some embodiments, a camera (e.g., a wearable camera-based computing device of apparatus 110) may be configured to capture a plurality of images from an environment of user 100 using an image sensor (e.g., image sensor 220). In some embodiments, the camera may output an image signal that includes the captured plurality of images. In some embodiments, user 100 may be a new employee, an attendee at a conference, a new member of an industry group, etc.

In some embodiments, a memory unit (e.g., memory 550) may include a database configured to store information related to each individual included in a plurality of individuals (e.g., individuals in a work organization, conference attendees, members of an industry group, etc.). In some embodiments, the database may be pre-loaded with information related to each individual included in the plurality of individuals. In some embodiments, the database may be pre-loaded with information related to each individual included in the plurality of individuals prior to providing apparatus 110 to user 100. For example, user 100 may receive apparatus 110 upon arriving at a conference. User 100 may use apparatus 110 to recognize other attendees at the conference. In some embodiments, user 100 may return apparatus 110 or keep apparatus 110 as a souvenir.

In some embodiments, the memory unit may be included in apparatus 110. In some embodiments, the memory unit may be a part of apparatus 110 or accessible to apparatus 110 via a wireless connection. In some embodiments, the stored information may include one or more facial characteristics of each individual of the plurality of individuals, in some embodiments, the stored information may include at least one of a name, a place of employment, a job title, a place of residence, a birthplace, an age, an indication of expertise, a name of a college or university attended by the individual, one or more interests shared by user 100 and the individual, one or more likes or dislikes shared by user 100 and the individual, or an indication of at least one relationship between the individual and a third person with whom user 100 also has a relationship.

In some embodiments, at least one processor (e.g., processor 210) may be programmed to detect, in at least one image 4811 of the plurality of captured images, a face of an individual 4801 represented in at least one image 4811 of the plurality of captured images. In some embodiments, processor 210 may isolate at least one aspect (e.g., facial feature such as eye, nose, mouth, a distance between facial features, a ratio of distances, etc.) of the detected face of individual 4801 and compare the at least one aspect with at least some of the one or more facial characteristics stored in the database for the plurality of individuals, to identify a recognized individual 4801 associated with the detected face. In some embodiments, the at least one aspect may be isolated and/or selectively analyzed relative to other features in the environment of user 100.

The identification may be based, for example, on a distance computed according to some metric between the captured aspect and the one or more facial characteristics stored in the database, the distance being below a predetermined threshold. In some embodiments, processor 210 may retrieve at least some of the stored information for recognized individual 4801 from the database and cause the at least some of the stored information retrieved for recognized individual 4801 to be automatically conveyed to user 100. In some embodiments, the at least some of the stored information retrieved for recognized individual 4801 may be automatically conveyed to user 100 audibly via a speaker (e.g., feedback-outputting unit 230) wirelessly connected to the wearable camera-based computing device of apparatus 100. In some embodiments, the speaker may be included in a wearable earpiece. In some embodiments, the at least some of the stored information retrieved for recognized individual 4801 may be automatically conveyed to user 100 visually via a display device (e.g., display 260) wirelessly connected to apparatus 100. In some embodiments, the display device may include at least one of a mobile device (e.g., computing device 120), server, personal computer, smart speaker, or device having a same device type as apparatus 110. In some embodiments, computing device 120 or apparatus 110 may include a user input device (e.g., a keyboard, a mouse-type device, a gesture sensor, an action sensor, a physical button, an oratory input, etc.) and processor 210 may be programmed to retrieve additional information regarding individual 4801 based on an input received from user 100 via the user input device.

In some embodiments, processor 210 may retrieve, from the database, a linking characteristic. In some embodiments, the linking characteristic may be shared by recognized individual 4801 and user 100. In some embodiments, the linking characteristic may relate to (e.g., currently or in the past) at least one of a place of employment, a job title, a place of residence, a birthplace, an age, an expertise, a name of a college or university, or the like. In some embodiments, the linking characteristic may relate to one or more interests shared by user 100 and individual 4801, one or more likes or dislikes shared by user 100 and individual 4801, or an indication of at least one relationship between individual 4801 and a third person with whom user 100 also has a relationship.

In some embodiments, the at least some of the stored information for recognized individual 4801 may include at least one identifier associated with recognized individual 4801 and at least one linking characteristic shared by recognized individual 4801 and user 100. In some embodiments, at least one identifier associated with recognized individual 4801 may include e.g., currently or in the past) a name, a place of employment, a job title, a place of residence, a birthplace, an age, an expertise associated with the recognized individual, or a name of a college or university attended by recognized individual 4801.

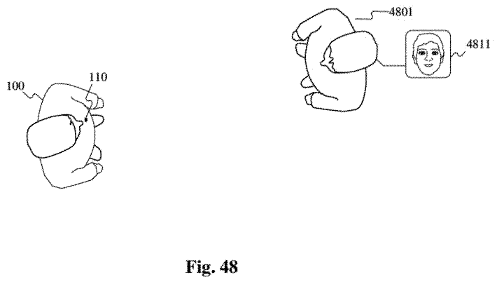

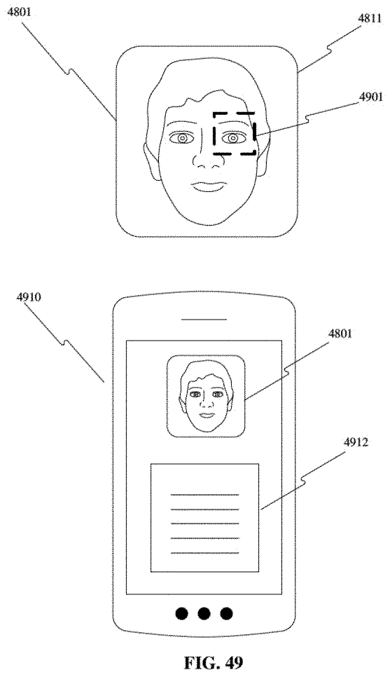

FIG. 49 is an illustration of an exemplary image obtained by a wearable camera-based computing device and stored information displayed on a device consistent with the disclosed embodiments. In some embodiments, a camera (e.g., a wearable camera-based computing device of apparatus 110) may be configured to capture a plurality of images from an environment of user 100 using an image sensor (e.g., image sensor 220). In some embodiments, the camera may output an image signal that includes the captured plurality of images. In some embodiments, user 100 may be a new employee, an attendee at a conference, a new member of an industry group, etc.

In some embodiments, at least one processor (e.g., processor 210) may be programmed to detect, in at least one image 4811 of the plurality of captured images, a face of an individual 4801 represented in the at least one image 4811 of the plurality of captured images. In some embodiments, processor 210 may isolate at least one aspect 4901 (e.g., facial feature such as eye, nose, mouth, etc.) of the detected face of individual 4801 and compare at least one aspect 4901 with at least some of the one or more facial characteristics stored in the database for the plurality of individuals, to identify a recognized individual 4801 associated with the detected face. In some embodiments, the at least one aspect may be isolated and/or selectively analyzed relative to other features in the environment of user 100.

In some embodiments, processor 210 may receive at least one image 4811 captured by the camera and may identify, based on analysis of at least one image 4811, individual 4801 in the environment of user 100. Processor 210 may be configured to analyze captured image 4811 and detect features of a body part or a face part (e.g., aspect 4901) of at least individual 4801 using various image detection or processing algorithms (e.g., using convolutional neural networks (CNN), scale-invariant feature transform (SIFT), histogram of oriented gradients (HOG) features, or other techniques). Based on the detected representation of a body part or a face part of at least one individual 4801, at least one individual 4801 may be identified. In some embodiments, processor 210 may be configured to identify at least one individual 4801 using facial recognition components.

For example, a facial recognition component may be configured to identify one or more faces within the environment of user 100. The facial recognition component may identify facial features on the faces of individuals, such as the eyes, nose, cheekbones, jaw, or other features. The facial recognition component may analyze the relative size and position of these features to identify the individual. In some embodiments, the facial recognition component may utilize one or more algorithms for analyzing the detected features, such as principal component analysis (e.g., using eigenfaces), linear discriminant analysis, elastic bunch graph matching (e.g., using Fisherface), Local Binary Patterns Histograms (LBPH). Scale Invariant Feature Transform (SIFT), Speed Up Robust Features (SURF, or the like. Additional facial recognition techniques, such as 3-Dimensional recognition, skin texture analysis, and/or thermal imaging, may be used to identify individuals. Other features, besides facial features, of individuals may also be used for identification, such as the height, body shape, or other distinguishing features of the individuals.

The facial recognition component may access the database to determine if the detected facial features correspond to an individual for whom there exists stored information. For example, processor 210 may access the database containing information about the plurality of individuals data representing associated facial features or other identifying features. Such data may include one or more images of the individuals, or data representative of a face of the user that may be used for identification through facial recognition. The facial recognition component may also access a contact list of user 100, such as a contact list on the user's phone, a web-based contact list (e.g., through Outlook™, Skype™, Google™, SalesForce™, etc.), etc. In some embodiments, the database may be compiled through previous facial recognition analysis. For example, processor 210 may be configured to store data associated with one or more faces recognized in images captured by apparatus 110 in the database. Each time a face is detected in the images, the detected facial features or other data may be compared to previously identified faces in the database. The facial recognition component may determine that an individual is a recognized individual if the individual has previously been recognized by the system in a number of instances exceeding a certain threshold, if the individual has been explicitly introduced to apparatus 110, or the like.

In some embodiments, processor 210 may retrieve at least some stored information 4912 for recognized individual 4801 from the database and cause the at least some of stored information 4912 retrieved for recognized individual 4801 to be automatically conveyed to user 100. In some embodiments, the at least some of stored information 4912 retrieved for recognized individual 4801 may be automatically conveyed to user 100 audibly via a speaker (e.g., feedback-outputting unit 230) wirelessly connected to the wearable camera-based computing device of apparatus 100. In some embodiments, the speaker may be included in a wearable earpiece. In some embodiments, the at least some of stored information 4912 retrieved for recognized individual 4801 may be automatically conveyed to user 100 visually via a display device 4910 (e.g., display 260) wirelessly connected to apparatus 100. In some embodiments, display device 4910 may include at least one of a mobile device (e.g., computing device 120), server, personal computer, smart speaker, or device having a same device type as apparatus 110. In some embodiments, computing device 120 or apparatus 110 may include a user input device (e.g., a keyboard, a mouse-type device, a gesture sensor, an action sensor, a physical button, an oratory input, etc.) and processor 210 may be programmed to retrieve additional information regarding individual 4801 based on an input received from user 100 via the user input device.

In some embodiments, the stored information may include one or more facial characteristics of each individual of the plurality of individuals. In some embodiments, the stored information may include at least one of a name, a place of employment, a job title, a place of residence, a birthplace, an age, an indication of expertise, a name of a college or university attended by the individual, one or more interests shared by user 100 and the individual, one or more likes or dislikes shared by user 100 and the individual, or an indication of at least one relationship between the individual and a third person with whom user 100 also has a relationship.

In some embodiments, stored information 4912 may include a linking characteristic. In some embodiments, the linking characteristic may be shared by recognized individual 4801 and user 100. In some embodiments, the linking characteristic may relate to (e.g., currently or in the past) at least one of a place of employment, a job title, a place of residence, a birthplace, an age, an expertise, or a name of a college or university. In some embodiments, the linking characteristic may relate to one or more interests shared by user 100 and individual 4801, one or more likes or dislikes shared by user 100 and individual 4801, or an indication of at least one relationship between individual 4801 and a third person with whom user 100 also has a relationship.

In some embodiments, the at least some of stored information 4912 for recognized individual 4801 may include at least one identifier associated with recognized individual 4801 and at least one linking characteristic shared by recognized individual 4801 and user 100. In some embodiments, at least one identifier associated with recognized individual 4801 may include (e.g., currently or in the past) a name, a place of employment, a job title, a place of residence, a birthplace, an age, an expertise associated with the recognized individual, or a name of a college or university attended by recognized individual 4801.

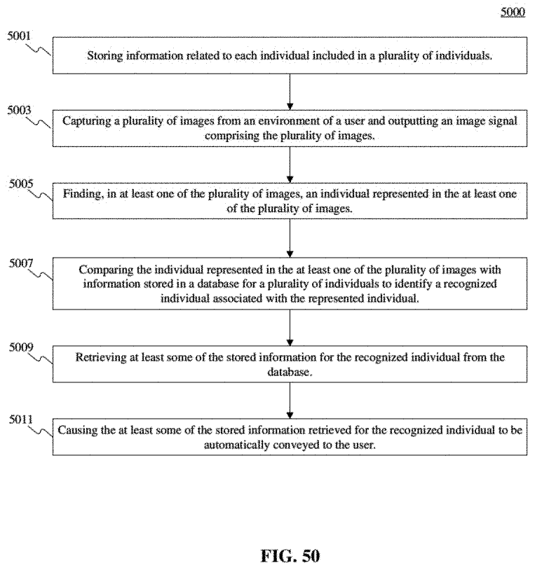

FIG. 50 is a flowchart showing an exemplary process for identifying and sharing information related to people in an organization related to a user based on images captured from an environment of the user consistent with the disclosed embodiments. For example, a wearable device may be configured to detect a facial feature of an individual from images captured from the environment of a user and share information associated with the recognized individual with the user, for example, according to process 5000.

In step 5001, a memory unit (e.g., memory 550) may be loaded with or otherwise include a database storing information related to each individual included in a plurality of individuals (e.g., individuals in a work organization, conference attendees, members of an industry group, etc.). In some embodiments, the database may be pre-loaded with information related to each individual included in the plurality of individuals. In some embodiments, the database may be pre-loaded with information related to each individual included in the plurality of individuals prior to providing apparatus 110 to user 100. For example, user 100 may receive apparatus 110 upon arriving at a conference. User 100 may use apparatus 110 to recognize other attendees at the conference. In some embodiments, user 100 may return apparatus 110 or keep apparatus 110 as a souvenir.

In some embodiments, the memory unit may be included in apparatus 110. In some embodiments, the memory unit may be linked to apparatus 110 via a wireless connection. In some embodiments, the stored information may include one or more facial characteristics of each individual of the plurality of individuals. In some embodiments, the stored information may include at least one of a name, a place of employment, a job title, a place of residence, a birthplace, an age, an indication of expertise, a name of a college or university attended by the individual, one or more interests shared by user 100 and the individual, one or more likes or dislikes shared by user 100 and the individual, or an indication of at least one relationship between the individual and a third person with whom user 100 also has a relationship. In some embodiments, the at least some of the stored information may include one or more images of or associated with recognized individual 4801. In some embodiments, the at least some of the stored information for recognized individual 4801 may include at least one identifier associated with recognized individual 4801 and at least one linking characteristic shared by recognized individual 4801 and user 100. In some embodiments, at least one identifier associated with recognized individual 4801 may include (e.g., currently or in the past) a name, a place of employment, a job title, a place of residence, a birthplace, an age, an expertise associated with the recognized individual, or a name of a college or university attended by recognized individual 4801.

In step 5003, a camera (e.g., a wearable camera-based computing device of apparatus 110) may capture a plurality of images from an environment of user 100 using an image sensor (e.g., image sensor 220). In some embodiments, the camera may output an image signal that includes the captured plurality of images. In some embodiments, user 100 may be a new employee, an attendee at a conference, a new member of an industry group, etc.

In step 5005, at least one processor (e.g., processor 210) may be programmed to find, in at least one image 4811 of the plurality of captured images, an individual 4801 represented in the at least one image 4811 of the plurality of captured images. In some embodiments, at least one processor may be programmed to find or detect a feature (e.g., a face) of individual 4801 represented in the at least one image 4811 of the plurality of captured images. In some embodiments, processor 210 may receive at least one image 4811 captured by the camera Processor 210 may be configured to analyze captured image 4811 and detect features of a body part or a face part (e.g., aspect 4901) of at least individual 4801 using various image detection or processing algorithms (e.g., using convolutional neural networks (CNN), scale-invariant feature transform (SIFT), histogram of oriented gradients (HOG) features, or other techniques).

For example, a facial recognition component may be configured to identify one or more faces within the environment of user 100. The facial recognition component may identify facial features on the faces of individuals, such as the eyes, nose, cheekbones, jaw, or other features. The facial recognition component may analyze the relative size and position of these features to identify the individual. In some embodiments, the facial recognition component may utilize one or more algorithms for analyzing the detected features, such as principal component analysis (e.g., using eigenfaces), linear discriminant analysis, elastic bunch graph matching (e.g., using Fisherface), Local Binary Patterns Histograms (LBPH). Scale invariant Feature Transform (SIFT), Speed Up Robust Features (SURF), or the like. Additional facial recognition techniques, such as 3-Dimensional recognition, skin texture analysis, and/or thermal imaging, may be used to identify individuals. Other features, besides facial features, of individuals may also be used for identification, such as the height, body shape, or other distinguishing features of the individuals.

In step 5007, processor 210 may compare the individual represented in the at least one of the plurality of images with information stored in the database for the plurality of individuals to identify a recognized individual 4801 associated with the represented individual. In some embodiments, processor 210 may isolate at least one aspect (e.g., facial feature such as eye, nose, mouth, etc.) of the detected face of individual 4801 and compare the at least one aspect with at least some of the one or more facial characteristics stored in the database for the plurality of individuals to identify a recognized individual 4801 associated with the detected face. In some embodiments, the at least one aspect may be isolated and/or selectively analyzed relative to other features in the environment of user 100. The facial recognition component may access the database to determine if the detected facial features correspond to a recognized individual. For example, processor 210 may access the database containing information about the plurality of individuals data representing associated facial features or other identifying features. Such data may include one or more images of the individuals, or data representative of a face of the user that may be used for identification through facial recognition. The facial recognition component may also access a contact list of user 100, such as a contact list on the user's phone, a web-based contact list (e.g., through Outlook™, Skype™, Google™, SalesForce™, etc.), etc. In some embodiments, the database may be compiled through previous facial recognition analysis. For example, processor 210 may be configured to store data associated with one or more faces recognized in images captured by apparatus 110 in the database. Each time a face is detected in the images, the detected facial features or other data may be compared to faces in the database, which may be previously stored or previously identified. The facial recognition component may determine that an individual is a recognized individual if the individual has previously been recognized by the system in a number of instances exceeding a certain threshold, if the individual has been explicitly introduced to apparatus 110, or the like.

In step 5009, processor 210 may retrieve at least some of the stored information for recognized individual 4801 from the database and cause the at least some of the stored information retrieved for recognized individual 4801 to be automatically conveyed to user 100. In some embodiments, processor 210 may retrieve, from the database, a linking characteristic. In some embodiments, the linking characteristic may be shared by recognized individual 4801 and user 100. In some embodiments, the linking characteristic may relate to (e.g., currently or in the past) at least one of a place of employment, a job title, a place of residence, a birthplace, an age, an expertise, or a name of a college or university. In some embodiments, the linking characteristic may relate to one or more interests shared by user 100 and individual 4801, one or more likes or dislikes shared by user 100 and individual 4801, or an indication of at least one relationship between individual 4801 and a third person with whom user 100 also has a relationship.

In step 5011, the at least some of the stored information retrieved for recognized individual 4801 may be automatically conveyed to user 100 audibly via a speaker (e.g., feedback-outputting unit 230) wirelessly connected to the wearable camera-based computing device of apparatus 100. In some embodiments, the speaker may be included in a wearable earpiece. In some embodiments, the at least some of the stored information retrieved for recognized individual 4801 may be automatically conveyed to user 100 visually via a display device (e.g., display 260) wirelessly connected to apparatus 100. In some embodiments, the display device may include at least one of a mobile device (e.g., computing device 120), server, personal computer, smart speaker, or device having a same device type as apparatus 110. In some embodiments, computing device 120 or apparatus 110 may include a user input device (e.g., a keyboard, a mouse-type device, a gesture sensor, an action sensor, a physical button, an oratory input, etc.) and processor 210 may be programmed to retrieve additional information regarding individual 4801 based on an input received from user 100 via the user input device.

Tracking and Guiding Individuals Using Camera-Based Devices

Camera-based devices may be designed to improve and enhance an individual's (e.g., customers, patients, etc.) interactions with his or her environments by allowing users in the environment to rely on the camera-based devices to track and guide the individual during daily activities. Different individuals may have a need for different levels of aid depending on the environment. As one example, individuals may be patients in a hospital and users (e.g., hospital employees such as staff, nurses, doctors, etc.) may benefit from camera-based devices to track and guide patients in the hospital. However, typical tracking and guiding methods may not rely on camera-based devices and may not provide a full picture of an individual's movement through an environment. Therefore, there is a need for apparatuses and methods for automatically tracking and guiding one or more individuals in an environment based on images captured from the environment of one or more users.

The disclosed embodiments include tracking systems including camera-based devices that may be configured to track and guide individuals in an environment based on images captured from an environment of a user. For example, a wearable camera-based computing device worn by a user may be configured to capture a plurality of images from an environment of the user (e.g., patients, hospital employees, healthcare professionals, customers, store employees, service members, etc.). In some embodiments, one or more stationary camera-based computing devices may be configured to capture a plurality of images from the environment of the user. The tracking system may receive a plurality of images from the camera-based computing device and identify at least one individual (e.g., patients, hospital employees, healthcare professionals, customers, store employees, service members, etc.) represented by the plurality of images. The tracking system may determine at least one characteristic of the at least one individual and generate and send an alert regarding the individual's location. In some embodiments, the camera-based computing device may be configured to capture a plurality of images from the environment of a user (e.g., a service member) and output an image signal comprising one or more images from the plurality of images.

In some embodiments, the camera-based computing device may include a memory unit storing a database comprising information related to each individual included in a plurality of individuals (e.g., patients, hospital employees, healthcare professionals, customers, store employees, service members, etc.). The stored information may include one or more facial characteristics and at least one of a name, a place of employment, a job title, a place of residence, a birthplace, or an age.

In some embodiments, more than one camera, which may include a combination of stationary cameras and wearable cameras, may be used to track and guide individuals in an environment. For example, a first device may include a camera and capture a plurality of images from an environment of a user. The first device may further include a memory device storing at least one visual characteristic of at least one person and may include at least one processor programmed to transmit the at least one visual characteristic of at least one individual to a second device. The second device may include a camera and the second device may be configured to recognize the at least one person in an image captured by the camera of the second device.

For example, the second device may be configured to detect, in at least one image captured by the camera of the second device, a face of an individual represented in the at least one of the plurality of images captured by the camera of the first device; compare at least one aspect of the detected face with at least some of the one or more facial characteristics stored in the database for a plurality of individuals including the at least one individual to identify a recognized individual associated with the detected face; retrieve at least some of the stored information for the recognized individual from the database; and cause the at least some of the stored information retrieved for the recognized individual to be automatically conveyed to the first device.

In some embodiments, a user associated with the first device may be a hospital employee. A camera of the first device may capture a plurality of images from an environment of the hospital employee. The first device may further include a memory device storing at least one visual characteristic of at least one person and may include at least one processor programed to transmit the at least one visual characteristic of at least one individual to a second device. The second device may include a camera and the second device may be configured to recognize the at least one person in an image captured by the camera of the second device. In some embodiments, the recognized individual may be a patient.

In some embodiments, the second device may be configured to detect, in at least one image captured by the camera of the second device, a face of an individual represented in the at least one of the plurality of images captured by the camera of the first device; and compare at least one aspect of the detected face with at least some of the one or more facial characteristics stored in the database for a plurality of individuals including the at least one individual to identify a recognized individual associated with the detected face. In some embodiments, a user may be associated with the second device and the user associated with the second device may be a hospital employee who is in the environment of the recognized individual. In some embodiments, the recognized individual may be a patient. The second device may be configured to retrieve at least some stored information for the recognized individual from a database, and may cause the at least some of the stored information retrieved for the recognized individual to be automatically conveyed to the first device. For example, the stored information may include an indication that the patient (e.g., the recognized individual) is scheduled to have an appointment with the hospital employee (e.g., a user associated with the second device).

In some embodiments, a hospital employee associated with the second device may be in an environment of the patient, but the hospital employee may not necessarily be scheduled to have an appointment with the patient. The stored information may include an indication that the patient is scheduled to have an appointment with a different hospital employee (e.g., a hospital employee associated with the first device) who is not associated with the second device. The second device may be configured to automatically convey the stored information regarding the patient's scheduled appointment to the first device. In some embodiments, the information may also be augmented with a current location of the patient. The hospital employee may also access the patient and instruct them to where the scheduled appointment is to take place. In some embodiments, the second device may be a stationary device in an environment (e.g., an environment of the user).

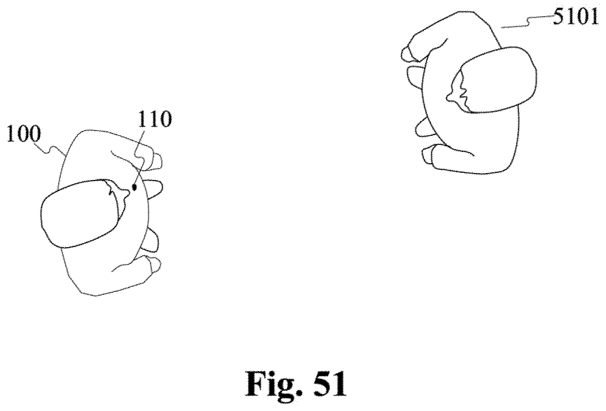

FIG. 51 is a schematic illustration showing an exemplary environment including a camera-based computing device consistent with the disclosed embodiments. In some embodiments, the camera-based computing device may be a wearable device (e.g., apparatus 110). In some embodiments, apparatus 110 may include at least one tracking subsystem. In some embodiments apparatus 110 may include voice and/or image recognition. In some embodiments, a camera (e.g., a wearable camera-based computing device of apparatus 110) may be configured to capture a plurality of images from an environment of user 100 using an image sensor (e.g., image sensor 220). In some embodiments, the camera may output an image signal that includes the captured plurality of images. In some embodiments, user 100 may be a hospital employee, healthcare professional, customer, store employee, service member, etc.

In some embodiments, a memory unit (e.g., memory 550) may include a database configured to store information related to each individual included in a plurality of individuals (e.g., patients, hospital employees, healthcare professionals, customers, store employees, service members, etc.). In some embodiments, the memory unit may be included in apparatus 110. In some embodiments, the memory unit may be accessible to apparatus 110 via a wireless connection. In some embodiments, the stored information may include one or more facial or body characteristics of each individual of the plurality of individuals. In some embodiments, the stored information may include at least one of one or more facial or body characteristics, a name, a place of employment, a job title, a place of residence, a birthplace, or an age.

In some embodiments, at least one processor (e.g., processor 210) may be programmed to receive a plurality of images from one or more cameras of apparatus 110. In some embodiments, processor 210 may be a part of apparatus 110. In some embodiments, processor 210 may be in a system or device that is separate from apparatus 110. In some embodiments, processor 210 may be programmed to identify at least one individual 5101 (e.g., customers, patients, employees, etc.) represented by the plurality of images. In some embodiments, processor 210 may be programmed to determine at least one characteristic (e.g., an alternate location where the at least one individual is expected, a time at which the at least one individual is expected at the alternate location) of at least one individual 5101 and generate and send an alert based on the at least one characteristic.

For example, processor 210 may be programmed to receive a plurality of images from a camera of apparatus 110, where at least one image of individual 5101 or at least one image of the environment of individual 5101 shows that individual 5101 is in a first location of an organization (e.g., the at least one image may show an employee or sign associated with the labor and delivery unit of a hospital). Based on at least one image of individual 5101 and at least one characteristic of individual 5101 stored in a memory unit (e.g., memory 550), processor 210 may be programmed to determine that individual 5101 should actually be in a second location of the organization (e.g., the radiology department of the hospital). Processor 210 may be programmed to generate and send an alert to an individual (e.g., user 100, individual 5101, employee 5203, etc.) based on the at least one characteristic, where the alert indicates that individual 5101 should be in the second location instead of the first location, thereby allowing user 100 or another employee to guide individual 5101 to the correct location.

In some embodiments, processor 210 may determine a location associated with at least one individual 5101 based on an analysis of the plurality of images and comparing one or more aspects of an environment represented in the plurality of images with image data stored in at least one database. In some embodiments, processor 210 may determine a location associated with at least one individual 5101 based on an output of a positioning unit associated with the at least one tracking subsystem (e.g., apparatus 110). In some embodiments, the positioning unit may be a global positioning (GPS) unit. For example, the one or more aspects of an environment represented in the plurality of images may include a labor and delivery nurse or a sign for the labor and delivery unit of a hospital. Processor 210 may analyze and compare the one or more aspects with image data stored in at least one database and determine that individual 5101 is located in or near the labor and delivery unit of the hospital.

In some embodiments, processor 210 may be programmed to determine a location in which at least one image was captured. For example, processor 210 may determine a location (e.g., location coordinates) in which an image was captured based on metadata associated with the image. In some embodiments, processor 210 may determine the location based on at least one of a location signal, location of apparatus 110, an identity of apparatus 110 (e.g., an identifier of apparatus 110), or a feature of the at least one image (e.g., a feature of an environment included in the at least one image).

In some embodiments, processor 210 may determine the at least one characteristic by sending at least one identifier (e.g., one or more of the plurality of images captured by apparatus 110, information included in a radio-frequency identification (RFID) tag associated with at least one individual 5101, etc.) associated with at least one individual 5101 to a server remotely located relative to the at least one tracking subsystem (e.g., apparatus 110), and receiving, from the remotely located server, the at least one characteristic relative to a determined location, where the at least one characteristic includes an alternate location where at least one individual 5101 is expected (e.g., the radiology department of a hospital). In some embodiments, the at least one characteristic may include a time at which at least one individual 5101 is expected at the alternate location. In some embodiments, the alert may identify the alternate location where at least one individual 5101 is expected.

In some embodiments, processor 210 may determine the at least one characteristic by monitoring an amount of time at least one individual 5101 spends in a determined location and wherein the alert may include an instruction for user 100 (e.g., a service member, hospital employees, healthcare professionals, customers, store employees, service members, etc.) to check in with at least one individual 5101, and the alert may be generated if at least one individual 5101 is observed in the determined location for more than a predetermined period of time. In some embodiments, the alert may be generated based on input from a server located remotely relative to at least one tracking subsystem (e.g., apparatus 110).

In some embodiments, the alert may be delivered to user 100 or to another individual, for example a hospital employee known to be nearby, via a mobile device associated with user 100 or with the individual. In some embodiments, the mobile device may be part of apparatus 110. In some embodiments, the alert may be delivered to at least one individual 5101 via a mobile device associated with at least one individual 5101. In some embodiments, apparatus 110 may be a first device that includes a first camera configured to capture a plurality of images from an environment of a user 100 and output an image signal comprising the plurality of images. The first device may include a memory device (e.g., memory 550) storing at least one visual characteristic (e.g., facial features such as eye, nose, mouth, etc.) of at least one individual 5101, and at least one processor (e.g., processor 210) that may be programmed to transmit the at least one visual characteristic to a second device comprising a second device camera.

In some embodiments, more than one camera, including a combination of stationary cameras and wearable cameras, may be used to track and guide at least one individual 5101. For example, the first device may capture a plurality of images from an environment of user 100. In some embodiments, the first device may further include a memory device storing at least one visual characteristic of at least one person and at least one processor of the first device may be programmed to transmit at least one visual characteristic of at least one individual 5101 to the second device. The second device may be configured to recognize at least one individual 5101 in an image captured by the second device camera. For example, individual 5101 may be a patient and the first device and the second device may be stationary devices in a hospital. In some embodiments, the first device may be associated with a first hospital employee and the second device may be associated with a second hospital employee. In some embodiments, user 100 may be hospital employee. In some embodiments, the first device and the second device may be a combination of stationary devices or wearable devices. For example, the first and second devices may capture a plurality of images from an environment of at least one individual 5101 (e.g., a patient) as at least one individual 5101 moves throughout an environment (e.g., a hospital).

In some embodiments, the second device may be configured to indicate, based on recognizing at least one individual 5101, that at least one individual 5101 is associated with user 100 of the first device. For example, the second device may be configured to detect, in at least one image captured by the device camera of the second device, a face of at least one individual 5101 represented in the at least one of the plurality of images captured by the camera device of the first device; compare at least one aspect of the detected face with at least some of the one or more facial characteristics stored in the database for a plurality of individuals including the at least one individual to identify a recognized individual associated with the detected face; retrieve at least some of the stored information for the recognized individual 5101 from the database; and cause the at least some of the stored information retrieved for the recognized individual 5101 to be automatically conveyed to the first device. For example, the second device may be in a hospital and at least one individual 5101 may be a patient. The second device may be configured to indicate, based on recognizing the patient (e.g., at least one individual 5101), that the patient is associated with a physician (e.g., user 100). In some embodiments, the stored information may be an indication that the patient is scheduled to have an appointment with the physician. For example, if the patient is not in the correct location of a hospital for their appointment with the physician, the second device may be configured to generate an alert for the user of the second device or for the patient to help direct the patient to the correct location for their scheduled appointment.

In some embodiments, a user (e.g., user 100) associated with the first device may be a hospital employee. A camera of the first device may capture a plurality of images from an environment of the hospital employee. The first device may further include a memory device storing at least one visual characteristic of at least one person and may include at least one processor programmed to transmit the at least one visual characteristic of at least one individual to at least one second device. The second device may include a camera and the second device may be configured to recognize the at least one person (e.g., individual 5101) in an image captured by the camera of the second device. In some embodiments, the recognized individual may be a patient.

In some embodiments, the second device may be configured to detect, in at least one image captured by the camera of the second device, a face of an individual represented in the at least one of the plurality of images captured by the camera of the first device; and compare at least one aspect of the detected face with at least some of the one or more facial characteristics stored in the database for a plurality of individuals including the at least one individual to identify a recognized individual associated with the detected face. In some embodiments, a user may be associated with the second device and the user associated with the second device may be a hospital employee who is in the environment of the recognized individual. In some embodiments, the recognized individual may be a patient. The second device may be configured to retrieve at least some stored information for the recognized individual from a database and cause the at least some of the stored information retrieved for the recognized individual to be automatically conveyed to the first device. For example, the stored information may include an indication that the patient (e.g., the recognized individual) is scheduled to have an appointment with the hospital employee (e.g., a user associated with the second device).

In some embodiments, a hospital employee associated with the second device may be in an environment of the patient, but the hospital employee may not necessarily be scheduled to have an appointment with the patient. The stored information may include an indication that the patient is scheduled to have an appointment with a different hospital employee (e.g., a hospital employee associated with the first device) who is not associated with the second device. The second device may be configured to automatically convey the stored information regarding the patient's scheduled appointment to the first device, together with a current estimated location of the patient. In some embodiments, the second device may be a stationary device in an environment (e.g., an environment of the user).

In some embodiments, at least one processor may be included in the camera unit. In some embodiments, the at least one processor may be included in a mobile device wirelessly connected to the camera unit. In some embodiments, the system may include a plurality of tracking subsystems, and a position associated with at least one individual 5101 may be tracked based on images acquired by camera units associated with the plurality of tracking subsystems.

In some embodiments, the system may include one or more stationary camera units and a position associated with at least one individual 5101 may be tracked based on images acquired by the one or more stationary camera units. For example, one or more stationary camera units may be positioned in one or more locations such that one or more stationary camera units may be configured to acquire one or more images of the at least one individual 5101. For example, one or more stationary camera units may be positioned throughout a hospital such that at least one image of at least one individual 5101 may be acquired.

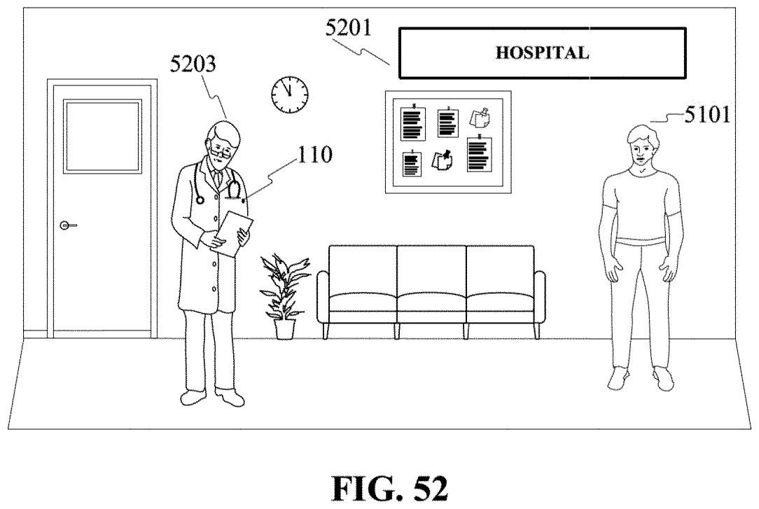

FIG. 52 is an illustration of an exemplary environment in which a camera-based computing device operates consistent with the disclosed embodiments. In some embodiments, a user such as an employee 5203 (e.g., a doctor) may wear apparatus 110. In some embodiments, a camera (e.g., a wearable camera-based computing device of apparatus 110) may be configured to capture a plurality of images from an environment of the user using an image sensor (e.g., image sensor 220). In some embodiments, the camera may output an image signal that includes the captured plurality of images.

In some embodiments, at least one processor (e.g., processor 210) may be programmed to receive a plurality of images from one or more cameras of apparatus 110. In some embodiments, processor 210 may be programmed to identify at least one individual 5101 (e.g., a customer, a patient, an employee, etc.) represented by the plurality of images. In some embodiments, processor 210 may be programmed to determine at least one characteristic (e.g., an alternate location where the at least one individual is expected, a time at which the at least one individual is expected at the alternate location) of at least one individual 5101 and generate and send an alert based on the at least one characteristic.

For example, processor 210 may be programmed to receive a plurality of images from a camera of apparatus 110, where at least one image of individual 5101 or at least one image of an aspect 5201 of the environment of individual 5101 shows that individual 5101 is in a first location of an organization (e.g., aspect 5201 may be a sign associated with the labor and delivery unit of a hospital). In other embodiments, the location of individual 5101 may be determined in another manner, such as by using GPS information or another localization method. Based on at least one image of individual 5101 and at least one characteristic of individual 5101 stored in a memory unit (e.g., memory 550), processor 210 may be programmed to determine that individual 5101 should actually be in a second location of the organization (e.g., the radiology department of the hospital). Processor 210 may be programmed to generate and send an alert to individual 5101 based on the at least one characteristic. In some embodiments, the alert may be sent to other users, such as other hospital employees determined to be in the vicinity of individual 5101. For example, when the at least one characteristic is an alternate location where individual 5101 is expected, the alert may indicate that individual 5101 should be in the second location instead of the first location. Based on the alert, a user (e.g., another hospital employee in the vicinity of individual 5101 who received the alert may guide individual 5101 to the correct location (e.g., a location in the hospital where individual 5101 is scheduled to have an appointment).

In some embodiments, processor 210 may determine a location associated with at least one individual 5101 based on an analysis of the plurality of images and comparing aspect 5201 of an environment represented in the plurality of images with image data stored in at least one database. In some embodiments, processor 210 may determine a location associated with at least one individual 5101 based on an output of a positioning unit associated with the at least one tracking subsystem (e.g., apparatus 110). In some embodiments, the positioning unit may be a global positioning (GPS) unit. For example, aspect 5201 represented in the plurality of images may be a sign for the labor and delivery unit of a hospital. Processor 210 may analyze and compare aspect 5201 with image data stored in at least one database and determine that individual 5101 is located in or near the labor and delivery unit of the hospital.

In some embodiments, the system may include one or more stationary camera units, and a position associated with at least one individual 5101 may be tracked based on images acquired by the one or more stationary camera units. For example, one or more stationary camera units may be positioned in one or more locations such that one or more stationary camera units may be configured to acquire one or more images of the at least one individual 5101, aspect 5201, or employee 5203. For example, one or more stationary camera units may be positioned throughout a hospital such that at least one image of at least one individual 5101, aspect 5201, or employee 5203 may be acquired.

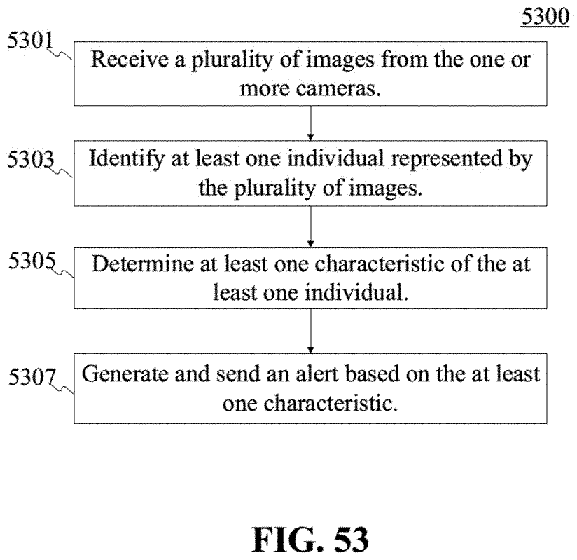

FIG. 53 is a flowchart showing an exemplary process 5300 for tracking and guiding one or more individuals in an environment based on images captured from the environment of one or more users consistent with the disclosed embodiments.

In step 5301, at least one processor (e.g., processor 210) may be programmed to receive a plurality of images from one or more cameras of apparatus 110. For example, processor 210 may be programmed to receive a plurality of images from apparatus 110, where at least one image of individual 5101 or at least one image or the environment of individual 5101 (e.g., aspect 5201) shows that individual 5101 is in a first location of an organization (e.g., the at least one image may show an employee or sign associated with the labor and delivery unit of a hospital).

In step 5303, processor 210 may be programmed to identify at least one individual 5101 (e.g., customers, patients, employees, etc.) represented by the plurality of images. For example, in some embodiments, apparatus 110 may include a memory device (e.g., memory 550) storing at least one visual characteristic (e.g., facial features such as eye, nose, mouth, etc.) of at least one individual 5101, and processor 210 that may be programmed to transmit the at least one visual characteristic to a second device comprising a second device camera. In some embodiments, processor 210 may be configured to recognize at least one individual 5101 in an image captured by apparatus 110.

In some embodiments, more than one camera, including a combination of stationary cameras and wearable cameras, may be used to track and guide at least one individual 5101. For example, the first device may capture a plurality of images from an environment of user 100. In some embodiments, at least one processor of the first device may be programmed to transmit at least one visual characteristic of at least one individual 5101 to the second device and the second device may be configured to recognize at least one individual 5101 in an image captured by the second device camera.

In step 5305, processor 210 may be programmed to determine at least one characteristic (e.g., an alternate location where the at least one individual is expected, a time at which the at least one individual is expected at the alternate location) of at least one individual 5101. In some embodiments, processor 210 may determine the at least one characteristic by sending at least one identifier (e.g., one or more of the plurality of images captured by apparatus 110, information included in n radio-frequency identification (RFID) tag associated with at least one individual 5101, etc.) associated with at least one individual 5101 to a server remotely located relative to the at least one tracking subsystem (e.g., apparatus 110) receiving, from the remotely located server, the at least one characteristic relative to a determined location, where the at least one characteristic includes an alternate location where at least one individual 5101 is expected (e.g., the radiology department of a hospital). In some embodiments, the at least one characteristic may include a time at which at least one individual 5101 is expected at the alternate location. In some embodiments, the alert may identify the alternate location where at least one individual 5101 is expected.

In some embodiments, processor 210 may determine the at least one characteristic by monitoring an amount of time at least one individual 5101 spends in a determined location and the alert may include an instruction for user 100 (e.g., a service member, hospital employees, healthcare professionals, customers, store employees, service members, etc.) to check in with at least one individual 5101 and the alert may be generated if at least one individual 5101 is observed in the determined location for more than a predetermined period of time. In some embodiments, the alert may be generated based on input from a server located remotely relative to at least one tracking subsystem (e.g., apparatus 110).

In some embodiments, more than one camera, including a combination of stationary cameras and wearable cameras, may be used to track and guide at least one individual 5101. For example, the first device may capture a plurality of images from an environment of user 100. In some embodiments, the first device may further include a memory device storing at least one visual characteristic of at least one person and at least one processor of the first device may be programmed to transmit at least one visual characteristic of at least one individual 5101 to the second device. The second device may be configured to recognize at least one individual 5101 in an image captured by the second device camera. For example, individual 5101 may be a patient and the first device and the second device may be stationary devices in a hospital. In some embodiments, the first device may be associated with a first hospital employee and the second device may be associated with a second hospital employee. In some embodiments, user 100 may be hospital employee. In some embodiments, the first device and the second device may be a combination of stationary devices or wearable devices. For example, the first and second devices may capture a plurality of images from an environment of at least one individual 5101 (e.g., a patient) as at least one individual 5101 moves throughout an environment (e.g., a hospital).

In some embodiments, a second device may be configured to indicate, based on recognizing at least one individual 5101, that at least one individual 5101 is associated with user 100 of the first device. For example, the second device may be configured to detect, in at least one image captured by the device camera of the second device, a face of at least one individual 5101 represented in the at least one of the plurality of images captured by the camera device of a first device; compare at least one aspect of the detected face with at least some of the one or more facial characteristics stored in the database for a plurality of individuals including the at least one individual to identify a recognized individual associated with the detected face; and retrieve at least some of the stored information for the recognized individual 5101 from the database; and cause the at least some of the stored information retrieved for the recognized individual 5101 to be automatically conveyed to the first device. For example, the second device may be in a hospital and at least one individual 5101 may be a patient. The second device may be configured to indicate, based on recognizing the patient (e.g., at least one individual 5101), that the patient is associated with a physician (e.g., user 100). In some embodiments, the stored information may be an indication that the patient is scheduled to have an appointment with the physician. For example, if the patient is not in the correct location of a hospital for their appointment with the physician, the second device may be configured to generate an alert for the user of the first device or for the patient to help direct the patient to the correct location for their scheduled appointment.

In some embodiments, a user associated with the first device may be a hospital employee. A camera of the first device may capture a plurality of images from an environment of the hospital employee. The first device may further include a memory device storing at least one visual characteristic of at least one person and may include at least one processor programmed to transmit the at least one visual characteristic of at least one individual to a second device. The second device may include a camera and the second device may be configured to recognize the at least one person in an image captured by the camera of the second device. In some embodiments, the recognized individual may be a patient.

In some embodiments, the second device may be configured to detect, in at least one image captured by the camera of the second device, a face of an individual represented in the at least one of the plurality of images captured by the camera of the first device; compare at least one aspect of the detected face with at least some of the one or more facial characteristics stored in the database for a plurality of individuals including the at least one individual to identify a recognized individual associated with the detected face. In some embodiments, a user may be associated with the second device and the user associated with the second device may be a hospital employee who is in the environment of the recognized individual. In some embodiments, the recognized individual may be a patient. The second device may be configured to retrieve at least some stored information for the recognized individual from a database and cause the at least some of the stored information retrieved for the recognized individual to be automatically conveyed to the first device. For example, the stored information may include an indication that the patient (e.g., the recognized individual) is scheduled to have an appointment with the hospital employee (e.g., a user associated with the second device).

In some embodiments, a hospital employee associated with the second device may be in an environment of the patient, but the hospital employee may not necessarily be scheduled to have an appointment with the patient. The stored information may include an indication that the patient is scheduled to have an appointment with a different hospital employee (e.g., a hospital employee associated with the first device) who is not associated with the second device. The second device may be configured to automatically convey the stored information regarding the patient's scheduled appointment to the first device. In some embodiments, the second device may be a stationary device in an environment (e.g., an environment of the user).

In step 5307, processor 210 may generate and send an alert based on the at least one characteristic. Based on at least one image of individual 5101 and at least one characteristic of individual 5101 stored in a memory unit (e.g., memory 550), processor 210 may be programmed to determine that individual 5101 should actually be in a second location of the organization (e.g., the radiology department of the hospital). Processor 210 may be programmed to generate and send an alert to an individual (e.g., user 100, individual 5101, employee 5203, etc.) based on the at least one characteristic, where the alert indicates that individual 5101 should be in the second location instead of the first location, thereby allowing user 100 or another individual to guide individual 5101 to the correct location.

In some embodiments, the alert may be delivered to an individual via a mobile device associated with the individual. In some embodiments, the mobile device may be part of apparatus 110. In some embodiments, the alert may be delivered to at least one individual 5101 via a mobile device associated with at least one individual 5101. In some embodiments, apparatus 110 may be a first device that includes a first camera configured to capture a plurality of images from an environment of a user 100 and output an image signal comprising the plurality of images.

Passively Searching for Persons

When wearable devices become ubiquitous, they will have an added ability to serve the public good, such as by locating missing persons, fugitive criminals, or other persons of interest. For example, traditionally, when a missing person is reported to law enforcement, law enforcement may coordinate with local media, display notices on billboards, or even dispatch an emergency phone message, such as an AMBER alert. However, the effectiveness of these methods is often limited, as citizens may not see the alert or may ignore or forget the description of the alert. Further, the existence of an alert may cause the person of interest to go into hiding to prevent being identified.

However, automation of this alert and search functionality may overcome these limitations. For example, a person of interest's characteristics, such as facial metadata, might be shared across a network of wearable device users, thus turning each user into a passive searcher. When the missing person is recognized by a device, the device may automatically transmit a report to the police without the device user having to take a separate action or interrupting other functions of the user device. If this is done without the knowledge of a user, a person of interest may never be aware of the search, and refrain from going into hiding. Further, wearable devices according to the present disclosure may provide better identification ability than other camera systems, because the wearable devices are disposed closer to face level than many security cameras.

Thus, as discussed above, wearable devices such as apparatus 110 may be enlisted to aid in finding a person of interest in a community. The apparatus may comprise at least one camera included in a housing, such as image sensor 220. The at least one camera may be configured to capture a plurality of images representative of an environment of a wearer. In this way, apparatus 110 may be considered a camera-based assistant system. Additionally, the camera-based assistant system may also comprise a location sensor included in the housing, such as a GPS, inertial navigation system, cell signal triangulation, or IP address location system. Further still, as stated above, the camera-based assistant system may also comprise a communication interface, such as wireless transceiver 530, and at least one processor, such as processor 210.

Apparatus 110 may be configured to communicate with an external camera device, as well, such as a camera worn separately from apparatus 110, or an additional camera that may provide a different vantage point from a camera included in the housing. Such communication may be through a wired connection, or may be made wirelessly (e.g., using a Bluetooth™, NFC, or forms of wireless communication). As discussed above, apparatus 110 may be worn by user 100 in various configurations, including being physically connected to a shirt, necklace, a belt, glasses, a wrist strap, a button, or other articles associated with user 100. In some embodiments, one or more additional devices may also be included, such as computing device 120. Accordingly, one or more of the processes or functions described herein with respect to apparatus 110 or processor 210 may be performed by an external processor, or by at least one processor included in the housing.

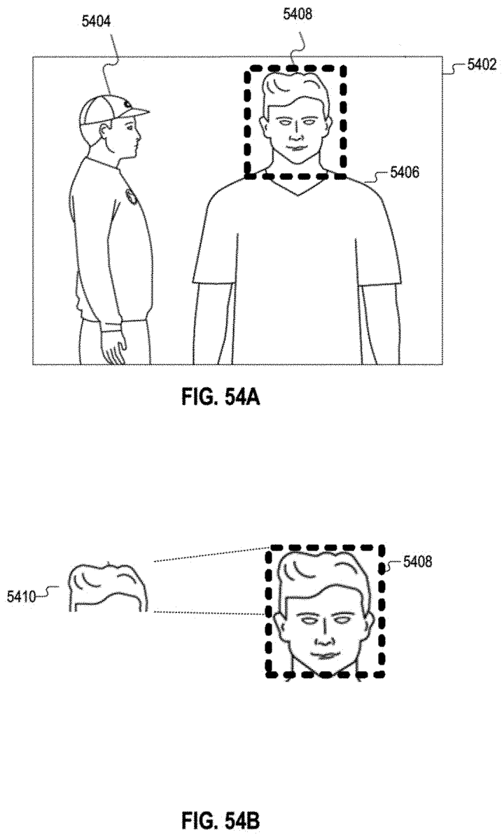

Processor 210 may be programmed to detect an identifiable feature associated with a person of interest in an image captured by the at least one camera. FIG. 54A is a schematic illustration of an example of an image captured by a camera-based assistant systems consistent with the present disclosure. Image 5402 represents a field of view of the at least one camera that may be analyzed by processor 210. As an example, a camera may capture image 5402, and processor 210 may identify two people, including side-facing person 5404 and front-facing person 5406 in image 5402.

Processor 210 may pre-process image 5402 to identify regions for further processing. For example, in some scenarios, processor 210 may be programmed to detect a feature that is observable on the person of interest's face. Thus, processor 210 may store a portion of image 5402 containing a face, such as region 5408. In some embodiments, processor 210 may forward the pre-processed image to another device for additional processing, such as a central server, rather than or in addition to analyzing the image further.

Additionally, processor 210 may exclude regions that do not include a correct view of a person's face. For example, if an identifiable feature of the person of interest is visible based on the person of interest's full face, processor 210 may ignore side-facing persons, such as person 5404. Additionally, some identifiable features may be mutually exclusive with other features. For example, if a person of interest has a unique hairstyle, processor 210 may ignore persons wearing hats or hoods. This pre-processing step may reduce processing time, enhance identification accuracy, and reduce power consumption.

FIG. 54B is a schematic illustration of an identification of an identifiable feature associated with a person of interest consistent with the present disclosure. In FIG. 54B, processor 210 (and/or another device, if the image is forwarded) further analyzes region 5408 containing the face of front-facing person 5406 to determine if the identifiable feature of the person of interest is present in region 5408. For example, the identifiable feature of a person of interest may be his unique hairstyle 5410. Processor 210 may compare unique hairstyle 5410 to region 5408 to determine if region 5408 includes the person of interest. In FIG. 54B, unique hairstyle 5410 matches the hair of person 5406 in region 5408, and processor 210 may then determine that there is a match.

Although an image comparison is used in the schematic illustration of FIG. 54B, other comparison methods are also envisioned. For example, rather than comparing an image to a captured image, processor 210 may compare measurements to a captured image, such as a person's height, or measurement ratios, such as a ratio of a person's mouth width to the person's head width, to make a determination that a person of interest is in the captured image. For example, other identifiable features may include a facial feature, a tattoo, or a body shape. Additionally or alternatively, any feature or characteristics used in any face recognition algorithm or system may be used.

Further, the identifiable feature may be associated with the person, rather than being an aspect of the person of interest's body, such as a license plate of the person of interest's vehicle, or unique clothing or accessories. Additionally, in some embodiments, the at least one camera may include a video camera, and processor 210 may analyze a video for an identifiable feature of a person of interest, such as gait or unusual limb movements.

When law enforcement learns that there is a person of interest, such as a fugitive or missing person, law enforcement may need to disseminate information about identifiable features of a person to a plurality of apparatuses in a community to begin passively searching for the person of interest. Additionally, when an apparatus captures an image of a person of interest, the apparatus may need to send a report to law enforcement.

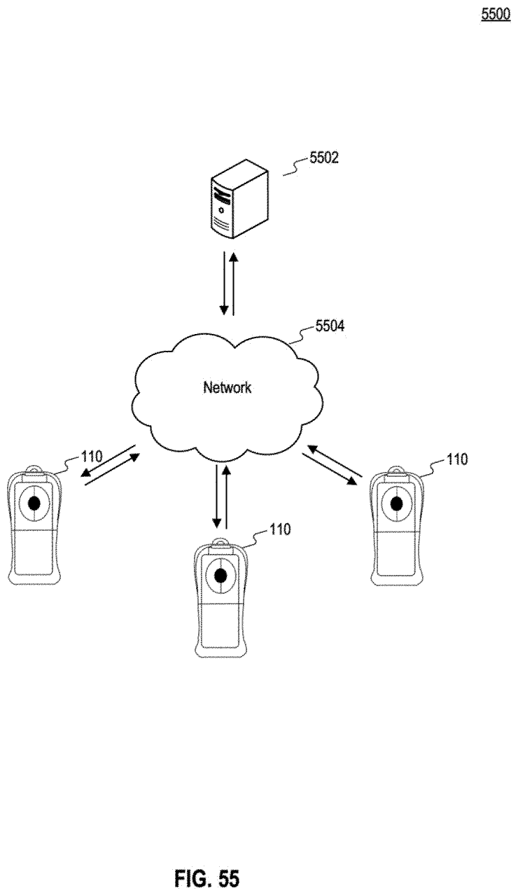

Accordingly, FIG. 55 is a schematic illustration of a network including a server and multiple wearable apparatuses consistent with the present disclosure. System 5500 of FIG. 55 includes one or more servers 5502. The one or more servers may, for example, be operated by law enforcement or other legal authorities. Alternatively or additionally, one or more servers 5502 may be operated by an intermediary which provides information to a legal authority when a person of interest is identified.

One or more servers 5502 may connect via a network 5504 to a plurality of apparatuses 110. Network 5504 may be, for example, a wireless module (e.g., Wi-Fi, cellular). Further, communication between apparatus 110 and server 5504 may be accomplished through any suitable communication channels, such as, for example, a telephone network, an extranet, an intranet, the internet, satellite communications, off-line communications, or other wireless protocols.

In the disclosed embodiments, the data transferred from one or more servers 5502 via network 5504 to a plurality of apparatuses 110 may include information concerning an identifiable feature of a person of interest. The information may include an image of the person or the identifiable feature, as was shown in FIG. 54B. The information may alternatively or additionally include text information, such as text representing a license plate number or displayed on clothing. Further still, the information may include measurements, colors, proportions, or any other characteristic of the person of interest or an identifiable feature thereof.

Apparatuses 110 may also use network 5504 to communicate findings to one or more servers 5502. For example, if one of apparatuses 110 captures an image containing an identifiable feature or characteristic of a person of interest, received from one or more servers 5502, the apparatus 110 may send information to one or more servers 5502 via network 5504. The information may include a location of the apparatus when the image was captured, a copy of the image or portion of the image, and a time of capture. Authorities may use reports to dispatch officers to apprehend or locate the person of interest.

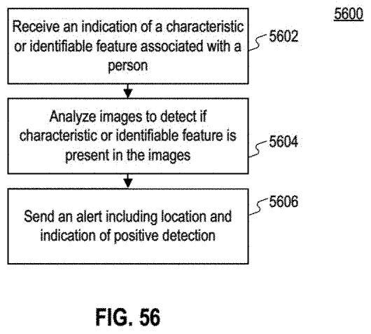

FIG. 56 is a flowchart showing an exemplary process for sending alerts when a person of interest is found consistent with the present disclosure. Processor 210 of apparatus 110, such as a camera-based assistant system, may be programmed to perform some or all of the steps illustrated for process 5600. Alternatively, steps of process 5600 may be performed by a different processor, such as a processor of a server or external computing device.

At step 5602, processor 210 may receive, via a communication interface and from a server located remotely with respect to the camera-based assistant system, an indication of at least one characteristic or identifiable feature associated with a person of interest. As discussed above, this indication may be received via network 5504 from one or more servers 5502.

At step 5604, processor 210 may analyze the plurality of captured images to detect whether the at least one characteristic or identifiable feature of the person of interest is represented in any of the plurality of captured images. In some embodiments, a user wearing the camera-based assistant system may receive an indication, such as from the camera-based assistant system itself, that the camera-based assistant system is analyzing the plurality of captured images. Alternatively, analyzing the plurality of captured images to detect whether the at least one characteristic or identifiable feature is represented by any of the plurality of captured images may be performed as a background process executed by the at least one processor. In other words, the user's interaction with the camera based assistant system may be uninterrupted, and the user may be unaware that the camera-based assistant system is analyzing the plurality of captured images.

In some embodiments, the at least one identifiable characteristic or feature of the person of interest may include a voice signature, such as a voice pitch, speed, speech impediment, and the like. To aid in locating a person of interest, the camera-based assistant system may further include a microphone, such as a microphone included in the housing. Further, step 5604 may include analyzing an output of the microphone to detect whether the output of the microphone corresponds to the voice signature associated with the person of interest. For example, processor 210 may perform waveform analysis on a waveform generated by the microphone, such as determining overtones or voice pitch, and compare the extracted waveforms with the at least one identifiable voice feature to determine if there is a match. If a match is found, the camera-based assistant system may send an audio clip for further analysis, such as to one or more servers 5502.

Processor 210 may also perform speech analysis to determine words in a captured speech. For example, a person of interest may be a kidnapper of a child with a unique name. Processor 210 may analyze captured audio for someone stating the unique name, indicating that the kidnapper may be nearby. Voice signature and audio analysis may thus provide additional benefits beyond image recognition techniques, as the camera-based assistant system need not have a clear view of a person of interest to capture his voice. It will be appreciated that combining any two or more of the methods above may also be beneficial for enhancing the identification confidence.

In some embodiments, the camera-based assistant system may enhance capture fidelity when a person of interest is likely to be nearby. For example, if authorities suspect that a person of interest is within a mall, camera-based assistant systems having a location with the mall may increase frame capture rate, image focus or size, and/or decrease image compression to increase the likelihood of detecting the person of interest even from long distances. Further, the at least one processor may be programmed to change a frame capture rate of the at least one camera if the camera-based assistant system detects the at least one identifiable feature of the person of interest in at least one of the plurality of captured images. For example, if the at least one processor determines that a first image includes or likely includes the at least one identifiable characteristic or feature, the at least one processor may increase the frame capture rate to provide additional data of the person to further confirm that the person of interest is in the captured images, or to provide additional clues on the whereabouts and behavior of the person of interest.

At step 5606, processor 210 may send an alert, via the communication interface, to one or more recipient computing devices remotely located relative to the camera-based assistant system, wherein the alert includes a location associated with the camera-based assistant system, determined based on an output of the location sensor, and an indication of a positive detection of the person of interest. The alert may include other information as well, such as the image or audio that formed the basis of the positive detection. In some embodiments, camera-based assistant systems may also send a negative detection to confirm that they are searching for the person of interest but have been unsuccessful.

The recipient device may be the one or more servers 5502 that provided to the camera-based assistant system the at least one characteristic or identifiable feature associated with the person of interest, such as via network 5504. For example, the one or more recipient computing devices may be associated with at least one law enforcement agency.

In some embodiments, the one or more recipient computing devices may include a mobile device associated with a family member of the person of interest. For example, the indication of at least one identifiable feature associated with a person of interest may be accompanied by contact information of a family member, such as a phone number or email. Apparatus 110 may directly send a message of a positive detection to the family member. Alternatively, to avoid falsely giving hope to a family from a false detection of a family member, the message of positive detection may be screened prior to sending, for example, by a human or a more complex analysis by another processor.

In some embodiments, the recognition certainty may be increased if multiple recognition events are received from different apparatuses 110. In some embodiments, camera-based assistant systems may be networked and send preliminary alerts to other camera-based assistant systems. A server or a camera-based assistant system may then send an alert to a family member if a number of positive detects in an area exceeds a threshold. For example, if a threshold is five positive detections, a server or camera-based assistant systems in an area may send out messages to other camera-based assistant systems in the area. A fifth camera-based assistant system making a fifth positive detection may then send an alert. In this manner, the risk of false positives may be reduced.

In some embodiments, the alert may not be sent to the wearer of a camera-based assistant system, such as when processing occurs in the background, or when a law enforcement agency wishes to keep a search secret so that the person of interest is not aware of the search. Further, in some embodiments, the at least one processor may be further programmed to forego sending the alert based on a user input. For example, the camera-based assistant system may present and aural, visual, or tactile notification to the user that a match of a person of interest has been made. The camera-based assistant system may automatically send the alert if no response is received from the user for a certain time period, or may only send the alert if the user confirms the alert may be sent. Further, the camera-based assistant system may provide the notification along with information about the person of interest. This may allow users to personally verify that a person of interest is nearby, maneuver to get a better sight of the potential person of interest, speak with the person of interest to confirm his identity, or call authorities to provide additional contextual information unavailable to a camera and microphone, such as how long the person of interest has been at a location or how likely he is to remain. This may be helpful in missing person situations, as citizens may speak with the missing person to ensure their identity safely.

Further, in some embodiments, the alert may further include data representing at least one other individual within a vicinity of the person of interest represented in the plurality of images. The data may be an image, characteristic, data item such as a car license, or identity of the at least one other individual, and may help authorities solve missing persons cases or confirm an identity. The vicinity may be within the same captured image. For example, a captured image may reveal the presence of a missing person, as well as a captor. The captor's image may be sent with the alert along with the missing person's image.

Another aspect of the present disclosure relates to a system for locating a person of interest. The system may be used, for instance, to manage passive searching of a plurality of camera-based assistant systems in an area. The system may include at least one server, one or more communication interfaces associated with the at least one server; and one or more processors included in the at least one server.

The system may cooperate with camera-based assistant systems performing steps of process 5600. For example, the system may send to a plurality of camera-based assistant systems, via the one or mow communication interfaces, an indication of at least one characteristic or identifiable feature associated with a person of interest. For example, the system may be the one or more servers 5502, and the communication interfaces may be network 5504. In some embodiments, the at least one identifiable feature may be associated with one or more of a facial feature, a tattoo, a body shape; or a voice signature. Accordingly, the indication may be an image, a recognition indication, presence of facial hair, a body part comprising the tattoo, height, weight, facial or body proportions, and the like. Further, the system may receive, via the one or more communication interfaces, alerts from the plurality of camera-based assistant systems, such as via network 5504.

Alerts provided by camera-based assistant systems may include multiple pieces of information. First, an alert may include an indication of a positive detection of the person of interest, based on analysis of the indication of at least one identifiable feature associated with a person of interest provided by one or more sensors included onboard a particular camera-based assistant system, by methods and techniques previously disclosed. The indication may be a binary true/false indication, or a figure of merit representing the certainty of the match. The alert may also include a location associated with the particular camera-based assistant system. In some embodiments, the location may be determined by an onboard location determining device, such as a GPS module. The location may also be added after the alert is sent, such as by appending cell site location information to the alert message.

The system may also provide to one or more law enforcement agencies after receiving alerts from at least a predetermined number of camera-based assistant systems, via the one or more communication interfaces, an indication that the person of interest has been located. Thus, the system may refrain from contacting law enforcement until a certain number of alerts have been received. The indication may be sent automatically. In some embodiments, a human analyst may review the received alerts and confirm a likelihood of detection prior to the system sending the indication.

Despite waiting for a predetermined number of camera-based assistant systems alerts before contacting authorities, chances of false positive detections may remain high depending on, for example, camera quality or image matching and detection algorithm sophistication. When authorities are searching for a missing person, oftentimes resources of time and officers are lacking. Therefore, certain embodiments of the presently disclosed system may add additional capabilities to reduce chances of false positives and wasted resources.

For example, camera-based assistant systems may calculate a figure of merit or other indication of a certainty level of a match. Camera-based assistant systems themselves may be programmed to only send alerts when the certainty level exceeds a threshold, and may forego sending an alert in response to a certainty level of a positive detection being less than a threshold. The one or more processors of the system may also be further programmed to discard alerts received from the plurality of camera-based assistant systems that are associated with a certainty below a predetermined threshold. For example, the system may consider alerts associated with a high level of certainty when determining to provide a law enforcement indication, archive for future review alerts associated with a medium level of certainty, and discard alerts having a low level of certainty.

In some embodiments, the certainty threshold may be based on a population density of an area within which the plurality of camera-based assistance systems are located. For example, if a person of interest is likely to be within a crowded city, there may be many individuals having similar characteristics or identifiable features as the person of interest, resulting in a high rate of false positives alerts. Therefore, the system may require a high certainty for alerts within a crowded city. Alternatively, in a sparsely populated rural area, there may be fewer people having similar characteristics or identifiable features as the person of interest, resulting in a lower likelihood of false positives. The system may then require a lower certainty for alerts within a rural area. The certainty threshold may be relayed to the camera-based assistant systems along with the identifiable feature, or the system may screen alerts based on reported certainty levels. In some embodiments, the certainty threshold may also depend on the case. For example, in the first hours after a suspected kidnap, when time is of essence, the law enforcement agencies may ask for receiving any clue or identification, even with very low certainty, while in other cases a higher threshold may be set.

Another technique to reduce the rate of false positives may be to provide the indication that the person of interest has been located to one or more law enforcement agencies in response to the received alerts being associated with locations within a threshold distance of other alerts. For example, a plurality of camera-based assistant systems may be distributed across a city. If a first camera-based assistant system reports an alert a minute after another alert associated with a second camera-based assistant system thirty miles away, the alerts may have a higher likelihood of being false. However, if a third camera-based assistant system reports an alert five minutes later from a location only a half mile away from the first camera, there may be a higher likelihood of a true positive detect. In some embodiments, the threshold distance may be based on an elapsed time. For example, the threshold distance may be five hundred feet for the first minute after a first alert, a mile for live minutes, and two miles for ten minutes. If a predetermine number of alerts come from locations within the threshold distance of each other, the likelihood of a false positive may be reduced, and the system may provide the indication to law enforcement.

Persistent and passive monitoring by camera-based assistant systems may, however, discourage users who are concerned about maintaining privacy while also gaining other benefits of wearing camera-based assistant systems. Thus, camera-based assistant systems may provide users with opt-out ability. For example, the camera-based assistant systems may inform respective users of an incoming request from the system to begin searching for a person of interest. The information may include the reason for the search, such as a missing child, and the content of the search, such as an image or the identifiable feature, and danger of the person of interest. A user may then be presented with an ability to opt-out of providing alerts or searching even if the camera-based assistant system could make a high confidence detection of the person of interest.

A user may also be able to set default preferences. For example, the user may select to always search for a missing child, and never search for a fugitive. The user may further indicate regions where searching and/or alerting is not permitted, such as inside the user's home or office, or only where searching and/or alerting is permitted, such as in public transportation. A user's camera-based assistant systems may use internal location determination devices to determine if it is within a do-not-alert region, or may also recognize the presence of a geographically-constrained network, such as a home Wi-Fi signal.

It will be appreciated that although the disclosure related to a single person of interest, apparatus 110 may assist in searching for a plurality of persons. It will also be appreciated that once a missing person has been found, apparatus 110 may be notified, and searching for the relevant characteristics or identifiable features may be stopped.

Automatically Enforced Age Threshold

Wearable camera-based assistant systems present significant opportunities for improving interpersonal communications by aiding people and providing mechanisms to record and contextualize conversations. For example, camera-based assistant systems may provide facial recognition features which aid a wearer in identifying the person whom the wearer meets or recording a conversation with the person for later replay.

Although these methods may be useful for adults, local laws and societal expectations may specify that children remain anonymous. For example, some jurisdictions may outlaw unconsented identification and recording of minors. As a result, a jurisdiction may ban camera-based assistant systems due to public policy concerns. Further, a social stigma may arise around wearing a camera-based assistant system, discouraging those who may benefit from wearing a camera-based assistant systems from doing so in public.

These public policy concerns may be allayed by automated methods to prevent identification of individuals in an image if the individual is under a certain age threshold, such as excluding children from being identified. Thus, a camera-based assistant system may forego identification of an individual if certain characteristics, such as facial, body features, size, or body proportions, indicate that the individual is younger than a threshold age. In some embodiments, for example, the automated method may be active by default with no disabling mechanism. Alternatively, the automated method may be disabled by option or status, such as being within the house of a wearer where public policy may allow identification of young people.

Thus, as discussed above, wearable devices such as apparatus 110 may be programmed to forego identification of individuals if they appear to be younger than a certain age. The apparatus may comprise at least one camera included in a housing, such as image sensor 220. The at least one camera may be configured to capture a plurality of images representative of an environment of a wearer. In this way, apparatus 110 may be considered a camera-based assistant system. Additionally, the camera-based assistant system may also comprise a location sensor included in the housing, such as a GPS, inertial navigation system, cell signal triangulation, or IP address location system. Further still, as stated above, the camera-based assistant system may also comprise a communication interface, such as wireless transceiver 530, and at least one processor, such as processor 210.

Apparatus 110 may be configured to communicate with an external camera device, as well, such as a camera worn separately from apparatus 110, or an additional camera that may provide a different vantage point from a camera included in the housing. Such communication may be through a wired connection, or may be made wirelessly (e.g., using a Bluetooth™, NFC, or forms of wireless communication). As discussed above, apparatus 110 may be worn by user 100 in various configurations, including being physically connected to a shirt, necklace, a belt, glasses, a wrist strap, a button, or other articles associated with user 100. In some embodiments, one or more additional devices may also be included, such as computing device 120. Accordingly, one or more of the processes or functions described herein with respect to apparatus 110 or processor 210 may be performed by an external processor, or by at least one processor included in the housing.

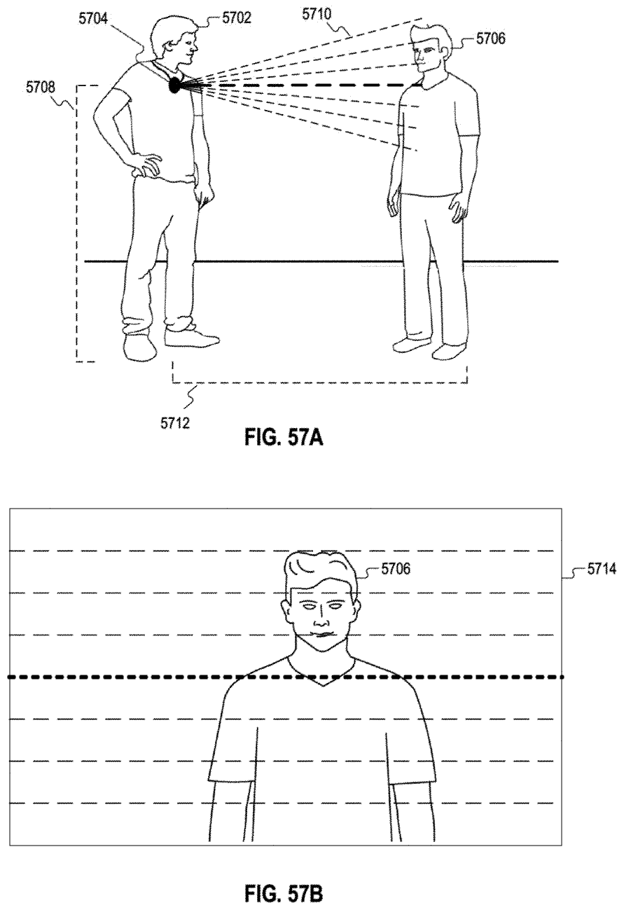

Processor 210 may be programmed to detect a characteristic of an individual in an image captured by the at least one camera. FIG. 57A is a schematic illustration of an example of a user wearing a wearable apparatus in an environment consistent with the present disclosure. In FIG. 57A, a wearer 5702 of a camera-based assistant system 5704 is facing a friend 5706. Camera-based assistant system 5704 may record a conversation between wearer 5702 and friend 5706, or may provide identification functionality to aid wearer 5702 in identifying friend 5706, for example if wearer 5702 has a disability. Camera-based assistant system may also provide wearer 5702 with contextualization of the conversation with friend 5706, such as reminders of past conversations, birthday, scheduled meetings, common friends, social networks, and the like.

Camera-based assistant system 5704 may be programmed to assess the age of friend 5706 prior to identifying him. For example, camera-based assistant system 5704 may estimate a height of an individual in a captured image and set an assessed age determined based on the estimated height. Camera-based assistant system 5704 may assess the individual's age prior to an identification routine.

In further detail, camera-based assistant system 5704 may store a height above ground 5708 at which camera-based assistant system 5704 is worn. Wearer 5704 may enter height 5708 via a user interface. Further, camera-based assistant system 5704 may use an altimeter or radar sensor to estimate its height above ground.

Additionally, camera-based assistant system 5704 may be disposed at any of a plurality of angles 5710 with respect to friend 5706. For example, a positive angle between camera-based assistant system 5704 and the top of the head of friend 5706, relative to a center line, may indicate that the camera-based assistant system 5704 is disposed below the friend's head, and thus that friend 5706 is taller than height 5708. Conversely, a negative angle between camera-based assistant system 5704 and the top of the head of friend 5706 may indicate that camera-based assistant system 5704 is disposed above the friend's head, and that friend is shorter than height 5708.

A distance 5712 to friend 5706 may vary the angle 5710 at which the friend appears in an image captured by camera-based assistant system 5704. For example, if friend 5706 is close, the angle may be large and positive, and if friend 5706 is far, the angle may be small, despite friend 5706 maintaining the same height. Thus, camera-based assistant system 5704 may estimate or measure distance 5712. For example, camera-based assistant system may use a radar or proximity sensor, such as one disposed in or on the housing of the camera-based assistant system, to make a distance measurement. In some embodiments, camera-based assistant system 5704 may estimate distance 5712 based on a focal length of a camera of camera-based assistant system 5704 and/or a size of the individual in a captured image relative to the total image size.

Additionally, camera-based assistant system 5704 may also correct for a look angle of wearer 5702. For example, if a user is looking upwards, the center line of angles 5170 may itself be at an angle compared to level, such as if wearer 5704 is looking upward or downward at friend 5706 on a hill. Thus, camera-based assistant system may measure the kook angle of wearer 5702, such as by a gyroscope or other angle measurement device disposed in the housing.

FIG. 57B is an example image captured by a camera of the wearable apparatus consistent with the present disclosure. Example image 5714 may be captured by camera-based assistant system 5704 from the scenario illustrated in FIG. 57A. For example, friend 5706 is shown in image 5714. Further, image 5714 is divided into sectors corresponding to angles 5710. Each sector may represent, for example, a five-degree sector, such that the top of the head of friend 5706 lies approximately 15 degrees above the center line of camera-based assistant system 5704. Thus, camera-based assistant system 5704 may identify an angle from the at least one camera to a top of a head of the at least one individual based on a representation of the at least one individual in one of the plurality of images.

Further, camera-based assistant system 5704 may determine, based on the identified angle, the estimated height of the at least one individual. For example, camera-based assistant system 5704 may multiply the tangent of the identified angle by distance 5712, and add the product to height 5708. Using the estimated height, camera-based assistant system may predict an age of the at least one individual. For example, camera-based assistant system 5704 may compare the estimated height to a growth chart or equation representing average height versus age for a relevant population. In some embodiments, camera-based assistant system 5704 may identify the sex of the individual, such as by hair length or clothing, and use a sex-specific growth chart, as women and men have different growth rates, thus allowing a more accurate age estimation. In further embodiments, instead of using growth charts, camera-based assistant system 5704 may compare the estimated height to a threshold level (which may depend on the sex of the individual). If the height is below the threshold, the individual may be assumed to be a child, and if the height is above the threshold, the individual may be assumed to be an adult.

In some embodiments, camera-based assistant system 5704 may additionally or alternatively estimate the height of the at least one individual by reference to objects near the individual. For example, camera-based assistant system 5704 may identify a height of an object represented in one of the plurality of images. The object may be an object that has a standard height, such as a stop sign, door frame, or vehicle. Camera-based assistant system 5704 may determine the existence of a standard object and retrieve a corresponding height. Camera-based assistant system 5704 may also determine if the at least one individual is at approximately the same distance from camera-based assistant system 5704 as the object, such as by determining if both the object and the individual can be in focus simultaneously. Camera-based assistant system 5704 may then determine, based on the identified height of the object, the estimated height of the at least one individual.

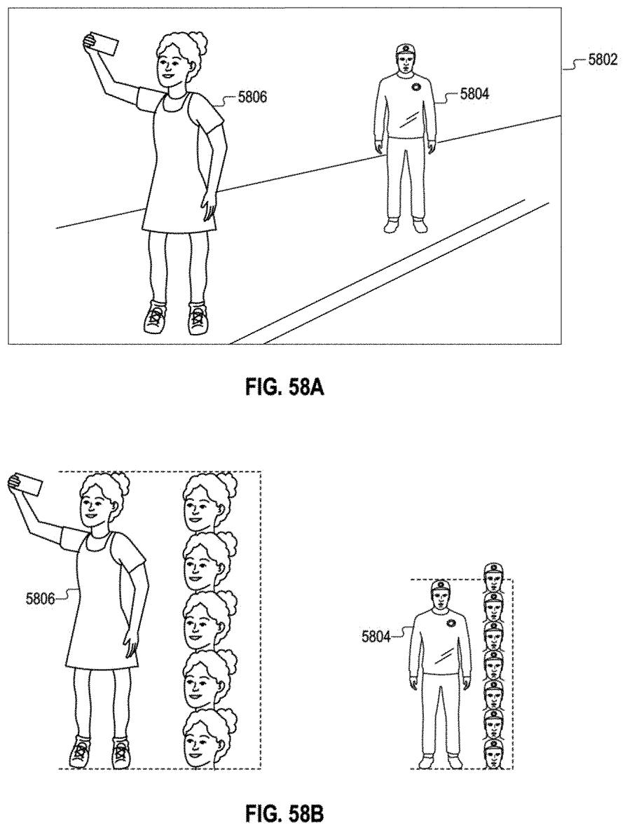

Other characteristics may also be used to estimate the age of an individual. FIG. 58A is an example image captured by a camera of the wearable apparatus consistent with the present disclosure. Image 5802 of FIG. 58A may be captured by a camera-based assistant system, for example. Image 5802 displays both a man 5804 and a girl 5806. Although man 5804 may be taller than girl 5806, girl 5806 fills a greater portion of image 5802 and appears longer than man 5804. This may occur, for example, if man 5804 is further from the camera-based assistant system than girl 5806.

Nonetheless, although man 5804 is further away and appears smaller than girl 5806, a camera-bused assistant system may be able to determine that the man is older than the girl by comparing head-to-body ratios. FIG. 58B is an example head-to-height ratio determination of individuals in an example image consistent with the present disclosure. In FIG. 58B, girl 5806 is illustrated adjacent to the head of girl 5806. Thus, the head-to-height ratio of girl 5806 as illustrated is approximately 1:5. In contrast, man 5804 illustrated in FIG. 58B has a head-to-height ratio of approximately 1:6.5. In general, adults have a lower head-to-height ratio than children, or, stated another way, children have larger heads proportional to their bodies. This trend may enable a camera-based assistant system to identify if a child is present in the image and forego identification of the child. Further, because an individual's head length is scaled proportional to his height in an image, the head-to-height ratio of an individual may remain constant despite the individual being further away and thus smaller in the image.

Accordingly, camera-based assistant systems according to the present disclosure may use a head-to-height comparison method to predict an age of an individual. The camera-based assistant system may determine a head size of at least one individual based on at least one of the plurality of images. The head size may be, for example, the head height measured in pixels of the image. Similarly, the camera-based assistant system may determine a body size of the at least one individual based on at least one of the plurality of images. The body size may also be a height measured in pixels. Further, the camera-based assistant system may determine a ratio of the determined head size to the determined body size; and predict the age based on the ratio. For example, the camera-based assistant system may compare the determined ratio to a threshold, chart, equation, or database showing a trend of head-to-height ratio versus age, and the camera-based assistant system may extract an age based on the ratio.

Camera-based assistant systems according to the present disclosure may use other methods to predict an age of an individual, as well. As an additional example, children often have larger eyes than adults, proportional to their head size. As a person ages, the ratio of eye size to head size may decrease in a measurable manner that may be used to predict the person's age. Thus, a camera-based assistant system may determine an eye measurement of the at least one individual based on at least one of the plurality of images, and determine a head measurement of the at least one individual based on at least one of the plurality of images. Pattern recognition techniques may be used to identify the boundaries of a person's eyes in an image, such as by determining a brightness gradient across a person's face and a color gradient between a person's face and a background of an image. Measurements may be, for example, in pixels of an image. Further, the camera-based assistant system may determine a ratio of the determined eye measurement to the determined head measurement and predict the age based on the ratio. For example, the ratio may be correlated to age in a database, chart, equation, and the like.

In some embodiments, a predicted age may have significant uncertainty. For example, head-to-height ratios of children under a threshold of 10 years old may be between 1:3 and 1:7, while adults may have head-to-height ratios between 1:5 and 1:8. Thus, although these ratios ae merely exemplary and not intended to be limiting, there may be overlap between ratios corresponding to children and ratios corresponding to adults, for both the head-to-height ratio and the eye size-to-head size ratio. Therefore, camera-based assistant systems according to the present disclosure may set a conservative threshold that falsely excludes some adults from identification in order to have greater likelihood of excluding all people below a certain age. Alternatively, camera-based assistant systems according to the present disclosure may have liberal thresholds to reduce the likelihood of falsely excluding adults while increasing the chance of identifying children. Further, in some embodiments, a camera-based assistant system may be programmed to exclude adults from identification rather or in addition to children.

Additional features of a person may be used to predict the person's age. For example, children typically do not have facial bar, tattoos, or jewelry. Thus, in some embodiments, a camera-based assistant system may determine whether a person has facial hair, tattoos, or jewelry, and set, as the predicted age, an age greater than the threshold in response to the at least one individual having at least one of facial hair, a tattoo, or jewelry. The age may be arbitrarily and sufficiently high so as to ensure that the predicted age exceeds the threshold. For example, if a threshold age is 15, a camera-based assistant system may predict that a person's age is 25 due to the presence of a tattoo. A camera-based assistant system may determine the presence of a tattoo or facial hair on a person by detecting a color or brightness gradient on the person's skin. Additionally, a camera-based assistant system may determine the presence of jewelry by detecting a high concentration of light in an area of an image.

As yet another example of an age prediction method, a camera-based assistant system may predict a person's age based on characteristics of the person's voice. For example, children's voices are typically higher in pitch than adults. Thus, in some embodiments, a camera-based assistant system may further comprise a microphone. The camera-based assistant system may record audio representing a voice of the at least one individual using the microphone. The camera-based assistant system may determine if a person is speaking by detecting movement of a person's mouth in a series of images, for example, synchronized to detected audio. The camera-based assistant system may also determine a pitch of the audio representing the voice, such as by performing a Fourier transform on an audio signal. Further, the camera-based assistant system may predict the age based on the pitch. For example, the camera-based assistant system may access a correlation between age and voice pitch to predict a person's age. This technique may be beneficial in that there is a low risk of mistaking a person as being older than his true age. For example, although some adults have a high pitch voice, few children have voices with sufficiently low pitches to be mistaken for an adult, in contrast with other disclosed methods such as height which may be complicated by unusually tall children.

Further still, in some embodiments, a camera-based assistant system may combine multiple age prediction techniques to increase accuracy. For example, a person's age may be approximated by a combined score representing his head-to-height ratio and voice pitch. Thus, although each technique may have substantial margins of error of a predicted age, by averaging or taking a weighted sum of multiple predictions, the camera-based assistant system may provide a composite predicted age with lower margins of error. Depending on the particular requirements, in some situations a captured individual may be considered an adult only if all relevant tests so indicate. In other situations, it may be sufficient that one test provides an indication that the individual is an adult for the individual to be considered an adult.

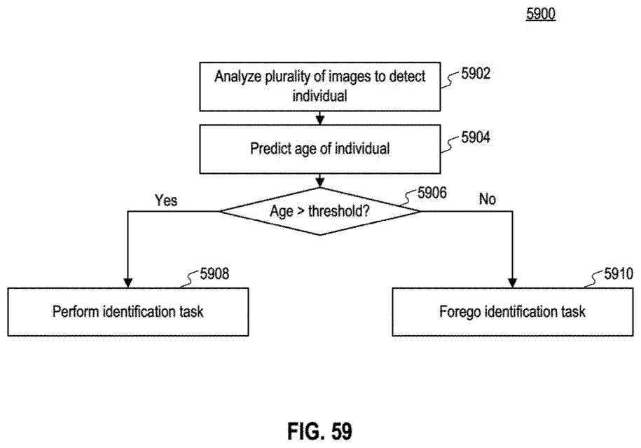

FIG. 59 is a flowchart showing an exemplary process for identifying faces using a wearable camera-based assistant system consistent with the present disclosure. Processor 210 may be programmed to perform the steps of process 5900 illustrated in FIG. 59, for example.

At step 5902, processor 210 of a camera-based assistant system may automatically analyze a plurality of images, captured by at least one camera of the camera-based assistant system, to detect a representation in at least one of the plurality of images of at least one individual in the environment of the wearer. Processor 210 may perform pattern recognition to identify shapes similar to human body shapes in an image. Processor 210 may also analyze a sequence of images to identify movement indicating the presence of an individual. Further, processor 210 may detect a plurality of individuals, and analyze each, some, or one of the detected individuals using process 2900.

At step 5904, processor 210 may predict an age of the at least one individual based on detection of one or more characteristics associated with at least one individual represented in the at least one of the plurality of images. For example, step 5904 may include any or a combination of the age prediction methods discussed previously. In some embodiments, the age prediction may also use analysis of an audio capturing speech by the individual, as described above.

At step 5906, processor 210 may compare the predicted age to a predetermined age threshold. The predetermined age threshold may be set by a manufacturer. It may be initialized by a signal setting the predetermined age threshold based on a locality's rules and laws. Further, the predetermined threshold may be set by a user via a user interface. The threshold may be, for example, 15 years old.

If the predicted age is greater than the threshold, step 5906 is YES, and processor 210 proceeds to perform at least one identification task associated with the at least one individual at step 5908. The identification task may include, for example, comparing a facial feature associated with the at least one individual to records in one or more databases to determine whether the at least one individual is one or more of: a recognized individual, a person of interest, or a missing person.

As stated above, the camera-based assistant system may also comprise a communication interface, such as wireless transceiver 530. Processor 210 may receive records via wireless transceiver 530 over a communication network, such as Wi-Fi, cellular, a telephone network, an extranet, an intranet, the Internet, satellite communications, off-line communications, or other wireless protocols. Processor 210 may compare the image of the at least one individual to records stored in a memory of apparatus 110. Further, step 5908 may include sending an image via the communication network to a separate processor for identification, so as to reduce power consumption by processor 210. For example, step 5908 may further include sending a message containing a result of the at least one identification task. The message may be sent, for example, to a user's account for record keeping of the conversation and identification task. In some embodiments, the message may be sent to other parties, such as law enforcement in the case of a missing person or fugitive.

Alternatively, if the predicted age is not greater than the predetermined threshold, step 5906 is NO, and processor 210 proceeds to step 5910 to forego the at least one identification task. Step 5910 may include methods to prevent re-checking the age of an underage individual previously seen. For example, if processor 210 advances to step 5910, processor 210 may introduce a time delay before returning to step 5902 to analyze additional images. The time delay may be adaptive, such that the time delay increases as a number of foregone identification tasks increases. For example, if a user is an uncle speaking with his underage niece, processor 210 may identify that the niece is underage and wait a minute before analyzing additional images. If the niece remains in the images after a minute, processor 210 may again advance to step 5910, but then wait additional five minutes before returning to step 5902. If the niece is still in the image at this point, step 5902 may wait an additional ten minutes, and so on, to avoid completing unnecessary age predictions and conserve battery power.

It is appreciated that estimating the age of a captured individual may be used for additional decisions beyond determining whether to forego identification of the individual. Such decisions may relate to storing a captured image or sound of the individual, or the like. The estimated age may also be used to enforce age restrictions, such as, for example, age restrictions for alcohol or tobacco purchases.

Personalized Mood Baseline

Mood is part of human beings' emotional rhythm. While some people can actively monitor their moods and manage them, other people may have difficulty understanding, predicting, and managing their moods, causing potential impacts in interpersonal communication or even deterioration in mental health. Therefore, there is a need to detect mxx changes, predict moods, and provide recommendations.

The disclosed wearable device may be configured to use voice data and image data captured for individuals to detect mood changes of the individuals. The wearable device may detect a representation of an individual in the plurality of images and identify the individual as the speaker by correlating at least one aspect of the audio signal with changes associated with the representation of the individual across the plurality of images. The wearable device may monitor indicators of body language associated with the speaker over a time period, and this monitoring may be based on analysis of the plurality of images and characteristics of the voice of the speaker over the time period and/or on analysis of the audio signal. Based on a combination of the monitored indicators of body language and the characteristics of the voice of the speaker, the wearable device may determine a plurality of mood index values associated with the speaker and store the plurality of mood index values in a database. The wearable device may further determine a baseline mood index value for the speaker based on the plurality of mood index values and provide to a user of the wearable device at least one of an audible or visible indication of a characteristic of a mood of the speaker, so that the user can understand and manage the mood. If the speaker is other than the user, the user may better understand the speaker and know how to handle him or her. Additionally or alternatively, the user may provide the results to the speaker so that the speaker may understand and manage the mood, too.

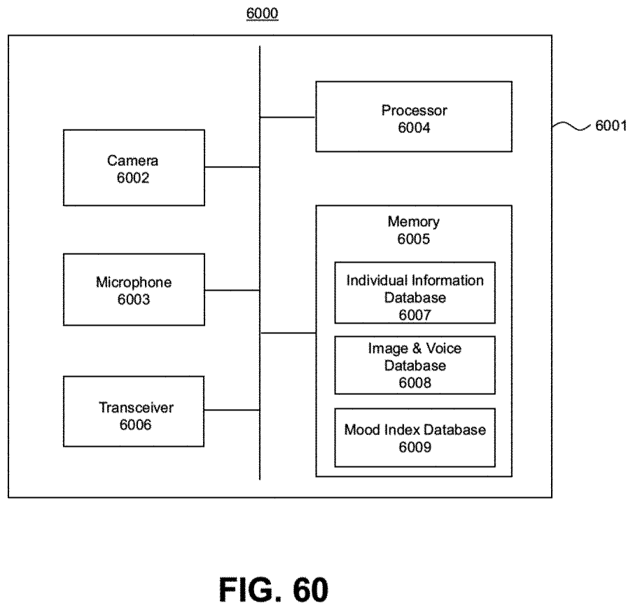

FIG. 60 is a schematic illustration of an exemplary wearable device consistent with the disclosed embodiments. Wearable device 6000 is shown in FIG. 60 in a simplified form, and wearable device 6000 may include additional elements or may have alternative configurations, for example, as shown in FIGS. 5A-5C. As shown, wearable device 60000 includes a housing 6001, at least one camera 6002, at least one microphone 6003, at least one processor 6004, a memory 6005, and a transceiver 6006. Wearable device 6000 may also include other elements, such as a display and a speaker, etc.

Camera 6002 may be associated with housing 6001 and configured to capture a plurality of images from an environment of a user of wearable device 6000. For example, camera 6002 may be image sensor 220, as described above. In some embodiments, camera 6002 may include plurality of cameras, which may each correspond to image sensor 220. In some embodiments, camera 6002 may be included in housing 6001.

Microphone 6003 may be associated with the housing 6001 and configured to capture an audio signal of a voice of a speaker. For example, microphone 6003 may be microphones 443 or 444, as described above. Microphone 6003 may include a plurality of microphones. Microphone 6003 may include a directional microphone, a microphone array, a multi-port microphone, or various other types of microphones. In some embodiments, microphone 6003 may be included in housing 6001.

Transceiver 6006 may transmit image data and/or audio signals to another device. Transceiver 6006 may also receive image data and/or audio signals from another device. Transceiver 6006 may also transmit an audio signal to a device that plays sound to the user of wearable device 6000, such as a speakerphone, a hearing aid, or the like. Transceiver 6006 may include one or mom wireless transceivers. The one or more wireless transceivers may be any devices configured to exchange transmissions over an air interface by use of radio frequency, infrared frequency, magnetic field, or electric field. The one or more wireless transceivers may use any known standard to transmit and/or receive data (e.g., Wi-Fi, Bluetooth), Bluetooth Smart, 802.15.4, or ZigBee). In some embodiments, transceiver 6006 may transmit data (e.g., raw image data, processed image and/or audio data, extracted information) from wearable device 6000 to server 250. Transceiver 6006 may also receive data from server 250. In some embodiments, transceiver 6006 may transmit data and instructions to an external feedback outputting unit 230.

Memory 6005 may include an individual information database 6007, an image and voice database 6008, and a mood index, database 6009. Image and voice database 6008 may include one or more images and voice data of one or more individuals, or example, image and voice database 6008 may include a plurality of images captured by camera 6002 from an environment of the user of wearable device 6000. Image and voice database 6008 may also include an audio signal of the voice of the speaker captured by microphone 6003. Image and voice database 6008 may also include data extracted from the plurality of images or audio signal, such as extracted features of one or more individuals, voiceprints of one or more individuals, or the like. Images and voice stored within the database may be synchronized. Individual information database 6007 may include information associating the one or more images and/or voice data stored in image and voice database 6008 with the one or more individuals. Individual information database 6007 may also include information indicating whether the one or more individuals are known to user 100. For example, individual information database 6007 may include a mapping table indicating a relationship of individuals to the user of wearable device 6000. Mood index database 6009 includes plurality of mood index values associated with the speaker. The plurality of mood index values may be determined by at least one processor 6004. The plurality of mood index values may be used for determining a baseline mood index value for the speaker. Optionally, memory 6005 may also include other components, for example, orientation identification module 601, orientation adjustment module 602, and monitoring module 603 as shown in FIG. 6. Individual information database 6007, image and voice database 6008, and mood index database 6009 are shown within memory 6005 by way of example only, and may be located in other locations. For example, the databases may be located on a remote server, a cloud server, or in another associated device.

Processor 6004 may include one or more processing units. In some embodiments, processor 604 may be programmed to receive a plurality of images captured by camera 6002. Processor 600M may also be programmed to receive a plurality of audio signals representative of sounds captured by microphone 6003. In an embodiment, processor 6004 may be included in the same housing as microphone 6003 and camera 6002. In another embodiment, microphone 6003 and camera 6002 may be included in a first housing, and processor 6004 may be included in a second housing. In such an embodiment, processor 6004 may be configured to receive the plurality of images and/or audio signals from the first housing via a wireless link (e.g., Bluetooth™, NFC, etc.). Accordingly, the first housing and the second housing may further comprise transmitters or various other communication components. Processor 6004 may be programmed to detect a representation of an individual in the plurality of images and may be programmed to identify the individual as the speaker by correlating at least one aspect of the audio signal with one or more changes associated with the representation of the individual across the plurality of images. For example, processor 6004 may be programmed to identify the individual as the speaker by correlating the audio signal with movements of lips of the speaker detected through analysis of the plurality of images.

Processor 6004 may be programmed to monitor one or more indicators of body language associated with the speaker over a time period, and the monitoring may be based on analysis of the plurality of images. The one or more indicators of body language associated with the speaker may include but is not limited to one or more of: (i) a facial expression of the speaker, (ii) a posture of the speaker, (iii) a movement of the speaker, (iv) an activity of the speaker, (v) a temperature image of the speaker; or (vi) a gesture of the speaker. In one embodiment, the time period may be continuous. In another embodiment, a time period may include a plurality of non-contiguous time intervals.

Processor 6004 may be programmed to monitor one or more characteristics of the voice of the speaker over a time period, and the monitoring may be based on analysis of the audio signal. For example, the one or more characteristics of the voice of the speaker may include but is not limited to one or more of: (i) a pitch of the voice of the speaker, (ii) a tone of the voice of the speaker, (iii) a rate of speech of the voice of the speaker, (iv) a volume of the voice of the speaker, (v) a center frequency of the voice of the speaker, (vi) a frequency distribution of the voice of the speaker, or (vii) a responsiveness of the voice of the speaker. The captured speech and images may also be monitored for laughing, crying, or any other sounds by the speaker. In some embodiments, the speaker is the user of wearable device 6000, while in other embodiments the speaker is an individual the user is speaking too. In further embodiments, multiple individuals, whether including the user or not, may be monitored.

Processor 6004 may be programmed to determine, over the time period and based on a combination of the one or more monitored indicators of body language and the one or more characteristics of the voice of the speaker, a plurality of mood index values associated with the speaker. For example, processor 6004 may be programmed to determine the plurality of mood index values associated with the speaker using a trained neural network. The mood index may include various codes or other identifiers for different emotional states generally (e.g., happy, excited, sad, angry, stressed, etc.). Codes may include numbers, letters, or any suitable indicator for storing information. Processor 6004 may be programmed to store the plurality of mood index values in a database. For example, the plurality of mood index values may be stored in mood index database 6009 of wearable device 6000.

Processor 6004 may be programmed to determine a baseline mood index value for the speaker based on the plurality of mood index values stored in the database. The baseline mood index can be represented in various ways. For example, the baseline mood index may include numerical ranges of values to represent a spectrum or degree associated with a particular emotional state (e.g., happy, enthusiastic, energic, reserved, tired, sad and a degree of how any of the above). Processor 6004 may be further programmed to determine at least one deviation from the baseline mood index value over time.

Processor 6004 may be programmed to provide to the user at least one of an audible or visible indication of at least one characteristic of a mood of the speaker. The at least one characteristic of the mood of the speaker may include a representation of the mood of the speaker at a particular time during the time period. In some embodiments, the at least one characteristic of the mood of the speaker may include a representation of the baseline mood index value of the speaker, in some embodiments, the at least one characteristic of the mood of the speaker may include a representation of a mood spectrum for the speaker determined based on the plurality of mood index values stored in the database. In some embodiments, providing to the user at least one of an audible or visible indication of at least one characteristic of the mood of the speaker may include causing the visible indication to be shown on a display, such as display 260 as described above. The display may be included in housing 6001 of wearable device 6000. Alternatively, the display and/or processor 6004 may be included in a secondary device that is wired or wirelessly connected to wearable device 6000. The secondary device may include a mobile device or headphones configured to be worn by the user. In some embodiments, providing to the user at least one of an audible or visible indication of at least one characteristic of the mood of the speaker may include causing sounds representative of the audible indication to be produced from the speaker. The speaker may be included in housing 6001 of wearable device 6000. Alternatively, the speaker may be associated with a secondary device that is wirelessly connected to wearable device 6000. The secondary device may include a mobile device, headphones configured to be worn by the user, a hearing aid, or the like.

In some embodiments, processor 604 may be further programmed to monitor, over the time period and based on analysis of the plurality of images, an activity characteristic associated with the speaker. For example, the activity characteristic may include at least one of: (i) consuming a specific food or drink, (ii) meeting with a specific person, (iii) taking part in a specific activity, or (iv) a presence in a specific location. Processor 6004 may be further programmed to determine a level of correlation between one or more of the mood index values and the monitored activity characteristic. Processor 6004 may be further programmed to store in the database information indicative of the determined level of correlation; and provide to the user, as part of the audible or visible indication of the at least one characteristic of the mood of the speaker, the information indicative of the determined level of correlation. Processor 6004 may be further programmed to generate a recommendation for a behavioral change of the speaker based on the determined level of correlation between the one or more of the mood index values and the monitored activity characteristic; and provide to the user, as part of the audible or visible indication of the at least one characteristic of the mood of the speaker, the generated recommendation.

In some embodiments, processor 6004 may be further programmed to determine at least one mood change pattern for the speaker based on the plurality of mood index values stored in the database. The at least one mood change pattern may correlate the speaker's mood with at least one periodic time interval. The at least one mood change pattern may correlate the speaker's mood with at least one type of activity. For example, the at least one type of activity may include: a meeting between the speaker and the user, a meeting between the speaker and at least one individual other than the user, a detected location in which the speaker is located, or a detected activity in which the speaker is engaged. Processor 6004 may be further programmed to, during a subsequent encounter with the speaker, generate a mood prediction for the speaker based on the determined at least one mood change pattern; and provide to the user a visual or audio representation of the generated mood prediction.

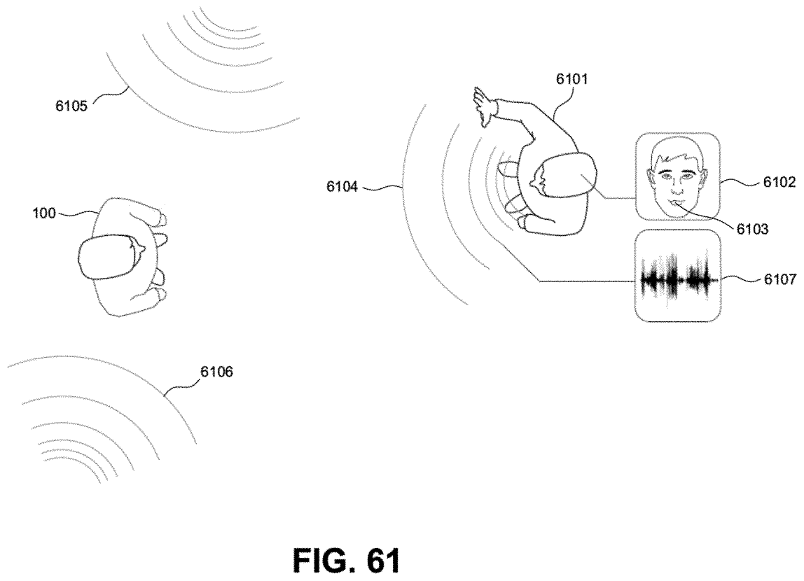

FIG. 61 is a schematic illustration showing an exemplary environment of a user of a wearable device consistent with the disclosed embodiments. Wearable device 6000, worn by user 100 may be configured to capture a plurality of sounds 6104, 6105, and 6106, and identify one or more individuals within the environment of the user. Sound 6104 may be associated with the voice of individual 6101, and sounds 6105 and 6106 may be associated with additional voices or background noise in the environment of user 100. Wearable device 6000 may also be configured to capture a plurality of images from the environment of user 100. The captured images and audio signals of the voices may be stored in image and voice database 6008 of memory 6005. Wearable device 6000 may then detect a representation of an individual in the plurality of images, for example, individual 6101, and identify the individual as the speaker, for example by correlating at least one aspect of audio signal 6107 of the voice of individual 6101 with one or more changes associated with the representation of individual 6101 across the plurality of images. For example, as shown in FIG. 61, wearable device 6000 may identify individual 6101 as the speaker by detecting one or more movements of lips 6103 of individual 6101, and correlating audio signal 6107 of the voice of individual 6101 with the movements of the lips 6103. Wearable device 6000 may further determine the relationship of individual 6101 with user 100 using the individual information stored in individual information database 6007. In some embodiments, individual 6101 may be a family member, friend, colleague, relative, or prior acquaintance of user 100. In some embodiments, individual 6101 may be unknown to user 100.

Based on analysis of the plurality of captured images, wearable device 6000 may monitor one or more indicators of body language associated with the speaker over a time period. For example, the one or more indicators of body language associated with the speaker may include at least one of: (i) a facial expression of the speaker, (ii) a posture of the speaker. (iii) a movement of the speaker, (iv) an activity of the speaker, (v) an image temperature of the speaker; or (vi) a gesture of the speaker. Based on analysis of the audio signal, wearable device 600) may monitor one or more characteristics of the voice of the speaker over the time period. For example, the one or more characteristics of the voice of the speaker may include at least one of: (i) a pitch of the voice of the speaker, (ii) a tone of the voice of the speaker, (iii) a rate of speech of the voice of the speaker, (iv) a volume of the voice of the speaker, (v) a center frequency of the voice of the speaker, (vi) a frequency distribution of the voice of the speaker, or (vii) a responsiveness of the voice of the speaker.

Wearable device 6000 may determine, over the time period and based on a combination of the one or more monitored indicators of body language and the one or more characteristics of the voice of the speaker, a plurality of mood index values associated with the speaker and store the plurality of mood index values in mood index database 6009 of memory 6005. Wearable device 6000 may determine a baseline mood index value for the speaker based on the plurality of mood index values stored in the database, and provide to the user at least one of an audible or visible indication of at least one characteristic of a mood of the speaker. The mood of the individual and the mood baseline can be represented in various ways. For example, this may include numerical ranges of values to represent a spectrum or degree associated with a particular emotional state (e.g., happy, enthusiastic, energic, reserved, tired, sad and a degree of how happy, enthusiastic, energic, reserved, tired, sad). A mood index may also include various codes or other identifiers for different emotional states generally (e.g., happy, excited, sad, angry, stressed, etc.). Codes or identifiers may include numbers, letters, or any suitable indicator for storing information. In some embodiments, wearable device 6000 may use the captured image data and voice data to identify periodic (e.g., monthly or in proximity to a regular event) mood swings of a particular individual captured by camera 6002; predict that the individual is likely to be in a certain mood (sad, angry, stressed, etc.); and provide a notification (e.g., warning) upon encountering the individual. FIG. 61 shows an exemplary embodiment in which wearable device 6000 is worn by user 100. In another embodiment, device 6000 may be mounted at various locations separate from the user (e.g., on a tabletop, on a monitor, etc.) using various clips or fasteners, as described above. In this embodiment, user 100 may be the individual for which the mood changes are determined.

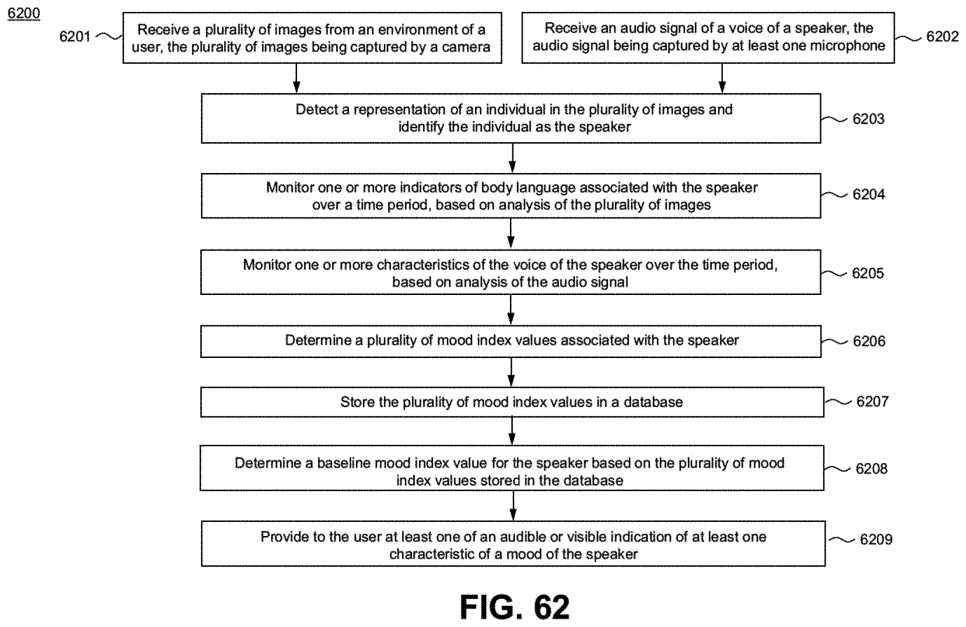

FIG. 62 is a schematic illustration showing a flowchart of an exemplary method for detecting mood changes of an individual consistent with the disclosed embodiments. Processor 6004 may perform process 6200 to detect mood changes of an individual after microphone 6003 captures an audio signal of a voice of individual 6101 and camera 6002 captures images of individual 6101. In some embodiments, device 6000 may also capture the voice of user 100 and may capture images, for example from a low position, of the face of user 100, and may use this information for assessing baseline mood index and mood changes of user 100.

Method 6200 may include a step 6201 of receiving a plurality of images from an environment of a user, the plurality of images being captured by a camera. For example, at step 6201, processor 6004 may receive the plurality of images captured by camera 6002. In some embodiments, the plurality of images may include facial images 6102 of individual 6101. The plurality of images may also include a posture or gesture of individual 6101. The plurality of images may also include video frames that show a movement or activity of individual 6101.

Method 6200 may include a step 6202 of receiving an audio signal of a voice of a speaker, the audio signal being captured by at least one microphone. For example, at step 6202, microphone 6003 may capture a plurality of sounds 6104, 6105, and 6106, and processor 6004 may receive a plurality of audio signals representative of the plurality of sounds 6104, 6105, and 6106. Audio signal 6107 is associated with the voice of individual 6101, and 6105 and 6106 may be additional voices or background noise in the environment of user 100. In some embodiments, sounds 6105 and 6106 may include speech or non-speech sounds by one or more persons other than individual 6101, environmental sound (e.g., music, tones, or environmental noise), or the like.

Method 6200 may include a step 6203 of detecting a representation of an individual in the plurality of images and identifying the individual as the speaker by correlating at least one aspect of the audio signal with one or more changes associated with the representation of the individual across the plurality of images. For example, at step 6203, process 6004 may detect movements of lips 6103 of individual 6101, based on analysis of the plurality of images. Processor 6004 may identify one or more points associated with the mouth of individual 6101. In some embodiments, processor 6004 may develop a contour associated with the mouth of individual 6101, which may define a boundary associated with the mouth or lips of the individual. The lips 6103 identified in the image may be tracked over multiple frames or images to identify the movements of the lips. Processor 6004 may further identify individual 6101 as the speaker by correlating audio signal 6107 with movements of lips 6103 of individual 6101 detected through analysis of the plurality of images.

Method 6200 may include a step 6204 of monitoring one or more indicators of body language associated with the speaker over a time period, based on analysis of the plurality of images. For example, at step 6204, processor 6004 may monitor at least one of: (i) a facial expression of the speaker, (ii) a posture of the speaker, (iii) a movement of the speaker, (iv) an activity of the speaker, (v) an image temperature of the speaker; or (vi) a gesture of the speaker. The time period may be continuous or may include a plurality of non-contiguous time intervals.

Method 6200 may include a step 6205 of monitoring one or more characteristics of the voice of the speaker over the time period, based on analysis of the audio signal. For example, at step 6205, processor 6004 may monitor at least one of: (i) a pitch of the voice of the speaker, (ii) a tone of the voice of the speaker, (iii) a rate of speech of the voice of the speaker, (iv) a volume of the voice of the speaker, (v) a center frequency of the voice of the speaker, (vi) a frequency distribution of the voice of the speaker, or (vii) a responsiveness of the voice of the speaker.

Method 6200 may include a step 6206 of determining, over the time period and based on a combination of the one or more monitored indicators of body language and the one or more characteristics of the voice of the speaker, a plurality of mood index values associated with the speaker. For example, at step 6206, processor 6004 may determine the plurality of mood index values associated with the speaker using a trained neural network. The mood index may include various codes or other identifiers for different emotional states generally (e.g., happy, excited, sad, angry, stressed, etc.). The codes may include numbers, letters, or any suitable indicator for storing information.

Method 6200 may include a step 6207 of storing the plurality of mood index values in a database. For example, at step 6207, processor 6004 may store the plurality of mood index values in mood index database 6009 of memory 6005 of wearable device 6000 for further processing or future use.

Method 6200 may include a step 6208 of determining a baseline mood index value for the speaker based on the plurality of mood index values stored in the database. For example, at step 6208, processor 6004 may determine a baseline mood index value for the speaker based on the plurality of mood index values stored in the database. The baseline mood index can be represented in various ways. For example, this may include numerical ranges of values to represent a spectrum or degree associated with a particular emotional state (e.g., happy and a degree of how happy). Processor 6004 may further determine at least one deviation from the baseline mood index value over time.

Method 6200 may include a step 6209 of providing to the user at least one of an audible or visible indication of at least one characteristic of a mood of the speaker. The at least one characteristic of the mood of the speaker may include a representation of the baseline mood index value of the speaker or a representation of a mood spectrum for the speaker determined based on the plurality of mood index values stored in the database. Providing to the user at least one of an audible or visible indication of at least one characteristic of the mood of the speaker may include causing the visible indication to be shown on a display or causing sounds representative of the audible indication to be produced from a speaker.

The at least one characteristic of a mood of the speaker may be provided to the user together with the baseline mood index value, such that the user can see whether the current values are exceptional for the speaker, or within the speaker's baseline mood. In some embodiments, color or another coding may be used for indicating the degree of deviation from the baseline mood.

In some embodiments, after step 6209, method 6200 may include determining a new mood index value for the speaker based on analysis of at least one new image captured by the at least one camera or at least one new audio signal captured by the at least one microphone. For example, the at least one new image or the at least one new audio signal may be captured at later time, such as after a predetermined time period (e.g., an hour, day, week, month, etc.). Method 6200 may further include determining a new baseline mood index value for the speaker based on the plurality of mood index values stored in the database and the new mood index value, and comparing the new mood index value to the baseline mood index value. Method 6200 may further provide to the user at least one of an audible or visible indication based on the comparison. For example, the audio or visible indication may express a degree of change of the speaker's mood from the baseline (e.g., the speaker is 10% happier).

In some embodiments, memory 6005 may include a non-transitory computer readable storage medium storing program instructions which are executed by processor 6004 to perform the method 6200 as described above.

Life Balance and Health Analytics

An individual's everyday activities are good indicators of physical and psychological wellness of the individual. While some people can actively track their own activities to improve their life balance, other people may have difficulty tracking, understanding, and managing their wellness. For example, some people may have difficulty tracking their screen time and may not be aware that they engage in excessive screen time each day. This may cause physical or mental imbalance or even failure. Therefore, there is a need to track individual's activities, analyze the activities, and provide wellness recommendations.

The disclosed wearable device in an activity tracking system may be configured to capture a plurality of images of individuals or devices that a user of the wearable device interacted with. The wearable device may analyze the plurality of images to detect one or more activities from a predetermined set of activities in which the user is engaged. The wearable device may monitor an amount of time during which the user engages in the detected one or more activities. The wearable device may further provide to the user at least one of audible or visible feedback regarding at least one characteristic or detail associated with the detected one or more activities. For example, the wearable device may provide to the user an amount of time the user has spent with the individuals or devices. The wearable device may further provide to the user a recommendation for modifying one or more activities associated.

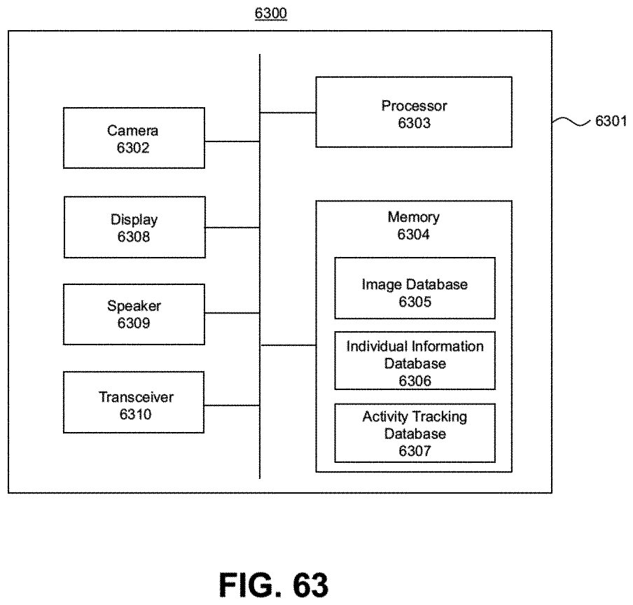

FIG. 63 is a schematic illustration of an exemplary wearable device in an activity tracking system consistent with the disclosed embodiments. Wearable device 6300 is shown in FIG. 63 in a simplified form, and wearable device 6300 may include additional elements or may have alternative configurations, for example, as shown in FIGS. 5A-5C. As shown, wearable device 6300 includes a housing 6301, at least one camera 6302, at least one processor 6303, a memory 6304, a display 6308, a speaker 6309, and a transceiver 6310.

Camera 6302 may be associated with housing 6301 and configured to capture a plurality of images from an environment of a user of wearable device 6300. For example, camera 6302 may be image sensor 220, as described above. Camera 6302 may have an image capture rate, which may be configurable by the user or based on predetermined settings. In some embodiments, camera 6302 may include plurality of cameras, which may each correspond to image sensor 220. In some embodiments, camera 6302 may be included in housing 6001.

Display 6308 may be any display device suitable for visually displaying information to the user. For example, display 6308 may be display 260, as described above. In some embodiments, display 6308 may be included in housing 6301.

Speaker 6309 may be any speaker or array of speakers suitable for providing audible information to the user. In some embodiments, speaker 6309 may be included in housing 6301. In some embodiments, speaker 6309 may be included in a secondary device different from wearable device 6300. The secondary device may be a hearing aid of any type, a mobile device, headphones configured to be worn by the user, or any other device configured to output audio.

Transceiver 6310 may transmit image data and/or audio signals to another device. Transceiver 6310 may also receive image data and/or audio signals from another device. Transceiver 6310 may also provide sound to an ear of the user of wearable device 6300. Transceiver 6310 may include one or more wireless transceivers. The one or more wireless transceivers may be any devices configured to exchange transmissions over an air interface by use of radio frequency, infrared frequency, magnetic field, or electric field. The one or more wireless transceivers may use any known standard to transmit and/or receive data (e.g., Wi-Fi, Bluetooth®, Bluetooth Smart, 802.15.4, or ZigBee). In some embodiments, transceiver 6310 may transmit data (e.g., raw image data, processed image and/or audio data, extracted information) from wearable device 6300 to server 250. Transceiver 6310 may also receive data from server 250. In some embodiments, transceiver 6310 may transmit data and instructions to an external feedback outputting unit 230.

Memory 6304 may include an image database 6305, an individual information database 6306, and an activity tracking database 6307. Image database 6305 may include one or more images of one or more individuals. For example, image database 6305 may include the plurality of images from the environment of the user of wearable device 6300 captured by camera 6302. Individual information database 6306 may include information associating the one or more images stored in image database 6305 with the one or more individuals. Individual information database 6306 may also include information indicating whether the one or more individuals are known to the user. For example, individual information database 6306 may include a mapping (e.g., a mapping table) indicating a relationship of individuals to the user of wearable device 6300. Activity tracking database 6307 may include information associated with a plurality of activities detected for the user and corresponding feedback to be provided to the user. The plurality of activities may be detected based on the plurality of images stored in image database 6305. The plurality of activities and the time spent on the activities may be used for determining the feedback by processor 6303. Image database 6305, individual information database 6306, and activity tracking database 6307 are shown within memory 6304 by way of example only, and may be located in other locations. For example, the databases may be located on a remote server, or in another associated device.

Processor 6303 may include one or more processing units. Processor 6303 may be programmed to receive a plurality of images captured by camera 6302. In an embodiment, processor 6303 may be included in the same housing as camera 6302. In another embodiment, camera 6302 may be included in a first housing, and processor 6303 may be included in a second housing. In such an embodiment, processor 6303 may be configured to receive the plurality of images from the first housing via a wired or wireless link (e.g., Bluetooth™, NFC, etc.). Accordingly, the first housing and the second housing may further comprise transmitters or various other communication components. In some embodiments, processor 6303 may be included in a secondary device wirelessly connected to wearable device 6300. The secondary device may include a mobile device. Processor 6303 may be programmed to detect a representation of individuals or item, or devices in the plurality of images.

Processor 6303 may be programmed to programmed at least one of the plurality of images to detect one or more activities in which the user of the activity tracking system is engaged. In some embodiments, the one or more activities may be detected from a predetermined set of activities. For example, the predetermined set of activities may include but are not limited to one or more of: eating a meal, consuming a particular type of food or drink, working, interacting with a computer device including a visual interface, talking on a phone, engaging in a leisure activity, speaking with one or more individuals, engaging in a sport, shopping, driving, or reading.

Processor 6303 may be programmed to monitor an amount of time during which the user engages in the detected one or more activities. In some embodiments, the amount of time may be contiguous. In some embodiments, the amount of time may include a plurality of non-contiguous time intervals summed together. The amount of time may be an amount of time the user has spent with the one or more recognized individuals or unrecognized individuals. The amount of time may be an amount of time the user has spent interacting with the plurality of different devices.

Processor 6303 may be programmed to categorize a user's interactions by creating a tag for one or more categories of activities, for example, meetings, computer work, meals, movies, hobbies, etc. In some embodiments, processor 6303 may keep track of the amount of time the user dedicates to each category and provide life balance analytics. Processor 6303 may further monitor and provide indication of other health analytics. In some embodiments this may include social analytics. For example, processor 6303 may generate a graphical interface that shows interaction analytics, such as percentage of interactions involving previously unknown people/known people, timing of interactions, location of interactions, etc. The location of the interactions may be obtained from a global positioning system, Wi-Fi, or the like. The location may also refer to a type of location, such as office, home, bedroom, beach, or the like. Processor 6303 may identify how much total time the user spends in front of multiple screens (e.g., a computer, phone, or TV) and provide a notice when total time is above a predetermined threshold. Processor 6303 may compare the screen time to an activity time (e.g., such as a comparison of TV time to time spent engaged in another activity, such as eating, cooking, playing sports, etc.).

Processor 6303 may be programmed to provide to the user at least one of audible or visible feedback regarding at least one characteristic associated with the detected one or more activities. For example, processor 6303 may be programmed to cause sounds representative of the audible feedback to be produced from speaker 6309. In some embodiments, providing to the user at least one of audible or visible feedback includes causing the visible feedback to be shown on display 6308. In some embodiments, the at least one of audible or visible feedback may indicate to the user at least one of: a total amount of time or a percentage of time within a predetermined time interval during which the user engaged in the detected one or more activities; an indication of the detection of the one or more activities in which the user engaged; or one or more characteristics associated with the detected one or more activities in which the user engaged. The one or more characteristics may include a type of food consumed by the user. In some embodiments, the at least one of audible or visible feedback may include a suggestion for one or more behavior modifications. In some embodiments, the suggestion for one or more behavior modifications may be based on user-defined goals. In some embodiments, the suggestion for one or more behavior modifications may be based on official recommendations. In some embodiments, the detection of the one or more activities is based on output from a trained neural network.

In some embodiments, the detected one or more activities may include detection of an interaction between the user and one or more recognized individuals, and the at least one of audible or visible feedback may indicate to the user an amount of time the user has spent with the one or more recognized individuals. In some embodiments, the detected one or more activities may include detection of an interaction between the user and one or more unrecognized individuals, and the at least one of audible or visible feedback may indicate to the user an amount of time the user has spent with the one or more unrecognized individuals. In these embodiments, processor 6303 may determine an individual as a recognized or unrecognized based on the data (e.g., the mapping table) stored in individual information database 6306.

In some embodiments, the detected one or more activities may include detection of user interactions with one or more of a plurality of different devices, each including a display screen, and the at least one of audible or visible feedback may indicate to the user an amount of time the user has spent interacting with the plurality of different devices. The one or more of a plurality of different devices may include one or more of: a television, a laptop, a mobile device, a tablet, a computer workstation, or a personal computer.

In some embodiments, the detected one or more activities may include detection of user interactions with one or more computer devices or specific applications therein, such as gaming applications, and the at least one of audible or visible feedback may indicate to the user a level of attentiveness associated with the user during interactions with the one or more computer devices or applications. The level of attentiveness may be determined based on one or more acquired images that show at least a portion of the user's face. In some embodiments, the one or more acquired images may be provided by camera 6302 or another image acquisition device included in housing 6301. In some embodiments, the one or more acquired images may be provided by a camera associated with the one or more computer devices. The level of attentiveness may be determined based on a detected rate of user input to the one or more computing devices.

In some embodiments, the detected one or more activities may include detection of user interactions with one or more items associated with potentially negative effects, and the at least one of audible or visible feedback may indicate to the user a suggestion for modifying one or more activities associated with the one or more items. For example, the one or more items associated with potentially negative effects may include at least one of: cigars, cigarettes, smoking paraphernalia, fast food, processed food, playing cards, casino games, alcoholic beverages, playing computer games, or bodily actions. The one or more items associated with potentially negative health effects may be defined by the user.

In some embodiments, the detected one or more activities may include detection of a presence in the user of one or more cold or allergy symptoms. For example, detection of the presence in the user of one or more cold or allergy symptoms may be based on analysis of one or more acquired images showing at least one of: user interaction with a tissue, user interaction with recognized cold or allergy medication, watery eyes, nose wiping, coughing, or sneezing. The at least one of audible or visible feedback may indicate to the user an amount of time the user has exhibited cold or allergy symptoms, in these embodiments, the at least one of audible or visible feedback may indicate to the user a detected periodicity associated with user-exhibited cold or allergy symptoms. The at least one of audible or visible feedback may also provide to the user an indication of an approaching allergy season during which allergy symptoms were detected in the user in the past.

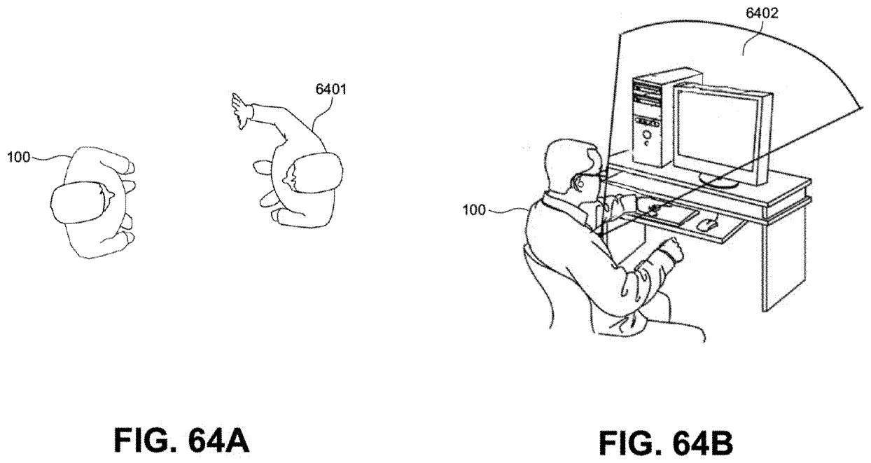

FIG. 64A is a schematic illustration showing an exemplary environment of a user of an activity tracking system consistent with the disclosed embodiments. Wearable device 6300, worn by user 100 may be configured to capture a plurality of images from the environment of user 100. The captured images may be stored in image database 6305 of memory 6304. Wearable device 6300 may then detect a representation of an individual in the plurality of images, for example, individual 6401, and identify the individual as the person with whom user 100 was interacting. Wearable device 6300 may further determine the relationship of individual 6401 with user 100 using the individual information stored in individual information database 6306. In some embodiments, individual 6401 may be a family member, friend, colleague, relative, or prior acquaintance of user 100. In some embodiments, individual 6401 may be unknown to user 100. Wearable device 6300 may further determine an amount of time user 100 has spent with individual 6401. Based on these determinations, wearable device 6300 may further provide at least one audible or visible feedback indicating to user 100 the amount of time the user has spent with individual 6401.

FIG. 64B is another schematic illustration showing an exemplary environment of a user of an activity tracking system consistent with the disclosed embodiments. Wearable device 63M), worn by user 100 may be configured to capture a plurality of images of a plurality of different devices, such as a television, a laptop, a mobile device, a tablet, a computer workstation, or a personal computer. For example, wearable device 6300 may capture a plurality of images of a computer 6402 that user 100 is interacting with. The captured images may be stored in image database 6305 of memory 6304. Wearable device 6300 may then determine an amount of time user 100 has spent interacting with computer 6402. Wearable device 6300 may further provide at least one audible or visible feedback indicating to user 100 the amount of time the user has spent with interaction with computer 6402. Wearable device 6300 may also differentiate between certain applications run on a computer such as word processing, playing games, browsing the Internet, or the like, watching different TV shows such as news, comedy, or the like, and may provide this data as part of the feedback provided to user 100 accordingly.

In some embodiments, wearable device 6300 may be configured to provide to user 100 an audible feedback by causing sounds representative of the audible feedback to be produced from speaker 6309. In some embodiments, wearable device 6300 may be configured to provide to user 100 a visible feedback by causing the visible feedback to be shown on display 6308.

FIG. 64A and FIG. 64B show exemplary embodiments in which the plurality of images are captured by wearable device 6300 that is worn by user 100. In these embodiments, the plurality of images captured by camera 6302 may not include user 100. In other embodiments, the plurality of images are captured by another camera that is associated with computer 6402 and the plurality of images may include at least a portion of the face of user 100. By analyzing user 100 in the plurality of images, the level of attentiveness of user 100 may be determined. For example, the level of attentiveness of user 100 may be determined based on a detected rate of user input to the computer 6402.

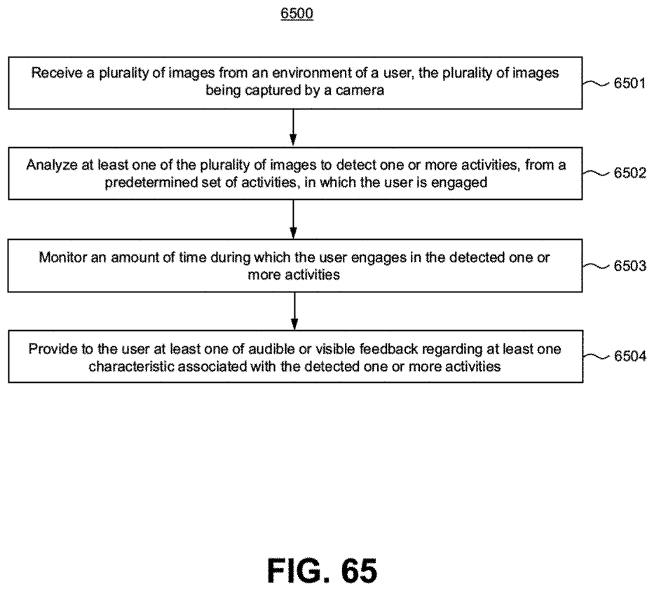

FIG. 65 is a schematic illustration showing a flowchart of an exemplary method for tracking activity of an individual consistent with the disclosed embodiments. Processor 6303 may perform process 6500 to track activity of an individual after camera 6302 or any other camera captures a plurality of images related to activity of user 100.

Method 6500 may include a step 6501 of receiving a plurality of images from an environment of a user, the plurality of images being captured by a camera. For example, at step 6501, processor 6303 may receive the plurality of images captured by camera 6302. In some embodiments, the plurality of images may include facial images of individual 6401. In some embodiments, the plurality of images includes devices that user 100 is interacting with. For example, the plurality of images may include computer 6402, in some embodiments, the plurality of images may include at least a portion of the face or other body part of user 100. The plurality of images may also include video frames that show a movement or activity of individual 6401 or user 100.

Method 6500 may include a step 6502 of analyzing at least one of the plurality of images to detect one or more activities, from a predetermined set of activities, in which the user is engaged. For example, at step 6502, processor 6303 may detect activities including one or more of: eating a meal: consuming a particular type of food or drink; working; interacting with a computer device including a visual interface; talking on a phone; engaging in a leisure activity; speaking with one or more individuals; engaging in a sport; shopping; driving; or reading, based on analysis of the plurality of images.

Method 6500 may include a step 6503 of monitoring an amount of time during which the user engages in the detected one or more activities. For example, at step 6503, processor 6303 may monitor an amount of time the user has spent with the one or more recognized individuals or unrecognized individuals. For another example, at step 6503, processor 6303 may monitor an amount of time the user has spent interacting with the plurality of different devices. The time period may be continuous or may include a plurality of non-contiguous time intervals summed together.

Step 6502 or step 6503 may further include obtaining at least one detail or characteristic of the user activities or individual user 100 is spending time with.

Method 6500 may include a step 6504 of providing to the user at least one of audible or visible feedback regarding at least one characteristic associated with the detected one or more activities. For example, at step 6504, processor 6303 may provide to the user at least one of audible or visible feedback including at least one of: a total amount of time or a percentage of time within a predetermined time interval during which the user engaged in the detected one or more activities; or an indication of the detection of the one or more activities in which the user engaged, processor 6303 may also provide to the user one or more characteristics associated with the detected one or more activities in which the user engaged. For example, the one or more characteristics include a type of food consumed by the user, application used on a computer or a mobile phone, or the like. The at least one of audible or visible feedback includes a suggestion for one or more behavior modifications. The suggestion for one or more behavior modifications may be based on user-defined goals or official recommendations.

Alternatively or additionally, in some embodiments, the at least one characteristic associated with the detected one or more activities may include an amount of time associated with the detected one or more activities.

In some embodiments, memory 6304 may include a non-transitory computer readable storage medium storing program instructions which are executed by processor 6303 to perform the method 6500 as described above.

Wearable Personal Assistant

As described throughout the present disclosure, a wearable camera apparatus may be configured to identify individuals, objects, and activities encountered or engaged in by a user. In some embodiments, the apparatus may be configured to track various goals associated with detected individuals, objects, or activities and provide information to a user regarding completion or projected completion of the goals based on captured image data. For example, this may include generating reminders to complete a goal, evaluating a likelihood a goal will be completed within a particular timeframe, recommending time slots for completing activities associated with a goal, generating notifications regarding completion of goals, or providing other forms of progress indicators or recommendations.

Consistent with the disclosed embodiments, wearable apparatus 110 may be configured to receive information identifying one or more goals. As used herein, a goal may refer to any form of a target achievement or a result associated with one or more activities of a user. In some embodiments, a goal may be associated with a variety of different types of activities and may be related to various aspects of a user's life. For example, the goals may include daily goals such as work-related goals, errand goals, social goals, business or career goals, fitness goals, health goals, financial goals, family goals, personal improvement goals, relationship goals, educational goals, spiritual goals, or any other form of goal an individual may have. The goals may be associated with activities that are at least partially detectable in images captured by wearable apparatus 110. For example, wearable apparatus 110 may receive various social goals, which may be associated with activities such as running an errand, meeting a particular individual, spending a certain amount of time with friends, discussing a particular topic with an individual, engaging in a particular activity or type of activity with an individual, attending a particular event or type of event (e.g., a book club meeting, etc.), using or refraining from using particular types of language when speaking with individuals (e.g., not using filler words such as “like” or “um,” using appropriate language around children, etc.), enunciating or speaking clearly, speaking in a particular language (e.g., time spent speaking the language, a degree of accuracy when speaking the language, etc.), or any other form of goal that may be associated with social interactions of the user. To provide additional examples, health or fitness goals may relate to activities such as consuming or avoiding the consumption of food or beverages, smoking, consuming alcohol, walking, running, swimming, cycling, exercising, lifting weights, viewing or interacting with screens (e.g., mobile phones, televisions, computers, video games, or other devices), standing, sitting, or any other activities related to the user's fitness or wellbeing. While various example goals and activities are described throughout the present disclosure, the disclosed embodiments are not limited to any particular goal or activity.

In some embodiments, the goal may be binary in that it is satisfied when a particular activity occurs or is achieved. For example, the goal may be to meet with a particular individual and once it occurs, the goal may be satisfied. Alternatively or additionally, a goal may include a target value that performance of the activity can be measured against. For example, the target value may include a number of occurrences of the activity or other events. In some embodiments, the target value may be based on an amount of time associated with an activity, such as an amount of time a user spends performing the activity. For example, this may include a cumulative amount of time the user spends playing video games, speaking with other individuals, exercising, looking at his or her phone, sitting at a desk, sleeping, or the like. In some embodiments, the amount of time may be associated with an individual instance of an activity, such as how long a user brushes his or her teeth each time. Various other time-based values may be used as goals, such as an interval between performing activities (e.g., how frequently a user mows the lawn, visits his or her parents, takes his or her medicine, etc.), a time of day (or week, month, year, etc.) at which an activity is performed, a rate the activity is performed at, or the like. Various other forms of target values may be specified, such as a speed (e.g., running speed, cycling speed, etc.), a weight, a volume (e.g., of a fluid or object), a height or length, a distance, a temperature, an audible volume (e.g., measured in decibels), a caloric intake, a size, a count, or any other type of value that may be used to measure particular goals. In some embodiments, the target value may be conditional upon or calculated based on other values. For example, a goal to spend a particular amount of time exercising may include a time value that is dependent on a caloric intake for the day. More specifically, a target amount of time the user is to spend running may be calculated based on the number of calories the user expends per minute while running as well as a number of calories consumed in a particular day such that the overall calories for the user in the day is less than a predetermined amount. Accordingly, the target value may vary based other detected activities or values.

In some embodiments, a goal may be associated with a time component indicating a period of time within which the user wishes to complete the goal. For example, the user may wish to complete an activity or reach a goal associated with an activity within a specified number of minutes, hours, days, weeks, months, years, or other suitable timeframes. In some embodiments, the time component may be based on a particular date. For example, the user may have a goal to complete an activity of running a certain distance without stopping by June 1. In some embodiments, the time component may be in reference to a recurring time period. For example, the time component may indicate the goal should be completed by a certain time each day, by a certain day of each month, before a particular time of each year, or the like. As with the target value discussed previously, the time component may also be conditioned upon or calculated based on other events or values.

The goals may be received or acquired by wearable apparatus 110 in various ways. In some embodiments, the goal may be specified by a user of the apparatus. Accordingly, wearable apparatus 110 or an associated device (e.g., computing device 120) may receive an input by a user specifying the goal. In some embodiments, this may include displaying a user interface through which user 100 may input the goal, including a target value, time component, or other information about the goal. The user interface may be displayed on wearable apparatus 110, computing device 120, or another device capable of communicating with wearable apparatus 110, such as a wearable device, a personal computer, a mobile device, a tablet, or the like. Alternatively or additionally, the goal may be verbally specified by the user. For example, user 100 may say “set a goal to take my medicine every day by 10:00 AM” and wearable apparatus 110 may recognize the speech to capture the goal. Accordingly, wearable apparatus 110 may be configured to search for particular trigger words or phrases, such as “goal” or “set a goal” indicating a user may wish to define a new goal. In some embodiments, the goal may be captured from other audio cues, such as a voice of an individual the user is speaking with. For example, a colleague of user 100 may ask him or her to complete a task by a particular date and wearable apparatus 110 may create a goal based on the encounter. In some embodiments, the goals may be acquired from other sources, such as a calendar of user 100, an internal memory (e.g., a default goal setting, a previously defined goal, etc.), an external memory (e.g., a remote server, a memory of an associated device, a cloud storage platform, etc.). Wearable apparatus 110 may also prompt a user to confirm one or more goals identified for the user.

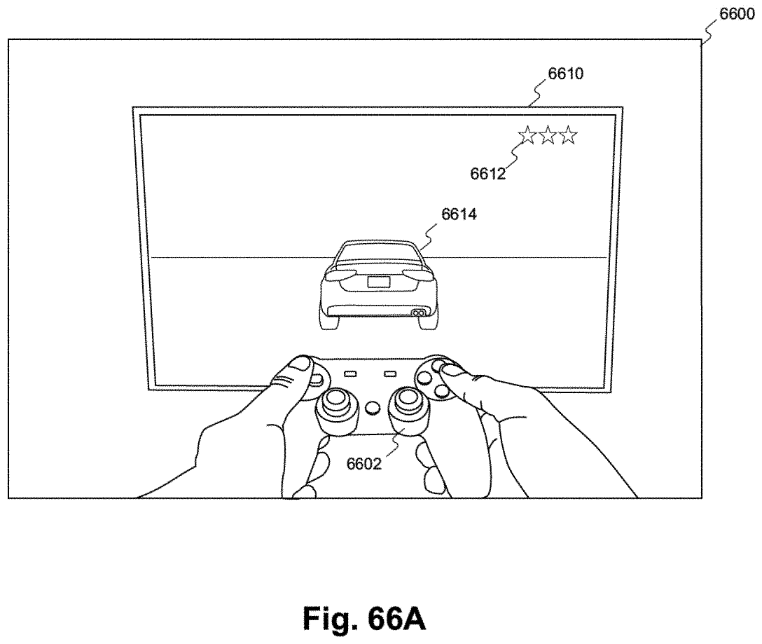

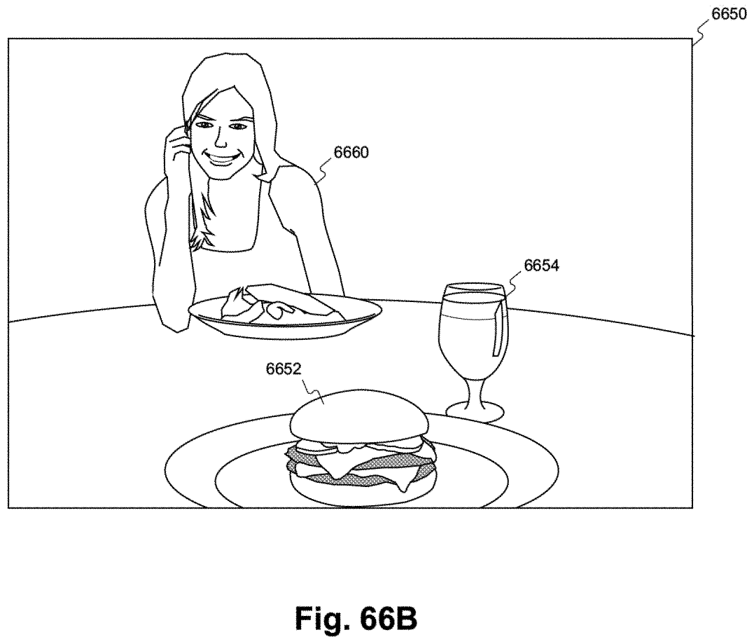

As described above, wearable apparatus 110 may be configured to capture one or more images from the environment of user 100. Wearable apparatus 110 may identify individuals, objects, locations, or environments encountered by the user as well as activities engaged in by the user for tracking performance of associated goals. FIG. 66A illustrates an example image 6600 that may be captured from an environment of user 100, consistent with the disclosed embodiments, image 6600 may be captured by image sensor 220, as described above. In the example shown in image 6600, user 100 may be playing a video game. Image 2600 may include other elements such as controller 6602, display device 6610, and display elements 6612 and 6614, which may be detected by wearable apparatus 110. For example, wearable apparatus 110 may use various edge or object detection algorithms as described throughout the present disclosure, such as frame differencing. Statistically Effective Multi-scale Block Local Binary Pattern (SEMB-LBP). Hough transform, Histogram of Oriented Gradient (HOG), Single Shot Detector (SSD), a Convolutional Neural Network (CNN), or similar techniques. Wearable apparatus 110 may also capture audio signals from the environment of user 100. For example, microphones 443 or 444 may be used to capture audio signals from the environment of the user, as described above. This may include voices of user 100, sounds from display device 6610, voices of other individuals, background noises, or other sounds from the environment.

Referring to example image 6600 shown in FIG. 66, wearable apparatus 110 may detect user 100 is engaged in an activity of playing a video game. For example, this may be based on the detection of controller 6602 and/or display device 6610, which may be associated with playing video games. In some embodiments, wearable apparatus 110 may detect display element 6612 and/or 6614, which may indicate the user is playing a video game. Controller 6602 or display elements 6612 or 6614 may be used to distinguish between watching television, or other events that may be associated with display device 6610. Based on the detected activity, wearable apparatus 110 may track a progress toward a particular goal. For example, user 100 may define a goal to spend below a certain number of hours each month playing video games or to only play video games on weekends. Accordingly, wearable apparatus 110 may track an amount of time user 100 engages in the activity or various other measurable aspects of the activity. This may be determined, for example, based on a number of image frames in which elements 6602, 6610, 6612, and/or 6614 are included, based on an elapsed time between when one of elements 6602, 6610, 6612, and/or 6614 is first detected and last detected within a timeframe, or other suitable methods for determining a duration of an activity. In some embodiments, the goal may be defined with respect to a subset of the activity. For example, wearable apparatus 110 may track an amount of time user 100 spends playing each of a plurality of games on display device 6610. Accordingly, wearable apparatus 110 may be configured to distinguish between multiple games, which may be based on the detection of display elements 6612 and 6614 (or similar display elements). As another example, wearable apparatus 110 may track goals associated with other aspects of playing video games, such as a user's performance on the video games (which may be indicated by graphical element 6612, for example), ergonomics of the user while playing video games, a room lighting level when playing, or various other aspects.

In some embodiments, wearable apparatus 110 may use a trained artificial intelligence engine, such as a trained neural network or other machine learning algorithm to identify particular activities and/or completion of a particular goal. For example, a set of training data may be input into a training algorithm to generate a trained model. Various other machine learning algorithms may be used, including a logistic regression, a linear regression, a regression, a random forest, a K-Nearest Neighbor (KNN) model (for example as described above), a K-Means model, a decision tree, a cox proportional hazards regression model, a Naïve Bayes model, a Support Vector Machines (SVM) model, a gradient boosting algorithm, or any other form of machine learning model or algorithm. The training data may include a plurality of images captured in the environment of a user and labels of the activities the user is engaged in while the images are captured. As a result of the training process, a model may be trained to determine activities a user is engaged on based on images that are captured by wearable apparatus 110.

FIG. 66B illustrates another example image 6650 that may be captured from an environment of user 100, consistent with the disclosed embodiments. Image 6650 may be captured by image sensor 220, as described above. In the example shown in image 6650, user 100 may be eating a meal with individual 6660, image 2600 may include other elements such as food item 6652 and drink 6654. In the example shown in FIG. 66B, wearable apparatus 110 may analyze image 6650 to track goals associated with one or more detected activities. In some embodiments, the goal may be a social goal associated with individual 6660. For example, user 100 may set a goal to meet with individual 6660 by a particular date. Accordingly, wearable apparatus 110 may be configured to recognize or identify individual 6660 using various techniques described throughout the present disclosure. For example, the apparatus may identify facial features on the face of the individual, such as the eyes, nose, cheekbones, jaw, or other features. The apparatus may use one or more algorithms for analyzing the detected features, such as principal component analysis (e.g., using Eigenfaces), linear discriminant analysis, elastic hunch graph matching (e.g., using Fisherface), Local Binary Patterns Histograms (LBPH), Scale Invariant Feature Transform (SIFT), Speed Up Robust Features (SURF), or the like. In some embodiments, the individuals may be identified based on other physical characteristics or traits such as a body shape or posture of the individual, particular gestures or mannerisms, skin tone, retinal patterns, distinguishing marks (e.g., moles, birth marks, freckles, scars, etc.), hand geometry, finger geometry, or any other distinguishing physical or biometric characteristics.

In another example, user 100 may set a goal to speak with individual 6660 about a certain topic within a particular timeframe. Accordingly, wearable apparatus may monitor audio signals captured by microphones 443 or 444 to identify a topic of conversation between individual 6660 and user 100. In some embodiments, the goal may not be specific to individual 6660 but may relate to broader social goals. For example, image 6650 may be analyzed to track goals related to an amount of time spent with friends or family members, a number of dates user 100 goes on (or similar social event categories), or the like. In some embodiments the goal may be associated with the speech of user 100. For example, this may include the number of times user 100 utters a filler word or phrase (such as “like” or “um”), utterance of other predefined words or phrases, how clearly a user speaks, a tone of the conversation, a topic of the conversation, a speech rate, or the like.

As another example, image 6650 may be analyzed to track one or more goals associated with the health or fitness of user 100. For example, wearable apparatus 110 may track eating or drinking patterns of user 100. In some embodiments, wearable apparatus 110 may determine that food item 6652 is a double cheeseburger, which may be used to track a caloric intake goal of user 110. For example, wearable apparatus 110 may perform a lookup function in a database or other data structure that may correlate food item classifications with average calorie values or other nutrient values. As another example, wearable apparatus 110 may recognize that beverage 6654 is a beer or other alcoholic beverage, which may be used to identify an activity of consuming alcohol. For example, user 100 may set a goal to have less than five alcoholic beverages a week, or similar goals.

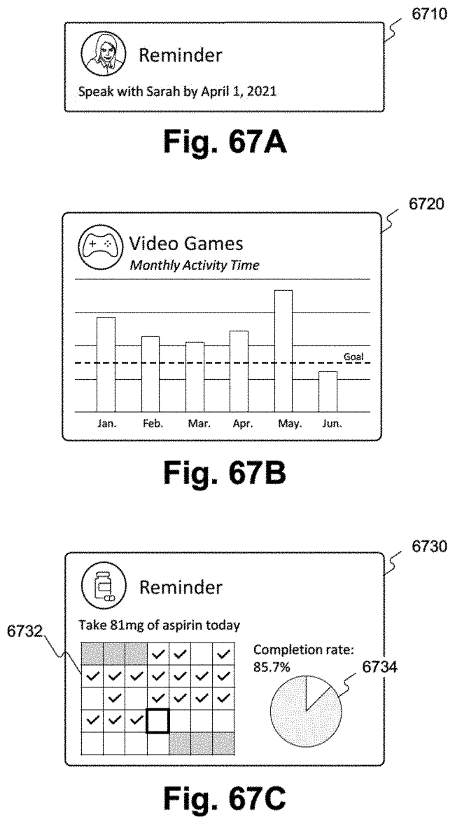

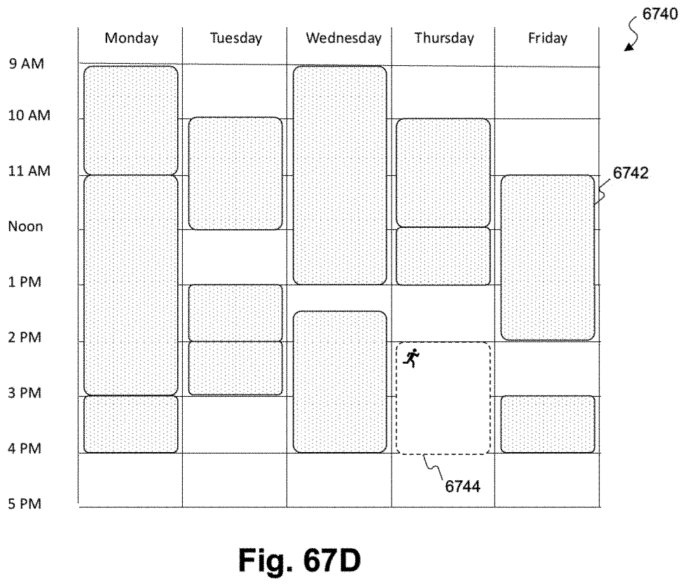

Wearable apparatus 110 may be configured to present information to user 100 based on completion or progress toward completion of the goal. This may include metrics relating to progress, likelihoods of completion, reminders, recommendations, or any other information associated with completion of goals. In some embodiments, the information may be visibly displayed to user 100. For example, the information may be presented on a display of wearable apparatus 110, computing device 120, or other associated devices. FIGS. 67A, 67B, and 67C illustrate example information that may be displayed to a user, consistent with the disclosed embodiments.

In some embodiments, wearable apparatus 110 may present information indicating completion or accomplishment of a goal, which may be provided through feedback outputting unit 230 or another component configured to provide feedback to a user. For example, the apparatus may display a notification or other indicator signifying completion of a goal. This may include displaying a notification element on a display, illuminating an indicator light, or the like. As another example, the notification may be an audible indication. For example, wearable apparatus 110 may present a chime, tone, vocal message (e.g., “Congratulations! You completed your goal of standing up every hour today!”, etc.), or other audio indicators. In some embodiments, the audible or visual indicators may be presented through a device other than wearable apparatus 110. For example, presenting the information may include transmitting or otherwise making the information available to a secondary device. For example, this may include a mobile device, a smartphone, a laptop, a tablet, a wearable device, or another form of computing device (which may include computing device 120). In some embodiments, the secondary device may include a headphone device (which may include in-ear headphones, on- or over-the-ear headphones, bone conduction devices, hearing aids, earpieces, etc.). Accordingly, the secondary device may display or present the audio or visual information to the user.

As another example, wearable apparatus 110 may present reminders associated with a goal. FIG. 67A illustrates an example reminder 6720 that may be presented to user 100, consistent with the disclosed embodiments. For example, user 100 may have a goal to meet with an individual named Sarah by Apr. 1, 2021. If wearable apparatus 110 determines user 100 has not completed the goal, reminder 6720 may be displayed. The reminder may be presented periodically (e.g., daily, weekly, monthly, etc.), based on an approaching completion date (e.g., within a few days, a few weeks, a month, etc.), based on other detected activities, or the like.

In some embodiments, the information may include an indication of a historical progress of the goal. FIG. 67B illustrates an example display element 6710 indicating a tracked progress for a goal associated with time spent playing video games. For example, user 100 may set a goal to spend less than 30 hours per month playing video games. Display element 6710 may include a chart showing a total time spent playing video games for each month along with an indicator of a goal or target time. In some embodiments, display element 6710 may be presented along with a notification that user 100 has successfully completed his or her goal for the month of June. Alternatively or additionally, display element 6710 may be presented along with a warning or reminder that user 100 is approaching the goal amount for the month of June.

In some embodiments, wearable apparatus 110 may be configured to determine a likelihood of whether user 100 will complete a particular goal within a specified timeframe. For example, if user 100 has a goal of playing less than 30 hours of video games in June, wearable apparatus may compare a progress of the goal (e.g., an amount of progress toward the goal, such as the number of hours spent playing in June) with the current date (e.g., the number of days in June that have passed) to determine whether user 100 is on track for reaching his or her goal. In some embodiments, the likelihood may consider historical information associated with the activity. For example, if user 100 typically spends more time playing video games in the beginning of the month, on weekends, or according to other recognized patterns, wearable apparatus 110 may account for this in determining the likelihood. Accordingly, if user 100 typically plays video games on weekends only, and there are no weekends left in June, the likelihood may be greater that user 100 will accomplish the goal. The likelihood may be represented as a score or other value (e.g., a percentage, a ratio, on a graduated scale, etc.), a binary indicator (e.g., likely to meet goal vs. unlikely to meet goal), a text-based description (e.g., very likely, somewhat likely, etc.), or any other suitable representation of a likelihood prediction.

If wearable apparatus 110 determines user 100 is unlikely to meet a goal, wearable apparatus 110 may generate a reminder of the goal. For example, this may include a reminder that the user set the goal as well as other information, such as the number of hours left before the target is reached, historical progress of reaching the goal, a reward or other incentive for reaching the goal, or other information. In some embodiments, wearable apparatus 110 may generate a recommendation for completing the goal. For example, wearable apparatus 110 may recommend that user 100 decrease his or her time playing video games for the rest of the month, not play video games on a particular day, perform a different activity (e.g., taking a walk, etc.), or various other recommendations. Conversely if user 100 is predicted to meet a goal, wearable apparatus 110 may generate a notification indicating user 100 is on track.

In some embodiments, wearable apparatus 110 may present additional information associated with a goal to user 100. For example, FIG. 67C illustrates another example reminder 6730 that may be presented to a user. As shown, reminder 6730 may include a calendar element 6732 that may indicate a progress associated with a goal. In the example shown in FIG. 67C, calendar element 6732 may include check marks indicating days of the month that user 100 has taken his or her medicine. Depending on the type of goal or activity, calendar element 6732 may include other visual indicators or metrics, such as numbers, colors, shading, progress bars, or other elements indicating goal performance. Alternatively or additionally, reminder 6730 may include a chart 6734 indicating a completion rate of a goal. In this example, chart 6734 may indicate that user 100 has taken his or her medicine on 85.7% of the days this month. While calendar element 6732 and chart 6734 are provided by way of example, any other form of display elements may be included to provide information associated with a goal to a user. For example, this may include a diagram, flowchart, progress bar, graph, clock, timer, chart, table, image, icon, or any other form of visual elements. Further, while graphical elements are shown by way of example in FIGS. 67A, 67B, and 67C, any of the information described herein may also be presented audibly, for example, through a verbal dictation, chime, tone, etc.

As discussed above, wearable apparatus 110 may predict a likelihood of whether a task will be completed within a target timeframe. In some embodiments, wearable apparatus 110 may access a calendar of a user or other individuals, which may provide additional information relevant to likelihood of completion, recommendations, or other relevant information. FIG. 67D illustrates an example calendar 6740 that may be accessed by wearable apparatus 110. Consistent with the present disclosure, a calendar may be accessed in various ways. In some embodiments the calendar may be stored locally on wearable apparatus 110, for example, in memory 550. For example, a calendar may be downloaded to wearable apparatus 110 (and optionally synchronized as needed), or the calendar or certain entries may be manually entered by user 100. Alternatively or additionally, the calendar may be accessed from a remote location, such as a remote server or database, a cloud-based platform, a secondary device (e.g., computing device 120), or other devices that may store calendar information. In determining a likelihood of completion of a goal or activity, wearable apparatus 110 may consider a calendar of user 100. For example, if user 100 has a goal to complete an activity within the current week, wearable apparatus 110 may consider whether user 100 has sufficient availability to complete the activity.

In some embodiments, this may include determining an estimated time required for completing the activity. This may be determined based on previous instances of user 100 performing the activity. For example, if user 100 typically spends an average of 1.5 hours meeting with an individual, wearable apparatus 110 may determine the number of available time slots of at least 1.5 hours in length within the target completion time when determining a likelihood of completion. Depending on the type of activity, wearable apparatus 110 may look for continuous or noncontinuous time periods. For example, a goal for user 100 to visit the dentist likely requires a continuous block of time, whereas a goal to spend a certain amount of time reading can likely be dispersed throughout the user's schedule. Wearable apparatus 110 may also consider a time of day when user 100 typically performs the activity. For example, a goal for user 100 to complete an activity of washing his or her car likely must be performed during the day, whereas a goal for user 100 to do his or her laundry may be less restrictive. In some embodiments, predefined values for required completion time or typical times of day for completion may be used. This may include default values for particular activities (e.g., factory defaults, industry standards, averages for other users, etc.) or user-defined values (e.g., received through a graphical user interface), for example.

In some embodiments, wearable apparatus 110 may be configured to generate recommendations regarding scheduling for goals or activities. For example, wearable apparatus 110 may determine that time slot 6744 is the only remaining (or the best remaining) time slot for completing a running activity and may recommend the activity be performed in time slot 6744. This recommendation may be presented in various ways. For example, the activity may automatically be added to calendar 6740. In some embodiments, wearable apparatus 110 may also prompt user 100 to confirm before adding the calendar event. The recommendation may also be presented visually (e.g., through a graphical element, which may be similar to those described above with respect to FIGS. 67A, 67B, and 67C), through an audible recommendation, or the like.

In some embodiments, wearable apparatus 110 may consider other information when recommending time slots for completing activities. As one example, wearable apparatus 110 may consider location information included in the calendar 6740 for recommending time slots. For example, if user 100 typically runs at home, wearable apparatus may avoid recommending time slots for a running activity adjacent to or between activities scheduled for other locations, such as at the office. In some embodiments, wearable apparatus 110 may account for a typical time for traveling between two locations when scheduling the activity. For example, time slot 6744 may include an hour gap before the previous activity, which may allow user 100 to travel from work to home before beginning activity 6744. The typical travel time may be based on an average observed travel time for user 100 (e.g., based on GPS location data, captured images, etc.), an average time for other users, an average time based on map data (e.g., common travel times, current traffic conditions, etc.), or any other data that may indicate or affect travel times.

In some embodiments, the recommendations may be determined based on a current location of the user. For example, if the user is currently at or near a location suitable for completing a goal or actions associated with a goal, wearable apparatus 110 may provide recommendations to complete the goal or the actions associated with a goal. As an illustrative example, if the user is near an address associated with an individual associated with a goal (e.g., a goal to meet the individual or discuss a certain topic with the individual), wearable apparatus 110 may generate a recommendation to visit the individual. In some embodiments, the recommendation may further be based on a calendar of the user. For example, if the user is near the supermarket and has free time in his or her calendar, wearable apparatus 110 may recommend that the user goes shopping now. As described above, the recommendation may also be based on future calendar events. For example, if the user is expected to be near the supermarket later, the recommendation may be complete a goal later when the user has free time.

As another example, wearable apparatus may also consider a calendar of another user when generating scheduling recommendations. For example, if user 100 has a goal to complete an activity involving another individual, wearable apparatus 110 may schedule the recommended time slot when the individual is available. In some embodiments, the nature of the goal may indicate the other individual must also be available (e.g., a goal to meet or spend time with the individual). Alternatively or additionally, wearable apparatus 110 may determine the other individual should also be available based on historical activities. For example, user 100 may commonly perform an activity of playing tennis with a particular individual. This may be determined based on analysis of images captured during the historical activities to determine the individual is in the environment of the user, as described throughout the present disclosure. Accordingly, future scheduled activities may be planned for when the individual is available. Wearable apparatus 110 may consider other factors, such as activity goals for the other individual (if available), location data for adjacent events, travel times, or other factors, similar to fir user 100.

According to some embodiments, wearable apparatus 110 may populate a calendar with other tasks that may not necessarily be included in the accessed calendar information. For example, referring to FIG. 67D, wearable apparatus 110 may insert an event in time slot 6742 into calendar 6740 for the purposes of scheduling or determining likelihoods of completion for activities. In some embodiments, the event in time slot 6742 may be determined based on historical activities identified by wearable apparatus 110. For example, user 100 may typically perform a recognized activity (or be in a particular location or with a particular individual) at the same time each day, week, month, year, etc. and wearable apparatus 110 may exclude the times slot for purposes of determining likelihood of completion or for making recommendations. As another example, the event in time slot 6742 may be another activity recommendation time slot, similar to time slot 6744. In other words, wearable apparatus may be configured to track multiple goals for user 100 and analyze calendar 6740 in conjunction with multiple goals. Accordingly, wearable apparatus 110 may optimize a schedule for user 100 to ensure that activities for multiple goals can be completed. For example, if the activity shown in time slot 6742 in FIG. 67D could not be completed in time slot 6744, wearable apparatus 110 may not consider time slot 6742 a feasible option for completing the running activity, since the two activities must be scheduled as shown in FIG. 67D in order for both activities to be completed during the indicated week. While FIG. 67D illustrates two events in a single week, it is to be understood that more complex scenarios involving longer time frames, calendars from multiple individuals, and multiple goals for the individuals may arise, increasing the need for the disclosed embodiments.

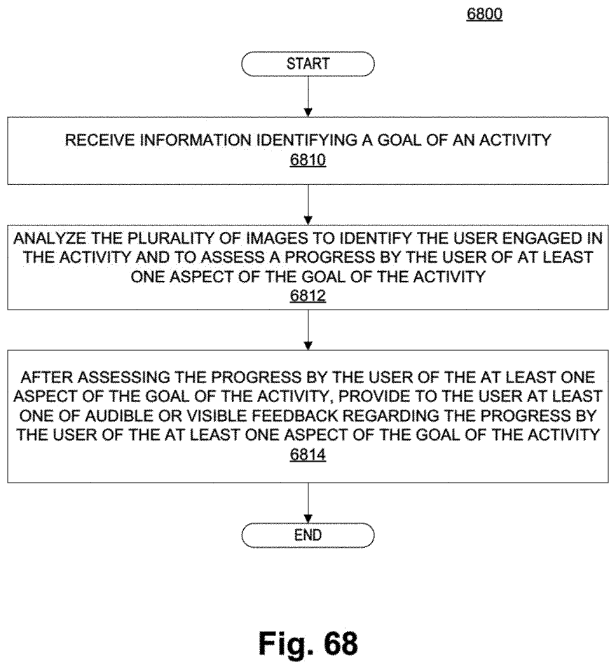

FIG. 68 is a flowchart showing an example process 6800 for tracking goals for activities of a user, consistent with the disclosed embodiments. Process 6800 may be performed by at least one processing device of a wearable personal assistant device, such as processor 220, as described above. In some embodiments, some or all of process 6800 may be performed by a different device, such as computing device 120. In some embodiments, a non-transitory computer readable medium may contain instructions that when executed by a processor cause the processor to perform process 6800. Further, process 6800 is not necessarily limited to the steps shown in FIG. 68, and any steps or processes of the various embodiments described throughout the present disclosure may also be included in process 6800, including those described above with respect to FIGS. 66A, 66B, 67A, 67B, 67C, and 67D.

In step 6810, process 6800 may include receiving information identifying a goal of an activity. As described above the goal may be identified in various ways. For example, identifying the goal may include accessing or retrieving information indicating the goal from a storage device (e.g., an internal storage device, an external device, a remote server, a cloud-based platform, etc.). In some embodiments, information indicating the goal may be received from an external device. For example, computing device 120 or a similar device may transmit information indicating the goal to wearable apparatus 110. As another example, the information identifying the goal activity may be provided to the wearable personal assistant device by the user. For example, a wearable personal assistant device may include a wireless transceiver associated with the housing for receiving from a secondary device the information identifying the goal activity. Accordingly, the information identifying the goal of the activity is provided by the user to the secondary device via one or more user interfaces associated with the secondary device. Alternatively or additionally, the wearable personal assistant device may include a microphone associated with the housing for receiving from the user the information identifying the goal of the activity. In some embodiments, the information identifying the goal of the activity may be received from other sources of information associated with the user, such as a calendar, a task list, a to-do list, an email or other message (e.g., by analyzing the message to identify tasks using a natural language processing algorithm), a schedule, or other data sources that may include goals of a user.

The goal may be associated with a wide variety of activities that may be performed by user 100 and recognized in captured images. For example, the activity or the goal may be associated with at least one of eating, drinking, sleeping, meeting with one or more other individuals, exercising, taking medication, reading, working, driving, interaction with computer-based devices, watching TV, smoking, consumption of alcoholic beverages, gambling, playing video games, standing, sitting, speaking, or various other user activities, including other examples described herein. In some embodiments, the goal or activity may be associated with a time component indicating a period of time within which the user wishes to complete the goal. For example, the information identifying the goal of the activity may include an indication of a certain amount of time during which the user wishes to exercise within a predetermined time period, an indication of a type of food or medication the user wishes to consume within a predetermined time period, an indication of an individual with whom the user wishes to meet within a predetermined time period, an indication of an individual with whom the user wishes to speak within a predetermined time period, or other examples as described herein. The time component may be at least one of: at least one hour in duration, at least one day in duration, at least one week in duration, at least one month in duration, at least one year in duration, or other suitable timeframes. In some embodiments, the goal may be an affirmative goal, for example, to complete a certain activity or spend a certain amount of time doing an activity in a certain time period. Alternatively or additionally, a goal may be negative or restrictive goal. For example, the goal may be to refrain from engaging in an activity or to limit an amount of time spent engaged in the activity.

Although not illustrated in FIG. 68, process 6800 may include a step of receiving a plurality of images captured from an environment of a user. For example, process 6800 may include receiving images such as images 6600 and 6650, as shown in FIGS. 66A and 66B, respectively. The images may be captured by a camera or other image capture device, such as image sensor 220. Accordingly, the camera and at least one processor performing process 6800 may be included in a common housing configured to be worn by the user, such as wearable apparatus 110. In some embodiments, the system may further include a microphone included in the common housing. In some embodiments, the plurality of images may be part of a stream of images, such as a video signal. Accordingly, receiving the plurality of images may comprise receiving a stream of images including the plurality of images, the stream of images being captured at a predetermined rate.

In step 6812, process 6800 may include analyzing the plurality of images to identify the user engaged in the activity. For example, this may include detecting various objects, individuals, actions, movements, environments, or the like, which may indicate an activity the user is engaged in. Step 6812 may further include analyzing the plurality of images to assess a progress by the user of at least one aspect of the goal of the activity. The progress may be determined, for example, based on an amount of time the user engages in an activity, a user's performance in a particular activity, whether the activity was engaged in, other individuals present, or the like, depending on the particular goal or activity. According to some embodiments, analysis of the plurality of images may be at least partially performed by a trained artificial intelligence engine, as described above. In some embodiments, assessing a progress may include determining whether the user has completed one or more actions associated with a goal. Further, in some embodiments, tracking the progress may include determining that the goal has been completed.

The type of information relevant for assessing the progress of a goal may depend on the type of goal. In some embodiments, the progress by the user of the at least one aspect of the goal of the activity may be assessed based, at least in part, on identification of a representation of a recognized individual in one or more of the plurality of images. For example, progress for a goal to meet with a particular individual may be assessed bused on detecting the individual in the images. Similarly, the progress by the user may be assessed based, at least in part, on identification of a textual name on a device screen appearing in one or more of the plurality of images. For example, a screen may display a name of a contact the user is speaking with, a relative, or the like. As another example, the progress by the user may be assessed based, at least in part, on identification of a representation of a certain type of food, drink, or medication in one or more of the plurality of images. For example, the user may have a goal to eat particular types of food or take his or her medication each day. Similarly, the progress may be assessed based, at least in part, on identification of a representation of exercise equipment appearing in one or more of the plurality of images. For example, step 6812 may include recognizing a treadmill, basketball, athletic clothing, or any other objects associated with exercise. The progress may also be based on an amount of time, within a certain time period, the user interacts with the exercise equipment. As another example, progress by the user may be assessed based, at least in part, on identification of a representation of a recognized location in one or more of the plurality of images. In some embodiments, the performance may be assessed based, at least in part, on identification of a representation of a recognized voice associated with an audio signal provided by a microphone associated with the housing of the wearable personal assistant device.

In step 6814, process 6800 may include after assessing the progress by the user of the at least one aspect of the goal of the activity, providing to the user at least one of audible or visible feedback regarding the progress by the user of the at least one aspect of the goal of the activity. For example, providing to the user the at least one audible or visible feedback regarding the progress by the user of the at least one aspect of the goal activity may include causing the visible feedback to be shown on a display. In some embodiments, the display may be included in the housing of the wearable personal assistant device. Alternatively or additionally, the display may be included in a secondary device wirelessly connected to the wearable personal assistant device. For example, the secondary device may include at least one of a mobile device, a laptop, a tablet, or a wearable device. In some embodiments, providing to the user the at least one audible or visible feedback regarding the progress of the at least one aspect of the goal of the activity may include causing sounds representative of the audible feedback to be produced from a speaker. In some embodiments, the speaker may be included in the housing of the wearable personal assistant device. Alternatively or additionally, the speaker may be included in a secondary device, such as a mobile device, a laptop, a tablet, or a wearable device. As another example, the secondary device may include headphones configured to be worn by the user, as described above.

In some embodiments, process 6800 may include providing additional information based on the status or progress of goals or activities as described herein. For example, process 6800 may include providing to the user at least one of an audible or visible reminder regarding the activity or the goal. The reminder may also include other information, such as an indication that the goal of the activity has not yet been completed or is expected not to be completed within a predetermined time period, at least one suggested present or future time window sufficient for completing the goal of the activity, an indication of a likelihood of completion of the goal of the activity within a certain time period in view of the determined future time windows, or similar information, as described herein.

According to some embodiments, process 6800 may include automatically monitoring schedule information associated with the user and determine future time windows potentially available for engaging in the activity, as described above with respect to FIG. 67D. In some embodiments, the schedule information may be obtained from an electronic calendar associated with the user. For example, process 6800 may include accessing a calendar, such as calendar 6740. Further, as described above, the schedule information may include an anticipated future routine associated with the user determined based on automatic analysis of prior activities in which the user has participated as well as timing associated with the prior activities. Process 6800 may further include providing to the user at least one of an audible or visible indication identifying the determined future time windows.

System for Reminding a User to Wear a Wearable Device

A system for providing an indication to a user (e.g., to remind the user) to wear a wearable device or, for example, to remember to carry the user's smartphone is disclosed. The disclosed system is configured to receive motion feedback from a mobile device (e.g., smartphone) paired with a wearable device (e.g., disclosed hearing aid device). For example, the motion feedback may indicate that the mobile device or the wearable device is moving while the other is still or moving at a different rate or in a different direction. In some embodiments, this determination may be based on time considerations alone. For example, when the devices are not moving at the same time (or during a particular time period), this may indicate a likelihood that the user has one of the two devices (mobile device and wearable device) but not the other. In some embodiments, however, when both the mobile device and the wearable device are moving at the same time (or during a particular time period), the movement of the two devices may not be sufficient to make a determination that the user does not have both devices. Therefore, the disclosed system may also evaluate position information to determine whether the mobile device and the wearable device are moving together and/or are co-located. For example, if the user is walking along a sidewalk with both the mobile device and the wearable device, both devices will be moving at the same time (or near in time to each other) and they will be co-located (or at least their reported positions will change similarly). On the other hand, if the user left her mobile device in a cab, the user may be walking on the sidewalk, and the cab may be driving on a road. In this situation, the mobile device and the wearable device may both be moving, but may not be moving together. Therefore, a more accurate determination of whether the user has both devices may be based on factors such as a current location, a change in location, a rate of change of location, a direction of change of location, motion timing, etc. The disclosed system may trigger a reminder to wear the wearable device (or not to forget the mobile phone) in various situations. The disclosed system may also be configured to evaluate the situation where both devices are static for a long time (e.g., minutes, hours, days, etc.).

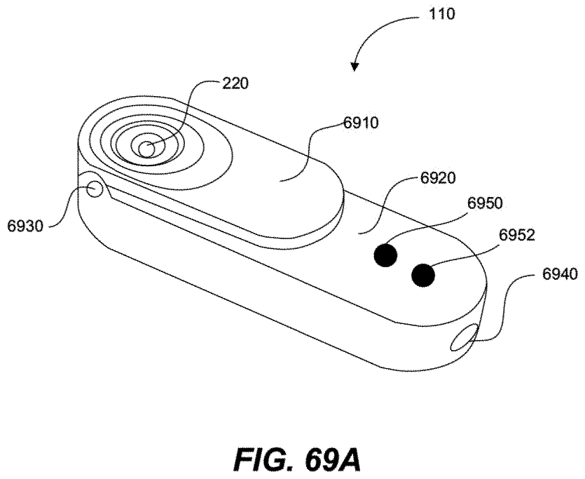

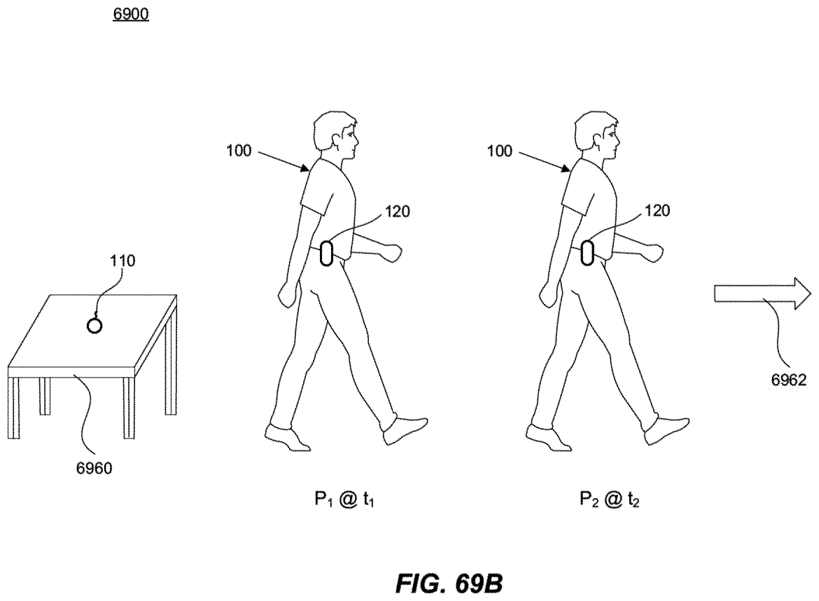

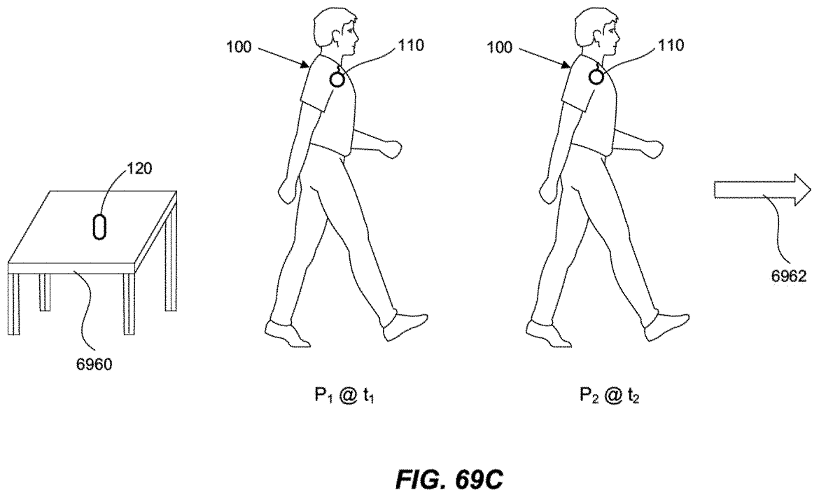

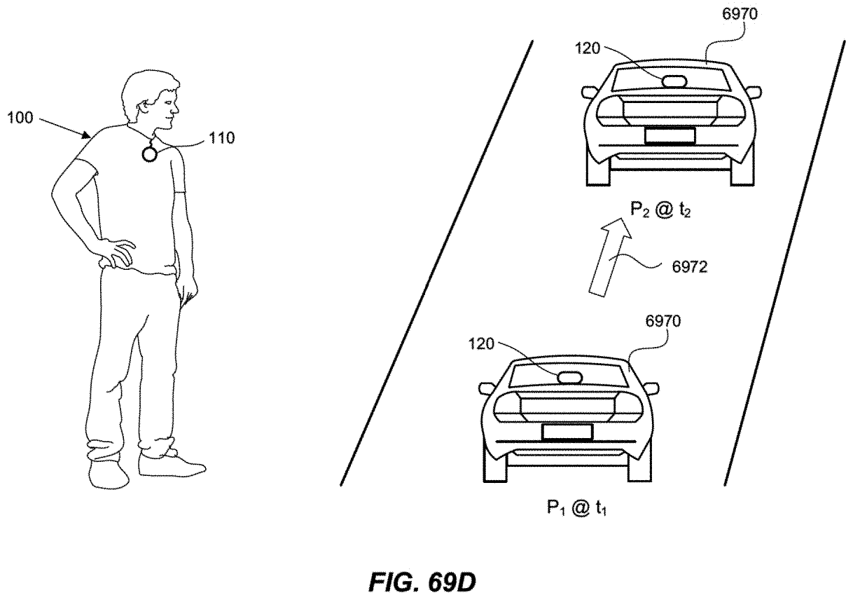

In some embodiments, the system may include a wearable device including at least one of a camera, a motion sensor, or a location sensor. FIG. 69A illustrates another embodiment of wearable apparatus 110 securable to an article of clothing of a user. For example, user 100 may wear a wearable device, such as, apparatus 110 that is physically connected to a shirt or other piece of clothing of user 100. Consistent with the disclosed embodiments, apparatus 110 may be positioned in other locations, as described previously. For example, apparatus 110 may be physically connected to a necklace, a belt, glasses, a wrist strap, a button, etc. In the following description, apparatus 110 will be referred to as wearable device 110 for ease of understanding. It is to be understood, however, that the disclosed wearable device may include devices similar to or different from apparatus 110.

In some embodiments, the wearable device may include at least one of a wearable camera or a wearable microphone. For example, wearable device 110 may include a camera configured to capture a plurality of images from an environment of a user. As discussed above, wearable device 110 may comprise one or more image sensors such as image sensor 220 that may be past of a camera included in apparatus 110. It is contemplated that image sensor 220 may be associated with different types of cameras, for example, a wide angle camera, a narrow angle camera, an IR camera, etc. In some embodiments, the camera may include a video camera. The one or more cameras may be configured to capture images from the surrounding environment of user 100 and output an image signal. For example, the one or more cameras may be configured to capture individual still images or a series of images in the form of a video. The one or more cameras may be configured to generate and output one or more image signals representative of the one or more captured images. In some embodiments, the image signal may include a video signal. For example, when image sensor 220 is associated with a video camera, the video camera may output a video signal representative of a series of images captured as a video image by the video camera.

In some embodiments the wearable device may include one or more wearable microphones configured to capture sounds from the environment of the user. For example, as discussed above, apparatus 110 may include one or more microphones 443, 444, as described with respect to FIGS. 4F and 4G. Microphones 443 and 444 may be configured to obtain environmental sounds and voices of various speakers communicating with user 100 and output one or more audio signals. In some embodiments, the microphone may include a least one of a directional microphone or a microphone array. For example, microphones 443, 444 may comprise one or more directional microphones, a microphone array, a multi-port microphone, or the like. The microphones shown in FIGS. 4F and 4G are by way of example only, and any suitable number, configuration, or location of microphones may be used.

As illustrated in FIG. 69A, capturing unit 6910 may be connected to power unit 6920 by one or more hinges. e.g., hinge 6930, such that capturing unit 6910 is positioned on one side of an article of clothing and power unit 6920 is positioned on the opposite side of the clothing. Power unit 6920 may include a connector 6940 (e.g., a plug) configured to receive a cable for transferring data and/or power to apparatus 110. In some embodiments, wearable apparatus 110 may further include one or more speakers (not shown).

As also discussed above, in some embodiments, the wearable device may include various sensors, including a motion sensor and/or a location sensor. In some embodiments, the location sensor associated with the wearable device may include at least one of a GPS sensor or an accelerometer. For example, wearable device 110 may include a microphone, and inertial measurement devices such as accelerometers, gyroscopes, magnetometers, temperature sensors, color sensors, light sensors, etc. It is also contemplated that wearable device 110 may include one or more location and/or position sensors. As illustrated in FIG. 69A, wearable device 110 may include accelerometer 6950 and/or location sensor 6952. Accelerometer 6950 may be configured to detect a motion or movement, for example, by detecting a change in velocity or acceleration of wearable device 110. Location sensor 6952 may be a GPS location sensor that may determine GPS coordinates associated with sensor 6952. It is contemplated, however, that location sensor 6952 may be configured to determine a location of wearable device 110 in many other ways. For example, sensor 6952 may be configured to determine the location of wearable device 110 based on triangulating wireless signals from a plurality of wireless transmitters/receivers. In other embodiments, sensor 6952 may employ electromagnetic radiation of various wavelengths and/or frequencies to determine a location of wearable device 110.

In some embodiments, a mobile device may include at least one of a motion sensor or a location sensor. In some embodiments, the mobile device comprises a mobile phone. In some embodiments, location sensor associated with the mobile device includes at least one of a GPS sensor or an accelerometer. For example, wearable apparatus 110 may be paired with a mobile device (e.g., a smartphone) associated with user 100. Wearable device 110 may be configured to send information such as audio, images, video, textual information, etc. to a paired device, such as computing device 120 (e.g., smartphone or mobile device). As discussed above, computing device 120 may include, for example, a laptop computer, a desktop computer, a tablet, a smartphone, a smartwatch, etc. In the following description, the disclosed mobile device will be referred to as mobile device 120 for ease of understanding. It is to be understood, however, that computing device 120 may include various types of non-mobile devices such as, for example, desktop computer, a server, etc. Mobile device 120 may include one or more accelerometers 6950 that may be configured to detect a motion, or change in velocity of acceleration of mobile device 120. Mobile device 120 may also include and one or more location sensors 6952 configured to determine a position of mobile device 120.

In some embodiments, the disclosed system may include at least one processor programmed to execute a method. In some embodiments, the at least one processor may comprise a processor provided on the wearable device (e.g., wearable device 120). In some embodiments, the at least one processor may be a processor provided on the mobile device. For example, wearable device 110 may include processor 210 (see FIG. 5A), 210a or 210b (see FIG. 5B). Similarly, mobile device 120 may include processor 540 (see FIG. 5C). As also discussed above, processor 210 or 540 may include any physical device having an electric circuit that performs a logic operation on input or inputs. For example, the processor may include one or more integrated circuits, microchips, microcontrollers, microprocessors, all or pad of a central processing unit (CPU), graphics processing unit (GPU), digital signal processor (DSP), field-programmable gate array (FPGA), or other circuits suitable for executing instructions or performing logic operations. It is also contemplated that in some embodiments, wearable device 110 and/or mobile device 120 may transmit and/or receive data and other information to/from server 250 over network 240. Server 250 may also include one or more processors similar to processors 210, 540. The following description describes various functions performed by processor 210. It is to be understood, however, that the disclosure is not so limited and some or all of the functions described with respect to processor 210 may be performed by processor 540 or similar processors associated with server 250. In particular, as discussed above, wearable device 110 may be worn by user 100 in various configurations, including being physically connected to a shirt, necklace, a belt, glasses, a wrist strap, a button, or other articles associated with user 100. Accordingly, one or more of the processes or functions described herein with respect to apparatus 110 or processor 210 may be performed by computing device 120 and/or processor 540, or by server 250 and its associated one or more processors.

In some embodiments, the at least one processor may be programmed to execute a method comprising receiving a first motion signal indicative of an output of at least one of a first motion sensor or a first location sensor of a mobile device. For example, motion sensor (e.g., accelerometer 6950) of mobile device 120 may sense a motion or change in velocity or acceleration of mobile device 120. For example, user 100 may be carrying or wearing mobile device 120 (e.g., a smartphone) and may be walking, running, riding, and/or traveling in, for example, a land-based, sea-based, or airborne vehicle. Accelerometer 6950 may periodically or continuously generate signals representative of the detected motion or change in velocity or acceleration of mobile device 120. Similarly, location sensor 6952 associated with mobile device 120 may periodically or continuously generate signals indicative of a location or position of mobile device 120. Processor 210 may be configured to receive the one or more first motion signals generated by sensors 6950 and/or 6952 wirelessly or via wired connections. As discussed above, these first motion signals may be indicative of outputs or signals generated by at least one of motion sensor 6950 (e.g., accelerometer 6950) or location sensor 6952 associated with mobile device 120.

In some embodiments, the at least one processor may be programmed to execute a method comprising receiving, from the wearable device, a second motion signal indicative of an output of at least one of the camera, the second motion sensor, or the second location sensor. For example, motion sensor (e.g., accelerometer 6950) of wearable device 110 may sense a motion or change in velocity or acceleration of wearable device 110. For example, user 100 may be carrying or wearing wearable device 110 and may be walking, running, riding, and/or traveling in, for example, a land-based, sea-based, or airborne vehicle. Sensor 6950 may periodically or continuously generate signals representative of the detected motion or change in velocity or acceleration of wearable device 110. Similarly, location sensor 6952 associated with wearable device 110 may periodically or continuously generate signals indicative of a location or position of wearable device 110. Processor 210 may be configured to receive the one or more second motion signals generated by sensors 6950 and/or 6952 associated with wearable device 110 wirelessly or via wired connections. As discussed above, these second motion signals may be indicative of outputs or signals generated by at least one of motion sensor 6950 and/or location sensor 6952 associated with wearable device 110.

In some embodiments, the second motion signal originates from the camera associated with the wearable device and is indicative of one or more differences between a plurality of images captured by the camera. For example, the one or more image sensors 220 associated with wearable device 110 may capture a plurality of images from an environment of user 100. Image sensor 220 and/or a processor associated with image sensor 220 may receive and analyze the plurality of images. Image sensor 220 and/or the processor associated with image sensor 220 may determine a change in a position of wearable device 100 based on, for example, one or more changes of positions of one or more objects in the plurality of images. Additionally or alternatively, image sensor 220 and/or a processor associated with image sensor 220 may detect that one or more objects may be present in some images but not in others. Further still, image sensor 220 and/or a processor associated with image sensor 220 may determine a change in size of one or more objects in the plurality of images. Based on detection of changes in position, sizes, etc. of one or more objects in the plurality of images, image sensor 220 may generate a signal indicative of the differences between the images. The signal generated by image sensor 220 may constitute the second motion signal received by processor 210.

In some embodiments, the at least one processor may be programmed to execute a method comprising determining, bused on the first motion signal and the second motion signal, one or more motion characteristics. In some embodiments, the one or more motion characteristics may include motions of the mobile device and the wearable device occurring during a predetermined time period. For example, processor 210 may be configured to analyze the first and second motion signal to determine one or more motion characteristics associated with mobile device 120 and/or wearable device 110. Determining motion characteristics may include, for example, determining whether one or both of mobile device 120 and/or wearable device 110 are still or moving. Additionally or alternatively, determining motion characteristics may include, for example, determining a change in position, a change in velocity, a change in direction, etc., of one or both of mobile device 120 and/or wearable device 110. FIG. 69B illustrates an exemplary situation when user 100 is moving but wearable device 110 is not moving, consistent with the disclosed embodiments. In particular, FIG. 69B illustrates a situation in which user 100 has forgotten to wear his or her wearable device 110. For example, as illustrated in FIG. 69B, wearable device 110 is located on table 6960 in an environment 6900 of user 100. As also illustrated in FIG. 69B, user 100 and, therefore, mobile device 120 carried by user 100 is moving away from table 6960 in a direction 6962. For example, user 100 and mobile device 120 are located at position Pₜ at time t₂ and at position P₂ at time t₂. In the example, of FIG. 69B, a motion characteristic associated with wearable device 110 is that of no movement (or no motion) during a time period Dt from time t₁ to t₂. On the other hand, a motion characteristic associated with a mobile device 120 that may be carried by user 100 has a motion characteristic of moving from a position P₁ to a position P₂ during time period Dt from t₁ to t₂.

FIG. 69C illustrates a situation in which user 100 has forgotten to carry his or her smartphone (e.g., mobile device 120). For example, as illustrated in FIG. 69B, mobile device 120 is located on table 6960 in an environment 6900 of user 100. As also illustrated in FIG. 69B, user 100 and, therefore, wearable device 110 being worn by user 100 is moving away from table 6960 in a direction 6962. For example, user 100 and wearable device 110 are located at position P₁ at time t₁ and at position P₂ at time t₂. In the example, of FIG. 69C, a motion characteristic associated with mobile device 120 is that of no movement (or no motion) during a time period Dt from time t₁ to t₂. On the other hand, a motion characteristic associated with a wearable device 110 that may be worn by user 100 has a motion characteristic of moving from a position P₁ to a position P₂ during time period Dt from t₁ to t₂.

FIG. 69D illustrates another exemplary situation when user 100 is not moving but mobile device 120 is moving, consistent with the disclosed embodiments. In particular, FIG. 69C illustrates a situation in which user 100 has forgotten his mobile device 120 in vehicle 6970. For example, as illustrated in FIG. 69C, user 100 is wearing wearable device 110. As also illustrated in FIG. 69B, however, a smartphone (e.g., mobile device 120) associated with user 100 is in vehicle 6970, which is moving away from user 100 in a direction 6972. For example, vehicle 6970 (with mobile device 120) is located at position P₁ at time t₁ and at position P₂ at time t₂. In the example, of FIG. 69D, a motion characteristic associated with mobile device 120 is that of movement from a position P₁ to a position P₂ during a time period Dt from t₁ to t₂. On the other hand, a motion characteristic associated with a wearable device 110 that may be worn by user 100 has a motion characteristic of not moving (or no motion) during the time period Dt from t₁ to t₂.

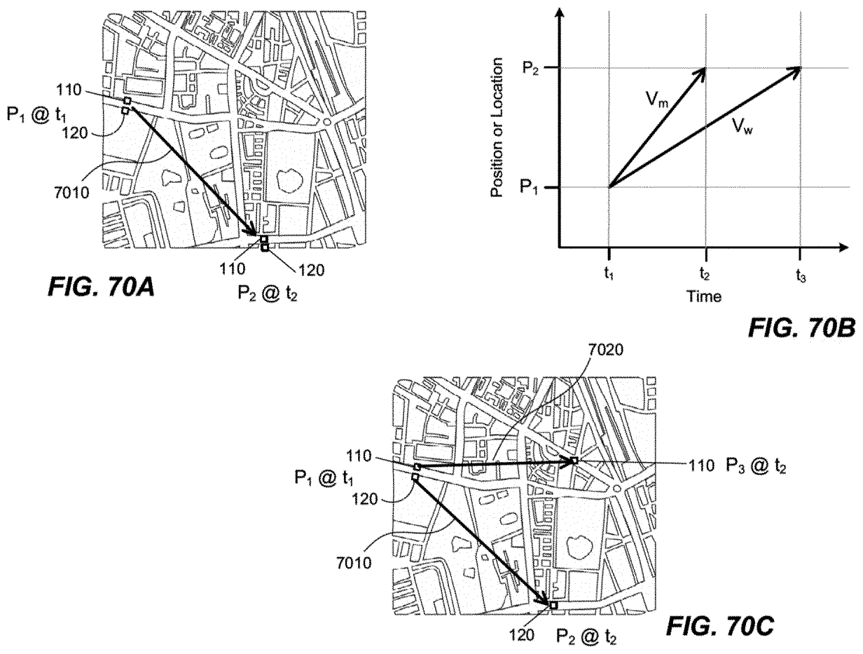

In some embodiments, the one or more motion characteristics may include changes in locations of the mobile device and the wearable device occurring during a predetermined time period. For example, processor 210 may be configured to analyze the first motion signal received from a mobile device 120 and/or a wearable device 110 associated with user 100 to determine positions of mobile device 120 and the wearable device 110 at different times. For example, a position sensor 6952 associated with a mobile device 120 associated with user 100 may generate signals indicative of positions of mobile device 120 during a time period Dt from time t₁ to t₂. Similarly, a position sensor 6952 associated with a wearable device 110 may generate signals indicative of positions of wearable device 110 during a time period Dt from time t₁ to t₂. FIG. 70A illustrates an exemplary section of a map showing the positions of wearable device 110 and mobile device 120 at times t₁ and t₂. For example, as illustrated in FIG. 70A, both mobile device 120 and wearable device 110 are located at position P₁ on the map at time t₁. Similarly, in the example of FIG. 70A, both mobile device 120 and wearable device 110 are located at position P₂ on the map at time t₂. In the example of FIG. 70A, a notion characteristic associated with mobile device 120 is that of movement from a position P₁ to a position P₂ during a time period Dt from t₁ to t₂. Similarly, as illustrated in FIG. 70A, a motion characteristic associated with wearable device 110 is that of movement from a position P₁ to a position P₂ during a time period Dt from t₁ to t₂.

In some embodiments, the one or more motion characteristics may include rates of change of locations of the mobile device and the wearable device occurring during a predetermined time period. For example, both mobile device 120 and wearable device 110 may move from position P₁ to P₂. However, mobile device 120 and wearable device 110 may be travelling at different rates or speeds. FIG. 70B illustrates an exemplary situation in which wearable device 110 may move from position P₁ at time t₁ to position P₂ at time t₃. This is illustrated by the arrow labeled V_{w} in FIG. 70B. As also illustrated in FIG. 70B, mobile device 120 may move from position Pₜ at time t₁ to position P₂ at time t₂, where time t₃ is greater than time t₂. This is illustrated by the arrow labeled Vₘ in FIG. 70B. As illustrated in FIG. 70B, a rate of change of location (e.g., V_{w}) for wearable device 110 is relatively slower than a rate of change of location (e.g., Vₘ) for mobile device 120. In the example of FIG. 70B, a motion characteristic associated with wearable device 110 may be a rate of change of location or speed V_{w}, which may be given by (P₂−P₁)/(t₃−t₁). On the other hand, as illustrated in FIG. 70B, a motion characteristic associated with mobile device 120 may be a rate of change of location or speed Vₘ, which may be given by (P₂−P₁)/(t₂−t₁). Because t₃ is greater than t₂, however, speed V_{w} of the wearable device 110 may be smaller than a speed Vₘ of the mobile device 120 in the example of FIG. 70B. It will also be appreciated that at one or more points in time between t₁ and t₃, the positions of wearable device 110 and mobile device 120 will be different.

In some embodiments, the one or more motion characteristics may include directions of motions of the mobile device and the wearable device occurring during a predetermined time period. For example, when user 100 is wearing wearable device 110 and is also carrying mobile device 120, a direction of motion of both mobile device 120 and wearable device 110. On the other hand, if user 100 is not carrying one of wearable device 110 or mobile device 120, in some situations, wearable device 110 and mobile device 120 may be moving in different directions. For example, as illustrated in FIG. 70A, both wearable device 110 and mobile device 120 may be located at position P₁ at time t₁ and at position P₂ at time t₂. This may occur, for example, when user 100 is wearing wearable device 110 and carrying mobile device 120 with him as user 100 travels from position P₁ to P₂. Thus, in this example, directions of motion of both wearable device 110 and mobile device 120 may correspond to direction 7010.

As illustrated in FIG. 70C, both wearable device 110 and mobile device 120 may be located at position P₁ at time t₁. However, at time t₂, wearable device 110 may be located at position P₃, whereas mobile device 120 may be located at position P₂. This may occur, for example, when user 100 is wearing wearable device 110 and travels from position P₁ to P₃, but user 100 may have left mobile device 120 in a cab that travelled from position P₁ to P₂ in the same time period Dt from time t₁ to t₂. As illustrated in FIG. 70C, in this situation, a motion characteristic associated with wearable device 110 may be direction 7020 of the change of location of wearable device 110, whereas a motion characteristic associated with mobile device 120 may be direction 7010 of the change of location of mobile device 120.

In some embodiments, the one or more motion characteristics associated with the user may be indicative of walking or running by the user. For example, the change of location, change of direction, or rate of change of location of wearable device 110 and/or mobile device 120 may be indicative of a particular type of movement (e.g., walking or running) by user 100. For example, user 100 may typically walk from location P₁ to P₂ (e.g., from user 100's home to a park, grocery store, or coffee shop, etc.) during a particular time period (e.g., particular time of the day, morning, between 7 AM and 8 AM, etc.). Thus, a motion characteristic of the wearable device 110 and/or the mobile device 1240 from location P₁ to P₂ during that particular time period may be indicative of user 100 walking. By way of another example, user 100 may go for a run during a particular time in the afternoon. A rate of change of location from P₁ (e.g., user 100's home) to location P₃ during that particular time in the afternoon may correspond to user 100 running between locations P₁ and P₃. Thus, a motion characteristic of the wearable device 100 and/or the mobile device 120 corresponding to a particular speed during afternoon may be indicative of user 100 running between locations P₁ and P₃.

In some embodiments, the one or more motion characteristics associated with the user may be unique to the user, may be learned through prior interaction with the user, and may be represented in at least one database accessible by the at least one processor. For example, locations P₁, P₂, P₃, a rate of change of location from P₁ to P₂ or P₁ to P₃, etc., during specific times of the day may be unique to user 100 and may correspond to actions taken by user 100 (e.g., walking to the park, or going for a run). Processor 210 may train a machine learning algorithm or neural network using data based on prior interactions with user 100. Examples of such machine learning algorithms may include support vector machines, Fisher's linear discriminant, nearest neighbor, k nearest neighbors, decision trees, random forests, neural networks, and so forth. For example, processor 210 may train a machine learning algorithm or neural network using location, time, speed, acceleration or other data associated with movements of user 100 and corresponding movements (or lack of movement) of wearable device 110 and/or mobile device 120 that may be collected over a period of time. Thus, these past interactions of user 100 may help to train the machine learning algorithm or neural network to detect a particular motion characteristic of wearable device 110 and/or mobile device 120. It is also contemplated that data such as location, time, speed, acceleration or other data associated with movements of user 100 and corresponding movements (or lack of movement) of wearable device (e.g., apparatus 110) and/or the mobile device (e.g., smartphone, computing device 120) and associated motion characteristics may be stored in a database (e.g., database 2760, 3070, 3370, etc.) It is further contemplated that the trained machine learning algorithm or neural network may also be stored in one or more databases 2760, 3070, 3370, etc.

In some embodiments, the at least one processor may be programmed to execute a method comprising determining, based on the first motion signal and the second motion signal, whether the mobile device and the wearable device differ in one or more motion characteristics. As discussed above, processor 210 may determine the one or more motion characteristics associated with wearable device 110 and/or mobile device 120. Further, processor 210 may determine whether one or more motion characteristics associated with wearable device 110 are different from one or more motion characteristics associated with mobile device 120. By way of example, consider the situation in FIG. 69B or 69C. In these two exemplary situations, one of wearable device 110 or mobile device 120 is still (i.e., stationary) while the other of wearable device 110 or mobile device 120 is moving. Thus, in these exemplary situations, at least some motion characteristics (e.g., locations over a predetermined time period) of wearable device 110 differ from corresponding motion characteristics of mobile device 120. Similarly, consider the exemplary situation illustrated in FIG. 70B in which a rate of change of location (e.g., speed) Vₘ of mobile device 120 may be greater than the rate of change of location, V_{w}, of wearable device 110. Thus, in this exemplary situation, at least some motion characteristics (e.g., rates of change of locations over a predetermined time period) of wearable device 110 differ from corresponding motion characteristics of mobile device 120. In some embodiments, the determining may comprise determining whether the mobile device and the wearable device share all motion characteristics. For example, consider the exemplary situation in FIG. 70A. In this example, both wearable device 110 and mobile device 120 travel from position P₁ at time t₁, to position P₂ at time t₂. Thus, in this exemplary situation, wearable device 110 and mobile device 120 may share all motion characteristics (e.g., locations over a predetermined time period).

In some embodiments, determining whether the mobile device and the wearable device share the one or more motion characteristics includes determining whether the first motion signal and the second motion signal differ relative to one or more thresholds. For example, it is contemplated that processor 210 may determine one or more differences between various parameters (e.g., positions, speeds, accelerations, velocities, directions of movement, etc., over one or more periods of time) associated with wearable device 110 and mobile device 120. It is contemplated that differences may be obtained in many ways, for example, vector distance, cosine distance, or by performing other mathematical operations known in the art for determining differences. By way of example, processor 210 may determine differences between the positions of wearable device 110 and mobile device 120 over a plurality of time periods. Furthermore, processor 210 may compare the determined differences with one or more thresholds. Processor 210 may determine that wearable device 110 and mobile device 120 share one or more motion characteristics when the corresponding differences are about zero, or are less than corresponding correlation thresholds. It is contemplated that differences may be determined based on other parameters, for example, velocities or speeds of wearable device 110 and mobile device 120 over one or more time periods, accelerations of wearable device 110 and mobile device 120 over one or more time periods, etc. It is further contemplated that the determined differences may be compared with corresponding thresholds to determine whether wearable device 110 and mobile device 120 share one or more motion characteristics.

In some embodiments, the at least one processor may be programmed to execute a method comprising providing an indication to a user based on a determination that the mobile device and the wearable device differ in at least one of the one or more motion characteristics. For example, when wearable device 110 and mobile device 120 do not share motion characteristics, it is likely that user 100 may have only one of wearable device 110 or mobile device 120 on his or her person. The disclosed system is configured to provide an indication to user 100 that either wearable device 110 or mobile device 120 is not currently being carried by user 100. Such an indication may include, for example, a reminder to user 100 to wear wearable device 110 or to remember to pick up mobile device 120 (e.g., smartphone).

In some embodiments, the indication may comprise at least one of an audible, a visual, or a haptic indication. In some embodiments, at least one of the mobile device or the wearable device may be configured to provide the indication to the user. Thus, for example, either wearable device 110 or mobile device 120, or both may be configured to provide the indication to user 100. Thus, for example, processor 210 may be configured to communicate information including the indication to feedback-outputting unit 230, which may include any device configured to provide information to user 100. Feedback outputting unit 230 may be provided as part of wearable device 110 (as shown) or may be provided external to wearable device 110 and may be communicatively coupled thereto. For example, feedback-outputting unit 230 may comprise audio headphones, a hearing aid type device, a speaker, a hone conduction headphone, interfaces that provide tactile cues, vibrotactile stimulators, etc. In some embodiments, processor 210 may communicate signals with an external feedback outputting unit 230 via a wireless transceiver 530, a wired connection, or some other communication interface.

Feedback outputting unit 230 may include one or more systems for providing an indication to user 100. Processor 210 may be configured to control feedback outputting unit 230 to provide an indication to user 100 when wearable device 110 and mobile device 120 do not share one or more motion characteristics. In the disclosed embodiments, the audible, visual, or haptic indication may be provided via any type of connected audible, visual, and/or haptic system. For example, audible indication may be provided to user 100 using a Bluetooth™ or other wired or wirelessly connected speaker, a smart speaker, an in-home or in-vehicle entertainment system, or a bone conduction headphone. In some embodiments, the indication may be provided by a secondary device associated with the user. In some embodiments, the secondary device associated with the user may comprise one of a laptop computer, a desktop computer, a smart speaker, headphones, an in-home entertainment system, or an in-vehicle system. For example, feedback outputting unit 230 of some embodiments may additionally or alternatively produce a visible output of the indication to user 100, for example, as part of an augmented reality display projected onto a lens of glasses 130 or provided via a separate heads up display in communication with apparatus 110, such as a display 260. For example, display 260 for providing a visual indication may be provided as part of computing device 120, which may include an onboard automobile heads up display, an augmented reality device, a virtual reality device, a smartphone, a laptop, a desktop computer, tablet, an in-home entertainment system, an in-vehicle system, etc. In some embodiments, feedback outputting unit 230 may include interfaces that provide tactile cues, vibrotactile stimulators. etc. for providing a haptic indication to user 100. As also discussed above, in some embodiments, the secondary computing device (e.g., Bluetooth headphone, laptop, desktop computer, smartphone, etc.) may be configured to be wirelessly linked to wearable device 110 or mobile device 120.

In some embodiments, the mobile device may be configured to provide the indication to the user when the wearable device is determined to be still and the mobile device is determined to be in motion. By way of example, consider the situation of FIG. 69B. In this example, user 100 is moving away from table 6960, from position P₁ to position P₂. Moreover, as illustrated in FIG. 69B, user 100 is wearing mobile device 120 (e.g., smartphone) on his or her belt. However, wearable device 110 is located on table 6960 and is still (i.e., not moving). In this case a processor (e.g., 540) of mobile device 120 may be configured to provide an indication to user 100 that user 100 is not wearing wearable device 100.

In some embodiments, the wearable device is configured to provide the indication to the user when the mobile device is determined to be still and the wearable device is determined to be in motion. By way of example, consider the situation of FIG. 69C. In this example, user 100 is moving away from table 6960 from position P₁ to position P₂. Moreover, as illustrated in FIG. 69B, user 100 is wearing wearable device 110. However, user 100 appears to have forgotten to carry his or her smartphone (e.g., mobile device 120). Thus, mobile device 120 is located on table 6960 and is stationary (i.e., not moving). In this case a processor (e.g., 210) of wearable device 110 may be configured to provide an indication to user 100 that user 100 is not carrying mobile device 120.

In some embodiments, the mobile device is configured to provide the indication to the user when both the mobile device and the wearable device are determined to be moving, the mobile device is determined to be moving with one or more characteristics associated with a motion of the user, and the wearable device is determined to be moving with other one or more motion characteristics. By way of example, consider the situation illustrated in FIG. 70C. In this example, both wearable device 110 and mobile device 120 are moving. However, mobile device 120 may move from position P₁ to position P₂, while wearable device 110 may move from position P₁ to position P₃ as illustrated in FIG. 70C. For example, user 100 may be carrying his or her smartphone (e.g., mobile device 120) as user 100 moves from position P₁ to position P₂. However, user 100 may have forgotten his or her wearable device 110 in a cab or in another person's possession and that cab or person may move from position P₁ to P₃ as illustrated in FIG. 70C. Thus, mobile device 120 may be moving with motion characteristics (e.g., locations, rate of change of locations, etc.) of user 100, whereas wearable device 110 may not be moving with the motion characteristics of user 100. Rather, wearable device 110 in this example may be moving with the motion characteristics of the cab or the other person carrying wearable device 110. In this exemplary situation, processor 540 of mobile device 120 (e.g., smartphone) may provide an indication to user 100 that user 100 is not wearing wearable device 110.

In some embodiments, the wearable device is configured to provide the indication to the user when both the mobile device and the wearable device are determined to be moving, the wearable device is determined to be moving with one or more characteristics associated with motion of the user, and the mobile device is determined to be moving without the one or more motion characteristics associated with the user. Consider again the example illustrated in FIG. 70C. In this example, both wearable device 110 and mobile device 120 are moving. However, mobile device 120 may move from position P₁ to position P₂, while wearable device 110 may move from position P₁ to position P₃ as illustrated in FIG. 70C. For example, user 100 may be wearing wearable device 110 as user 100 moves from position P₁ to position P₃. However, user 100 may have forgotten his or her smartphone (e.g., mobile device 120) in a cab and that cab move from position P₁ to P₂ as illustrated in FIG. 70C. Thus, wearable device 110 may be moving with motion characteristics (e.g., locations, rate of change of locations, etc.) of user 100, whereas mobile device 120 may not be moving with the notion characteristics of user 100. Rather, mobile device 120 in this example may be moving with the motion characteristics of the cab carrying mobile device 120. In this exemplary situation, processor 210 of wearable device 110 may provide an indication to user 100 that user 100 is not carrying his or her mobile device 120.

In some embodiments, the at least one processor may be further programmed to determine a battery level associated with the wearable device and provide, to the user, the indication representative of the determined battery level associated with the wearable device. Fr example, as discussed above, apparatus 110 may be powered using a battery (e.g., battery 442, FIG. 4E). Processor 210 may be configured to determine a battery level of battery 442. Battery level may be determined in many ways. For example, processor 210 may employ one or more electronic circuits such as resistors, capacitors, voltage detectors, current detectors, etc., to determine one or more parameters indicative of a battery level of battery 442. These parameters may include, for example, voltage output of battery 442, maximum current output of battery 442, a total amount of charge or energy remaining in battery 442, etc. Processor 210 may be configured to provide an indication regarding the determined battery level in a manner similar to the indications discussed above. For example, processor 210 may communicate with feedback unit 230 to provide the indication to user 100 using one or more of the techniques discussed above. The indication may include graphical, numerical, textual, audio, or haptic indication of, for example, a voltage level, current level, amount of charge, or amount of energy of battery 442. It is also contemplated that in some embodiments the indication may include a percentage of charge or energy remaining, or an indication of an amount of time after which the battery may be discharged and unable to power wearable device 110.

In some embodiments, the at least one processor may be programmed to determine, based on the first motion signal and the second motion signal, whether both the mobile device and the wearable device have been motionless for a predetermined period of time. For example, both wearable device 110 and mobile device 120 may be located on table 6960 during the night when user 100 may be sleeping. Processor 210 may determine changes in location, rates of changes or location, etc., of wearable device 110 and/or mobile device 120. By way of example, when the first and/or second motion signals indicate that mobile device 120 and/or wearable device 110, respectively, have not changed locations, processor 210 may determine that mobile device 120 and/or wearable device 110 have been motionless. By way of another example, when the first and/or second motion signals indicated that the rates of change of location of mobile device 120 and/or wearable device 110, respectively, are about equal to zero, processor 210 may determine that mobile device 210 and/or wearable device 110 have been motionless. Processor 210 may also determine an amount of time for which wearable device 110 and/or mobile device 120 have been motionless. For example, processor 210 may use one or more clock circuits in wearable device 110, mobile device 120, and/or one or more clock circuits associated with processor 210 to determine the amount of time for which wearable device 110 and/or mobile device 120 have been motionless (e.g., remained at the same location and/or had near zero speed/velocity/acceleration, etc.)

In some embodiments, the at least one processor may be programmed to determine whether both the mobile device and the wearable device have been motionless for a predetermined period of time based on an absence of the second motion signal received at the mobile device for at least part of the predetermined period of time. For example, processor 210 may periodically receive the first and second motion signals from mobile device 120 and wearable device 110. Position sensors 6950 and/or 6952 on mobile device 120 and/or wearable device 110 may, however, he configured to cease generating and transmitting the first and/or second motion signals when, for example, mobile device 120 and/or wearable device 110 are motionless (e.g., remain at the same location or have near zero velocity/acceleration etc.). By way of example, sensors 6950 and/or 6952 may be configured to cease generating and transmitting the first and/or second motion signals when mobile device 120 and/or wearable device 110 are motionless for a threshold amount of time. Processor 210 may be configured to determine that mobile device 120 and/or wearable device 110 are motionless when, for example, processor 210 does not receive signals from sensors 6950, 6952 associated with mobile device 120 and/or wearable device 110, respectively. As discussed above, processor 210 may use one or more clock circuits to determine an amount of time for which the first and second motion signals have not been received from sensors 6950 or 6952. Processor 210 may be configured to determine that mobile device 120 and/or wearable device 110 are motionless when the determined amount of time exceeds the threshold amount of time.

In some embodiments, the at least one processor may be programmed to send an interrogation signal to the wearable device from the mobile device upon an indication by the first motion signal of motion associated with the mobile device occurring after the predetermined period of time. As discussed above, processor 210 may be configured to determine that mobile device 120 and/or wearable device 110 are motionless for a predetermined period of time. It is contemplated that mobile device 120 may begin to move after the predetermined period of time, for example, when user 100 carries mobile device 120 and begins walking, running, etc., after the predetermined period of time. In response, processor 540 of mobile device 120 may be configured to send an interrogation signal to wearable device 110. In some embodiments, the interrogation signal may be configured to wake one or more components of the wearable device to reinitiate transmission to the mobile device of the second motion signal. By way of example, the interrogation signal may be designed to wake up one or more processors and/or circuits within wearable device 110 and cause wearable device 110 to begin performing its functions, including, for example, generating and transmitting the second motion signal indicative of a location, change of location, etc., of wearable device 110.

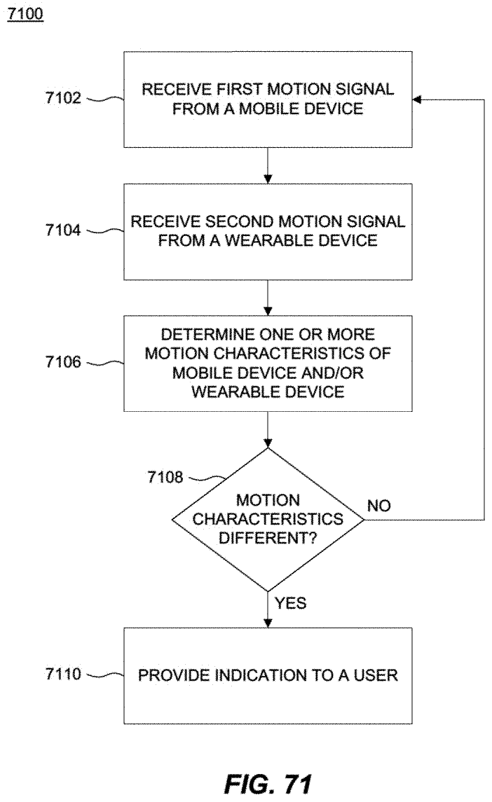

FIG. 71 is a flowchart showing an exemplary process 7100 for providing an indication to a user. Process 7100 may be performed by one or more processors associated with apparatus 110, such as processor 210 or by one or more processors (e.g., 540) associated with computing device 120 and/or server 250. In some embodiments, some or all of process 7100 may be performed on processors external to apparatus 110 (e.g., processors of computing device 120, server 250, etc.). For example, one or more portions of process 7100 may be performed by processors in hearing aid device 230, or in an auxiliary device, such as computing device 120 or server 250.

In step 7102, process 7100 may include a step of receiving a first motion signal from a mobile device. For example, as discussed above, motion sensor (e.g., accelerometer 6950 or location sensor 6952) of mobile device 120 may sense a motion or change in velocity or acceleration of mobile device 120. Sensors 6950 and/or 6952 may periodically or continuously generate signals representative of the detected motion (e.g., change in location or change in velocity or acceleration) of mobile device 120. Processor 210 may be configured to receive the one or more first motion signals generated by sensors 6950 and/or 6952 associated with mobile device 120, wirelessly or via wired connections. As discussed above, these first motion signals may be indicative of outputs or signals generated by at least one of motion sensor 6950 or location sensor 6952 associated with mobile device 120.

In step 7104, process 7100 may include a step of receiving a second motion signal from a wearable device. For example, as discussed above, motion sensor (e.g., accelerometer 6950 or location sensor 6952) of wearable device 110 may sense a motion or change in velocity or acceleration of wearable device 110. In another example, position sensor (e.g., GPS) of wearable device 110 may sense a position of wearable device 110. Sensors 6950 and/or 6952 may periodically or continuously generate signals representative of the detected motion (e.g., change in location or change in velocity or acceleration) of wearable device 110. Processor 210 may be configured to receive the one or more first motion signals generated by sensors 6950 and/or 6952 associated with wearable device 110, wirelessly or via wired connections. As discussed above, these second motion signals may be indicative of outputs or signals generated by at least one of motion sensor 6950 or location sensor 6952 associated with wearable device 110.

In step 7106, process 7100 may include a step of determining one or more motion characteristics of the mobile device and/or the wearable device. For example, processor 210 may be configured to analyze the first and second motion signals to determine one or more motion characteristics associated with mobile device 120 and/or wearable device 110. Determining motion characteristics may include, for example, determining whether one or both of mobile device 120 and/or wearable device 110 are still (i.e., not moving) or moving. Additionally or alternatively, determining motion characteristics may include, for example, determining a change in position, a change in velocity or acceleration, a change in direction, etc., of one or both of mobile device 120 and/or wearable device 110.

In step 7108, process 7100 may include a step of determining whether the motion characteristics of the mobile device and the wearable device am different. As discussed above, processor 210 may determine the one or more motion characteristics associated with a wearable device 110 and/or a mobile device 120. Further, processor 210 may determine whether one or more motion characteristics associated with wearable device 110 are shared with (e.g., are the same as or correlated with) one or more motion characteristics associated with mobile device 120, or one or more motion characteristic is different therebetween. Thus, for example, processor 210 may determine whether changes in location or rates of change of location of the mobile device and wearable device are similar (e.g., the difference is below a threshold) or different using one or more of the techniques discussed above.

In step 7108, when it is determined that the motion characteristics are not different (Step 7108: No), process 7100 may return to step 7102. In step 7108, when it is determined, however, that at least one motion characteristic is different (Step 7108: Yes), process 7100 may proceed to step 7110. In step 7110, process 7100 may include a step of providing an indication to a user. For example, when wearable device 110 and mobile device 120 do not share motion characteristics, it is likely that user 100 is carrying only one of wearable device 110 or mobile device 120. The disclosed system is configured to provide an indication to user 100 that either wearable device 110 or mobile device 120 is not being carried by user 100. Such an indication may include, for example, a reminder to user 100 to wear wearable device 110 or to pick up the user's mobile device 120. The indication to user 100 may be provided using one or more of the techniques described above.

The disclosed embodiments may include the following:

A system comprising: a camera configured to capture images from an environment of a user and output a plurality of image signals, the plurality of image signals including at least a first image signal and a second image signal; a microphone configured to capture sounds from an environment of the user and output a plurality of audio signals, the plurality of image signals including at least a first audio signal and a second audio signal; and at least one processor programmed to execute a method, comprising: receiving the plurality of image signals output by the camera; receiving the plurality of audio signals output by the microphone; recognizing, based on at least one of the first image signal or the second audio signal, at least one individual in a first environment of the user; applying a context classifier to classify the first environment of the user into one of a plurality of contexts, based on information provided by at least one of the first image signal, the first audio signal, an external signal, or a calendar entry; associating, in at least one database, the at least one individual with the context classification of the first environment; subsequently recognizing, based on at least one of the second image signal or the second audio signal, the at least one individual in a second environment of the user; and providing, to the user, at least one of an audible, visible, or tactile indication of the association of the at least one individual with the context classification of the first environment.
wherein the camera comprises a video camera and wherein the plurality of image signals comprises a plurality of video signals.
wherein the camera and the at least one microphone are each configured to be worn by the user.
wherein the camera and the microphone are included in a common housing.
wherein the at least one processor is included in the common housing.
wherein the common housing is configured to be worn by a user.
wherein recognizing the at least one individual comprises analyzing at least the second audio signal in order to identify a voice of the at least one individual.
wherein recognizing the at least one individual comprises analyzing at least the second image signal to identify at least one of a face, a posture, or a gesture associated with the at least one individual.
wherein the context classifier is at least one of: a machine learning model trained on one or more training examples, or a neural network.
wherein the plurality of contexts include at least a work context and a social context.
wherein the external signal is one of a location signal or a Wi-Fi signal.
wherein providing an indication of the association comprises providing the indication via a secondary computing device, the secondary computing device comprising at least one of a mobile device, a laptop computer, a desktop computer, a smart speaker, an in-home entertainment system, or an in-vehicle entertainment system.
wherein the secondary computing device is configured to be wirelessly linked to the camera and the microphone.
wherein providing an indication of the association comprises providing at least one of a start entry of the association, a last entry of the association, a frequency of the association, a time-series graph of the association, or a context classification of the association.
wherein providing an indication of the association comprises displaying, on a display, at least one of a bar chart, a pie chart, a histogram, a Venn diagram, a gauge, a heat map, a color intensity indicator; or a diagram including second images of a plurality of individuals including the at least one individual, the second images displayed in a same order as the individuals were positioned at a time when the images were captured.
wherein the display is provided on one of a mobile device, a laptop computer, a desktop computer, an in-home entertainment system, or an in-vehicle entertainment system.
wherein providing an indication of the association comprises providing a haptic indication as to whether the individual is known to the user.

A method for associating individuals with context, the method comprising: receiving a plurality of image signals output by a camera configured to capture images from an environment of a user, the plurality of image signals including at least a first image signal and a second image signal; receiving a plurality of audio signals output by a microphone configured to capture sounds from an environment of the user, the plurality of audio signals including at least a first audio signal and a second audio signal; recognizing, based on at least one of the first image signal or the first audio signal, at least one individual in a first environment of the user; applying a context classifier to classify the first environment of the user into one of a plurality of contexts, based on information provided by at least one of the first image signal, the first audio signal, an external signal, or a calendar entry; associating, in at least one database, the at least one individual with the context classification of the first environment; subsequently recognizing, based on at least one of the second image signal or the second audio signal, the at least one individual in a second environment of the user; and providing, to the user, at least one of an audible, visible, or tactile indication of the association of the at least one individual with the context classification of the first environment.

A non-transitory computer readable medium containing instructions that when executed by at least one processor, cause the at least one processor to perform a method, the method comprising: receiving a plurality of image signal output by a camera configured to capture images from an environment of a user, the plurality of image signals including at least a first image signal and a second image signal; receiving a plurality of audio signal output by a microphone configured to capture sounds from an environment of the user, the plurality of audio signals including at least a first audio signal and a second audio signal; recognizing, based on at least one of the first image signal or the first audio signal, at least one individual in a first environment of the user; applying a context classifier to classify the first environment of the user into one of a plurality of contexts, based on information provided by at least one of the first image signal, the first audio signal, an external signal, or a calendar entry; associating, in at least one database, the at least one individual with the context classification of the first environment; subsequently recognizing, based on at least one of the second image signal or the second audio signal, the at least one individual in a second environment of the user; and providing, to the user, at least one of an audible, visible, or tactile indication of the association of the at least one individual with the context classification of the first environment.

A system comprising: a camera configured to capture a plurality of images from an environment of a user and at least one processor programmed to execute a method, the method comprising: receiving an image signal comprising the plurality of images; detecting an unrecognized individual shown in at least one of the plurality of images taken at a first time; determining an identity of the detected unrecognized individual based on acquired supplemental information; accessing at least one database and comparing one or more characteristic features associated with the detected unrecognized individual with features associated with one or more previously unidentified individuals represented in the at least one database; based on the comparison, determining whether the detected unrecognized individual corresponds to any of the previously unidentified individuals represented in the at least one database; and if the detected unrecognized individual is determined to correspond to any of the previously unidentified individuals represented in the at least one database, updating at least one record in the at least one database to include the determined identity of the detected unrecognized individual.
wherein the method further comprises providing, to the user, at least one of an audible or visible indication associated with the at least one updated record.
wherein the supplemental information includes one or more inputs received from a user of the system.
wherein the one or more inputs include a name of the detected unrecognized individual.
wherein the name is inputted by the user via a microphone associated with the system.
wherein the supplemental information includes a name associated with the detected unrecognized individual, the name being determined by the at least one processor through analysis of an audio signal received from a microphone associated with the system.
wherein the at least one processor is further configured to prompt the user of the system to confirm that the name correctly corresponds to the detected unrecognized individual.
wherein the supplemental information includes a name associated with the detected unrecognized individual, the name being determined by the at least one processor by accessing at least one entry of an electronic calendar associated with a user of the system, wherein the at least one entry is determined to overlap in time with a time at which the unrecognized individual was detected in at least one of the plurality of images.
wherein the at least one processor is configured to prompt the user of the system to confirm that the name correctly corresponds to the detected unrecognized individual, wherein the prompt includes a visual prompt on a display associated with the system, and wherein the prompt shows the name together with the face of the detected unrecognized individual.
wherein the at least one processor is configured to update the at least one database with the name, at least one identifying characteristic of the detected unrecognized individual, and at least one informational aspect associated with the at least one entry of the electronic calendar associated with the user of the system.
wherein the at least one informational aspect associated with the at least one entry includes one or more of a meeting place, a meeting time, or a meeting topic.
wherein the characteristic features include at least one of a facial feature determined based on analysis of the image signal, or a voice feature determined based on analysis of an audio signal provided by a microphone associated with the system.
wherein determining whether the detected unrecognized individual corresponds to any of the previously unidentified individuals represented in the at least one database is based on at least one of: a machine learning algorithm trained on one or more training examples, or a neural network.
wherein the system further comprises: a microphone configured to capture sounds from an environment of the user and output an audio signal.
wherein the camera, the microphone, and the at least one processor are included in a common housing.
wherein the common housing is configured to be worn by a user.

A system comprising: a camera configured to capture a plurality of images from an environment of a user; and at least one processor programmed to execute a method, the method comprising: receiving an image signal comprising the plurality of images; detecting a first individual and a second individual shown in the plurality of images; determining an identity of the first individual and an identity of the second individual; and accessing at least one database and storing in the at least one database one or more indicators associating at least the first individual with the second individual.
wherein the one or more indicators includes a time, date or place during which the first individual and the second individual were encountered together.
wherein the one or more indicators includes information from at least one entry of an electronic calendar associated with the user.
wherein the first individual and the second individual appear together within at least one of the plurality of images.
wherein the first individual appears in a first one of the plurality of images captured at a first time, and the second individual appears, without the first individual, in a second one of the plurality of images captured at a second time different from the first time, and wherein the first and second times are separated by less than a predetermined time period.
wherein the predetermined time period is less than one hour.
wherein the predetermined time period is less than one minute.
wherein the predetermined time period is less than one second.
wherein determining the identity of the first individual and the identity of the second individual includes comparing one or more characteristics of the first individual and the second individual with stored information from the at least one database.
wherein the one or more characteristics include at least one of facial features determined based on analysis of the plurality of images or voice features determined based on analysis of an audio signal provided by a microphone associated with the system.
wherein the at least one processor is configured to: receive a search query from a user of the system, wherein the search query indicates the first individual; access the at least one database to retrieve information about the first individual; and provide the retrieved information to the user, wherein the information includes at least an identity of the second individual.
wherein the at least one processor is configured to: detect a subsequent encounter with the first individual through analysis of the plurality of images; access the at least one database to retrieve information about the first individual; and provide the retrieved information to the user, wherein the information includes at least an identity of the second individual.
wherein the at least one processor is configured to: detect a plurality of individuals through analysis of the plurality of images; identify the first individual from among the plurality of individuals by comparing at least one characteristic of the first individual, determined based on analysis of the plurality of images, with information stored in the at least one database; identify at least the second individual from among the plurality of individuals based on the one or more indicators stored in the at least one database associating the second individual with the first individual.

A system comprising: a camera configured to capture a plurality of images from an environment of a user; and at least one processor programmed to execute a method, the method comprising: receiving an image signal comprising the plurality of images; detecting a first unrecognized individual represented in a first image of the plurality of images; associating the first unrecognized individual with a first record in a database; detecting a second unrecognized individual represented in a second image of the plurality of images; associating the second unrecognized individual with the first record in a database; determining, based on supplemental information, that the second unrecognized individual is different from the first unrecognized individual; and generating a second record in the database associated with the second recognized individual.
wherein the supplemental information comprises a third image showing both the first unrecognized individual and the second unrecognized individual.
wherein the supplemental information comprises an input from the user.
wherein the supplemental information comprises a minute difference detected between the first unrecognized individual and the second unrecognized individual.

A system comprising: a camera configured to capture a plurality of images from an environment of a user; at least one processor programmed to: receive the plurality of images; detect one or more individuals represented by one or more of the plurality of images; identify at least one spatial characteristic related to each of the one or more individuals; generate an output including a representation of at least a face of each of the detected one or more individuals together with the at least one spatial characteristic identified for each of the one or more individuals; and transmit the generated output to at least one display system for causing a display to show to a user of the system a timeline view of interactions between the user and the one or more individuals, wherein representations of each of the one or more individuals are arranged on the timeline according to the identified at least one spatial characteristic associated with each of the one or more individuals.
wherein the timeline view shown to the user is interactive.
wherein the timeline view is scrollable in time.
wherein selecting a representation of a particular individual among the one or more individuals shown on the timeline causes initiation of a communication session between the user and the particular individual.
wherein the representations of each of the one or more individuals include at least one of face representations or textual name representations of the individuals.
wherein the display is included on a device configured to wirelessly link with a transmitter associated with the system.
wherein the at least one spatial characteristic is indicative of a relative distance between the user and at least one of the one or more individuals, or relative locations between the one or more individuals, during encounters between the user and the one or more individuals.
wherein the at least one spatial characteristic is indicative of an angular orientation between the user and each of the one or more individuals, or an orientation of the one or more individuals relative to a detected object in the environment of the user during encounters between the user and the one or more individuals.
wherein the detected object includes a table.
further including a microphone configured to capture sounds from the environment of the user and to output an audio signal.
wherein the at least one processor is programmed to: detect, based on analysis of the audio signal, at least one key word spoken by the user or by the one or more individuals; include in the generated output a representation of the detected at least one key word; and transmit the generated output to the at least one display system for causing the display to show to the user of the system the timeline view together with a representation of the detected at least one key word.
wherein the at least one processor is programmed to: detect, based on analysis of the audio signal, at least one key word spoken by a speaker being the user or by the one or more individuals; store the at least one key word in association with at least one characteristic selected from: the speaker, a location of the user where the at least one key word was detected, a time when the at least one key word was detected, a subject related to the at least one key word.
wherein the camera, the at least one processor and a microphone are included in a common housing configured to be worn by the user.

A graphical user interface system for presenting to a user of the system a graphical representation of a social network, the system comprising: a display; a data interface; and at least one processor programmed to: receive, via the data interface, an output from a wearable imaging system including at least one camera, wherein the output includes image representations of one or more individuals from an environment of the user along with at least one element of contextual information for each of the one or more individuals; identify the one or more individuals associated with the image representations; store, in at least one database, identities of the one or more individuals along with corresponding contextual information for each of the one or more individuals; and cause generation on the display of a graphical user interface including a graphical representation of the one or more individuals and the corresponding contextual information determined for the one or mom individuals.
wherein the at least one processor is further programmed to store, in the at least one database, image representations of unidentified individuals along with the at least one element of contextual information for each of the unidentified individuals.
wherein the at least one processor is further programmed to update the at least one database with later-obtained identity information for one or more of the unidentified individuals included in the at least one database.
wherein the later-obtained identity information is determined based on at least one of: a user input, a spoken name captured by a microphone associated with the wearable imaging system, or image matching analysis performed relative to one or more remote databases.
wherein the at least one element of contextual information for each of the one or more individuals includes one or mom of: whether an interaction between the one or more individuals and the user was detected; a name associated with the one or more individuals; a time at which the user encountered the one or more individuals; a place where the user encountered the one or more individuals; an event associated with an interaction between the user and the one or more individuals; or a spatial relationship between the user and the one or more individuals.
wherein the one or more individuals include at least two individuals, and wherein the at least one element of contextual information indicates whether an interaction was detected between the at least two individuals.
wherein the at least one element of contextual information for each of the one or more individuals includes one or more of: a name associated with the one or more individuals; a time at which the user encountered the one or more individuals; a place where the user encountered the one or more individuals; an event associated with an interaction between the user and the one or more individuals; or a spatial relationship between the user and the one or mom individuals.
wherein the at least one processor is programmed to: receive a selection of an individual among the one or more individuals graphically represented by the graphical user interface; and initiate a communication session relative to the selected individual based on the received selection.
wherein the at least one processor is programmed to enable user controlled navigation associated with the one or more individuals graphically represented by the graphical user interface.
wherein the graphical user interface displays the one or more individuals in a network arrangement, and wherein the user controlled navigation includes one or more of: scrolling in at least one direction relative to the network, changing an origin of the network from the user to one of the one or more individuals, zooming in or out relative to the network, or hiding selected portions of the network.
wherein hiding of selected portions of the network is based on one or more selected filters associated with the contextual information associated with the one or more individuals.
wherein the network arrangement is three-dimensional, and the user controlled navigation includes rotation of the network arrangement.
wherein the at least one processor is programmed to: aggregate, based upon access to the one or more databases, at least a first social network associated with a first user with at least a second social network associated with a second user different from the first user; and display to at least the first or second user a graphical representation of the aggregated social network.
wherein the at least one processor is programmed to allow user controlled navigation relative to the graphical display of the aggregated social network.
wherein the graphical display of the aggregated social network identifies individual contacts associated with the first user, individual contacts associated with the second user, and individual contacts shared by the first and second users.

A system comprising: a camera configured to capture images from an environment of a user and output an image signal; a microphone configured to capture voices from an environment of the user and output an audio signal; and at least one processor programmed to execute a method, comprising: identifying, based on at least one of the image signal or the audio signal, at least one individual speaker in a first environment of the user; applying a voice classification model to classify at least a portion of the audio signal into one of a plurality of voice classifications based on at least one voice characteristic, the voice classifications denoting an emotional state of the individual speaker; applying a context classification model to classify the first environment of the user into one of a plurality of contexts, based on information provided by at least one of the image signal, the audio signal, an external signal, or a calendar entry; associating, in at least one database, the at least one individual speaker with the voice classification, and the context classification of the first environment; and providing, to the user, at least one of an audible, visible, or tactile indication of the association.
wherein the at least one voice characteristic comprises: a pitch of the individual speaker's voice, a tone of the individual speaker's voice, a rate of speech of the individual speaker's voice, a volume of the individual speaker's voice, a center frequency of the individual speaker's voice, a frequency distribution of the individual speaker's voice, or a responsiveness of the individual speaker's voice.
wherein the method further comprises analyzing the at least one audio signal to distinguish voices of two or more different speakers represented by the audio signal.
wherein analyzing the at least one audio signal to distinguish voices of two or more different speakers in the audio signal comprises distinguishing a component of the audio signal representing a voice of the user, if present among the two or more speakers, from a component of the audio signal representing a voice of the at least one individual speaker.
wherein the voice classification model is applied to the component of the audio signal representing the voice of the user.

The system of claim 4, wherein the voice classification model is applied to the component of the audio signal representing the voice of the at least one individual.
wherein the method further comprises: applying an image classification model to classify at least a portion of the image signal, the portion of the image signal representing at least one of the user, or the at least one individual, into one of a plurality of image classifications based on at least one image characteristic, the image classifications denoting an emotional state of the user, or the at least one individual.
wherein the at least one image characteristic comprises: a facial expression of the speaker, a smile, a posture of the speaker, a movement of the speaker, an activity of the speaker, or an image temperature of the speaker.
wherein the camera comprises a video camera and the image signal comprises a video signal.
wherein the camera and the at least one microphone are each configured to be worn by the user.
wherein the camera and the microphone are included in a common housing.
wherein the at least one processor is included in the common housing.
wherein identifying the at least one individual comprises recognizing a voice of the at least one individual.
wherein identifying the at least one individual comprises recognizing a face of the at least one individual.
wherein identifying the at least one individual comprises recognizing at least one of a posture, or a gesture of the at least one individual.
wherein the context classification model is based on at least one of: a neural network or a machine learning algorithm trained on one or more training examples.
wherein the plurality of contexts include at least a work context and a social context.
wherein providing an indication of the association comprises providing the indication via a secondary computing device.
wherein the secondary computing device comprises at least one of: a mobile device, a smartphone, a laptop computer, a desktop computer, a smart speaker, an in-home entertainment system, or an in-vehicle entertainment system.
wherein the secondary computing device is configured to be wirelessly linked to the system including the camera and the microphone.
wherein providing an indication of the association comprises providing at least one of a first entry of the association, a last entry of the association, a frequency of the association, a time-series graph of the association, a context classification of the association, or a voice classification of the association.
wherein providing an indication of the association comprises showing, on a display, at least one of: a bar chart, a pie chart, a histogram, a Venn diagram, a gauge, a heat map, or a color intensity indicator.
wherein the display is provided on one of: a mobile device, a smartphone, a laptop computer, a desktop computer, an in-home entertainment system, or an in-vehicle entertainment system.
wherein the method further comprises determining an emotional situation within an interaction between the user and the individual speaker.
wherein the method avoids transcribing the interaction, thereby maintaining privacy of the user and the individual speaker.

A system comprising: a camera configured to capture a plurality of images from an environment of a user; a microphone configured to capture sounds from the environment of the user; and at least one processor programmed to execute a method comprising: identifying a vocal component of the audio signal; determining whether at least one characteristic of the vocal component meets a prioritization criteria for the at least one characteristic; adjusting at least one control setting of the camera when the at least one characteristic meets the prioritization criteria; and foregoing adjustment of the at least one control setting when the at least one characteristic does not meet the prioritization criteria.
wherein the control setting comprises one of an image capture rate, a video frame rate, an image resolution, an image size, a zoom setting, an ISO setting, or a compression method used to compress the captured images.
wherein the camera and the at least one processor are included in a common housing.

The system of claim 1, wherein the at least one processor is included in a secondary computing device wirelessly linked to the camera and the microphone.

The system of claim 5, wherein the secondary computing device comprises at least one of a mobile device, a laptop computer, a desktop computer, a smartphone, a smartwatch, a smart speaker, an in-home entertainment system, or an in-vehicle entertainment system.
wherein the camera comprises a transmitter configured to wirelessly transmit the captured images to a receiver coupled to the at least one processor.
wherein identifying the vocal component comprises analyzing the audio signal to distinguish voices of one or more speakers in the audio signal.
wherein analyzing the audio signal comprises distinguishing a component of the audio signal representing a voice of the user.
wherein the vocal component represents a voice of the user.
wherein the at least one characteristic of the vocal component comprises at least one of: a pitch of the vocal component, a tone of the vocal component, a rate of speech of the vocal component, a volume of the vocal component, a center frequency of the vocal component, or a frequency distribution of the vocal component.
wherein identifying the vocal component comprises: analyzing the audio signal to recognize speech included in the audio signal, and wherein the at least one characteristic of the vocal component comprises occurrence of at least one keyword in the recognized speech.
wherein adjusting the at least one setting of the camera comprises at least one of: increasing or decreasing the image capture rate, increasing or decreasing the video frame rate, increasing or decreasing the image resolution, increasing or decreasing the image size, increasing or decreasing the ISO setting, or changing a compression method used to compress the captured images to a higher-resolution or lower-resolution compression method.
wherein determining whether the at least one characteristic meets the prioritization criteria comprises: determining the at least one characteristic of the vocal component; comparing the at least one characteristic to a prioritization threshold for the at least one characteristic; and determining that the at least one characteristic meets the prioritization criteria when the at least one characteristic is about equal to the prioritization threshold.
wherein the prioritization threshold for the at least one characteristic includes a plurality of prioritization thresholds and adjusting the at least one setting of the camera comprises: comparing the at least one characteristic to the plurality of prioritization thresholds for the at least one characteristic; setting the at least one setting of the camera to a first setting when the at least one characteristic is about equal to a first prioritization threshold of the plurality of prioritization thresholds; and setting the at least one setting of the camera to a second setting when the at least one characteristic is about equal to a second prioritization threshold of the plurality of prioritization thresholds.
wherein determining whether the at least one characteristic of the vocal component meets the prioritization criteria for the characteristic comprises: determining a difference between the at least one characteristic and a baseline for the at least one characteristic; comparing the difference to a prioritization difference threshold for the at least one characteristic; and determining that the at least one characteristic meets the prioritization criteria when the difference is about equal to or exceeds the prioritization difference threshold.
wherein the prioritization different threshold for the at least one characteristic includes a plurality of prioritization difference thresholds and adjusting the at least one setting of the camera comprises: comparing the difference to the plurality of prioritization thresholds for the at least one characteristic; setting the at least one setting of the camera to a first setting when the difference is about equal to a first prioritization difference threshold of the plurality of prioritization difference thresholds; and setting the at least one setting of the camera to a second setting when the difference is about equal to a second prioritization difference threshold of the plurality of prioritization difference thresholds.

A method for controlling a camera, the method comprising: receiving a plurality of images captured by a wearable camera from an environment of a user; receiving an audio signal representative of sounds captured by a microphone from the environment of the user; identifying a vocal component of the audio signal; determining whether at least one characteristic of the vocal component meets a prioritization criteria for the at least one characteristic; adjusting at least one control setting of the camera when the at least one characteristic meets the prioritization criteria; and foregoing adjustment of the at least one control setting when the at least one characteristic does not meet the prioritization criteria.
wherein adjusting the at least one setting of the camera comprises at least one of: increasing the image capture rate, increasing the video frame rate, increasing the image resolution, increasing the image size, increasing the TSO setting, or changing a compression method used to compress the captured images to a higher-resolution compression method.
wherein determining whether the at least one characteristic meets the prioritization criteria comprises: determining the at least one characteristic of the vocal component; comparing the at least one characteristic to a prioritization threshold for the at least one characteristic; and determining that the at least one characteristic meets the prioritization criteria when the at least one characteristic is about equal to the prioritization threshold.
wherein determining whether the at least one characteristic of the vocal component meets the prioritization criteria for the characteristic comprises: determining a difference between the at least one characteristic and a baseline for the at least one characteristic; comparing the difference to a prioritization threshold for the at least one characteristic; and determining that the at least one characteristic meets the prioritization criteria when the difference is about equal to the prioritization threshold.

A non-transitory computer-readable medium including instructions which when executed by at least one processor perform a method, the method comprising: receiving a plurality of images captured by a wearable camera from an environment of a user; receiving an audio signal representative of sounds captured by a microphone from the environment of the user; identifying a vocal component of the audio signal; determining whether at least one characteristic of the vocal component meets a prioritization criteria for the at least one characteristic; adjusting at least one control setting of the camera when the at least one characteristic meets the prioritization criteria; and foregoing adjustment of the at least one control setting when the at least one characteristic does not meet the prioritization criteria.

A system comprising: a microphone configured to capture sounds from the environment of the user; a communication device configured to provide at least one audio signal representative of the sounds captured by the microphone; and at least one processor programmed to execute a method comprising: analyzing the at least one audio signal to distinguish a plurality of voices in the at least one audio signal; identifying a first voice among the plurality of voices; and determining, based on the analysis of the at least one audio signal: a start of a conversation between the plurality of voices; an end of the conversation between the plurality of voices; a duration of time, between the start of the conversation and the end of the conversation; and a percentage of the time, between the start of the conversation and the end of the conversation, for which the first voice is present in the audio signal; and providing, to the user, an indication of the percentage of the time for which the first voice is present in the audio signal.
wherein the microphone includes a least one of a directional microphone or a microphone array.
wherein the microphone comprises a transmitter configured to wirelessly transmit the captured sounds to a receiver coupled to the at least one processor.
wherein the receiver is incorporated in a hearing aid.
wherein identifying the first voice comprises identifying a voice of the user among the plurality of voices.
wherein determining the start of a conversation between the plurality of voices comprises determining a start time at which any voice is first present in the audio signal.
wherein determining the end of the conversation between the plurality of voices comprises determining an end time at which any voice is last present in the audio signal.
wherein determining the end time comprises identifying a period in the audio signal longer than a threshold period in which no voice is present in the audio signal.
wherein identifying the first voice comprises at least one of matching the first voice to a known voice or assigning an identity to the first voice.
wherein identifying the first voice comprises: identifying a known voice among the voices present in the audio signal; and assigning an identity to an unknown voice among the voices present in the audio signal.
further comprising providing an indication of the percentage of the time for which each of the identified voices is present in the audio signal.
wherein providing an indication comprises providing at least one of an audible, visible, or haptic indication to the user.
wherein providing an indication comprises displaying a representation of the percentage of the time for which the first voice is present in the audio signal.
wherein displaying the representation comprises displaying at least one of: a text, a bar chart, a pie chart, a histogram, a Venn diagram, a gauge, a heat map, or a color intensity indicator.
wherein the processor is further programmed to determine percentages of time for which the first voice is present in the audio signal over a plurality of time windows.
further comprising providing an indication of the determined percentages over the plurality of time windows.
wherein the at least one microphone and the processor are included in a common housing.
wherein the common housing is configured to be worn by a user.
wherein the at least one processor is included in a secondary computing device wirelessly linked to the at least one microphone.
wherein the secondary computing device comprises at least one of: a mobile device, a smartphone, a smartwatch, a laptop computer, a desktop computer, a smart television, an in-home entertainment system, or an in-vehicle entertainment system.

A method for processing audio signals, the method comprising: receiving at least one audio signal representative of sounds captured by a microphone from the environment of the user; analyzing the at least one audio signal to distinguish a plurality of voices in the at least one audio signal; identifying a first voice among the plurality of voices; and determining, based on the analysis of the at least one audio signal: a start of a conversation between the plurality of voices; an end of the conversation between the plurality of voices; a duration of time, between the start of the conversation and the end of the conversation; and a percentage of the time, between the start of the conversation and the end of the conversation, in which the first voice is present in the audio signal; and providing, to the user, an indication of the percentage of the time in which the first voice is present in the audio signal.
wherein determining the start of the conversation comprises determining a start time at which any voice is first present in the audio signal.
wherein determining the end of the conversation comprises determining an end time at which any voice is last present in the audio signal.
wherein determining the end time comprises identifying a period in the audio signal longer than a threshold period in which no voice is present in the audio signal.
wherein providing an indication comprises displaying a representation of the percentage of the time in which the first voice is present in the audio signal, the representation including at least one of: a bar chart, a pie chart, a histogram, a Venn diagram, a gauge, a heat map, or a color intensity indicator.
further comprising providing an indication of the percentage of the time for which each of the identified voices is present in the audio signal.

A non-transitory computer-readable medium including instructions which when executed by at least one processor perform a method, the method comprising: receiving at least one audio signal representative of sounds captured by a microphone from the environment of the user; analyzing the at least one audio signal to distinguish a plurality of voices in the audio signal; identifying a first voice among the plurality of voices; and determining, based on the analysis of the at least one audio signal: a start of a conversation between the plurality of voices; an end of the conversation between the plurality of voices; a duration of time, between the start of the conversation and the end of the conversation; and a percentage of the time, between the start of the conversation and the end of the conversation, in which the first voice is present in the audio signal; and providing, to the user, an indication of the percentage of the time in which the first voice is present in the audio signal.

A system comprising: a camera configured to capture a plurality of images from an environment of a user; at least one microphone configured to capture at least a sound of the user's voice; a communication device configured to provide at least one audio signal representative of the user's voice; and at least one processor programmed to execute a method comprising: analyzing at least one image from among the plurality of images to identify a user action; analyzing at least a portion of the at least one audio signal or at least one second image captured subsequent to the identified user action to take one or more measurements of at least one characteristic of the user's voice or behavior, the at least one characteristic comprising at least one of: (i) a pitch of the user's voice; (ii) a tone of the user's voice; (iii) a rate of speech of the user's voice; (iv) a volume of the user's voice; (v) a center frequency of the user's voice; (vi) a frequency distribution of the user's voice; (vii) a responsiveness of the user's voice; (viii) drowsiness by the user; (ix) hyper-activity by the user; (x) a yawn by the user; (xii) a shaking of the user's hand; (xiii) a period of time in which the user is laying down; or (xiv) whether the user takes a medication: determining, based on the one or more measurements of the at least one characteristic of the user's voice or behavior, a state of the user at the time of the one or more measurements; determining whether there is a correlation between the user action and the state of the user at the time of the one or more measurements; and if it is determined that there is a correlation between the user action and the state of the user at the time of the one or more measurements, providing, to the user, at least one of an audible or visible indication of the correlation.
wherein the camera and the at least one microphone are included in a common housing.
wherein the at least one processor and the communication device are included in the common housing.
wherein the audible indication of the correlation is provided to a hearing aid of the user.
wherein the common housing is configured to be worn by a user.
wherein the at least one processor is included in a secondary computing device wirelessly linked to a device including the camera and the at least one microphone comprising at least one of: (i) a mobile device, or (ii) a laptop computer, or (iii) a desktop computer, or (iv) a smart speaker, or (v) an in-home entertainment system, or (vi) an in-vehicle entertainment system.
wherein providing, to the user, at least one of an audible or visible indication of the correlation comprises the secondary computing device providing the at least one of an audible or visible indication.
wherein the method further comprises analyzing the at least one audio signal to distinguish the sound of the user's voice from other sounds captured by the at least one microphone.
wherein determining a state of the user at the time of the one or more measurements comprises: classifying the one or more measurements of the at least one characteristic of the user's voice based on a classification rule corresponding to the at least one characteristic.
wherein the classification rule is based on one or more machine learning algorithms trained on one or more training examples or on one or more outputs of at least one neural network.
wherein determining a state of the user at the time of the one or more measurements comprises: scoring the one or more measurements within a range of scores for the at least one characteristic; and determining the state of the user based on the scoring of the one or more measurements.
wherein analyzing at least one image from among the plurality of images to identify a user action comprises classifying the at least one image based on a classification rule corresponding to the user action.
wherein the classification rule is based on one or more machine learning algorithms trained on one or more training examples or on one or more outputs of at least one neural network.
wherein the identified user action comprises one of: (i) consuming a specific food or drink, or (ii) meeting with a specific person, or (iii) taking part in a specific activity, or (iv) using a specific tool, or (iv) going to a specific location.
wherein determining whether there is a correlation between the user action and the state of the user at the time of the one or more measurements comprises: classifying the user action based on a classification rule corresponding to the user action; classifying the one or more measurements of the at least one characteristic of the user's voice or behavior based on a classification rule corresponding to the at least one characteristic; and determining that there is a correlation between the user action and the state of the user, if the user action and the one or more measurements of the at least one characteristic of the user's voice or behavior are classified in corresponding classes.
wherein the classification rule is based on one or more machine learning algorithms trained on one or more training examples or on one or more outputs of at least one neural network.
wherein providing, to the user, at least one of an audible or visible indication of the correlation comprises providing, to the user, at least one of an audible or visible identification of the user action and the corresponding classes.
wherein the method further comprises choosing the at least one characteristic from among a plurality of measurable characteristics based on the identified user action.
wherein the at least one of the audible or the visible indication of the correlation is provided a predetermined amount of time after capturing the at least one image.

A method of correlating a user action to a user state subsequent to the user action, comprising: receiving, at a processor, a plurality of images from an environment of a user; receiving, at the processor, at least one audio signal representative of the user's voice; analyzing at least one image from among the received plurality of images to identify a user action; analyzing at least a portion of the at least one audio signal or at least one second image captured subsequent to the identified user action to take one or more measurements of at least one characteristic of the user's voice or behavior, the at least one characteristic comprising at least one of: (i) a pitch of the user's voice; (ii) a tone of the user's voice; (iii) a rate of speech of the user's voice; (iv) a volume of the user's voice; (v) a center frequency of the user's voice; (vi) a frequency distribution of the user's voice; (vii) a responsiveness of the user's voice; (viii) drowsiness by the user; (ix) hyper-activity by the user; (x) a yawn by the user; (xii) a shaking of the user's hand; (xiii) a period of time during which the user is laying down; or (xiv) whether the user takes a medication; determining, based on the one or more measurements of the at least one characteristic of the user's voice or behavior, the user state, the user state being a state of the user at the time of the plurality of measurements; determining whether there is a correlation between the user action and the user state; and if it is determined that there is a correlation between the user action and the user state, providing, to the user, at least one of an audible or visible indication of the correlation.
further including: capturing the plurality of images using one or more cameras of a wearable device; capturing at least a sound of the user's voice using one or more microphones of the wearable device; and transmitting the captured plurality of images and the captured at least one audio signal from the wearable device to the processor of a secondary computing device disposed remote from the wearable device, wherein the secondary computing device includes one of (i) a mobile device, (ii) a laptop computer, (iii) a desktop computer, (iv) a smart speaker. (v) an in-hone entertainment system, or (vi) an in-vehicle entertainment system.
wherein providing, to the user, at least one of an audible or visible indication of the correlation comprises the secondary computing device providing the at least one of an audible or visible indication.
wherein the identified user action comprises one of: (i) consuming a specific food or drink, or (ii) meeting with a specific person, or (iii) taking part in a specific activity, or (iv) using a specific tool, or (iv) going to a specific location.
wherein determining whether there is a correlation between the user action and the user state comprises: classifying the user action based on a classification rule corresponding to the user action; classifying the one or more measurements of the at least one characteristic of the user's voice or behavior based on a classification rule corresponding to the at least one characteristic; and determining that them is a correlation between the user action and the user state if the user action and the plurality of measurements of the at least one characteristic of the user's voice or behavior are classified in corresponding classes.

A computer-readable medium storing instructions that, when executed by a computer, cause it to perform a method comprising: receiving, at a processor, a plurality of images from an environment of a user; receiving, at the processor, at least one audio signal representative of the user's voice; analyzing at least one image from among the received plurality of images to identify a user action; analyzing at least a portion of the at least one audio signal or at least one second image captured subsequent to the identified user action to take one or more measurements of at least one characteristic of the user's voice or behavior, the at least one characteristic comprising at least one of: (i) a pitch of the user's voice; (ii) a tone of the user's voice; (iii) a rate of speech of the user's voice; (iv) a volume of the user's voice; (v) a center frequency of the user's voice; (vi) a frequency distribution of the user's voice: (vii) a responsiveness of the user's voice; (viii) drowsiness by the user; (ix) hyper-activity by the user (x) a yawn by the user; (xii) a shaking of the user's hand; (xiii) a period of time during which the user is laying down; or (xiv) whether the user takes a medication; determining, based on the one or more measurements of the at least one characteristic of the user's voice or behavior, the user state, the user state being a state of the user at the time of the plurality of measurements; determining whether there is a correlation between the user action and the user state; and if it is determined that there is a correlation between the user action and the user state, providing, to the user, at least one of an audible or visible indication of the correlation.

The computer-readable medium claim 29, wherein the identified user action comprises one of: (i) consuming a specific food or drink, or (ii) meeting with a specific person, or (iii) taking part in a specific activity, or (iv) using a specific tool, or (iv) going to a specific location.

A system comprising: a camera configured to capture a plurality of images from an environment of a user; at least one microphone configured to capture at least a sound of the user; a communication device configured to provide at least one audio signal representative of the user's voice; and at least one processor programmed to execute a method comprising: analyzing at least one image from among the plurality of images to identify an event in which the user is involved; analyzing at least a portion of the at least one audio signal captured during the identified event to identify at least one indicator of alertness of the user; tracking changes in the at least one indicator of alertness of the user during the identified event; and causing an audible or visual output to the user indicative of a level of alertness of the user during the identified event.
wherein the identified event includes at least one of: driving a car, participating in a meeting, participating in a sports event, or engaging in a conversation with at least one other individual.
wherein the at least one indicator of alertness of the user includes at least one of: a rate of speech of the user, a tone associated with the user's voice, a pitch associated with the user's voice, a volume associated with the user's voice, or a responsiveness level of the user.
wherein the responsiveness level of the user is associated with an average length of time between a conclusion of speech by an individual other than the user and initiation of speech by the user.
wherein the at least one processor is included in a secondary computing device wirelessly linked to a device including the camera and the at least one microphone.
wherein the secondary computing device comprises at least one of: (i) a mobile device, or (ii) a laptop computer, or (iii) a desktop computer, or (iv) a smart speaker, or (v) an in-home entertainment system, or (vi) an in-vehicle entertainment system, or (vii) a smart phone.
wherein causing an audible or visual output to the user indicative of a level of alertness of the user during the identified event includes causing a graphical representation of the level of alertness of the user during at least a portion of the identified event on a display associated with the secondary computing device of an indicator.
wherein the camera and the at least one microphone are included in a common housing.
wherein the at least one processor and the communication device are included in the common housing.
wherein the common housing is configured to be worn by the user.
wherein causing an audible or visual output to the user includes providing an audible indication to one of a hearing aid, a headphone, or an earphone of the user.
wherein the method further comprises providing to the user a tactile indication of a level of alertness of the user during the identified event.
wherein the at least one microphone incudes a plurality of microphones or a microphone array.
wherein the method further comprises analyzing the at least one audio signal to distinguish the sound of the user's voice from other sounds captured by the at least one microphone.

A method for detecting alertness of a user during an event, comprising: receiving, at a processor, a plurality of images from an environment of a user; receiving, at the processor, at least one audio signal representative of the user's voice; analyzing at least one image from among the plurality of images to identify an event in which the user is involved; analyzing at least a portion of the at least one audio signal captured during the identified event to identify at least one indicator of alertness of the user based on the at least one audio signal; tracking changes in the at least one indicator of alertness of the user during the identified event; and causing an audible or visual output to the user indicative of a level of alertness of the user during the identified event.
wherein the identified event includes at least one of: driving a car, participating in a meeting, or engaging in a conversation with at least one other individual.
wherein the at least one indicator of alertness of the user includes at least one of: a rate of speech of the user, a tone associated with the user's voice, a pitch associated with the user's voice, a volume associated with the user's voice, or a responsiveness level of the user.
wherein the at least one processor is included in a secondary computing device wirelessly linked to a device including the camera and the at least one microphone.

A computer-readable medium storing instructions that, when executed by a computer, cause it to perform a method comprising: receiving, at a processor, a plurality of images from an environment of a user; receiving, at the processor, at least one audio signal representative of the user's voice; analyzing at least one image from among the plurality of images to identify an event in which the user is involved; analyzing at least a portion of the at least one audio signal captured during the identified event to identify at least one indicator of alertness of the user based on the at least one audio signal; tracking changes in the at least one indicator of alertness of the user during the identified event; and causing an audible or visual output to the user indicative of a level of alertness of the user during the identified event.
wherein the identified event includes at least one of: driving a car, participating in a meeting, or engaging in a conversation with at least one other individual, and the at least one indicator of alertness of the user includes at least one of: a rate of speech of the user, a tone associated with the user's voice, a pitch associated with the user's voice, a volume associated with the user's voice, or a responsiveness level of the user.

A system comprising: at least one microphone configured to capture voices from an environment of the user and output at least one audio signal; and at least one processor programmed to execute a method comprising: analyzing the at least one audio signal to identify a conversation; logging the conversation; analyzing the at least one audio signal to automatically identify words spoken during the logged conversation; comparing the identified words to a user-defined list of key words to identify at least one key word spoken during the logged conversation; associating, in at least one database, the identified spoken key word with the logged conversation; and providing, to the user, at least one of an audible or visible indication of the association between the spoken key word and the logged conversation.
wherein the at least one of the audible or visible indication of the association between the spoken key word and the logged conversation is provided after a predetermined time period.
wherein the method further comprises: analyzing the at least one audio signal to distinguish a voice of the user from other sounds captured by the at least one microphone.
wherein identifying key words spoken during the logged conversation comprises identifying, in the audio signal, representations of key words spoken by the user or by at least one other individual.
wherein the method further comprises: identifying the at least one individual.
wherein identifying the at least one individual comprises recognizing, based on analysis of the audio signal, a voice of the at least one individual.
further comprising: a camera configured to capture images from an environment of the user and output an image signal, wherein identifying the at least one individual comprises recognizing, based on analysis of the image signal, the at least one individual.
wherein recognizing the at least one individual, based on analysis of the image signal, comprises recognizing at least one of (i) a face, (ii) a posture, or (iii) a gesture of the at least one individual represented by the image signal.
wherein the camera and the at least one microphone am included in a common housing.
wherein the common housing is configured to be worn by the user.
wherein the method further comprises: analyzing the at least one audio signal to acquire a first measurement of at least one voice characteristic.
wherein the at least one voice characteristic comprises: (i) a pitch, (ii) a tone, (iii) a rate of speech. (iv) a volume, (v) a center frequency. (vi) a frequency distribution, or (vii) a responsiveness of the voice.
wherein the method further comprises: applying a voice classification rule to classify at least a portion of the audio signal into one of a plurality of voice classifications based on the at least one voice characteristic.
wherein the portion of the audio signal comprises the representation of the identified key word.
wherein: applying the voice classification rule comprises applying the voice classification rule to a component of the audio signal associated with a voice of the user or another individual.
wherein the plurality of voice classifications denote the speaker's mood.
wherein the method further comprises: associating, in the at least one database, the voice classification with the identified spoken key word and the logged conversation; and providing, to the user, at least one of an audible or visible indication of the association between the voice classification, the spoken key word, and the logged conversation.

The system of claim 13, wherein the voice classification rule is based on at least one of: a neural network or a machine learning algorithm trained on one or more training examples.
wherein the method further comprises: applying a context classification rule to classify the environment of the user into one of a plurality of contexts including at least a work context and a social context, based on information provided by at least one of (i) the audio signal, (ii) an image signal, (iii) an external signal, or (iv) a calendar entry.
wherein the context classification rule is based on at least one of: a neural network or a machine learning algorithm trained on one or more training examples.
wherein the plurality of contexts include at least a work context and a social context.
wherein the external signal is one of (i) a location signal, or (ii) a Wi-Fi signal.
wherein the at least one processor is included in a secondary computing device configured to be wirelessly linked to the at least one microphone, wherein the secondary computing device comprises at least one of: a smart phone (i) a mobile device. (ii) a laptop computer, a tablet computer, (ii) a desktop computer, (iv) a smart speaker. (v) an in-home entertainment system, or (vi) an in-vehicle entertainment system.
wherein providing an indication of the association comprises providing the indication via the secondary computing device
wherein analyzing the at least one audio signal to identify a conversation comprises: identifying at least one of (i) a start time of the conversation, (ii) an end time of the conversation, (iii) a context classification of the conversation, (iv) a context classification of the association. (v) a voice classification of the association, or (vi) participants in the conversation.
wherein logging the conversation comprises: identifying the conversation in the at least one database by at least one of (i) a start time of the conversation, (ii) an end time of the conversation, (iii) a context classification of the conversation, (iv) a context classification of the association, (v) a voice classification of the association, or (vi) participants in the conversation.
wherein the at least one key word is determined dynamically in response to a word spoken by an individual in the logged conversation.
further comprising identifying an intonation in which the at least one keyword is said.

A method of detecting key words in a conversation associated with a user, comprising: receiving, at a processor, at least one audio signal from at least one microphone; analyzing the at least one audio signal to identify a conversation; logging the conversation; analyzing the at least one audio signal to automatically identify words spoken during the logged conversation; comparing the identified words to a user-defined list of key words to identify at least one key word spoken during the logged conversation; associating, in at least one database, the identified spoken key word with the logged conversation; and providing, to the user, at least one of an audible or visible indication of the association between the spoken key word and the logged conversation.

A computer-readable medium storing instructions that, when executed by a computer, cause it to perform a method comprising: receiving, at a processor, at least one audio signal from at least one microphone; analyzing the at least one audio signal to identify a conversation; logging the conversation; analyzing the at least one audio signal to automatically identify words spoken during the logged conversation; comparing the identified words to a user-defined list of key words to identify at least one key word spoken during the logged conversation; associating, in at least one database, the identified spoken key word with the logged conversation; and providing, to the user, at least one of an audible or visible indication of the association between the spoken key word and the logged conversation.

A system comprising: a user device comprising: a camera configured to capture a plurality of images from an environment of a user and output an image signal comprising the plurality of images; and at least one processor programmed to: detect, in at least one of the plurality of images, a face of an individual represented in the at least one of the plurality of images; isolate at least one facial feature of the detected face; store, in a database, a record including the at least one facial feature; share the record with one or more other devices; receive a response including information associated with the individual, the response provided by one of the other devices; update the record with the information associated with the individual; and provide, to the user, at least some of the information included in the updated record.
wherein the camera is a video camera and the image signal is a video signal.
wherein the response is triggered based on a positive identification of the individual by at least one of the other devices, and wherein the response is based on analysis of the record shared by the user device.
wherein the camera and the at least one processor are included in a common housing.
wherein the common housing is configured to be worn by the user.
wherein the at least some of the information provided to the user includes at least one of a name of the individual, an indication of a relationship between the individual and the user, an indication of a relationship between the individual and a contact associated with the user, a job title associated with the individual, a company name associated with the individual, or a social media entry associated with the individual.
wherein the one or more other devices each comprise at least one of: (i) a mobile device, or (ii) a server, or (iii) a personal computer, or (iv) a smart speaker, or (v) an in-home entertainment system, or (vi) an in-vehicle entertainment system, or (vii) a device having a same device type as the first device.
wherein: the user device further comprises an input device; and wherein the at least one processor is further programmed to: receive, via the input device, additional information regarding the individual; update the record with the additional information; and share the updated record with at least one of the other devices, wherein the additional information is related to an itinerary of the individual.
wherein the information includes at least a portion of an itinerary associated with the individual, and wherein the at least one processor is further programmed to: determine a location in which at least one image was captured; determine whether the location correlates with the itinerary; and if the location does not correlate with the itinerary: provide, to the user, an indication that the location does not correlate with the itinerary.
wherein the at least some of the information provided to the user is provided audibly via a speaker wirelessly connected to the user device.
wherein the speaker is included in a wearable earpiece.
wherein the at least some of the information provided to the user is provided visually via a display device wirelessly connected to the user device.
wherein the display device includes a mobile device
wherein the database is stored in at least one memory of the user device, or at least one memory accessible to the user device and the one or more other devices, or in at least one memory linked to the user device via a wireless connection.
wherein the at least one processor is programmed to cause the at least some information included in the updated record to be presented to the user via a secondary computing device in communication with the user device.
wherein the secondary computing device comprises at least one of: (i) a mobile device, or (ii) a laptop computer, or (iii) a desktop computer, or (iv) a smart speaker, or (v) an in-home entertainment system, or (vi) an in-vehicle entertainment system.
wherein sharing the record with a second device comprises: providing the secondary computing device with an address of a memory location associated with the record.
wherein sharing the record with the one or more other devices comprises: forwarding a copy of the record to the one or more other devices.
wherein sharing the record with the one or more other devices comprises identifying one or more contacts of the user.
wherein the user device and the one or more other devices are configured to be wirelessly linked via a wireless data connection.
wherein providing to the user at least some of the information included in the response is limited to a predetermined number of responses.

A system comprising: a user device comprising: a camera configured to capture a plurality of images from an environment of a user and output an image signal comprising the plurality of images; and at least one processor programmed to: detect, in at least one of the plurality of images, a face of an individual represented in the at least one of the plurality of images; based on the detection of the face, share a record with one or more other devices; receive a response including information associated with the individual, the response provided by one of the other devices; update the record with the information associated with the individual; and provide, to the user, at least some of the information included in the updated record.
wherein the at least one processor is programmed to: isolate at least one facial feature of the detected face; store the at least one facial feature in the record.

A method comprising: capturing, by a camera of a user device, a plurality of images from an environment of a user and outputting an image signal comprising the plurality of images; detecting, in at least one of the plurality of images, a face of an individual represented in the at least one of the plurality of images; isolating at least one facial feature of the detected face; storing, in a database, a record including the at least one facial feature; sharing the record with one or more other devices: receiving a response including information associated with the individual, the response provided by one of the other devices; updating the record with the information associated with the individual; and providing, to the user, at least some of the information included in the updated record wherein the response is triggered based on a positive identification of the individual by at least one of the other devices, and wherein the response is based on analysis of the record shared by the user device.
wherein the at least some of the information provided to the user includes at least one of a name of the individual, an indication of a relationship between the individual and the user, an indication of a relationship between the individual and a contact associated with the user, a job title associated with the individual, a company name associated with the individual, or a social media entry associated with the individual.
wherein the user device further comprises an input device and the method further comprises: receiving, via the input device, additional information regarding the individual; updating the record with the additional information; and sharing the updated record with at least one of the other devices.

A non-transitory computer readable medium that stores a set of instructions that is executable by at least one processor of a computing device to cause the computing device to perform a method comprising: capturing, by a camera of a user device, a plurality of images from an environment of a user and outputting an image signal comprising the plurality of images; detecting, in at least one of the plurality of images, a face of an individual represented in the at least one of the plurality of images; isolating at least one facial feature of the detected face; storing, in a database, a record including the at least one facial feature; sharing the record with one or more other devices; receiving a response including information associated with the individual, the response provided by one of the other devices; updating the record with the information associated with the individual; and providing, to the user, at least some of the information included in the updated record.

A wearable camera-based computing device, comprising: a memory unit including a database configured to store information related to each individual included in a plurality of individuals, the stored information including one or more facial characteristics and at least one of: a name, a place of employment, a job title, a place of residence, a birthplace, an age, an indication of expertise, a name of a college or university attended by the individual, one or more interests shared by a user and the individual, one or more likes or dislikes shared by the user and the individual, or an indication of at least one relationship between the individual and a third person with whom the user also has a relationship; and a camera configured to capture a plurality of images from an environment of the user and output an image signal comprising the plurality of images; at least one processor programmed to: detect, in at least one of the plurality of images, a face represented in the at least one of the plurality of images; compare at least one aspect of the detected face with at least some of the one or more facial characteristics stored in the database for the plurality of individuals to identify a recognized individual associated with the detected face; retrieve at least some of the stored information for the recognized individual from the database; and cause the at least some of the stored information retrieved for the recognized individual to be automatically conveyed to the user.
wherein the database is pre-loaded with the information related to each individual included in the plurality of individuals prior to providing the device to the user.
wherein the at least some of the stored information retrieved for the recognized individual is automatically conveyed to the user audibly via a speaker wirelessly connected to the wearable camera-based computing device.
wherein the speaker is included in a wearable earpiece.
wherein the at least some of the stored information retrieved for the recognized individual is automatically conveyed to the user visually via a display device wirelessly connected to the wearable camera-based computing device.
wherein the display device includes a mobile device.
wherein a linking characteristic, shared by the recognized individual and the user, relates to at least one of: a place of employment, a job title, a place of residence, a birthplace, an age, an expertise, or a name of a college or university.
wherein a linking characteristic, shared by the recognized individual and the user, relates to at least one of: one or more interests shared by the user and the individual, one or more likes or dislikes shared by the user and the individual, or an indication of at least one relationship between the individual and a third person with whom the user also has a relationship.
wherein at least one identifier associated with the recognized individual includes a name, a place of employment, a job title, a place of residence, a birthplace, an age, an expertise associated with the recognized individual, or a name of a college or university attended by the recognized individual.
wherein the at least some of the stored information for the recognized individual includes at least one identifier associated with the recognized individual and at least one linking characteristic shared by the recognized individual and the user.
wherein comparing the at least one aspect of the detected face with the at least some of the one or more facial characteristics stored in the database for the plurality of individuals comprises analyzing a relative size and position of the at least one aspect of the detected face.

A method comprising: storing, via a memory unit including a database, information related to each individual included in a plurality of individuals, the stored information including one or more facial characteristics and at least one of: a name, a place of employment, a job title, a place of residence, a birthplace, an age, an indication of expertise, a name of a college or university attended by the individual, one or more interests shared by a user and the individual, one or more likes or dislikes shared by the user and the individual, or an indication of at least one relationship between the individual and a third person with whom the user also has a relationship; capturing, via a camera, a plurality of images from an environment of the user and outputting an image signal comprising the plurality of images; detecting, in at least one of the plurality of images, a face represented in the at least one of the plurality of images; comparing at least one aspect of the detected face with at least some of the one or more facial characteristics stored in the database for the plurality of individuals to identify a recognized individual associated with the detected face; retrieving at least some of the stored information for the recognized individual from the database; and causing the at least some of the stored information retrieved for the recognized individual to be automatically conveyed to the user.
further comprising automatically conveying the at least some of the stored information retrieved for the recognized individual to the user audibly via a speaker wirelessly connected to the wearable camera-based computing device.
wherein the speaker is included in a wearable earpiece.
automatically conveying the at least some of the stored information retrieved for the recognized individual to the user visually via a display device wirelessly connected to the first device.
wherein the display device includes a mobile device.
wherein a linking characteristic, shared by the recognized individual and the user, relates to at least one of: a place of employment, a job title, a place of residence, a birthplace, an age, an expertise, or a name of a college or university.
wherein a linking characteristic, shared by the recognized individual and the user, relates to at least one of: one or more interests shared by the user and the individual, one or more likes or dislikes shared by the user and the individual, or an indication of at least one relationship between the individual and a third person with whom the user also has a relationship.
wherein at least one identifier associated with the recognized individual includes a name, a place of employment, a job tide, a place of residence, a birthplace, an age, an expertise associated with the recognized individual, or a name of a college or university attended by the recognized individual.
wherein the at least some of the stored information for the recognized individual includes at least one identifier associated with the recognized individual and at least one linking characteristic shared by the recognized individual and the user

A non-transitory computer readable medium that stores a set of instructions that is executable by at least one processor of a computing device to cause the computing device to perform a method comprising: storing, via a memory unit including a database, information related to each individual included in a plurality of individuals, the stored information including one or more facial characteristics and at least one of: a name, a place of employment, a job title, a place of residence, a birthplace, an age, an indication of expertise, a name of a college or university attended by the individual, one or more interests shared by a user and the individual, one or more likes or dislikes shared by the user and the individual, or an indication of at least one relationship between the individual and a third person with whom the user also has a relationship; capturing, via a camera, a plurality of images from an environment of the user and outputting an image signal comprising the plurality of images; detecting, in at least one of the plurality of images, a face represented in the at least one of the plurality of images; comparing at least one aspect of the detected face with at least some of the one or more facial characteristics stored in the database for the plurality of individuals to identify a recognized individual associated with the detected face; retrieving at least some of the stored information for the recognized individual from the database; and causing the at least some of the stored information retrieved for the recognized individual to be automatically conveyed to the user.

A camera-based assistant system, comprising: a housing; at least one camera included in the housing, the at least one camera being configured to capture a plurality of images representative of an environment of a wearer of the camera-based assistant system; a location sensor included in the housing; a communication interface; and at least one processor programmed to: receive, via the communication interface and from a server located remotely with respect to the camera-based assistant system, an indication of at least one characteristic or identifiable feature associated with a person of interest; analyze the plurality of captured images to detect whether the at least one characteristic or identifiable feature of the person of interest is represented in any of the plurality of captured images; and send an alert, via the communication interface, to one or more recipient computing devices remotely located relative to the camera-based assistant system, wherein the alert includes a location associated with the camera-based assistant system, determined based on an output of the location sensor, and an indication of a positive detection of the person of interest.
wherein the one or more recipient computing devices include the server that provided to the camera-based assistant system the at least one characteristic or identifiable feature associated with the person of interest.
wherein the one or more recipient computing devices include a mobile device associated with a family member of the person of interest.
wherein the one or more recipient computing devices are associated with at least one law enforcement agency.
wherein the alert is not sent to the wearer of the camera-based assistant system.
wherein the analysis of the plurality of captured images to detect whether the at least one characteristic or identifiable feature of the person of interest is represented by any of the plurality of captured images is performed as a background process executed by the at least one processor.
wherein the at least one characteristic or identifiable feature of the person of interest is associated with one or more of: a facial feature, a tattoo, or a body shape.
further including a microphone included in the housing, wherein the at least one characteristic or identifiable feature of the person of interest includes a voice signature, and wherein the at least one processor is programmed to analyze an output of the microphone to detect whether the voice signature associated with the person of interest is represented by the output of the microphone.
wherein the at least one camera includes a video camera.
wherein the at least one processor is included in the housing.
wherein the at least one processor is further programmed to change a frame capture rate of the at least one camera after detecting that the at least one characteristic or identifiable feature of the person of interest is represented in at least one of the plurality of captured images.
wherein the alert further includes data representing at least one other individual within a vicinity of the person of interest represented in the plurality of images.
wherein the at least one processor is further programmed to forego sending the alert based on a user input.
wherein the at least one processor is further programmed to forego sending the alert in response to a certainty level of the positive detection being less than a threshold.

A system for locating a person of interest, comprising: at least one server; one or more communication interfaces associated with the at least one server; and one or more processors included in the at least one server, wherein the one or more processors are programmed to: send to a plurality of camera-based assistant systems, via the one or more communication interfaces, an indication of at least one identifiable feature associated with a person of interest, wherein the at least one identifiable feature is associated with one or more of: a facial feature, a tattoo, a body shape; or a voice signature; receive, via the one or more communication interfaces, alerts from the plurality of camera-based assistant systems, wherein each alert includes: an indication of a positive detection of the person of interest, based on analysis of the indication of at least one identifiable feature associated with a person of interest provided by one or more sensors included onboard a particular camera-based assistant system, and a location associated with the particular camera-based assistant system; and provide to one or more law enforcement agencies after receiving alerts from at least a predetermined number of camera-based assistant systems, via the one or more communication interfaces, an indication that the person of interest has been located.
wherein the one or more processors are further programmed to discard alerts received from the plurality of camera-based assistant systems that are associated with a certainty below a predetermined threshold.
wherein the threshold is based on a population density of an area within which the plurality of camera-based assistance systems are located.
wherein at least one identifiable feature is further associated with a license plate of a vehicle of the person of interest.
the camera-based assistance systems notify respective users of the camera-based assistance systems and allow the users to opt-out of providing an alert.
wherein the camera-based assistance systems do not provide an alert when located within a home of a respective user.
wherein the indication that the person of interest has been located is provided to one or more law enforcement agencies in response to the received alerts being associated with locations within a threshold distance of other alerts.

A camera-based assistant system, comprising: a housing; at least one camera included in the housing, the at least one camera being configured to capture a plurality of images representative of an environment of a wearer of the camera-based assistant system; and at least one processor programmed to: automatically analyze the plurality of images to detect a representation in at least one of the plurality of images of at least one individual in the environment of the wearer; predict an age of the at least one individual based on detection of one or more characteristics associated with at least one individual represented in the at least one of the plurality of images; perform at least one identification task associated with the at least one individual if the predicted age is greater than a predetermined threshold; and forego the at least one identification task if the predicted age is not greater than the predetermined threshold.
wherein the at least one identification task includes comparing a facial feature associated with the at least one individual to records in one or moue databases to determine whether the at least one individual is one or more of: a recognized individual, a person of interest, or a missing person.
wherein predicting the age of the at least one individual further comprises: estimating a height of the at least one individual; and setting, as the predicted age, an age determined based on the estimated height.
wherein estimating the height of the at least one individual comprises: identifying a height of an object represented in one of the plurality of images; determining, based on the identified height of the object, the estimated height of the at least one individual.
wherein estimating the height of the at least one individual comprises: identifying an angle from the at least one camera to a top of a head of the at least one individual based on a representation of the at least one individual in one of the plurality of images; and determining, based on the identified angle, the estimated height of the at least one individual.
wherein predicting the age of the at least one individual further comprises: determining an eye measurement of the at least one individual based on at least one of the plurality of images; determining a head measurement of the at least one individual based on at least one of the plurality of images; determining a ratio of the determined eye measurement to the determined head measurement; and predicting the age based on the ratio.
wherein predicting the age of the at least one individual further comprises: determining a head size of at least one individual based on at least one of the plurality of images; determining a body size of the at least one individual based on at least one of the plurality of images; determining a ratio of the determined head size to the determined body size; and predicting the age based on the ratio.
wherein predicting the age of the at least one individual further comprises: determining whether the at least one individual has at least one of facial hair, a tattoo, or jewelry; and setting, as the predicted age, an age greater than the threshold in response to the at least one individual having at least one of facial hair, a tattoo, or jewelry.
further comprising a microphone, wherein the at least one processor is further programmed to: record audio representing a voice of the at least one individual using the microphone; determine a pitch of the audio representing the voice; and predict the age based on the pitch.
wherein performing at least one identification task further comprises sending a message containing a result of the at least one identification task.

A method for identifying faces using a wearable camera-based assistant system, the method comprising: automatically analyzing a plurality of images captured by a camera of the wearable camera-based assistant system to detect a representation in at least one of the plurality of images of at least one individual in an environment of a wearer; predicting an age of the at least one individual based on detection of one or more characteristics associated with at least one individual represented in the at least one of the plurality of images; performing at least one identification task associated with the at least one individual if the predicted age is greater than a predetermined threshold; and foregoing the at least one identification task if the predicted age is not greater than the predetermined threshold.
wherein the at least one identification task includes comparing a facial feature associated with the at least one individual to records in one or more databases to determine whether the at least one individual is one or more of: a recognized individual, a person of interest, or a missing person.
wherein predicting the age of the at least one individual further comprises: estimating a height of the at least one individual; and setting, as the predicted age, an age determined based on the estimated height.
wherein estimating the height of the at least one individual comprises: identifying a height of an object represented in one of the plurality of images; determining, based on the identified height of the object, the estimated height of the at least one individual.
wherein estimating the height of the at least one individual comprises: identifying an angle from the at least one camera to a top of a head of the at least one individual based on a representation of the at least one individual in one of the plurality of images; and determining, based on the identified angle, the estimated height of the at least one individual.
wherein predicting the age of the at least one individual further comprises: determining an eye measurement of the at least one individual based on at least one of the plurality of images; determining a head measurement of the at least one individual based on at least one of the plurality of images; determining a ratio of the determined eye measurement to the determined head measurement; and predicting the age based on the ratio.
wherein predicting the age of the at least one individual further comprises: determining a head size of at least one individual based on at least one of the plurality of images; determining a body size of the at least one individual based on at least one of the plurality of images; determining a ratio of the determined head size to the determined body size; and predicting the age based on the ratio.
wherein predicting the age of the at least one individual further comprises: determining whether the at least one individual has at least one of facial hair, a tattoo, or jewelry; and setting, as the predicted age, an age greater than the threshold in response to the at least one individual having at least one of facial hair, a tattoo, or jewelry.
further comprising: recording audio representing a voice of the at least one individual using a microphone of the camera-based assistant system; determining a pitch of the audio representing the voice; and predicting the age based on the pitch.

A camera-based assistant system, comprising: a housing; at least one camera included in the housing, the at least one camera being configured to capture a plurality of images representative of an environment of a wearer of the camera-based assistant system; and at least one processor programmed to: automatically analyze the plurality of images to detect a representation in at least one of the plurality of images of at least one individual in the environment of the wearer; determine whether an age of the at least one individual, as based on detection of one or more characteristics associated with the at least one individual represented in the at least one of the plurality of images, is greater than a predetermined threshold; perform at least one identification task associated with the at least one individual if the predicted age is greater than a predetermined threshold; and forego the at least one identification task if the predicted age is not greater than the predetermined threshold.

A non-transitory computer-readable storage medium that, when executed on one or more processors, cause the one or more processors to perform operations comprising: automatically analyzing a plurality of images captured by a camera of the wearable camera-based assistant system to detect a representation in at least one of the plurality of images of at least one individual in an environment of a wearer; predicting an age of the at least one individual based on detection of one or more characteristics associated with at least one individual represented in the at least one of the plurality of images: performing at least one identification task associated with the at least one individual if the predicted age is greater than a predetermined threshold; and foregoing the at least one identification task if the predicted age is not greater than the predetermined threshold.

A wearable device, comprising: a housing; at least one camera associated with the housing, the at least one camera being configured to capture a plurality of images from an environment of a user of the wearable device; at least one microphone associated with the housing, the at least one microphone being configured to capture an audio signal of a voice of a speaker; and at least one processor programmed to: detect a representation of an individual in the plurality of images and identify the individual as the speaker by correlating at least one aspect of the audio signal with one or more changes associated with the representation of the individual across the plurality of images; monitor one or more indicators of body language associated with the speaker over a time period, based on analysis of the plurality of images; monitor one or more characteristics of the voice of the speaker over the time period, based on analysis of the audio signal; determine, over the time period and based on a combination of the one or more monitored indicators of body language and the one or more characteristics of the voice of the speaker, a plurality of mood index values associated with the speaker; store the plurality of mood index values in a database; determine a baseline mood index value for the speaker based on the plurality of mood index values stored in the database; and provide to the user at least one of an audible or visible indication of the baseline mood index of the speaker.
wherein the at least one characteristic of the mood of the speaker includes a representation of the mood of the speaker at a particular time during the time period.
wherein the at least one characteristic of the mood of the speaker includes a representation of the baseline mood index value of the speaker.
wherein the at least one characteristic of the mood of the speaker includes a representation of a mood spectrum for the speaker determined based on the plurality of moo index baseline values stored in the database.
wherein the time period is continuous.
wherein the time period includes a plurality of non-contiguous time intervals.
wherein the speaker is the user of the wearable device.
wherein the speaker is an individual speaking with the user of the wearable device.
wherein the plurality of mood index values are determined using a trained neural network.
wherein the at least one processor is programmed to identify the individual as the speaker by correlating the audio signal with movements of lips of the speaker detected through analysis of the plurality of images.
wherein the one or more indicators of body language associated with the speaker include at least one of: (i) a facial expression of the speaker, (ii) a posture of the speaker. (iii) a movement of the speaker, (iv) an activity of the speaker, (v) an image temperature of the speaker; or (vi) a gesture of the speaker.

The wearable device of claim 1, wherein the one or more characteristics of the voice of the speaker include at least one of: (i) a pitch of the voice of the speaker, (ii) a tone of the voice of the speaker, (iii) a rate of speech of the voice of the speaker. (iv) a volume of the voice of the speaker. (v) a center frequency of the voice of the speaker, (vi) a frequency distribution of the voice of the speaker, or (vii) a responsiveness of the voice of the speaker.
wherein the at least one processor is further programmed to: monitor, over the time period and based on analysis of the plurality of images, an activity characteristic associated with the speaker; determine a level of correlation between one or more of the mood index values and the monitored activity characteristic; store in the database information indicative of the determined level of correlation; and provide to the user, as part of the audible or visible indication of the at least one characteristic of the mood of the speaker, the information indicative of the determined level of correlation.
wherein the at least one processor is further programmed to: generate a recommendation for a behavioral change of the speaker based on the determined level of correlation between the one or more of the mood index values and the monitored activity characteristic; and provide to the user, as part of the audible or visible indication of the at least one characteristic of the mood of the speaker, the generated recommendation.
wherein the activity characteristic includes at least one of: (i) consuming a specific food or drink, (ii) meeting with a specific person, (iii) taking pad in a specific activity, or (iv) a presence in a specific location.
wherein providing to the user at least one of an audible or visible indication of at least one characteristic of the mood of the speaker includes causing sounds representative of the audible indication to be produced from the speaker.
wherein the speaker is associated with a secondary device wirelessly connected to the wearable device.
wherein the secondary device includes a mobile device or headphones configured to be worn by the user.
wherein providing to the user at least one of an audible or visible indication of at least one characteristic of the mood of the speaker includes causing the visible indication to be shown on a display.
wherein the display or the at least one processor is included in a secondary device wirelessly connected to the wearable device.
wherein the at least one processor is further programmed to: determine at least one mood change pattern for the speaker based on the plurality of mood index values stored in the database; during a subsequent encounter with the speaker, generate a mood prediction for the speaker based on the determined at least one mood change pattern; and provide to the user a visible or audio representation of the generated mood prediction.
wherein the at least one mood change pattern correlates the speaker's mood with at least one periodic time interval.
wherein the at least one mood change pattern correlates the speaker's mood with at least one type of activity.
wherein the at least one type of activity includes: a meeting between the speaker and the user, a meeting between the speaker and at least one individual other than the user, a detected location in which the speaker is located, or a detected activity in which the speaker is engaged.
wherein the at least one processor is further programmed to determine at least one deviation from the baseline mood index value.
wherein the at least one processor is programmed to: determine a new mood index value for the speaker based on analysis of at least one new image captured by the at least one camera or at least one new audio signal captured by the at least one microphone; and determine a new baseline mood index value for the speaker based on the plurality of mood index values stored in the database and the new mood index value; compare the new mood index value to the baseline mood index value; and provide to the user at least one of an audible or visible indication based on the comparison.

A computer-implemented method for detecting mood changes of an individual, the method comprising: receiving a plurality of images from an environment of a user, the plurality of images being captured by a camera; receiving an audio signal of a voice of a speaker, the audio signal being captured by at least one microphone; detecting a representation of an individual in the plurality of images and identifying the individual as the speaker by correlating at least one aspect of the audio signal with one or more changes associated with the representation of the individual across the plurality of images; monitoring one or more indicators of body language associated with the speaker over a time period, based on analysis of the plurality of images; monitoring one or more characteristics of the voice of the speaker over the time period, based on analysis of the audio signal; determining, over the time period and based on a combination of the one or more monitored indicators of body language and the one or more characteristics of the voice of the speaker, a plurality of mood index values associated with the speaker; storing the plurality of mood index values in a database; determining a baseline mood index value for the speaker based on the plurality of mood index values stored in the database; and providing to the user at least one of an audible or visible indication of at least one characteristic of a mood of the speaker.

A non-transitory computer readable storage media, storing program instructions which are executable by at least one processor to perform: receiving a plurality of images from an environment of a user, the plurality of images being captured by a camera; receiving an audio signal of a voice of a speaker, the audio signal being captured by at least one microphone; detecting a representation of an individual in the plurality of images and identifying the individual as the speaker by correlating at least one aspect of the audio signal with one or more changes associated with the representation of the individual across the plurality of images; monitoring one or more indicators of body language associated with the speaker over a time period, based on analysis of the plurality of images; monitoring one or more characteristics of the voice of the speaker over the time period, based on analysis of the audio signal; determining, over the time period and based on a combination of the one or more monitored indicators of body language and the one or more characteristics of the voice of the speaker, a plurality of mood index values associated with the speaker; storing the plurality of mood index values in a database; determining a baseline mood index value for the speaker based on the plurality of mood index values stored in the database; and providing to the user at least one of an audible or visible indication of at least one characteristic of a mood of the speaker.

An activity tracking system, comprising: a wearable device including a housing; a camera associated with the housing and configured to capture a plurality of images from an environment of a user of the activity tracking system; and at least one processor programmed to execute a method comprising: analyzing at least one of the plurality of images to detect one or more activities, from a predetermined set of activities, in which the user of the activity tracking system is engaged; monitoring an amount of time during which the user engages in the detected one or more activities; and providing to the user at least one of audible or visible feedback regarding at least one characteristic associated with the detected one or more activities.
wherein the detection of the one or more activities is based on output from a trained neural network.
wherein the predetermined set of activities includes one or more of: eating a meal; consuming a particular type of food or drink; working; interacting with a computer device including a visual interface; talking on a phone; engaging in a leisure activity; speaking with one or more individuals; engaging in a sport; shopping; driving; or reading.
wherein the amount of time is contiguous.
wherein the amount of time includes a plurality of non-contiguous time intervals summed together.
wherein providing to the user at least one of an audible or visible feedback includes causing sounds representative of the audible feedback to be produced from a speaker included in the housing or included in a secondary device being a mobile device or headphones configured to be worn by the user.
wherein providing to the user at least one of audible or visible feedback includes causing the visible feedback to be shown on a display.
wherein the at least one processor is included in a secondary device wirelessly connected to the wearable device, and the secondary device includes a mobile device.
wherein the at least one of audible or visible feedback indicates to the user at least one of: a total amount of time or a parentage of time within a predetermined time interval during which the user engaged in the detected one or more activities; an indication of the detection of the one or more activities in which the user engaged; or one or more characteristics associated with the detected one or more activities in which the user engaged.
wherein the one or more characteristics include a type of food consumed by the user or an application used on a computer or mobile device.
wherein the at least one of audible or visible feedback includes a suggestion for one or more behavior modifications.
herein the suggestion for one or more behavior modifications is based on user-defined goals or on official recommendations.
wherein the detected one or more activities include detection of an interaction between the user and one or more recognized or unrecognized individuals, and the at least one of audible or visible feedback indicates to the user an amount of time the user has spent with the one or more recognized individuals.
wherein the detected one or more activities include detection of user interactions with a plurality of different devices including one or more of: a television, a laptop, a mobile device, a tablet, a computer workstation, or a personal computer, and the at least one of audible or visible feedback indicates to the user an amount of time the user has spent interacting with the plurality of different devices.
wherein the detected one or more activities include detection of user interactions with one or more computer devices, and the at least one of audible or visible feedback indicates to the user a level of attentiveness associated with the user during interactions with the one or more computer devices, wherein the level of attentiveness is determined based on one or more images that show at least a portion of the user's face.
wherein the level of attentiveness is determined based on a detected rate of user input to the one or more computing devices.
wherein the detected one or more activities include detection of user interactions with one or more items associated with potentially negative effects, and the at least one of audible or visible feedback indicates to the user a suggestion for modifying one or more activities associated with the one or more items, wherein the one or more items associated with potentially negative effects include at least one of: cigars, cigarettes, smoking paraphernalia, fast food, processed food, playing cards, casino games, alcoholic beverages, or bodily actions.
wherein the one or more items associated with potentially negative health effects are defined by the user.
wherein the detected one or more activities include detection of a presence in the user of one or more cold or allergy symptoms, based on analysis of one or more acquired images showing at least one of: user interaction with a tissue, user interaction with recognized cold or allergy medication, watery eyes, nose wiping, coughing, or sneezing.
wherein the at least one of audible or visible feedback indicates to the user an amount of time the user has exhibited cold or allergy symptoms, or a detected periodicity associated with user-exhibited cold or allergy symptoms, or provides to the user feedback comprising an indication of an approaching allergy season during which allergy symptoms were detected in the user in the past.
wherein the at least one characteristic associated with the detected one or more activities includes an amount of time associated with the detected one or more activities.

A computer-implemented method for tracking activity of an individual, the method comprising: receiving a plurality of images from an environment of a user, the plurality of images being captured by a camera; analyzing at least one of the plurality of images to detect one or mom activities, from a predetermined set of activities, in which the user is engaged; monitoring an amount of time during which the user engages in the detected one or more activities; and providing to the user at least one of audible or visible feedback regarding at least one characteristic associated with the detected one or more activities.

A non-transitory computer readable storage media, storing program instructions which are executable by at least one processor to perform: receiving a plurality of images from an environment of a user, the plurality of images being captured by a camera; analyzing at least one of the plurality of images to detect one or more activities, from a predetermined set of activities, in which the user is engaged; monitoring an amount of time during which the user engages in the detected one or more activities; and providing to the user at least one of audible or visible feedback regarding at least one characteristic associated with the detected one or more activities.

A wearable personal assistant device, comprising: a housing; a camera associated with the housing, the camera being configured to capture a plurality of images from an environment of a user of the wearable personal assistant device; and at least one processor programmed to: receive information identifying a goal of an activity; analyze the plurality of images to identify the user engaged in the activity and to assess a progress by the user of at least one aspect of the goal of the activity; after assessing the progress by the user of the at least one aspect of the goal of the activity, provide to the user at least one of audible or visible feedback regarding the progress by the user of the at least one aspect of the goal of the activity.
wherein the at least one processor is further programmed to: automatically monitor schedule information associated with the user and determine future time windows potentially available for engaging in the activity; and provide to the user at least one of an audible or visible indication identifying the determined future dime windows.
wherein the schedule information is obtained from an electronic calendar associated with the user.
wherein the schedule information includes an anticipated future routine associated with the user determined based on automatic analysis of prior activities in which the user has participated as well as timing associated with the prior activities.
wherein the at least one processor is further programmed to provide to the user at least one of an audible or visible reminder regarding the activity or the goal.
wherein the at least one audible or visible reminder includes an indication that the goal of the activity has not yet been completed or is expected not to be completed within a predetermined time period.
wherein the at least one audible or visible reminder includes an identification of at least one suggested future time window sufficient for completing the goal of the activity.
wherein the reminder includes an indication of a likelihood of completion of the goal of the activity within a certain time period in view of the determined future time windows.
wherein providing to the user the at least one audible or visible feedback regarding the progress of the at least one aspect of the goal of the activity includes causing sounds representative of the audible feedback to be produced from a speaker, the speaker being at least one of included in the housing or included in a secondary device comprising at least one of a mobile device, a laptop, a tablet, or a wearable device, or comprises headphones configured to be worn by the user.
wherein the progress by the user indicates the user has completed the at least one aspect of the goal activity and wherein the audible or visible feedback indicates the at least one aspect of the goal activity is completed.
wherein providing to the user the at least one audible or visible feedback regarding the progress by the user of the at least one aspect of the goal activity includes causing the visible feedback to be shown on a display.
wherein the display is included in at least one of the housing or in a secondary device wirelessly connected to the wearable personal assistant device, the secondary device comprising at least one of a mobile device, a laptop, a tablet, or a wearable device.
wherein the activity or the goal is associated with at least one of: eating, drinking, sleeping, meeting with one or more other individuals, exercising, taking medication, reading, working, driving, interaction with computer-based devices, watching TV, smoking, consumption of alcoholic beverages, gambling, playing video games, standing, sitting, or speaking.
wherein the activity or the goal is associated with a time component indicating a period of time within which the user wishes to complete the goal.
wherein the time component is at least one of: at least one hour in duration, at least one day in duration, or at least one week in duration.
wherein the information identifying the goal of the activity is provided to the wearable personal assistant device by the user.
wherein the wearable personal assistant device includes a microphone associated with the housing for receiving from the user the information identifying the goal of the activity.
wherein the wearable personal assistant device includes a wireless transceiver associated with the housing for receiving from a secondary device the information identifying the goal activity, and wherein the information identifying the goal of the activity is provided by the user to the secondary device via one or more user interfaces associated with the secondary device.
wherein the information identifying the goal of the activity includes an indication of a certain amount of time during which the user wishes to exercise within a predetermined time period.
wherein the information identifying the goal of the activity includes an indication of a type of food or medication the user wishes to consume within a predetermined time period.
wherein the information identifying the goal of the activity includes an indication of an individual with whom the user wishes to meet within a predetermined time period.
wherein an identifier associated with the individual is stored in a database accessible by the wearable personal assistant device.
wherein the progress by the user of the at least one aspect of the goal of the activity is assessed based, at least in part, on identification of a representation of a recognized individual in one or more of the plurality of images.
wherein the progress by the user of the at least one aspect of the goal of the activity is assessed based, at least in part, on identification of a representation of a certain type of food, drink, or medication in one or more of the plurality of images.
wherein the progress by the user of the at least one aspect of the goal of the activity is assessed based, at least in part, on identification of a representation of exercise equipment appearing in one or more of the plurality of images and on an amount of time, within a certain time period, the user interacts with the exercise equipment.
wherein the progress by the user of the at least one aspect of the goal of the activity is assessed based, at least in part, on identification of a representation of a recognized location in one or more of the plurality of images.
wherein the at least one processor is further programmed to automatically track one or more goal completion metrics and provide to the user, via the at least one of audible or visible feedback, information relating to the tracked one or more goal completion metrics.
wherein the analysis of the plurality of images is at least partially performed by a trained artificial intelligence engine.

A system, comprising: a wearable device including at least one of a camera, a second motion sensor, or a second location sensor; and at least one processor programmed to execute a method, comprising: receiving, from a first motion signal indicative of an output of at least one of a first motion sensor or a first location sensor of a mobile device; receiving, from the wearable device, a second motion signal indicative of an output of at least one of the camera, the second motion sensor, or the second location sensor; determining, based on the first motion signal and the second motion signal, whether the mobile device and the wearable device differ in one or more motion characteristics; and providing an indication to a user based on a determination that the mobile device and the wearable device differ in at least one of the one or more motion characteristics. The system of claim 1, wherein said determining comprises determining whether the mobile device and the wearable device share all motion characteristics.
wherein the indication includes at least one of an audible, a visual, or a haptic indication.
wherein the mobile device comprises a mobile phone.
wherein the wearable device comprises at least one of a wearable camera or a wearable microphone.
wherein the one or more motion characteristics include: motions of the mobile device and the wearable device occurring during a predetermined time period.
wherein the one or more motion characteristics include: changes in locations of the mobile device and the wearable device occurring during a predetermined time period.
wherein the one or more motion characteristics include: rates of change of locations of the mobile device and the wearable device occurring during a predetermined time period.
wherein the one or more motion characteristics include: directions of motions of the mobile device and the wearable device occurring during a predetermined time period.
wherein the mobile device is configured to provide the indication to the user when the wearable device is determined to be still and the mobile device is determined to be in motion.
wherein the wearable device is configured to provide the indication to the user when the mobile device is determined to be still and the wearable device is determined to be in motion.
wherein the mobile device is configured to provide the indication to the user when both the mobile device and the wearable device are determined to be moving, the mobile device is determined to be moving with one or mom characteristics, and the wearable device is determined to be moving with other one or more motion characteristics.
wherein the one or more motion characteristics associated with the user are indicative of walking or running by the user.
wherein the one or more motion characteristics associated with the user are unique to the user, are learned through prior interaction with the user, and are represented in at least one database accessible by the at least one processor.
wherein the wearable device is configured to provide the indication to the user when both the mobile device and the wearable device are determined to be moving, the wearable device is determined to be moving with one or more characteristics associated with motion of the user, and the mobile device is determined to be moving with other one or more motion characteristics.
wherein determining whether the mobile device and the wearable device share the one or more motion characteristics includes determining whether the first motion signal and the second motion signal differ relative to one or more thresholds.
wherein at least one of the mobile device or the wearable device is configured to provide the indication to the user.
wherein the second motion signal originates from the camera associated with the wearable device and is indicative of one or more differences between a plurality of images captured by the camera.
wherein the first location sensor or the second location sensor includes at least one of a GPS sensor or an accelerometer.
wherein the indication is provided by a secondary device associated with the user.
wherein the secondary device associated with the user comprises one of a laptop computer, a desktop computer, a smart speaker, headphones, an in-home entertainment system, or an in-vehicle system.
wherein the at least one processor comprises a processor provided on the mobile device or a processor provided on the wearable device.
wherein the at least one processor is further programmed to: determine a battery level associated with the wearable device; and provide, to the user, the indication representative of the determined battery level associated with the wearable device.
wherein the at least one processor is further programmed to: determine, based on the first motion signal and the second motion signal, whether both the mobile device and the wearable device have been motionless for a predetermined period of time; and send an interrogation signal to the wearable device from the mobile device upon an indication by the first motion signal of motion associated with the mobile device occurring after the predetermined period of time.
wherein the at least one processor is programmed to determine whether both the mobile device and the wearable device have been motionless for a predetermined period of time, based on an absence of the second motion signal received at the mobile device for at least part of the predetermined period of time.
wherein the interrogation signal is configured to wake one or more components of the wearable device to reinitiate transmission to the mobile device of the second motion signal.

A method of providing an indication to a user, the method comprising: receiving, from a mobile device, a first motion signal indicative of an output of a first motion sensor or a first location sensor associated with the mobile device; receiving, from a wearable device, a second motion signal indicative of an output of at least one of a second motion sensor, a second location sensor, or a camera associated with the wearable device; determining, based on the first motion signal and the second motion signal, whether the mobile device and the wearable device share one or more motion characteristics; and providing an indication to a user based on a determination that the mobile device and the wearable device do not share at least one of the one or more motion characteristics.

A non-transitory computer readable medium storing instructions executable by at least one processor to perform a method, the method comprising: receiving, from a mobile device, a first motion signal indicative of an output of a first motion sensor or a first location sensor associated with the mobile device; receiving, from a wearable device, a second motion signal indicative of an output of at least one of a second motion sensor, a second location sensor, or a camera associated with the wearable device; determining, based on the first motion signal and the second motion signal, whether the mobile device and the wearable device share one or more motion characteristics; and providing an indication to a user based on a determination that the mobile device and the wearable device do not share at least one of the one or more motion characteristics.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such us secondary storage devices, for example, hard disks or CD ROM, or other firms of RAM or ROM, USB media, DVD, Blu-ray. Ultra HD Blu-ray, or other optical drive media.

Computer programs based on the written description and disclosed methods are within the skill of an experienced developer. The various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1-22. (canceled)

23. A system comprising:
a camera configured to capture images from an environment of a user and output an image signal;
a microphone configured to capture voices from an environment of the user and output an audio signal; and
at least one processor programmed to execute a method, comprising:
identifying, based on at least one of the image signal or the audio signal, at least one individual speaker in a first environment of the user;
applying a voice classification model to classify at least a portion of the audio signal into one of a plurality of voice classifications based on at least one voice characteristic, the voice classifications denoting an emotional state of the at least one individual speaker;
applying a context classification model to classify the first environment of the user into one of a plurality of contexts, based on information provided by at least one of the image signal, the audio signal, an external signal, or a calendar entry;
associating, in at least one database, the at least one individual speaker with the voice classification, and the context classification of the first environment; and
providing, to the user, at least one of an audible, visible, or tactile indication of the association.

24. The system of claim 23, wherein the at least one voice characteristic comprises:
a pitch of the at least one individual speaker's voice,
a tone of the at least one individual speaker's voice,
a rate of speech of the at least one individual speaker's voice,
a volume of the at least one individual speaker's voice,
a center frequency of the at least one individual speaker's voice,
a frequency distribution of the at least one individual speaker's voice, or
a responsiveness of the at least one individual speaker's voice.

25. The system of claim 23, wherein the method further comprises analyzing the audio signal to distinguish voices of two or more different speakers represented by the audio signal.

26. The system of claim 25, wherein analyzing the audio signal to distinguish voices of two or more different speakers in the audio signal comprises distinguishing a component of the audio signal representing a voice of the user, if present among the two or more different speakers, from a component of the audio signal representing a voice of the at least one individual speaker.

27. The system of claim 26, wherein the voice classification model is applied to the component of the audio signal representing the voice of the user.

28. The system of claim 26, wherein the voice classification model is applied to the component of the audio signal representing the voice of the at least one individual.

29. The system of claim 23, wherein the method further comprises:
applying an image classification model to classify at least a portion of the image signal, the portion of the image signal representing at least one of the user, or the at least one individual, into one of a plurality of image classifications based on at least one image characteristic, the image classifications denoting an emotional state of the user, or the at least one individual.

30. The system of claim 29, wherein the at least one image characteristic comprises:
a facial expression of the at least one speaker,
a smile,
a posture of the at least one speaker,
a movement of the at least one speaker,
an activity of the at least one speaker, or
an image temperature of the at least one speaker.

31. The system of claim 23, wherein the camera comprises a video camera and the image signal comprises a video signal.

32. The system of claim 23, wherein the camera and the microphone are each configured to be worn by the user.

33. The system of claim 23, wherein the camera and the microphone are included in a common housing.

34. The system of claim 33, wherein the at least one processor is included in the common housing.

35. The system of claim 23, wherein identifying the at least one individual comprises recognizing a voice of the at least one individual.

36. The system of claim 23, wherein identifying the at least one individual comprises recognizing a face of the at least one individual.

37. The system of claim 23, wherein identifying the at least one individual comprises recognizing at least one of a posture, or a gesture of the at least one individual.

38. The system of claim 23, wherein the context classification model is based on at least one of: a neural network or a machine learning algorithm trained on one or more training examples.

39. The system of claim 23, wherein the plurality of contexts include at least a work context and a social context.

40. The system of claim 23, wherein providing an indication of the association comprises providing the indication via a secondary computing device.

41. The system of claim 40, wherein the secondary computing device comprises at least one of:
a mobile device,
a smartphone,
a laptop computer,
a desktop computer,
a smart speaker,
an in-home entertainment system, or
an in-vehicle entertainment system.

42. The system of claim 40, wherein the secondary computing device is configured to be wirelessly linked to the system including the camera and the microphone.

43. The system of claim 23, wherein providing an indication of the association comprises providing at least one of a first entry of the association, a last entry of the association, a frequency of the association, a time-series graph of the association, a context classification of the association, or a voice classification of the association.

44. The system of claim 23, wherein providing an indication of the association comprises showing, on a display, at least one of:
a bar chart,
a pie chart,
a histogram,
a Venn diagram,
a gauge,
a heat map, or
a color intensity indicator.

45. The system of claim 44, wherein the display is provided on one of:
a mobile device,
a smartphone,
a laptop computer,
a desktop computer,
an in-home entertainment system, or
an in-vehicle entertainment system.

46. The system of claim 23, wherein the method further comprises determining an emotional situation within an interaction between the user and the at least one individual speaker.

47. The system of claim 23, wherein the method avoids transcribing an interaction associated with the audio signal, thereby maintaining privacy of the user and the at least one individual speaker.
